(19) United States
(12) Patent Application Publication
(10) Pub. No.: US 2009/0070131 A1
(43) Pub. Date: Mar. 12, 2009

(54) STANDARDIZED URBAN PRODUCT

(76) Inventor: Lin Chen, Hefei (CN)

Correspondence Address: HOFFMANN & BARON, LLP, 6900 JERICHO TURNPIKE, SYOSSET, NY, 11791, US

(21) Appl. No.: 12/159,683

(22) PCT Filed: Jun. 27, 2006
(86) PCT No.: PCT/CN2006/001469

§ 371 Date: Oct. 29, 2008

(30) Foreign Application Priority Data
Dec. 29, 2005 (CN) 200510132878.1

(51) Int. Cl. G06Q 10/00; E04B 1/00

(52) U.S. Cl. 705/1; 52/741.1

(57) ABSTRACT

A mesh-sheet standardized block module includes a standardized house module, an animal/plant type house artistic module, or other building, and a mesh-sheet standardized block underground space module. The mesh-sheet standardized block module further includes a net-like standardized road/bridge module and a net-like standardized canal module, and may be replicated and assembled to form a standardized urban product with a required scale. The standardized urban product has a scientific layout, appropriate function, fresh air, exquisite landscape, and fluent traffic. Moreover, due to its high efficiency and low cost, the standardized urban product has significant economic benefits, and may create a profit of 20,000 billion US dollars, and provide plenty of jobs. In addition the criteria and methods for manufacturing a standardized urban product with no traffic jam, but exquisite environment, low price, and commodity house markets in various prices are provided through technical schemes for countries with water sources such as China, the USA, India, and Nigeria.

### BACKGROUND OF THE INVENTION

1. Field of Invention

The present invention relates to an urban product, and more particularly to a standardized urban product.

2. Related Art

The existing urban products are manufactured by a scattered and tedious manufacturing method and also expands to surrounding areas in a cake-like spread pattern during the rapid growth of population. At the same time of the expansion, the existing urban product is confronted with the reality of the shortage of water resources, traffic jam, environmental pollution, employment difficulty, high manufacturing cost, widening income gap, and serious social conflicts. For this reason, experts and scholars of urban products have made discussions and attempts in many aspects. For example, the garden city of English scholar Edward has always been regarded as a classic in urban products by the experts and scholars all over the world. The Edward's satellite garden city product was initiated in 1903 and is characterized by a cross layout of farmlands and cities, such that not only residents living in the urban product can appreciate rural scenes, but also domestic wastes of urban residents may be recycled by farmlands, thus facilitating the ecological balance between human residence and the nature. The overall urban planning of Shanghai in China has also learned from and adopted the design concept of Edward's satellite garden city. However, the planning and design concept of the satellite garden city obviously does not conform to the practical direction of urbanization of rural population in countries with large populations such as China and India. The world population was only over 1 billion over 100 years ago. Due to a small population, gardens between London's main urban area and satellite cities have no agricultural pollution. However, areas between the main urban area and satellite cities in countries with large populations such as China and India have been reclaimed into farmlands. Sewage wastes of suburbs of the main urban area and satellite cities are discharged into farmlands. Also, the extensive use of pesticides and fertilizers causes serious pollution to farmlands. They both result in a severer pollution in urban-rural joint areas between the satellite cities and the main urban area. Each of the satellite cities also needs supporting facilities of urban construction infrastructure and urban social infrastructure. Due to the small size of the satellite urban areas, the cost of these supporting facilities is always higher than that of expanding a large city outwards in the cake-like spread pattern.

Since the current net growth of the world population is more than 90 million per year, the global population may have grown to 9 to 10 billion by the middle of this century. Therefore, the realization of a migration goal of urbanization of rural population by developing satellites cities to alleviate pressure of the rapid growth of population, traffic pressure, and environmental pressure of the main urban area in countries with large populations such as China and India is unrealistic from the perspective of global population growth and urbanization of rural population. The mere planning of satellite city clusters by learning from and adopting the planning concept of Edward's garden satellite city 100 years ago also reduces the utilization efficiency of urban population, urban land, urban water resources, and other resources. To examine the development of the urban product from the rapid growth of population and the strategy of mass migration of urbanization of rural population, the mere planning and construction of satellite cities and middle-and-small-size towns can no longer satisfy the actual requirement of the rapidly increasing urban population. By only relying on the manufacturing method of the existing urban product, many governments of countries with large populations is neither able to improve the supporting facilities of urban construction infrastructure and urban social infrastructure of middle-and-small-size towns in the satellite cities, nor able to alleviate the problems of industrial, agricultural, and domestic pollution of the satellite cities and middle-and-small-size towns thoroughly.

Due to the long-term discharging of industrial and agricultural sewage and domestic sewage into canals, canal products in cities of China, India, etc. in Asia and Africa have lost their beautiful landscape and life vigor. The manufacturing method and transportation technology of existing urban canal products cannot satisfy the freight demand of cities or the demand of citizens for appreciating beautiful sceneries of canals. Most of the existing canal products in cities are invested with money from taxpayers.

Existing bridges across rivers, lakes, and seas in cities have a limited traffic flow and single function.

From ancient to modern times, monarchs and experts and scholars in countries with large populations such as China and India appreciate the spider-web-like road structure very much when engaged in the urban planning and design of urban roads and bridges, because they think the spider can catch preys rapidly through the spider web when catching flying insects. The road network maps of most urban products in the world look just like pieces of solidified spider web.

After human stepped into the capitalism period, urban products especially invested and developed by American entrepreneurs adopted the market-positioning-oriented planning and design at the very start, and eliminated spider-web-like urban roads in order to satisfy the traffic demand and other demands of the people. Since the process of urbanization of rural population in America is several decades earlier than that in the countries with large populations such as China and India, neither such rapid development of today's urban products due to the over-fast growth of population nor the massive flow of vehicles and passengers in today's urban products can be predicted. The traffic jam not only bothers major cities in America and the world, but also is more predominant in urban products sharply developed in countries with large populations such as China and India. For example, roads and bridges in large and middle-size cities such as Shanghai and Beijing have become mobile car parks. The existing technology cannot solve the problems of traffic jam, parking difficulty, and environmental pollution in cities thoroughly.

Airports in existing urban products have small size, large amount, low efficiency, and high cost. For example, planes in multiple airports of New York in America take off and land in multiple sites, which aggravates the visual pollution and noise pollution for urban residents.

The method of filling the sea to build cities in existing urban products is scattered and tedious, has a small size, and lacks an overall scientific, artistic, and strategic planning scheme, which results in a lack of beautility of projects of filling the sea to build cities in existing urban products.

Existing block products in cities are manufactured by a scattered and tedious method with a long manufacturing cycle, construction of many redundant projects, unreasonable supporting facilities of infrastructure, traffic jam, and parking difficulty. According to the manufacturing technology of existing house products, raw materials such as sands, stones, cement and steel are transported from the resource place to the place of urban block product, so as to manufacture the house products with manual work and machine assistance. The manufacturing technology has a low efficiency, high cost, is a waste of resources, consumption of energy, and pollution of environment, and has a poor performance in preventing from terrorist attacks. Existing manufacturing technology of urban blocks and houses is one of the main reasons why commercial houses are expensive.

Existing house products are basically designed and manufactured with geometric models such as squares, rectangles, circles, semicircles, and triangles. Although existing house products are able to provide basic living conditions of urban and rural consumers, urban and rural residents are isolated from experiences of getting acquainted and compatible with animals and plants of the nature and short of healthy and artistic enjoyment in wild/ecological animal/plant type restaurant products.

Underground space products in existing urban blocks adopt a scattered and tedious manufacturing method. The lane, sidewalk, parking space, ventilation, illumination, and safety in the underground space products are far behind the demand of rapid growth of urban population. Rainwater pipes, sewage pipes, tap water pipes, landscape water pipes, coal gas pipes, natural gas pipes, oil pipes, heating pipes, cooling pipes, power supply pipelines, telephone pipelines, TV pipelines, computer pipelines, and intelligent pipelines in existing urban block products adopt a scattered and tedious manufacturing method and have high cost and low efficiency. The maintenance of various pipelines often requires the digging and mending on the ground, which results in not only a high cost and low efficiency in maintenance but also difficulties to the life of citizens.

Most of universities and technical secondary schools in existing urban products belong to comprehensive schools and depart from the actual requirement of industrialization. Enterprises cannot recruit professional talents and practical artisans who can take on important tasks immediately from graduated of universities and technical secondary schools. The graduates cannot find satisfactory employment posts either due to their mismatch majors and lack of the experience of applying theory to practice. Kindergartens, primary schools, and middle schools in existing urban products are manufactured by a scattered and tedious method. They have small size, large amount, generally lack physical exercise places, library and network learning places, science, culture, and art experimenting places, which results in students' lack of physical activities, practice, innovation, and vigor.

Existing urban products lack commodity industrial museums reflecting the variety, industry chain, historical evolution, culture, technology of commodities, lack exhibitions reflecting social division of labor, progress in technology, educational revolution, and variation of quality of life brought to human beings by commodity variation, and lack the learning, experiencing, and application of professional knowledge about commodities. Most of the theme parks in existing urban products belong to those of historical culture and historical figures, and an industrial park comprehensively and deeply reflecting a certain commodity is required.

Most of existing urban products adopt the functional layout with all-round development, lack a distinct characteristic of division of labor and water transportation of urban canals, and have high transportation cost, high drinking water cost, and high pollution control cost. Consequently, existing urban products have problems of high cost, low efficiency, high cost of commercial houses, high business cost, low economic benefit, insufficient investment, and employment difficulty. Enterprises in existing urban products are difficult to be merged into the main trend of global economic integration due to the lack of distinct environment and characteristic of division of labor.

Roads and bridges, blocks, buildings, units, room numbers in existing urban products have disordered address organization, too many address alterations, and too long addresses. Therefore, people from other places get lost easily. Even local people of the city often cannot tell or find the road and address exactly.

### SUMMARY OF THE INVENTION

Accordingly, the present invention is directed to a standard of an urban product, a modularized design scheme, and a manufacturing method thereof, so as to change the tedious, scattered on-site construction manner generally adopted in manufacturing an urban product, thereby compensating defects in the prior art.

A standardized urban product is provided. The standardized urban product is formed by replicating and assembling net-like standardized road/bridge modules and mesh-sheet standardized block modules. The net-like standardized road/bridge modules are arranged between the mesh-sheet standardized block modules. The mesh-sheet standardized block modules include buildings of the mesh-sheet standardized block modules and underground space of the mesh-sheet standardized block modules. The mesh-sheet standardized block modules are arranged between the net-like standardized road/bridge modules. The mesh-sheet standardized block modules and the net-like standardized road/bridge modules can be replicated and assembled to form standardized urban products on scales meeting people's demands.

The standardized urban product further includes net-like standardized canal modules. The net-like standardized canal modules are arranged between the mesh-sheet standardized block modules and the net-like standardized road/bridge modules. The net-like standardized canal modules in communication with the mesh-sheet standardized block modules and the net-like standardized road/bridge modules can be replicated and assembled to form a standardized urban product with a waterway-canal.

Upon actual requirements, a sheet-like standardized urban module further includes net-like standardized rail modules, multifunctional bridge modules, underground fairway modules, standardized airport modules, standardized kindergartens, primary schools, and middle schools, standardized senior high schools, industrial technical schools, industrial universities, industrial museums, and industrial parks.

The net-like standardized road/bridge modules are provided with intercommunication standardized overpasses, fast lanes, landscape isolation zones, slow lanes, and sidewalks. In such a module, motor vehicles can drive straightforward and turn right.

Upon actual requirements, the standardized urban product provides [symbol] -shaped standardized canal modules on irregular landscapes. The [symbol] -shaped standardized canal modules are arranged between the net-like standardized road/bridge modules and the mesh-sheet standardized block modules.

The standardized urban product provides standardized canal modules in the shape of [symbol] [symbol] or [symbol] on irregular landscapes. The [symbol] or [symbol] -shaped standardized canal modules are arranged between the net-like standardized road/bridge modules and the mesh-sheet standardized block modules.

Upon actual requirements, the net-like, [symbol] [symbol] or [symbol] -shaped standardized canal modules are provided with net-like, [symbol] [symbol] or [symbol] -shaped power supply pipeline modules and intelligent pipeline modules.

The net-like, [symbol] [symbol] or [symbol] -shaped standardized canal modules are further provided with net-like and mesh-sheet standardized clean water pipe modules for drawing clean groundwater from the underground thereof or the underground on both sides.

Upon actual requirements, the standardized urban product is provided with industrial manufacturing mesh-sheet standardized block modules including standardized workshops and other buildings. The industrial manufacturing mesh-sheet standardized block modules are arranged between the mesh-sheet standardized underground space modules and the net-like/mesh-sheet standardized pipeline modules, and also arranged between the net-like standardized road/bridge modules.

Upon actual requirements, the standardized urban product provides commercial/residential mesh-sheet standardized block modules including standardized house modules, animal/plant type house artistic modules, or other buildings. The commercial/residential mesh-sheet standardized block modules are arranged between the mesh-sheet standardized block underground space modules and the net-like/mesh-sheet standardized pipeline modules, and also arranged between the net-like standardized road/bridge modules.

Upon actual requirements, the standardized urban product further provides R&D transactional mesh-sheet standardized block modules including standardized house modules, animal/plant type house artistic modules, or other buildings. The R&D transactional mesh-sheet standardized block modules are arranged between the mesh-sheet standardized block underground space modules and the net-like/mesh-sheet standardized pipeline modules, and also arranged between the net-like standardized road/bridge modules.

Upon actual requirements, the standardized urban product further provides hybrid economic mesh-sheet standardized block modules including standardized house modules, animal/plant type house artistic modules, or other buildings. The hybrid economic mesh-sheet standardized block modules are arranged between the mesh-sheet standardized block underground space modules and the net-like/mesh-sheet standardized pipeline modules, and also arranged between the net-like standardized road/bridge modules.

Upon actual requirements, the standardized urban product further provides garden-type mesh-sheet standardized block modules including standardized house modules, animal/plant type house artistic modules, or other buildings. The garden-type mesh-sheet standardized block modules are arranged between the mesh-sheet standardized block underground space modules and the net-like/mesh-sheet standardized pipeline modules, and also arranged between the net-like standardized road/bridge modules.

Upon actual requirements, the standardized urban product further provides cultural relics and historic sites type mesh-sheet standardized block modules including standardized house modules, animal/plant type house artistic modules, or other buildings. The cultural relics and historic sites type mesh-sheet standardized block modules are arranged between the mesh-sheet standardized block underground space modules and the net-like/mesh-sheet standardized pipeline modules, and also arranged between the net-like standardized road/bridge modules.

Upon actual requirements of resources like rivers, lakes, seas, mountain areas, and wetlands, the standardized urban product further provides scenic spot type mesh-sheet standardized block modules including standardized house modules, animal/plant type house artistic modules, or other buildings. The scenic spot type mesh-sheet standardized block modules are arranged between the mesh-sheet standardized block underground space modules and the net-like/mesh-sheet standardized pipeline modules, and also arranged between the net-like standardized road/bridge modules.

Upon actual requirements, the standardized urban product further provides square standardized block modules.

Upon actual requirements, the standardized urban product further provides rectangular standardized block modules.

Upon actual requirements, the standardized urban product further provides triangular standardized block modules.

Upon actual requirements, the standardized urban product further provides rhombic standardized block modules.

Upon actual requirements, the standardized urban product further provides hexagonal standardized block modules.

Upon actual requirements, the standardized urban product further provides honeycomb-type standardized block modules.

Upon actual requirements, the standardized urban product further provides circular standardized block modules.

Upon actual requirements, the standardized urban product further provides elliptic standardized block modules.

Upon actual requirements, the standardized urban product further provides animal/plant type block artistic modules.

Upon actual requirements, the mesh-sheet standardized block modules are provided with standardized commercial pedestrian street modules.

The mesh-sheet standardized block modules are set with an area of a (m)×a (m)=a² (m²).

The mesh-sheet standardized block modules are set with an area of a (m)×b (m)=ab (m²).

The mesh-sheet standardized block modules and the net-like standardized road/bridge modules are integrated and replicated to form a sheet-like standardized urban module assembled with G, one hundred, or within one hundred mesh-sheet standardized block modules.

The mesh-sheet standardized block modules, the net-like standardized road/bridge modules, and the net-like standardized canal modules are integrated and replicated to form a sheet-like standardized urban module assembled with G, one hundred, or within one hundred mesh-sheet standardized block modules.

The mesh-sheet standardized block modules include standardized house modules. The standardized house modules are further provided with industrial prefabricated standardized house components, such as house foundations, septic tanks, walls, floorslabs, stairs, walkways, doors, windows, balconies, floors, and roofs.

Upon actual requirements, the standardized house module components include buckling members and prefabricated/preserved holes. The upper-layer walls and the low-layer walls as well as the walls and the roofs are joined and butt welded with reinforcing steel bars, and the welding seams are filled by concrete. The lateral joining between the walls, the joining between the doors, windows, walls and the floorslabs, and the joining between the floors are accomplished by buckling members, and the joints are filled by concrete.

The standardized house module can be integrally prefabricated in a template house module transportation standard case.

Upon actual requirements, the wall boards of the standardized house module are hollow wall boards filled with rice hulls, straws, crop stalks, and other plants, or filled with plastic foam materials.

Upon actual requirements, the walls of the standardized house module have corners with prefabricated/preserved holes. When being assembled, the house module is locked by anchor chains passing through the roof to the house module foundation and penetrating the corners of each floor according to actual requirements.

Upon actual requirements, external walls of the standardized house module have lining walls, and the lining walls are provided with prefabricated/preserved screws and hidden buckles chained to the external walls.

Upon actual requirements, the lining walls of the standardized house module are adhered to the external walls through adhesives.

Upon actual requirements, the lining walls of the standardized house module are hollow.

Upon actual requirements, the roofs, walls, doors, and enclosure walls of anti-terrorism house modules are fabricated by explosion-proof, bulletproof, fireproof, waterproof, and sound insulation materials. Upon actual requirements, the transparent enclosure walls, windows, and swimming pool safety covers of the anti-terrorism house modules are made of bulletproof, radiation-proof, and sound insulation glass.

Upon actual requirements, the anti-terrorism house modules are provided with antitoxic oxygen supply intelligent early-warning facilities connected to air-conditioners.

The animal/plant type house artistic modules are fabricated with colors and vivid images of the animals and plants in the nature by construction and decoration materials. The shapes of the animal/plant type house artistic modules portray the animals and plants in the nature. As for the house artistic modules in shapes of animals and plants in the water, environmental color modules matching the animals and plants in the water are provided to serve as podium buildings of the aquatic animal/plant type house artistic modules. As for the house artistic modules in shapes of the animals and plants on the land, environmental color modules matching the animals and plants on the land are provided to serve as podium buildings of the terrestrial animal/plant type house artistic modules.

Upon actual requirements, the walls, doors, windows, balconies, roofs, and external decorations of the animal/plant type house artistic modules are artistic portrayal of the animal/plant or in consistent environmental colors. Upon actual requirements, the walkways, bedrooms, kitchens, toilets, and various pipelines, etc., inside the animal/plant type house artistic modules are fabricated by combining the conventional house inner structure with characteristics of the animals and plants.

Upon actual requirements, the internal/external decorations of the animal/plant type house artistic modules demonstrate and portray origins, evolution, taming, living environment, food chains, natural enemies, scientific knowledge, or legend stories of the animals and plants.

The animal/plant type house artistic modules are fabricated in the form of comics, sketch, animation, cartoon, paper-cut, iron picture, feather picture, sample picture, shell picture, oil painting, traditional Chinese painting, water color painting, computer drawing, spray painting, sculpture, ceramics, clay sculpture, aluminum alloy steel engraving, reinforcing steel bar cement, wood bamboo carving, clay rock, plastic sculpture, copper sculpture, glass artwork, bio-nano hybrid material imitation, picture-story book, woodcut, fairy tale picture, story picture, film/TV program picture, or photograph.

T The assembled module in which the net-like standardized road/bridge modules and the mesh-sheet standardized block modules are integrated includes the net-like/mesh-sheet standardized pipeline modules. Upon actual requirements, the net-like/mesh-sheet standardized pipeline modules are selectively provided with net-like/mesh-sheet standardized rainwater pipe modules, net-like/mesh-sheet standardized tap water pipe modules, net-like/mesh-sheet standardized sewage pipe modules, net-like/mesh-sheet standardized clean water pipe modules, net-like/mesh-sheet standardized coal gas pipe modules, net-like/mesh-sheet standardized natural gas pipe modules, net-like/mesh-sheet standardized oil pipe modules, net-like/mesh-sheet standardized heating pipe modules, net-like/mesh-sheet standardized cooling pipe modules, net-like/mesh-sheet standardized power supply pipeline modules, net-like/mesh-sheet standardized telephone pipeline modules, net-like/mesh-sheet standardized TV pipeline modules, net-like/mesh-sheet standardized computer pipeline modules, and net-like/mesh-sheet standardized intelligent pipeline modules.

Upon actual requirements, the mesh-sheet standardized block underground space modules are provided with underground annular main driveways and cross main driveways in communication with the net-like standardized road/bridge modules. Traffic lanes and sidewalks for ease of coming in and out are located between the annular/cross main driveways and the parking spaces.

Upon actual requirements, a business invitation industry standardized urban product is provided.

Upon actual requirements, an aircraft industry standardized urban product is provided.

Upon actual requirements, a shipping industry standardized urban product is provided.

Upon actual requirements, a rail industry standardized urban product is provided.

Upon actual requirements, an automobile industry standardized urban product is provided.

Upon actual requirements, a motorcycle industry standardized urban product is provided.

Upon actual requirements, a bicycle industry standardized urban product is provided.

Upon actual requirements, a construction machinery industry standardized urban product is provided.

Upon actual requirements, a construction material industry standardized urban product is provided.

Upon actual requirements, a steel industry standardized urban product is provided.

Upon actual requirements, a copper material industry standardized urban product is provided.

Upon actual requirements, an aluminum material industry standardized urban product is provided.

Upon actual requirements, a mining industry standardized urban product is provided.

Upon actual requirements, a petrochemical industry standardized urban product is provided.

Upon actual requirements, a fuel gas industry standardized urban product is provided.

Upon actual requirements, an environmental protection industry standardized urban product is provided.

Upon actual requirements, an electric power industry standardized urban product is provided.

Upon actual requirements, an agricultural product industry standardized urban product is provided.

Upon actual requirements, an ethnic customs dietary culture industry standardized urban product is provided.

Upon actual requirements, a furniture industry standardized urban product is provided.

Upon actual requirements, an office industry standardized urban product is provided.

Upon actual requirements, a cultural and artistic industry standardized urban product is provided.

Upon actual requirements, a sports industry standardized urban product is provided.

Upon actual requirements, a medical health industry standardized urban product is provided.

Upon actual requirements, an education industry standardized urban product is provided.

Upon actual requirements, a communication information industry standardized urban product is provided.

Upon actual requirements, a household appliances industry standardized urban product is provided.

Upon actual requirements, a textile industry standardized urban product is provided.

Upon actual requirements, an industrial machinery industry standardized urban product is provided.

Upon actual requirements, a commodity industry standardized urban product is provided.

Upon actual requirements, a heater/cooler industry standardized urban product is provided.

Upon actual requirements, an elevator industry standardized urban product is provided.

Upon actual requirements, a food industry standardized urban product is provided.

Upon actual requirements, a paper printing industry standardized urban product is provided.

Upon actual requirements, a gardening industry standardized urban product is provided.

Upon actual requirements, a disabled supplies industry standardized urban product is provided.

Upon actual requirements, a logistics industry standardized urban product is provided.

Upon actual requirements, a military/police supplies industry standardized urban product is provided.

Upon actual requirements, the sheet-like standardized urban modules are set with an area of a (m)×a (m)=a² (m²).

Upon actual requirements, the sheet-like standardized urban modules are set with an area of a (m)×b (m)=ab (m²).

Upon actual requirements, the standardized urban product further provides net-like standardized rail modules. The net-like standardized rail modules are arranged between the net-like standardized road/bridge modules and the mesh-sheet standardized block modules.

Upon actual requirements, the standardized urban product further provides net-like standardized rail modules. The net-like standardized rail modules are arranged between the net-like standardized road/bridge modules and the mesh-sheet standardized block modules as well as the net-like standardized canal modules.

Upon actual requirements, the standardized urban product further provides net-like standardized rail modules. The net-like standardized rail modules are arranged between the net-like standardized road/bridge modules and the sheet-like standardized urban modules.

Upon actual requirements, the standardized urban product further provides net-like standardized rail modules. The net-like standardized rail modules are arranged between the net-like standardized road/bridge modules and the sheet-like standardized urban modules as well as the net-like standardized canal modules.

Upon actual requirements, the standardized urban product further provides industrial technical schools.

Upon actual requirements, the standardized urban product further provides industrial universities.

Upon actual requirements, the standardized urban product further provides industrial parks.

Upon actual requirements, the standardized urban product further provides industrial museums.

The mesh-sheet standardized block modules at a number within four and including four or within G and including G are provided with a standardized kindergarten/primary/middle school composed of a kindergarten, a primary school, and a middle school. The mesh-sheet standardized block modules at a number within 25 and including 25 or within G and including G are provided with a standardized senior high school. The standardized senior high school and the standardized kindergarten, primary, and middle school both have sports, scientific, literary & experimental, library, and network areas.

Upon actual requirements, the standardized urban product further provides underground fairway modules with water as the carrier.

The underground fairway module having a cross-sectional area=π×(d÷2)²÷2+d·b+ππ×(d÷2)²÷2 and a length of L (m) is located in a range of altitude D (m) to −C (m).

Upon actual requirements, the underground fairway module is provided with standardized power supply pipelines, standardized intelligent pipelines, and electric/intelligent shipping dock areas.

Upon actual requirements, the water inlets and outlets of the underground fairway module are equipped with electric/intelligent water gates.

Upon actual requirements, the multifunctional bridge module is provided with railways and rail stations. Upon actual requirements, the rail station is equipped with sightseeing elevators and sightseeing stairs directly leading to the sightseeing corridor bridge on the top floor. Upon actual requirements, the multifunctional bridge module is further provided with traffic lanes for heavy/light vehicles and parking platforms. Upon actual requirements, the parking platform is equipped with sightseeing elevators or sightseeing stairs.

Upon actual requirements, the multifunctional bridge module is provided with one-story or multi-story sightseeing corridor bridges. Upon actual requirements, the sightseeing corridor bridge is further equipped with entertainment sightseeing places and sightseeing passages.

The multifunctional bridge module has a first-layer bridge floor provided with fast lanes and slow lanes, and a second-layer bridge floor provided with sightseeing corridor bridges for pedestrians.

Upon actual requirements, the standardized airport module has standardized terminal modules in a shape of [symbol] [symbol] or

[symbol]

Upon actual requirements, the components of the standardized house modules and the urban infrastructures in the standardized urban product are designed, fabricated at places of origin for raw materials according to standardized modules, and then transported to the location of the standardized urban product to be further installed in standard.

Upon actual requirements, it is convenient for the mesh-sheet standardized block modules to provide underground space modules with required scales. Upon actual requirements, the earthwork demanded by the mesh-sheet standardized block underground space module can be shipped through amphibian dredges or earthwork transport ships to a sea beach for filling the sea to build cities or to a lake beach for filling the lake to build cities.

The standardized urban product can lend the standardized workshops by means of rent-free or rent reduction, so as to attract more industrial enterprises and accommodate more employees, thereby promoting the marketing of the standardized house products.

In the present invention, the standardized urban product is constituted by technical characteristics and schemes of the net-like standardized road/bridge modules, the net-like, [symbol] [symbol] or [symbol] -shaped standardized canal modules, the net-like standardized rail modules, the sheet-like standardized urban modules, the mesh-sheet standardized block modules, the mesh-sheet standardized block underground space modules, the multifunctional bridge modules, the standardized airport modules, the underground fairway modules, the standardized house modules, the animal/plant type house artistic products, the wild/ecological animal/plant type restaurant modules, the net-like/mesh-sheet standardized pipeline modules, the business invitation industry standardized urban products, the aircraft industry standardized urban products, the shipping industry standardized urban products, the rail industry standardized urban products, the automobile industry standardized urban products, the motorcycle industry standardized urban products, the bicycle industry standardized urban products, the construction machinery industry standardized urban products, the construction material industry standardized urban products, the steel industry standardized urban products, the copper material industry standardized urban products, the aluminum material industry standardized urban products, the mining industry standardized urban products, the petrochemical industry standardized urban products, the fuel gas industry standardized urban products, the environmental protection industry standardized urban products, the electric power industry standardized urban products, the agricultural product industry standardized urban products, the ethnic customs dietary culture industry standardized urban products, the furniture industry standardized urban products, the office supplies industry standardized urban products, the culture artistic supplies industry standardized urban products, the sports supplies industry standardized urban products, the medical health industry standardized urban products, the education supplies industry standardized urban products, the communication information industry standardized urban products, the household appliances industry standardized urban products, the textile industry standardized urban products, the industrial machinery industry standardized urban products, the commodity industry standardized urban products, the heater/cooler industry standardized urban products, the elevator industry standardized urban products, the food industry standardized urban products, the paper printing industry standardized urban products, the gardening industry standardized urban products, the disabled supplies industry standardized urban products, the logistics industry standardized urban products, or military/police supplies industry standardized urban products. As the technical characteristics of the standardized urban product are formed by the technical characteristics and schemes listed in the present invention, any urban product design and manufacturing (construction), or implementations of the real estate design, exploitation, and manufacturing (construction) will be considered infringing the claims of the standardized urban product of the present invention by employing the technical characteristics and schemes of the net-like standardized road/bridge modules, the net-like, [symbol] [symbol] or [symbol] -shaped standardized canal modules, the net-like standardized rail modules, the sheet-like standardized urban modules, the mesh-sheet standardized block modules, the mesh-sheet standardized block underground space modules, the multifunctional bridge modules, the standardized airport modules, the underground fairway modules, the standardized house modules, the animal/plant type house artistic products, the wild/ecological animal/plant type restaurant modules, the net-like/mesh-sheet standardized pipeline modules, the business invitation industry standardized urban products, the aircraft industry standardized urban products, the shipping industry standardized urban products, the rail industry standardized urban products, the automobile industry standardized urban products, the motorcycle industry standardized urban products, the bicycle industry standardized urban products, the construction machinery industry standardized urban products, the construction material industry standardized urban products, the steel industry standardized urban products, the copper material industry standardized urban products, the aluminum material industry standardized urban products, the mining industry standardized urban products, the petrochemical industry standardized urban products, the fuel gas industry standardized urban products, the environmental protection industry standardized urban products, the electric power industry standardized urban products, the agricultural product industry standardized urban products, the ethnic customs dietary culture industry standardized urban products, the furniture industry standardized urban products, the office supplies industry standardized urban products, the culture artistic supplies industry standardized urban products, the sports supplies industry standardized urban products, the medical health industry standardized urban products, the education supplies industry standardized urban products, the communication information industry standardized urban products, the household appliances industry standardized urban products, the textile industry standardized urban products, the industrial machinery industry standardized urban products, the commodity industry standardized urban products, the heater/cooler industry standardized urban products, the elevator industry standardized urban products, the food industry standardized urban products, the paper printing industry standardized urban products, the gardening industry standardized urban products, the disabled supplies industry standardized urban products, the logistics industry standardized urban products, or the military/police supplies industry standardized urban products.

In the present invention, the wild/ecological animal/plant restaurant modules include animal/plant type restaurant modules, such as wild/ecological soft-shelled turtle type restaurant modules, wild/ecological donkey restaurant modules, wild/ecological cattle restaurant modules, wild/ecological pig restaurant modules, wild/ecological horse restaurant modules, wild/ecological sheep restaurant modules, wild/ecological dog restaurant modules, wild/ecological rabbit restaurant modules, wild/ecological chicken restaurant modules, wild/ecological duck restaurant modules, wild/ecological goose restaurant modules, wild/ecological pigeon restaurant modules, wild/ecological deer restaurant modules, wild/ecological squirrel restaurant modules, wild/ecological ostrich restaurant modules, wild/ecological peacock restaurant modules, wild/ecological roe deer restaurant modules, wild/ecological bird restaurant modules, wild/ecological masked civet restaurant modules, wild/ecological snake restaurant modules, wild/ecological eel restaurant modules, wild/ecological fish restaurant modules, wild/ecological shellfish restaurant modules, wild/ecological sea cucumber/abalone restaurant modules, wild/ecological tortoise restaurant modules, wild/ecological frog restaurant modules, wild/ecological insect restaurant modules, wild/ecological bean/tomato restaurant modules, wild/ecological potato/eggplant restaurant modules, wild/ecological calabash/capsicum restaurant modules, wild/ecological waxgourd/cabbage restaurant modules, wild/ecological bamboo shoot/blind weed restaurant modules, wild/ecological mushroom/caraway restaurant modules, wild/ecological radish/celery restaurant modules, wild/ecological cafe modules, and wild/ecological ginkgo restaurant modules.

Upon actual requirements, the mesh-sheet standardized block underground space module provided by the present invention may also be considered as an underground space of the mesh-sheet standardized block module integrated with the net-like/mesh-sheet standardized pipeline modules. With continuous progress in technology, the types of the pipelines employed in the standardized urban product are increased or decreased to meet the demands of the standardized urban product in different periods. Thus, the types of the pipelines in the net-like/mesh-sheet standardized pipeline modules of the present invention can be increased or decreased according to actual requirements of the standardized urban product. Besides, the above implementation in practice may not affect the claims of the net-like/mesh-sheet standardized pipeline modules in the present invention.

In the present invention, the term “module” refers to a “product” designed and fabricated by modularization. The “module” in the present invention is a product capable of being repeatedly replicated and fabricated, for example, the standardized house module is the standardized house product fabricated by standardization, the net-like standardized road/bridge module is the net-like standardized road/bridge product fabricated by standardization, the net-like standardized canal module is the net-like standardized canal product fabricated by standardization, the mesh-sheet standardized block module is the mesh-sheet standardized block product fabricated by standardization, and the rest can be deduced by analogy. In the present invention, the term “net-like” refers to the shape similar to mesh wires of a whole piece of standardized fishnet, or similar to iron wires of a whole piece of standardized wire netting. The term “net-like” in the present invention refers to the net-like standardized road/bridge module, net-like standardized canal module, and net-like standardized rail module. As for the terms “net-like” and “mesh-sheet” in the present invention, the term “net-like” refers to the net-like standardized pipeline module of the net-like standardized road/bridge module, and the term “mesh-sheet” refers to the mesh-sheet standardized pipeline module of the mesh-sheet standardized block modules. The net-like standardized pipeline modules of the net-like standardized road/bridge modules communicate with the mesh-sheet standardized pipeline modules of the mesh-sheet standardized block modules to form the net-like/mesh-sheet standardized pipeline modules, namely, the net-like/mesh-sheet standardized rainwater pipe module, the net-like/mesh-sheet standardized sewage pipe module, the net-like/mesh-sheet standardized tap water pipe module, the net-like/mesh-sheet standardized clean water pipe module, the net-like/mesh-sheet standardized coal gas pipe module, the net-like/mesh-sheet standardized natural gas pipe module, the net-like/mesh-sheet standardized oil pipe module, the net-like/mesh-sheet standardized heating pipe module, the net-like/mesh-sheet standardized cooling pipe module, the net-like/mesh-sheet standardized power supply pipeline module, the net-like/mesh-sheet standardized telephone pipeline module, the net-like/mesh-sheet standardized TV pipeline module, the net-like/mesh-sheet standardized computer pipeline module, and the net-like/mesh-sheet standardized intelligent pipeline module.

In the present invention, the term “sheet-like” refers to the shape similar to a whole piece of standardized fishnet or a whole piece of standardized wire netting. In the present invention, the term “sheet-like” refers to a sheet-like standardized urban module, and the “mesh-sheet” looks like meshes in a fishnet or meshes in a wire netting. In the present invention, the term “mesh-sheet” refers to the mesh-sheet standardized block module. The sheet-like standardized urban module and the mesh-sheet standardized block module provided by the present invention are integrated among the net-like standardized canal modules, the net-like standardized road/bridge modules, the net-like standardized rail modules, the net-like/mesh-sheet standardized rainwater pipe modules, the net-like/mesh-sheet standardized sewage pipe modules, the net-like/mesh-sheet standardized tap water pipe modules, the net-like/mesh-sheet standardized clean water pipe modules, the net-like/mesh-sheet standardized coal gas pipe modules, the net-like/mesh-sheet standardized natural gas pipe modules, the net-like/mesh-sheet standardized oil pipe modules, the net-like/mesh-sheet standardized heating pipe modules, the net-like/mesh-sheet standardized cooling pipe modules, the net-like/mesh-sheet standardized power supply pipeline modules, the net-like/mesh-sheet standardized telephone pipeline modules, the net-like/mesh-sheet standardized TV pipeline modules, the net-like/mesh-sheet standardized computer pipeline modules, and the net-like/mesh-sheet standardized intelligent pipeline modules.

In the present invention, the expression “upon actual requirements” is used to enable technicians and investors reading the present invention to adopt the technique provided by the present invention or adopt a technique not mentioned in the present invention according to actual requirements. No matter in which case, the technicians and investors have one more option.

[Implementations]

As the prices of the land, construction materials, decoration materials, mineral resources, mechanics, and labors vary in different countries and places in the world, the manufacturing cost of the standardized urban product also varies in different countries and places. It is impossible for the present invention to give examples for each aspect, so the present invention only takes the standardized urban product implemented in the plain along the river bank and the seacoast of the middle-lower reaches of Yangtze River in China as an example to illustrate the practicability of the present invention for the technicians and investors. In the present invention, G represents quantity, L (m) is length, d (m) is diameter, b (m) is width, C (m) is depth, a (m) is side length of a square, and π is a data parameter for calculating an upper-half circle, a lower-half circle, or a circle.

In a first preferred technical embodiment of the present invention, on alluvial plains, river banks, lake beaches, and sea beaches with abundant water resources based on town clusters, an extra large-size standardized urban product formed by replicating and assembling G, or tens, or hundreds, or thousands of sheet-like standardized urban modules is provided.

In another preferred technical embodiment of the present invention, on even lands with abundant water resources based on towns, a large-size standardized urban product formed by replicating and assembling G, or hundreds, or thousands of mesh-sheet standardized block modules is provided.

In another preferred technical embodiment of the present invention, on lands with water resources based on towns, a middle-and-small-size standardized urban product formed by replicating and assembling G, or several, or tens of mesh-sheet standardized block modules is provided.

In the present invention, preferably, the mesh-sheet standardized block modules or the sheet-like standardized urban modules are compiled by a calculation mode and calculation reference with Arabic numerals of 1, 2, 3 . . . , 10, . . . , 100, . . . , 1000 . . . 100000. Upon actual requirements, the mesh-sheet standardized block modules are set with an area of a (m)×a (m)=a² (m²) or with an area of a (m)×b (m)=ab (m²). For the ease of exemplification and area calculation, the present invention adopts a calculation mode of 1 km×1 km=1 (km²) to calculate the area of the mesh-sheet standardized block modules, so as to be replicated and assembled to obtain the areas of the standardized urban product and the sheet-like standardized urban modules. Upon actual requirements, the sheet-like standardized urban modules are set with an area of a (m)×a (m)=a² (m²) or with an area of a (m)×b (m)=ab (m²). For the ease of exemplification and area calculation, the present invention adopts a calculation mode of 10 (km)×10 (km)=100 (km²) to calculate the area of the sheet-like standardized urban modules, so as to be replicated and assembled to obtain the area of a large-size or extra large-size standardized urban product.

[Standardized Canal Module]

As the cost of the waterway transportation is tens of times lower than the highway transportation, and also several times lower than the railway transportation, the advantages of the waterway transportation and the water utilization lead to a better method for manufacturing the standardized urban product. Upon actual requirements, in the present invention, the net-like standardized canal modules sever as inlets for waterway transportation and water supply, and the drain outlets for the standardized urban product. Further, upon actual requirements, on irregular landscapes of the standardized urban product, the present invention also provides [symbol] [symbol] or [symbol] -shaped standardized canal modules. The net-like, [symbol] [symbol] [symbol] -shaped standardized canal modules provided by the present invention are arranged between the sheet-like standardized urban modules. The net-like, [symbol] [symbol] or [symbol] -shaped standardized canal modules provided by the present invention are arranged between the mesh-sheet standardized block modules. Additionally, upon actual requirements, the present invention may industrially prefabricate, transport, and manufacture through a assembly line the net-like, [symbol] [symbol] or [symbol] -shaped standardized canal modules with materials such as reinforced concrete at places with river, lake, and sea resources, and then deliver the manufactured modules to be assembled on the location of the standardized urban product.

In a preferred technical embodiment of the present invention, preferably, the standardized canal module with L (m) in length×b (m) in average width×C (m) in depth is open to G-ton ships. In another preferred technical embodiment of the present invention, preferably, the sheet-like standardized urban module is provided with 4-ship channel net-like standardized canal modules with 100 km in length, 50 m in bottom width, and 4.5 m in depth open to 1000-ton ships. Upon actual requirements, the present invention is further provided with standardized canal module dock service sections. The net-like, [symbol] [symbol] or [symbol] -shaped standardized canal modules provided by the present invention can transport construction materials and mineral resources by waterway to the destination of the standardized urban product which is a bank of 500 m on average, and also transport supplies and commodities manufactured and traded in the standardized urban product out through waterway. In addition, the waterway not only has a great transport capacity, but also has a cost tens of times lower than the automobiles and several times lower than the railway transportation. Therefore, the net-like, [symbol] [symbol] or [symbol] -shaped standardized canal modules transport construction materials and mineral resources to the location of the standardized urban product for construction according to the existing technology, so as to improve the transportation efficiency, alleviate the transportation pollution, lower the transportation cost, enhance the manufacturing and operating efficiency, and reduce the manufacturing and business cost.

Upon actual requirements, the present invention provides net-like, [symbol] [symbol] or [symbol] -shaped power supply pipeline modules and intelligent pipeline modules for the net-like, [symbol] [symbol] or [symbol] -shaped standardized canal modules, so as to supply clean energy to electric/intelligent ships. Upon actual requirements, in the present invention, electric/intelligent water gates are set at the water inlets and outlets of the net-like, [symbol] [symbol] or [symbol] -shaped standardized canal modules, so as to control the water level in the net-like, [symbol] [symbol] or [symbol] -shaped standardized canal modules. Further, upon actual requirements, the clean groundwater beneath or at both sides of the riverway of the net-like, [symbol] [symbol] or [symbol] -shaped standardized canal modules can be drawn out to make the clean groundwater on the riverbed rapidly compensated. The clean groundwater filtered by sediments in the nature is not only low in cost, but more natural and real, and thus can be used to form the most lively, vivid, compatible, and gentle waterfalls, fountains, water streets, water corridors, water bridges, brooks, pools, etc., in the standardized urban product.

Upon actual requirements, the present invention also provides underground fairway modules with water as the carrier. In a preferred technical embodiment of the present invention, two circulated underground fairway modules are provided. The underground fairway modules having a cross-sectional area=π×(d÷2)²÷2+d·b+π(d÷2)²÷2 and a length of L (m) are located in a range of altitude D (m) to −C (m). In another preferred technical embodiment of the present invention, underground fairway modules located in a range of altitude 12 (m) to −18 (m) with a cross-sectional area=3.14×(20 m÷2)²÷2+20 m×10 m+3.14×(20 m÷2)²÷2 are provided for two snake-shaped and electric train-type electric/intelligent ships. The underground fairway modules provided by the present invention are partially above the water. Further, upon actual requirements, power supply pipeline modules and intelligent pipeline modules are provided to supply power and provide functions such as illumination, automatic photography, and automatic control for the electric/intelligent ships. The underground fairway modules are manufactured by tunnel excavation or other techniques, so as to prevent seawater entering to affect the ecologic environment. The underground fairway modules are provided with mineral resources shipping docks. Additionally, upon actual requirements, the present invention also provides antitoxic early-warning systems, automatic load/unload systems, mineral resources standard case load/unload devices, techniques for loading/unloading articles through vehicle/ship conveyer belts, and techniques for automatically lifting articles.

Upon actual requirements, the underground fairway modules adopt seawater resources as the carrying water sources, as the seawater resources are inexhaustible, and the seawater fairway has a great transport capacity. Upon actual requirements, the present invention may also adopt the river water, lake water, underground water, and intermediate water as carrying media for the underground fairway modules. The length and the cross-sectional area of the underground fairway module vary according to the actual transportation volume and requirements of the commercial and military value. The underground fairway modules can be set along the seacoast, between the coalfields, oil fields, and mines, between the coastal and inland cities, between the coastal and inland countries, and circulate between the seacoast and the inland or between the inland and the seacoast.

The technical schemes provided by the present invention have the following efficacies. First, the underground fairway modules of the present invention achieve great economic benefits. As the water transport capacity is larger than the train and even far beyond the automobile, it is apparent that the transportation cost is significantly reduced. Secondly, plenty of land resources are saved, and the environmental pollution is alleviated, so the present invention is more concealed, secure, and reliable from the strategic aspect. Thirdly, as abundant seawater is adopted as the transportation medium, there is certainly no worry about the transportation of supplies for the standardized urban product. Further, the present invention sets electric/intelligent water gates on the water inlets and drain outlets of the standardized canal modules and the underground fairway modules, so as to control the water sources and the water levels.

For example, two underground fairway modules on upper and lower layers are manufactured to transport 5-10 billion ton goods per year. The underground fairway modules, the net-like, [symbol] [symbol] or [symbol] -shaped standardized canal modules, and the standardized urban products can be connected to form the most economical and secure transportation main artery once for all.

For example, assume that it costs RMB 294.9 billion to manufacture a 457 km underground fairway module+a 210 km standardized canal module from east to Tang Gugang Gulf in Tianjin, China and west to Dongsheng area in Inner Mongolia, China. Further, assume that a transportation fee of RMB 100 is saved every ton of coal, and 1 billon tons of coal is delivered each year, so in total RMB 100 billion is saved from the transportation fee. Moreover, as about 600 billion tons of coal is delivered from Inner Mongolia, Shaanxi, and Shanxi in China, theoretically, RMB 60,000 billion can be saved from the transportation fee.

At present, 150 billion tons of mineral resources mined each year need to be delivered. Thus, the net-like, [symbol] [symbol] or [symbol] -shaped standardized canal modules and underground fairway modules can be reasonably provided according to cities, populations, resources, and transportation volumes.

[Manufacturing Cost Estimation on Standardized Canal Module]

□. Manufacturing Cost Estimation on Earthwork for the Net-Like Standardized Canal Module of the Sheet-Like Standardized Urban Module

(1) Manufacturing cost estimation on earthwork excavation and delivery for the net-like standardized canal module

For example, the standardized canal module is 50 m in bottom width and 4.5 m in depth, so the cost estimation for excavating 1 km earthwork is as follows:

1. project volume: (54.5 m+50 m)×4.5 m×½×1000 m=235125 m³

2. unit price of the project: 2.27 RMB/m³ (thrown by a grab)
4.16 RMB/m³ (shoveled by a carryscraper)

3. calculated by reasonable comprehensive economic indexes, the total project volume has 25% earthwork thrown by grabs and the rest 75% shoveled by carryscrapers. Therefore, 1 km canal product is calculated as follows:

the amount of earthwork thrown by grabs: 235125 m³×25%=58781 m³

the amount of earthwork shoveled by carryscrapers: 235125 m³×75%=176344 m³

4. the comprehensive manufacturing cost on earthwork excavation and delivery for the 1 km standardized canal module is: 58781 m³×2.27 RMB/m³+176344 m³×4.16 RMB/m³=RMB 867024

5. assume that the net-like standardized canal module of the sheet-like standardized urban module has a length of 100 km, and the total manufacturing cost is: 867024 RMB/km×100 km=RMB 86702400

□. Manufacturing Cost Estimation on Slope Revetment Project for the Net-Like Standardized Canal Module of the Sheet-Like Standardized Urban Module

(2) Cost estimation on revetment project for the net-like standardized canal module

If the standardized canal module is 50 m in bottom width and 4.5 m in depth, and the revetment adopts prefabricated reinforced concrete products with a length of 4.5 m, width of 3.0 m, and thickness of 0.12 m, the cost estimation of a 1 km revetment is as follows:

1. the 1 km revetment (3 m×4.5 m) requires 666 pieces of prefabricated products

2. the 1 km revetment requires prefabricated concrete at a volume of: 3 m×4.5 m×0.12 m×666=1078.92 m³

3. the 1 km revetment requires prefabricated reinforcing steel bars with a diameter of 8 mm at an amount as follows:

The reinforcing steel bars with a diameter of 8 mm are spaced by a pitch of 150 mm×150 mm, and have 19 units at a length of 4.5 m and 29 units at a length of 3 m.

19 units×4.5 m/unit+29 units×3.0 m/unit×0.395 kg/m×666=45379.58 kg

4. estimation on labor and material costs for the 1 km revetment concrete:

labor cost: 1078.92 m³×3.12 workday/m³×27.64 RMB/workday=RMB 93042.61

material cost: 1078.92 m³×107.91 RMB/m³=RMB 116426.26

5. estimation on labor and material costs for the 1 km revetment reinforcing steel bars:

labor cost: 45379.58 kg×13.6 workday/ton×27.64 RMB/workday=RMB 17058.37

material cost: 45379.58 kg×3500 RMB/ton=RMB 158828.53
the total cost of Items 4 and 5 is RMB 385355.77

6. the net-like standardized canal module of the sheet-like standardized urban module has a length of 100 km, and the total manufacturing cost is: 385355.77 RMB/km×100 km=RMB 38535577

As the total investment on the revetment of the net-like standardized canal module should also consider the transportation fee, installation fee, mechanical use fee, unexpected expenses, and site cost which takes up about 20% of the project cost, i.e., RMB 7707115. Thereby, the total manufacturing cost of the revetment for the net-like standardized canal module of the sheet-like standardized urban module is: RMB 38535577+7707115=RMB 46242692.

(3) The net-like standardized canal module of the sheet-like standardized urban module also takes electric and intelligent manufacturing cost estimations into account: for 1 million RMB/km, the total electric and intelligent investment is estimated as: 100 km×1 million RMB/km=RMB 100 million

In view of the above (1), (2), and (3), the net-like 100 km standardized canal module in the sheet-like standardized urban module has a total manufacturing cost of: RMB 86702400+46242692+100000000=RMB 232945092.

The 1 km standardized canal module has a manufacturing cost of RMB 2329451.
Affix

□. According to No. 612 Order in 1996 issued by Highway, the Ministry of Transportation of the People's Republic of China, “Investment Estimation, Price Evaluation and Budget Compilation Method for Highway Fundamental Construction” and “Approximate Estimate (Budgetary) Norm of Highway Project”, and based on the labor cost of 27.64 RMB/workday and diesel oil of 3.94 RMB/kg in Hefei district of China in the year 2004, the following results can be calculated: 1. the unit price for shoveling earthwork by a carryscraper: 4.16 RMB/m³; 2. the unit price for excavating earthwork by a grab: 2.27 RMB/m³

□. Statistics of Labor and Material Prices (Referring to the Price List of Hefei District of China in August 2004)

1. labor: 27.64 RMB/workday;

2. cement: 350 RMB/ton (No. 525); 270 RMB/ton (No. 425); 250 RMB/ton (No. 325);

3. medium (coarse) sand: 20 RMB/m³; 18 RMB/m³;

4. gravel: 20 RMB/m³; 18 RMB/m³;

5. reinforcing steel bar: 3500 RMB/ton (average price);

6. steel cable: 5600 RMB/ton (average price);

7. asphalt: 2500 RMB/ton; 3500 RMB/ton (improved);

8. burned lime: 147 RMB/ton;

9. diesel oil: 3.94 RMB/kg;

10. coal: 360 RMB/ton.

□. The Unit Price of Each Type of Concrete can be Calculated According to “Approximate Estimate (Budgetary) Norm of Highway Project”

1. the unit price of C50 concrete is 186.75 RMB/m³;

2. the unit price of C40 concrete is 162.25 RMB/m³;

3. the unit price of C30 concrete is 124.05 RMB/m³;

4. the unit price of C25 concrete is 107.91 RMB/m³;

5. the unit price of C15 concrete is 91.86 RMB/m³;

6. the unit price of C10 concrete is 92.35 RMB/m³.

[Manufacturing Cost Estimation on Underground Fairway Module]

In an embodiment of the present invention, in the 667 km underground fairway module from east to Tang Gugang Gulf in Tianjin, China and west to Dongsheng area in Inner Mongolia, China, the section from Tang Gugang Gulf in Tianjin to Yi county in Hebei province is about 210 km, and can be open excavated for the standardized canal module. The open excavation of the canal is designed to have an average width of 60 m and an average depth of 25 m. The section from Yi county, Hebei to Dongsheng, Inner Mongolia is 457 km, and the underground fairway module can be manufactured by means of underground tunnel technique. The underground fairway module has two upper and lower tunnels, and for example, each tunnel has a cross-sectional area of 3.14×(20 m÷2)²÷2+20 m×10 m+3.14×(20 m÷2)²÷2=514 m².

The manufacturing cost estimation on the tunnel of the underground fairway module can be referred to in the Dongqianhu Waterworks tunnel connection project in Ningbo City, China. The project is about a first-grade highway tunnel. The tunnel has two sections, with a full length of 380 m and a cross-sectional area of 67 m². The manufacturing cost of the project is 15 million RMB. 15 million RMB÷380 m÷67 m²=589 RMB/m³. The manufacturing cost on each cubic meter of the tunnel is RMB 589. With reference to the standardized canal module, the comprehensive manufacturing cost on the open excavate of the canal is 5.65 RMB/m³. In an example of the present invention, the manufacturing cost on the tunnel project of the underground fairway module is: tunnel length 457,000 m×cross-sectional area 514 m²×589 RMB/m³×2+project manufacturing cost on open excavation of the standardized canal product 25 m (depth)×60 m (width)×210,000 m (length)×5.65 RMB/m³+manufacturing cost on electric/intelligent automatic control devices 667 km×1 million RMB/km+land expropriation and housing removal settlement fees 210 km×60 m (width)×40,000 RMB/mou+manufacturing cost on electric/intelligent automatic shipping docks 5 billion RMB+unexpected expenses 10 billion RMB=RMB 294.9 billion.

[Net-Like Standardized Road/Bridge Module]

In a preferred technical embodiment of the present invention, upon actual requirements, the sheet-like standardized urban module is provided with a 200 km net-like standardized road/bridge module integrated with 100 mesh-sheet standardized block modules. Upon actual requirements, 101 standardized intercommunication overpass modules and 200 standardized canal bridge modules are set on the cross-junctions of the 200 km net-like standardized road/bridge module. Further, upon actual requirements, the sheet-like standardized urban module, for example, provides net-like standardized road/bridge modules with 10 km (length)×90 m (width)×20 two-way drive 8-lane to 14-lane structures vertically and horizontally in total. A middle-and-small-size standardized urban product is provided with 6-lane to 8-lane according to actual requirements of the traffic load. A large-and-middle-size standardized urban product is provided with 10-lane to 12-lane according to actual requirements of the traffic load. An extra large-size standardized urban product is provided with 14-lane to 22-lane according to actual requirements of the traffic load. The net-like standardized road/bridge module may be provided with certain quantity of lanes according to actual requirements of the traffic load of the standardized urban product. For the unification of calculation, the net-like standardized road/bridge module, for example, takes 14-lane as its reference for calculation. In a preferred technical embodiment of the present invention, according to actual requirements of the traffic load, the investment on fast lanes can be reduced by manufacturing the 8-lane, 10-lane, 12-lane first, and the reserved spaces for fast lanes can be substituted by gardening products. In a preferred technical embodiment of the present invention, upon actual requirements, the net-like standardized road/bridge module provided with intercommunication standardized overpasses, fast lanes, green belts, slow lanes, and sidewalks, not only serves as express highways but also business high streets. In addition, the design features of the one-way 7-lane in the 14-lane fast lanes are as follows: 1, 2, 3-fast lanes are set with a minimum speed of 120 km/h and with no upper limit; 4, 5, 6-fast lanes are set with a speed of 60 km/h to 120 km/h; and 7-fast lane is specified for right-turn entrance/exit with a set speed of 30 km/h to 60 km/h. The net-like standardized road/bridge module is further provided with underground passages for the slow lanes and sidewalks to pass through other lanes according to actual requirements.

The net-like standardized pipeline modules of the net-like standardized road/bridge underground space module communicates with the mesh-sheet standardized pipeline modules of the mesh-sheet standardized block underground space module, and then communicates with the standardized house modules, animal/plant type house artistic modules, or other buildings to form the net-like/mesh-sheet standardized pipeline module. Upon actual requirements, the net-like/mesh-sheet standardized pipeline module selectively provides the net-like/mesh-sheet standardized rainwater pipe modules, the net-like/mesh-sheet standardized tap water pipe modules, the net-like/mesh-sheet standardized sewage pipe modules, the net-like/mesh-sheet standardized clean water pipe modules, the net-like/mesh-sheet standardized coal gas pipe modules, the net-like/mesh-sheet standardized natural gas pipe modules, the net-like/mesh-sheet standardized oil pipe modules, the net-like/mesh-sheet standardized heating pipe modules, the net-like/mesh-sheet standardized cooling pipe modules, the net-like/mesh-sheet standardized power supply pipeline modules, the net-like/mesh-sheet standardized telephone pipeline modules, the net-like/mesh-sheet standardized TV pipeline modules, the net-like/mesh-sheet standardized computer pipeline modules, and the net-like/mesh-sheet standardized intelligent pipeline modules.

The present invention also provides structures and methods for maintaining the standardized urban product pipeline modules, so as to reduce the provision and maintenance cost of the pipeline modules, improve the provision and maintenance efficiency of the pipeline modules, and also ensure the sewage water generated by the standardized urban products to be disposed in a qualified way.

Upon actual requirements, the present invention further provides soundproof walls between the fast lanes and the sidewalks of the net-like standardized road/bridge module, so as to prevent noises emitted by motor vehicles on the fast lanes from annoying the pedestrians and residents.

In the present invention, the sheet-like standardized urban module calculates the traffic load by a single-lane average speed of 120 km/h: 1000 km single-lane 20 units/m×60 m/h×10 km×14-lane×20 standardized road/bridges×75% traffic load discount rate=2.52 million/h traffic load. In a preferred technical embodiment of the present invention, upon actual requirements, an 8-lane elevated road/bridge module is set on the net-like standardized road/bridge module or an 8-lane underground fast lanes module is set in the underground space, so as to increase the traffic load of the sheet-like standardized urban module by 1.44 million units/h. That is, upon actual requirements, the sheet-like standardized urban module may provide 2.52 million units/h traffic load or 2.52 million units/h traffic load+1.44 million units/h traffic load=3.96 million units/h traffic load, and thus no traffic jam will occur even if all the residents in the sheet-like standardized urban module drive on the road at the same time. Further, upon actual requirements, the net-like standardized road/bridge module achieves the following technical characteristics: the vehicles can be driven straightforward or turned right, there are no traffic lights nor toll stations, and the vehicles can be driven non-stoppingly without causing a jam.

According to the present invention, in a middle-and-small-size standardized urban product without any traffic jam, the net-like standardized road/bridge module integrated with the mesh-sheet standardized block module may selectively provide roundabouts for driving or provide traffic lights to substitute intercommunication standardized overpasses, so as to reduce the manufacturing cost of the net-like standardized road/bridge module.

Upon actual requirements, the present invention further provides multifunctional bridge modules spanning over the water surfaces such as rivers, lakes, and seas. Ships can sail under the multifunctional bridge module. The first-layer bridge floor has rail module passages and rail stations upon actual requirements, and the rail stations are provided with sightseeing elevators and sightseeing stairs directly leading to the sightseeing corridor bridge on the top floor upon actual requirements. The first-layer bridge floor may further communicate with the butted net-like standardized road/bridge modules and the top-floor sightseeing corridor bridges on both banks, so as to provide the standardized rainwater pipe modules, the standardized tap water pipe modules, the standardized sewage pipe modules, the standardized clean water pipe modules, the standardized coal gas pipe modules, the standardized natural gas pipe modules, the standardized oil pipe modules, the standardized heating pipe modules, the standardized cooling pipe modules, the standardized power supply pipeline modules, the standardized telephone pipeline modules, the standardized TV pipeline modules, the standardized computer pipeline modules, and the standardized intelligent pipeline modules. Upon actual requirements, the second-layer of the multifunctional bridge module is provided with traffic lanes for heavy vehicles, and the third, fourth, or Gth-floor of the same is provided with traffic lanes for light vehicles. The traffic lanes for light vehicles are composed of fast lanes, slow lanes, and temporary parking platforms, in which the temporary parking platforms are set with sightseeing elevators and stairs directly leading to the top floor upon actual requirements. In addition, one or more layers of sightseeing corridor bridges including entertainment sightseeing places may be further provided. Upon actual requirements, the number of layers of the bridge and the quantity of the fast lanes in the multifunctional bridge module are determined according to the traffic load in actual circumstances.

Further, the present invention provides a multifunctional bridge module with a first-layer bridge floor composed of fast lanes, slow lanes, and sidewalks, a bridge head composed of parking lot for motor and non-motor vehicles, and a second-layer bridge floor composed of sightseeing corridor bridges for pedestrians. In addition, the sightseeing corridor bridges for pedestrians are equipped with entertainment sightseeing facilities according to actual requirements.

The multifunctional bridge module of the present invention achieves the following efficacies. A multifunctional bridge module is built on places to span over rivers, lakes, and seas to bear a traffic load like several bridges, thus reducing the cost for manufacturing bridges and also providing places for sightseeing and entertainments. According to the present invention, multifunctional bridge modules are built in the middle-and-small-size standardized urban product to communicate urban construction infrastructures with urban social infrastructures, thereby saving the investment cost and improving the service efficiency.

[Manufacturing Cost Estimation on Road/Bridge for Sheet-Like Standardized Urban Module]

□. Manufacturing Cost Estimation on the Net-Like Standardized Road Module with Labor and Material Prices as in Yangtze River Valley

(1) Cross-Section of the Net-Like Standardized Road Module

49 m(14-fast lanes×3.5 m/fast lane)+7 m(central separation belt)+15 m(2×7.5 m/slow lane)+3 m(2×1.5 m/two-side separation belt)+16 m(2×8 m/sidewalk)=90 m

(2) Length of the Net-Like Standardized Road Module

The sheet-like standardized urban module has all-together 20 standardized road/bridges, each with a length of 10000 m. As the lengths and manufacturing costs of the intercommunication standardized overpass modules and the crossing canal bridge modules of the net-like standardized road/bridge module are calculated individually, 101 intercommunication standardized overpass modules with a length of 240 m and 100 standardized canal bridge modules with a length of 50 m should be deducted.

10000 m×20−240 m×101−50 m×100=170760 m

(3) Area and Manufacturing Cost of the Fast Lanes of the Net-Like Standardized Road Module

1. area: 170760 m (length)×49 m (width)=8367240 m²

2. manufacturing cost: 8367240 m²×105 RMB/m²=RMB 878.5602 million

(4) Area and Manufacturing Cost of the Slow Lanes of the Net-Like Standardized Road module

1. area: 170760 m (length)×15 m (width)=2561400 m²

2. manufacturing cost: 2561400 m²×75 RMB/m²=RMB 192.105 million

(5) Area and Manufacturing Cost of the Sidewalks of the Net-Like Standardized Road Module

1. area: 170760 m (length)×16 m (width)=2732160 m²

2. manufacturing cost: 2732160 m²×40 RMB/m²=RMB 109.2864 million

(6) Area and Manufacturing Cost of the Separation Belt of the Net-Like Standardized Road Module

1. area: 170760 m (length)×10 m (width)=1707600 m²

2. manufacturing cost: 1707600 m²×20 RMB/m²=RMB 34.152 million

(7) Manufacturing Cost of the Net-Like Standardized Road Products of the Sheet-Like Standardized Urban Module

RMB 878.5602 million+192.105 million+109.2864 million+34.152 million=RMB 1214.1036 million.

□. Manufacturing Cost Estimation on the Intercommunication Standardized Overpass Products

(1) Cost Estimation on Conventional Intercommunication Standardized Overpass Products

Taking a conventional intercommunication overpass for example, the overpass has a main bridge with a length of 60 m, width 51 m, and clearance height 4.5 m; an approach bridge with a length of 180 m and width 51 m; 4 clover-leaf ramps, each having a length of 210 m and width 7.5 m; and employs 30 m prestressing force hollow plate girders. In this overpass, assume the stakes adopted have a length of 20 m and a diameter of 1.5 m. The base slabs of the main/approach bridge are in a size of 6.3 m×2.5 m×1.8 m, and the base slabs of the clover-leaf circuits adopt single-stake base slabs in a size of 2.5 m×2.5 m×1.8 m. The pier shafts of the main/approach bridge have an average height of 3.7 m with a size of 1.0 m×1.8 m, and the pier shafts of the clover-leaf ramps have an average height of 2.3 m with a size of 1.0 m×1.3 m. The main bridge, approach bridge, and clover-leaf ramps all adopt frame girders in a size of 1.8 m×1.2 m. The bridge floor is paved with 10 cm of C40 concrete, and the surface layer of the bridge floor is paved with 8 cm of asphalt concrete, in which there are 3 cm of medium-graded asphalt concrete and 5 cm of coarse-graded asphalt concrete. Additionally, the arrangement of the reinforcing steel bars and the design of the collision prevention handrails/walls of this overpass can be designed with reference to in bridge standard diagrams.

According to No. 612 Order in 1996 issued by Highway, the Ministry of Transportation of the People's Republic of China, “Investment Estimation, Price Evaluation and Budget Compilation Method for Highway Fundamental Construction” and “Approximate Estimate (Budgetary) Norm of Highway Project”, and based on the labor, material, mechanics, transportation, installation, etc., prices in Hefei district of China in the year 2004, the direct cost of this intercommunication overpass is calculated as: RMB 29,892,179, including labor cost of RMB 4,782,749, material cost RMB 19,130,994, and mechanical cost RMB 5,978,436 with a total bridge floor area of 18,540 m².

(2) Calculate the Manufacturing Cost of the Intercommunication Standardized Overpass Product According to “Investment Estimation Norm” and the Cost Composition

Based on the “Investment Estimation Norm” issued by the Ministry of Transportation of China in 1996 and the above example, an index direct cost is calculated as: RMB 10,497,649.

1. index direct cost: RMB 10,497,649;

2. direct cost: RMB 29,892,179;

3. other project fees: 29,892,179×3.04%=RMB 908,722;

4. other direct costs: (RMB 10,497,649+908,722)×7.87%=RMB 897,681;

5. on-site expenses: (RMB 10,497,649+908,722)×15.044%=RMB 1,715,975;

6. index direct project cost: (RMB 10,497,649+908,722+897,681+1,715,975)=RMB 14,020,027;

7. direct project cost: (RMB 29,892,179+908,722+897,681+1,715,975)=RMB 33,414,557;

8. indirect cost: RMB 1,715,975×5.2%=RMB 89,231;

9. construction technical facility fee: (RMB 14,020,027+89,231)×3%=RMB 423,278;

10. target profit: (RMB 14,020,027+89,231)×4%=RMB 564,370;

11. tax: (RMB 33,414,557+89,231+564370)×3.41%=RMB 1161724;

12. index construction engineering installation fee: RMB 14,020,027+89,231+423,278+564,370+1,161,724=RMB 16,258,630;

13. construction engineering installation fee: RMB 33,414,557+89,231+423,278+564,370+1,161,724=RMB 35,653,160;

14. purchase fee for devices, tools, and appliances: RMB 35,653,160×1.69%=RMB 602,538;

15. other fees (1), (2), (3), and (4) of project construction: RMB 3,632,551 in total;

(1) land/young crops compensation fee and resettlement subsidy: 50 mou×10,000 RMB/mou=RMB 500,000;

(2) the comprehensive administration cost of the construction unit is RMB 430,041 in total, including: construction unit administration cost: RMB 16,258,630×0.675%=RMB 109,746, project quality monitoring fee: RMB 16,258,630×0.15%=RMB 24,388, project supervision fee: RMB 16,258,630×1.6%=RMB 260,138, norm compiling management fee: RMB 16,258,630×0.17%=RMB 27,640, and design document examination fee: RMB 16,258,630×0.05%=RMB 8129;

(3) design fee: RMB 35,653,160×1.95%=RMB 695,237;

(4) construction period loan interest: RMB 35,653,160×5.63%=RMB 2,007,273;

16. reserved fees:

(1) increased/reserved fee being 5% of the project manufacturing cost: RMB 35,653,160×5%=RMB 1,782,658;

(2) reserve fund: (RMB 35,653,160+602,538+3,632,551−2,007,273)×9%=RMB 3,409,288;

17. investment estimate sum: RMB 35,653,160+602,538+3,632,551+1,782,658+3409288=RMB 45,080,195.

manufacturing cost per square meter: RMB 45,080,195÷18,540 m²=2432 RMB/m²

(3) Cost Estimation on Industrial Assembly Line Prefabrication, Transportation, and Installation

1. As assembly line facilities for prefabricating, transporting, and installing the intercommunication standardized overpass module are provided, thousands of intercommunication standardized overpass modules can be prefabricated, transported, and installed by means of assembly line production. Thus, the personnel can be harmoniously commanded and unitedly dispatched, so as to improve the production efficiency. According to a survey, the labor wage in Xingzi county of Jiangxi province, China is approximately 20 RMB/workday, above 40% lower than the areas adjacent to Shanghai, China.

2. As supporting standardized urban product steelworks, standardized urban product cement plants, and standardized urban product gravel processing plants, etc., are provided, the expense cost on advertisement, marketing, packaging, and transportation can be reduced. Further, upon estimation, the prices of the main construction materials are controlled around: gravel 20 RMB/ton, cement 260 RMB/ton, and steel products 3300 RMB/ton.

3. Due to the standardized assembly line prefabrication, transportation, and installation, the annual utilization of the mechanical devices is above 320 machine-shifts.

4. According to norm investment estimation, to build one overpass, the purchase fee for devices, tools, and appliances is about RMB 600,000. As the present invention provides a standardized manufacturing and installation assembly line, these devices can be used for building tens of or even more overpasses, so the cost is less than one tenth of the original estimation.

5. As a standardized manufacturing and installation mode is adopted, the blueprint of one overpass is applicable to thousands of overpasses, so the design fee is only 10% of the original value. Accordingly, the administration cost and supervision fee are both only 10% of the original figures.

6. In the conventional construction of an urban overpass, generally, one overpass is in the charge of a project team supported by construction units, supervision units, and construction units, so the management structure and form are non-economical. Further, to build a overpass, a piece of land is required and hardened to construct living and office buildings, and then goes through a second ploughing after the construction. Besides, to build a overpass, a set of moulds has to be made at a high cost but rarely used. During the construction of the overpass, the personnel are usually at leisure for a long time, thus causing a great waste of the human resources. In addition, the construction, installation, device allocation and transportation, and the build of access roads and temporary bridges for one overpass also increase the cost. Thereby, the present invention provides a standardized assembly line manufacturing method for prefabrication, transportation, and installation, thus saving plenty of land resources, human resources, and mechanical device resources.

In view of the above, the present invention provides a standardized and intensified manufacturing method, so as to greatly reduce the investment cost of the intercommunication standardized overpass module. The investment estimation after the cost reduction is shown below:

1. construction installation project fee: RMB 35,653,160×(1−30%)=RMB 24,957,212;

2. purchase fees for devices, tools, and appliances (applicable to above ten overpasses): RMB 60254;

3. other fees of project construction (RMB 1,116,165): (1) land/young crops compensation fee and resettlement subsidy: 0; (2) construction organization administration cost: RMB 43004; (3) investigation and design fee: RMB 69,524; (4) construction period loan interest: RMB 1,003,637;

4. reserved fees: (1) increased/reserved fee of the project manufacturing cost: RMB 1,782,658×50%=RMB 891,329; (2) reserve fund: RMB 3,409,288×(1−65%)=RMB 1,193,251;

5. investment estimate sum: RMB 28,218,211;

6. manufacturing cost per square meter: RMB 28218211÷18540 (m²)=1522 RMB/m².

□. Investment Estimation on Intercommunication Standardized Overpass Module of Sheet-Like Standardized Urban Module

Based on the above manufacturing cost, the investment estimation on 101 intercommunication standardized overpass modules of the sheet-like standardized urban module is: 101×28,218,211 RMB/unit=RMB 2,850,039,311

□. Investment Estimation on Standardized Canal Bridge Module of Sheet-Like Standardized Urban Module

Assume that the standardized canal bridge module has a standardized design of 50 m in length, 50 m in width, and 4.5 m in clearance. The sheet-like standardized urban module is set with 200 standardized canal bridge products, with a cost calculated by the manufacturing cost per square meter of RMB 1522, 50 m×50 m×1522 RMB/m²×200=RMB 761,000,000.

□. Investment Estimation on Standardized Bridge Product of Sheet-Like Standardized Urban Module:

RMB 2,850,039,311+761,000,000=RMB 3,611,039,311

□. Investment Estimation on Standardized Commercial Pedestrian Street

Standardized commercial pedestrian street modules are respectively built on four orientations of the mesh-sheet standardized block module. The standardized commercial pedestrian street module on each orientation has a length of, for example, 800 m, and a width of 30 m. As the manufacturing cost estimation per square meter is RMB 40, the project manufacturing cost of each standardized commercial pedestrian street module is 800 m×30 m×40 RMB/m²=RMB 960,000.

In the present invention, for example, 25 industrial manufacturing mesh-sheet standardized block modules and 75 commercial/residential mesh-sheet standardized block modules are assembled to form a sheet-like standardized urban module. In the 25 industrial manufacturing mesh-sheet standardized block modules, the commercial buildings along the road may satisfy commercial service requirements of the standardized workshops, with no need to build standardized commercial pedestrian street modules. The 75 commercial/residential mesh-sheet standardized block modules only need 75 standardized commercial pedestrian street modules to meet the market demand, and the project manufacturing cost is approximately RMB 72 million.

□. Manufacturing Cost Estimation on Net-Like Standardized Road/Bridge Module of Sheet-Like Standardized Urban Module:

manufacturing cost on standardized road RMB 1214.1036 million+manufacturing costs of 101 intercommunication standardized overpass modules and 200 standardized canal bridge modules RMB 3611.0393 million=RMB 4825.1429 million

RMB 4825.1429 million÷200 km net-like standardized road/bridge module=24.1257 million RMB/km(manufacturing cost of the standardized road/bridge products)

RMB 4825.1429 million÷100 mesh-sheet standardized block modules=48.2514 million RMB/unit(manufacturing cost of the net-like standardized road/bridge modules of the mesh-sheet standardized block modules)

□. Manufacturing Cost Estimation on Net-Like Standardized Road/Bridge Module of Sheet-Like Standardized Urban Module:

manufacturing cost on standardized road RMB 1214.1036 million+75 standardized commercial pedestrian streets RMB 72 million+manufacturing costs of 101 intercommunication standardized overpass modules and 200 standardized canal bridge modules RMB 3611.0393 million=manufacturing cost of the net-like standardized road/bridge modules of the sheet-like standardized urban modules RMB 4897.1429 million

manufacturing cost of the net-like standardized road/bridge module of the sheet-like standardized urban module RMB 4897.1429 million÷manufacturing cost of the standardized road/bridge modules of the 100 mesh-sheet standardized block modules=48.9714 million RMB/unit(manufacturing cost of the net-like standardized road/bridge modules of the mesh-sheet standardized block modules.

□. Manufacturing Cost Estimation on Net-Like Standardized Road/Bridge Module of R&D Transactional Sheet-Like Standardized Urban Module

400 standardized commercial pedestrian streets can be respectively built on four orientations of 100 R&D transactional mesh-sheet standardized block modules of the R&D transactional sheet-like standardized urban module. The manufacturing cost of each standardized commercial pedestrian street project is approximately RMB 960,000, and thus the manufacturing cost of the 400 standardized commercial pedestrian streets of the R&D transactional sheet-like standardized urban module is approximately RMB 384 million. Therefore, the manufacturing cost of standardized road RMB 1214.1036 million+manufacturing cost of the 400 standardized commercial pedestrian streets RMB 384 million+manufacturing costs of 101 intercommunication standardized overpasses and 200 standardized canal bridges RMB 3611.0393 million=RMB 5209.1429 million. Further, the manufacturing cost of the net-like standardized road/bridge modules of the R&D transactional sheet-like standardized urban module RMB 5209.1429 million÷manufacturing cost of the net-like standardized road/bridge modules of the 100 R&D transactional mesh-sheet standardized block modules=52.0914 million RMB/unit (manufacturing cost of the net-like standardized road/bridge modules of the R&D transactional mesh-sheet standardized block modules).

[Standardized Rail Module]

Upon actual requirements, the present invention provides net-like standardized rail modules for extra large-size and large-size standardized urban products. In particular, the present invention provides assembly line facilities for prefabricating, transporting, and installing reinforced concrete on the location of the resources, so as to manufacture the net-like standardized rail modules.

In a preferred technical embodiment of the present invention, upon actual requirements, the R&D transactional sheet-like standardized urban module is provided with double-track 20 km net-like standardized metro rail modules or 100 km net-like standardized light rail modules. Upon actual requirements, the present invention may further provide double-track 20 km net-like standardized light rail modules. In addition, the double-track lines of the net-like standardized rail module are built below the net-like standardized road/bridge modules, and have a standardized rail module station set every 1 km. Moreover, the standardized rail module stations connect the underground to the commercial buildings above the ground.

[Manufacturing Cost Estimation on Net-Like Standardized Rail Module]

(1) In the R&D transactional sheet-like standardized urban module, two metro stations are spaced by a mesh-sheet standardized block module, which is approximately 1 km. The traveling speed of the metro reaches above 100 km/h, and the number of passengers transported on one-way is around 50,000 in rush hour.

In the city of Harbin, China, the main line of the metro project is 14.4 km long, and the total investment of the project is RMB 4.52 billion. Deducting the adoptable 7381 project fees RMB 900 million, the investment estimation is RMB 3.62 billion, and the manufacturing cost per kilometer is RMB 250 million. Hangzhou Metro Line No. 1 in planning has a full length of 50.68 km, the estimated cost is about RMB 15.2 billion, and the manufacturing cost per kilometer is RMB 300 million. In the city of Hefei, China, a planned 7 km light rail product with 8 stations has a total manufacturing cost budget of about RMB 380 million, and the manufacturing cost per kilometer is RMB 53.63 million. According to the present invention, the manufacturing cost estimation per kilometer of the standardized light rail module is RMB 50 million, and the manufacturing cost estimation per kilometer of the standardized metro module is RMB 250 million on average.

The R&D transactional sheet-like standardized urban module is provided with 20 km net-like standardized metro modules or 100 km net-like standardized light rail modules, and the manufacturing cost is approximately RMB 5 billion.

(2) In the sheet-like standardized urban module, the double-track lines of the standardized light rail module are spaced by 10 km with a station every 1 km. The traveling speed of the metro reaches above 60 km/h, and the number of passengers transported on one-way is around 30,000 in rush hour. The sheet-like standardized urban module may further provide a 20 km standardized light rail module at a manufacturing cost of RMB 1 billion.

[Standardized Urban Trash Product]

Domestic garbage is collected by classifying organic garbage, construction garbage, batteries, and reclaimable industrial products. The garbage is disposed by being used for farmyard manure, burnt to generate electric power, buried, filled in a sea to build cities, or filled in a sea to create forests.

The sheet-like standardized urban module may selectively accommodate 1 million people, and calculated by an amount of 1 kg garbage per person each day, 1 million kg, i.e., 1000 tons of garbage will be produced each day.

Current, in China's investment-invitation bid for garbage processing, the garbage investment is about 150,000-200,000 RMB/ton. Taking the standardization, intensivism, and scale benefits of the standardized urban product into consideration, the investment is above 40% lower. Thus, the garbage processing investment of the standardized urban product can be reduced to 100,000 RMB/ton, and the total investment is: 1000 tons×100,000 RMB/ton=RMB 100 million.

According to the present invention, standardized trolley bus products are provided to travel in the net-like standardized road/bridge modules and the mesh-sheet standardized block modules.

The present invention further provides a desired number of taxies and high-speed taxies in the standardized urban product.

[Standardized Tap Water Product]

Upon actual requirements, the present invention provides net-like/mesh-sheet tap water pipe modules. For example, in order to supply clean and sanitary tap water to 1.1 billion urban population in China, the present invention sets drinking water channelized canal modules at places with clean water sources along the bank of the upper and middle reaches of the Pearl River. Upon actual requirements, drinking water channelized canal modules can be built at places with clean water sources like the Hanjiang River, Xiangjiang River, and Ganjiang River in the Yangtze River valley. Further, the drinking water channelized canal modules can be connected to tap water processing sites and net-like/mesh-sheet standardized tap water pipe modules in the standardized urban product by going down the Yangtze River and the Pearl River, so as to ensure the residents in the standardized urban product have clean and sanitary drinking water. The standardized urban product set in the coastal plain on the middle and lower reaches of the Yangtze River may conduct a total annual runoff amount of 228.4 billion m³ of clean drinking water sources, including an annual runoff amount of 39.4 billion m³ from the Qiantangjiang River, an annual runoff amount of 55.4 billion m³ from the Hanjiang River, an annual runoff amount of 64.9 billion m³ from the Xiangjiang River, and an annual runoff amount of 68.7 billion m³ from the Ganjiang River. In the coastal plain on the middle and lower reaches of the Yangtze River, 900 million rural population urbanizations in need of drinking/domestic water×water consumption of 0.4 m³ per person each day×365 day/year=domestic water consumption of 131.4 billion m³/year. The clean drinking water sources with an annual runoff amount of 228.4 billion m³-131.4 billion m³ of clean domestic water sources=97 billion m³ of clean domestic water sources remained each year. In addition, the present invention may also produce tap water and industrial water with water taken from the standardized canal modules.

In China, an annual runoff amount of the Yangtze River 951.3 billion m³+an annual runoff amount of the Pearl River 333.8 billion m³+an annual runoff amount of the Huai River 62.2 billion m³+an annual runoff amount of the Qiantangjiang River 39.4 billion m³=an annual runoff amount of 1386.7 billion m³. 1.1 billion population×0.4 m³/day domestic water consumption×365 day/year=160.6 billion m³/year domestic water consumption. Assume that the consumption of the industrial water is 200% of the domestic water, so the industrial water consumption is approximately 321.2 billion m³/year, and thus 160.6 billion m³/year domestic water consumption+321.2 billion m³/year industrial water consumption=481.8 billion m³/year total water consumption.

In China, an annual runoff amount of 1386.7 billion m³ fresh water resources on the upper reaches of the standardized urban product—481.8 billion m³/year total water consumption of the 1.1 billion population=an annual runoff amount of 904.9 billion m³ fresh water resources that can be saved. The present invention is able to supply water for the urbanization of 2 billion people in China.

In China, the standardized urban product provided by the present invention has more than 1000 km of urban coastline and about 4000 km of coastal canal, thus providing the cheapest and more favorable conditions for seawater desalination when the fresh water resources are insufficient.

[Investment Estimation on Standardized Tap Water Product]

The net-like/mesh-sheet standardized tap water pipe module adopts double-pipe water supply of direct drinkable water and domestic water. In order to save water, the water consumption per person each day is set to be 0.4 ton, and thus the water demand of the sheet-like standardized urban module each day is: 1 million people×0.4 ton/person each day=400,000 ton/day. At present, the investment on tap water in China is 1500 to 1800 RMB/ton. Calculated by saving 40%, the investment is approximately 1000 RMB/ton. The investment estimation on tap water in the sheet-like standardized urban module is: 400,000 ton×1000 RMB/ton=RMB 400 million.

[Standardized Sewage Water Processing Product]

Upon actual requirements, standardized sewage water processing modules provided by the present invention are disposed in the sheet-like standardized urban modules, and net-like/mesh-sheet standardized sewage pipe modules are disposed in the net-like standardized road/bridge modules and the mesh-sheet standardized block underground space modules for gathering industrial and domestic sewage water. In particular, the domestic and industrial sewage water are gathered strictly through separated pipes, then processed by the standardized sewage water processing module according to safe and qualified standards, and finally discharged into the canals, rivers, or seas. The intermediate water after being processed by the standardized sewage water processing module may also be used as landscape water in the standardized urban products.

[Investment Estimation on Standardized Sewage Water Processing Product]

The net-like/mesh-sheet standardized sewage pipe modules are prefabricated, transported, and installed according to individual treatments of the rain water and sewage water. Except the naturally purified part, the sewage water produced per person each day in the standardized urban product is 0.3 m³, and thus the sewage water produced each day in the sheet-like standardized urban module is: 1 million people×0.3 m³/person=300,000 m³.

The current urban sewage water processing project requires an investment of 1200 RMB/m³ on average. Calculated by saving 40%, the investment cost of the standardized urban product may reach 700 RMB/m³ on sewage water processing. Therefore, the investment on sewage water processing of the sheet-like standardized urban module is: 300,000 m³×700 RMB/m³=RMB 210 million.

[Standardized Airport Module]

In order to alleviate the visual and sound pollution caused by the take-off and landing of the planes to the urban residents, and also improve the utilization of the airport products, preferably, the present invention provides a standardized airport module capable of boarding 1-20 million passengers every day. The area of the standardized airport module varies according to actual requirements of the standardized urban products, and the standardized airport module is preferably disposed in the net-like standardized canal module to help build a water-land-air united transport network. The standardized airport module is provided with net-like standardized road/bridge modules and standardized airport underground space modules. The standardized airport underground space module further includes underground traffic lanes and parking spaces. According to the present invention, the standardized airport module is preferably equipped with a [symbol] [symbol] or [symbol] -shaped standardized airport terminal module composed of leisure squares, shopping malls, hotels, restaurants, tea-houses, cafes, and places for sports, literary, leisure, and entertainments. In addition, the standardized airport terminal module is surrounded by standardized parking aprons and standardized runways. Upon actual requirements, the standardized airport module of the present invention further has standardized fish ponds, standardized vegetable plots, and standardized nursery gardens/greenhouses within a radius range of several thousand meters. The standardized fish ponds, standardized vegetable plots, and standardized nursery gardens/greenhouses are provided to extend the distance from the standardized airport module to the residential districts in the standardized urban product. As such, not only the in-season products such as aquatic products, vegetables, flowers, and gardening products produced by the standardized fish ponds, standardized vegetable plots, and standardized nursery gardens/greenhouses can be supplied to the urban residents, but the environmental pollution caused by the take-off and landing of the planes to the urban residents can also be alleviated.

The standardized airport module provided by the present invention may attract customers from the peripheral areas within 100 km, and due to the net-like standardized road/bridge modules without limiting highest speed, it only takes about 30 minutes to drive to the 100 km-away standardized airport module.

Further, according to actual requirements of the market, the present invention may provide the standardized airport module at a time or in installments.

[Standardized Module for Filling a Sea to Build Cities]

The rivers laden with plenty of sediments form the alluvial plains and shoals along the rivers, lakes, and seacoasts.

For example, in China, the standardized urban product approximately needs to manufacture 121 billion m² of standardized house modules and corresponding urban infrastructures. In addition, about 60 billion m³ of stone resources can be reasonably quarried from mountains along the banks of the rivers, lakes, and seas. The proper quarry of the 60 billion m³ stones may reclaim plenty of flat land resources from the mountain areas. Besides, about 20 billion m³ of sand resources can be extracted by dredging the rivers and lakes. For example, the dredging of the sand silting in rivers and lakes, such as the Yangtze River, the Pearl River, the Poyang Lake, and the Dongting Lake, may enhance the water conservation and shipping functions of the same.

As the net-like standardized canal module, the net-like standardized rail module, and the mesh-sheet standardized block underground space module in the sheet-like standardized urban module need to excavate 80 km² of earthwork. Thus, the 80 km² of excavated earthwork for the sheet-like standardized urban module×900 sheet-like standardized urban modules in need of excavated earthwork=72000 km² of earthwork that can be filled in the shoals of the Yellow Sea, the East China Sea, and the South China Sea. The earthwork excavated for the sheet-like standardized urban module being 4 m deep on average in each square meter÷each square meter filling up the shoals of the Yellow Sea, the East China Sea, and the South China Sea for 8 m in depth on average=50% volume rate; 72000 km²×50% volume rate=36000 km²; and 36000 km²÷100 km² sheet-like standardized urban module=360 sheet-like standardized urban modules. Thereby, calculated by 1 million people living in each sheet-like standardized urban module on average, all-together 360 million people can be accommodated.

The northern beaches of the Yellow Sea and the East China Sea are too shallow, and the continental shelf extends very far. Further, a natural barrier formed by surrounding islands like Ryukyu Islands and Taiwan Island holds back the spread of the seismic waves. According to materials provided by the China Earthquake Administration, the northern shores of the Bohai Sea, the Yellow Sea, and the East China Sea are generally out of the impact of the seismic surge, as the marine natural disasters such as earthquakes, typhoons, and tsunamis caused by the Pacific Ocean lack objective conditions to intrude the northern continental coasts of the Yellow Sea and the East China Sea. Therefore, it is safe and feasible to fill up the northern beaches of the Yellow Sea and the East China Sea to build cities of 36,000 km² for accommodating 360 million people.

For example, the sea filling project of the sea beach in the Ganges River plain is a standardized project for filling the sea to build cities according to the population and residential requirements of India and Bengal. Further, the project for filling the sea to build cities along the seacoasts in the Ganges River plain requires an urban coastal levee project to prevent typhoons and tsunamis.

[Mesh-Sheet Standardized Block Module]

The mesh-sheet standardized block modules are arranged between the net-like standardized road/bridge modules, and between the net-like standardized road/bridge modules and the net-like standardized canal modules. The mesh-sheet standardized block modules may be further integrated with the net-like standardized road/bridge modules to form basic assembly modules in the standardized urban product, or arranged between the net-like standardized road/bridge modules and the net-like standardized canal modules to form preferred assembly modules in the standardized urban product.

In a preferred technical embodiment of the present invention, upon actual requirements, industrial manufacturing mesh-sheet standardized block modules, commercial/residential mesh-sheet standardized block modules, R&D transactional mesh-sheet standardized block modules, hybrid economic mesh-sheet standardized block modules, garden-type mesh-sheet standardized block modules, and cultural relics and historic sites type mesh-sheet standardized block modules may be provided. In addition, demanded by resources such as rivers, lakes, seas, mountain areas, and wetlands, scenic spot type mesh-sheet standardized block modules can be further provided.

The mesh-sheet standardized block module is provided with standardized commercial pedestrian street modules. In the standardized commercial pedestrian street module, dwelling houses or other buildings are constructed along the streets according to business or residential requirements, or commercial buildings are constructed along the streets according to the requirements of the R&D transactional mesh-sheet standardized block modules, or a second, third, and fourth layer of standardized commercial pedestrian street modules are built according to actual requirements. Upon actual requirements, the mesh-sheet standardized block modules are provided with standardized workshops, commercial buildings, dwelling houses, buildings for scientific research, culture, education, sports, medical health, leisure, and entertainment, parks, museums, and so on. These buildings are surrounded by roads, gardening of natural taste, and romantic artistic waterscape.

In a preferred technical embodiment of the present invention, a standardized kindergarten/primary/middle school composed of a kindergarten, a primary school, and a middle school is provided every four and within four mesh-sheet standardized block modules. It is good for the students of kindergarten, primary and middle schools to go to school on foot within 1 km without fast lanes as a way of exercise. Moreover, a standardized senior high school and a standardized industrial technical school are provided every 25 and within 25 mesh-sheet standardized block modules in the present invention.

According to the present invention, teaching resources such as sports areas, scientific, cultural, and artistic experimental places, libraries, and network places are provided for the standardized senior high school, the industrial technical school, and the standardized kindergarten/primary/middle school, so as to improve the students' body attribute, practice capability, and creativeness, and also improve the teaching quality and efficiency.

In the mesh-sheet standardized block module provided by the present invention, the net-like standardized road/bridge module has a gate on every orientation. The gates enable the vehicles traveling on the net-like standardized road/bridge module to turn right and enter the traffic lanes and parking spaces of the mesh-sheet standardized block module. Moreover, the gates also enable the vehicles in the mesh-sheet standardized block module to turn right and enter the net-like standardized road/bridge module. Further, the gates along the orientations of the standardized canal module are also equipped with standardized canal docks, and underground passages are provided between the adjacent mesh-sheet standardized block underground space modules.

The mesh-sheet standardized block underground space module is further provided with garbage collection and transport facilities.

The net-like standardized road/bridge module is connected to the mesh-sheet standardized block underground space module, and then to the standardized house module or animal/plant type house artistic module or other buildings to provide the net-like/mesh-sheet standardized pipeline module. Upon actual requirements, the net-like/mesh-sheet standardized pipeline module includes net-like/mesh-sheet rainwater pipe modules, net-like/mesh-sheet standardized tap water pipe modules, net-like/mesh-sheet standardized sewage pipe modules, net-like/mesh-sheet standardized clean water pipe modules, net-like/mesh-sheet standardized coal gas pipe modules, net-like/mesh-sheet standardized natural gas pipe modules, net-like/mesh-sheet standardized heating pipes modules, net-like/mesh-sheet standardized cooling pipe modules, net-like/mesh-sheet standardized oil pipe modules, net-like/mesh-sheet standardized power supply pipeline modules, net-like/mesh-sheet standardized TV pipeline modules, net-like/mesh-sheet standardized telephone pipeline modules, net-like/mesh-sheet standardized computer pipeline modules, and net-like/mesh-sheet standardized intelligent pipeline modules. Upon actual requirements, the mesh-sheet standardized block underground space module is further provided with pipeline inspection and maintenance service trucks to work along various pipelines, thereby reducing the cost, improving the efficiency, and also ensuring the life quality of the residents.

Upon actual requirements, in the mesh-sheet standardized block underground space module, the underground annular main driveway and the cross main driveway communicate with the net-like standardized road/bridge module and the standardized canal dock service section. Further, traffic lanes and sidewalks convenient in access are disposed between the annular/cross main driveways and the parking spaces. The underground passageways of the buildings are provided with exits or elevator doors, for the convenience of the residents to drive out and parking. Besides, the mesh-sheet standardized block underground space module is provided with waterproof glass skylights, solar power/wind power generation facilities, power supply facilities, intelligent facilities, ventilation skylights, and ventilation devices. The mesh-sheet standardized block underground space module further has air inlets in communication with air draft walkways, air draft doors/windows, and toilet air draft ducts of the building and also air outlets on the roof. In addition, the air outlets on the roof of the building are equipped with rain-proof facilities. Upon actual requirements, fresh air is provided through the ground waterproof glass skylights and ventilation devices for the mesh-sheet standardized block underground space module, and then the filthy air is exhausted through the air draft doors/windows, air draft walkways, air draft ducts, and ventilation devices of the building out of the mesh-sheet standardized block underground space module via the air vents on the roof. Therefore, the present invention adopts an air flow technique of fresh air low flow-in and filthy air high flow-out, so as to provide fresh air for the mesh-sheet standardized block underground space module in a circulation mode. Further, in practice, the mesh-sheet standardized block module may provide 40% to 80% or G % of mesh-sheet standardized block underground space module. The earthwork in the mesh-sheet standardized block underground space module can be delivered by amphibian dredges, earthwork conveyer belts, and earthwork transport ships to the sea beaches for sea reclamation.

In a preferred technical embodiment of the present invention, upon actual requirements, the traffic lanes and parking spaces for motor vehicles in the mesh-sheet standardized block module are all provided within the mesh-sheet standardized block underground space module. In another preferred technical embodiment of the present invention, upon actual requirements, the aboveground and underground spaces of the mesh-sheet standardized block module are respectively provided with traffic lanes and parking spaces. In practice, the mesh-sheet standardized block module is further equipped with aboveground/underground intelligent security monitoring alarm systems.

Upon actual requirements, the present invention is also provided with square standardized block modules, rectangular standardized block modules, triangular standardized block modules, rhombic standardized block modules, hexagonal standardized block modules, honeycomb-shaped standardized block modules, circular standardized block modules, elliptic standardized block modules, and wild animal/plant type block artistic modules.

[Standardized House Module]

The present invention provides a house product capable of being repeatedly implemented. Upon actual requirements, the present invention provides a standardized house module formed by standardized house components made of industrial prefabricated reinforced concrete or “glued stone” concrete or other materials. Compared with the current assembled houses, the standardized house module is better in thermal insulation, heat-proof, and sound insulation, lower in depreciation/damage rate, and can be used for permanent buildings.

The following technical schemes are adopted by the present invention. A standardized house module including industrial prefabricated standardized house module components such as house foundations, septic tanks, walls, floorslabs, stairs, walkways, doors, windows, balconies, floors, and roofs is provided. These components are set with buckling members and prefabricated/preserved holes. The upper-layer walls and the low-layer walls as well as the walls and the roofs are joined and butt welded with reinforcing steel bars, and the welding seams are filled by concrete. The lateral joining between the walls, the joining between the doors, windows, walls and the floorslabs, and the joining between the floors are accomplished by buckling members, and the joints are filled by concrete.

In a preferred embodiment of the present invention, the stories of the standardized house are integrally prefabricated in a template house module transportation standard case.

In another preferred embodiment of the present invention, the wall boards are hollow wall boards filled with rice hulls, straws, and crop stalks, or filled with plastic foam materials.

In another preferred embodiment of the present invention, the external walls of the standardized house module have corners with prefabricated/preserved holes. When assembled, the house module is locked by anchor chains passing through the roof to the house foundation and penetrating the corners of each floor.

In another preferred embodiment of the present invention, the external walls of the standardized house module have lining walls, and the lining walls are provided with prefabricated/preserved screws and hidden buckles chained to the external walls.

In another preferred embodiment of the present invention, upon actual requirements, the lining walls of the standardized house module are adhered to the external walls through adhesives.

In another preferred embodiment of the present invention, the lining walls are hollow.

The present invention achieves the following beneficial effects:

1. As the standardized house module of the present invention replaces the brick-concrete structured house made of bricks and tiles, and also replaces the frame structured house employing columns and beams for supporting and hollow bricks for walls, so as to significantly improve the manufacturing efficiency of the house, lower the manufacturing cost, reduce the environmental pollution, and meanwhile increase the available area of the house.

2. According to the present invention, as the walls have corners, instead of simply joining together the flat panel walls, the assembled house is stable and reliable.

3. As the present invention adopts hollow walls made of mixed materials, the house is warm in winter, heat-proof in summer, and sound-proof.

According to the present invention, the standardized house components of the house product, such as walls and floorslabs, can be designed into square, rectangular, circular, triangular, polygonal, elliptic, conical, cylindrical, honeycomb-shaped, and other geometric configurations. Thus, a standardized design is achieved through stable and regular patching.

According to the present invention, all or most of the standardized industrial workshops are designed on places with house construction material resources of sand, cement, steel products, etc., near mountains and rivers. The parts and components of the house product can be prefabricated and replicated through industrial assembly lines.

The house components provided by the present invention, such as corners with two walls, corners with one wall, corners with one wall and one layer of floorslab, the integral or one layer of stair/walkway, the integral toilet and kitchen, house foundation for separated units, septic tanks, doors, windows, balconies, walls, and various pipelines in house, are prefabricated and assembled. The upper/lower support standing walls and plane floorslabs of the house are joined and butt welded with reinforcing steel bars, and the welding seams are filled by concrete. According to the present invention, the upper/lower external walls of the house have corners with prefabricated/preserved holes. When assembled, the house module is locked by anchor chains passing through the roof to the house foundation and penetrating the corners of each floor. In the house, the lateral joining of each floor is fastened by steel bucking members and secret screws, so as to alleviate the damage of earthquakes to the house.

Upon actual requirements, the doors/windows are installed through prefabricated/preserved screws and hidden buckles.

Further, the present invention provides a prefabricated reinforced concrete hollow wall filled with crushed crops like rice hulls, straws, wheat stalks, sorghum stalks, and corn stalks, or filled with materials such as plastic foams, so as to achieve the purpose of thermal insulation, heat-proof, and sound insulation.

In the present invention, the external walls are support walls prefabricated by solid reinforced concrete. The thickness of the external wall and the proportion of the reinforcing steel bars are determined by the construction designers according to scientific operation with the height of the story and the weight of the building.

The lining walls are hollow walls, hollow roofs, vacuum walls, and vacuum roofs prefabricated by nuisance-free mixed materials such as seal plastics and flexible seal glass. As air is poor in thermal conductivity, and vacuum has even poorer thermal conductivity and is also sound-proof, the house product provided by the present invention is warm in winter, heat-proof in summer, and sound-proof. The lining walls can be easily and fixedly installed on the external walls through prefabricated/preserved screws and hidden buckles, and can also be adhered to the external walls through adhesives. In addition, the lining walls can be taken off the external walls for maintenance, and can be removed for recycling. The lining walls are mainly used for decoration, thermal insulation, heat-proof, and sound insulation.

In the present invention, a design of integral solar power can be added to the roof to increase the heat energy resources of the house.

The present invention is further provided with an anti-terrorism house module. Upon actual requirements, the roofs, walls, doors, and enclosure walls of the anti-terrorism house module are fabricated by explosion-proof, bulletproof, fireproof, waterproof, and sound insulation materials. Upon actual requirements, the transparent enclosure walls, windows, and swimming pool safety covers of the anti-terrorism house module are made of bulletproof, radiation-proof, and sound insulation glass. In addition, the anti-terrorism house module is set with antitoxic oxygen supply intelligent early-warning facilities connected to air-conditioners.

The anti-terrorism house module provided by the present invention has the following advantages. When the anti-terrorism house is under a terror attack or toxic gas intrusion, the intelligent anti-terrorism early-warning facilities will automatically issue an early-warning, automatically shut down the doors/windows, and automatically turn on the air-conditioners as well as the oxygen supply facilities.

The present invention further provides a house decoration module with standardized design. In particular, various nuisance-free paints and nuisance-free chemical pigments in bright colors, and materials like nuisance-free plastics, nuisance-free glass, nuisance-free metals, and nuisance-free nanometer mixed materials are sprayed on the prefabricated house module parts in an industrial mode, so as to perform standardized decoration on the kitchens, toilets, grounds, lights, pipelines, and so on. Through spraying, the appearance, color, and durability of the house are nearly equal to those of the automobiles and paintings; while the color and durability of the internal decoration of the house are nearly equal to those of the refrigerators, washing-machines, furniture, and paintings. Therefore, the present invention may greatly upgrade the artistic taste of the house decoration.

The standardized house module automatic load/unload transport steamboats and load/unload transportation house module standard cases provided by the present invention can ship the house module prefabricated products worldwide to be installed into standardized house modules, and afterward, the standardized house modules can be assembled into the standardized urban products.

The house module standard case provided by the present invention is made of a mixed material such as steel products, and manufactured according to the standardized size of the house module prefabricated products. The standard case is designed to be maintainable, reclaimable, capable of being recycled, and mainly used in loading/unloading, transporting, and installing prefabricated products for the house modules and house decoration modules.

According to actual requirements of the prefabricated products of the house module and house decoration module, the house module standard case can be designed into square, rectangular, circular, triangular, polygonal, elliptic, conical, cylindrical, honeycomb-shaped, and other geometric configurations, so as to enhance its stability and regularity. The house module standard case can be classified into two types: one is only used for loading/unloading and transporting prefabricated products of the house module and house decoration module; the other has dual functions, namely, used as models of the prefabricated products of the house module and house decoration module, and used for loading/unloading and transporting the same. The standard case has rail wheels on the bottom, dragging rings on two ends, and unloading rings on the top, thereby realizing functions of pushing, dragging, moving, unloading, and installation. The present invention further provides a prefabricated transportation house standard case for prefabricated floors. When the house is assembled, the floors prefabricated in the prefabricated transportation house standard case is slung out for integral installation.

The standardized house module automatic load/unload transport ships deliver the house module prefabricated products from the producing area to the location of the house by loading/unloading the house module standard cases. The standardized house module automatic load/unload transport ships are manufactured according to the standardized size of the house module standard case. The standardized house module automatic load/unload transport ships directly sling the house module standard cases onto the standardized house module self-control hoisting automobiles or rail products at the dock of shipping destination. Then, the house module standard cases are transported by the standardized house module self-control hoisting automobiles or rail products to the installation destination of the house, so as to realize the self-control hoisting installation. In addition, the standardized house self-control hoisting rail products and automobiles are manufactured according to the standardized size of the house module standard case.

[Manufacturing Cost Estimation on Reinforced Concrete Prefabricated House for 7-Story Standardized Residential Buildings within 24 m]

1. south and north walls: 88 m (length)×2 walls×19.6 m (height)×0.16 m (thickness)=551.936 m³

2. support main wall: 11 m (length)/wall×9 support walls×19.6 m (height)×0.16 m (thickness)=310.464 m³

3. circular beam foundation: 88 m (length)×1.6 m (width)×1 m (depth)×2 wall beams+(11 m−1.6 m)×9 support walls×1.6 m (width)×1 m (depth)=281.6 m³+135.36 m³=416.96 m³

4. story panel: 88 m (length)×1 m (width)×0.10 m (thickness)×7 stories=677.6 m³

5. thermal insulation roof: 90 m (length)×16 m (width)×0.12 m (thickness)=172.8 m³

6. internal wall: 11 m (length)×19.6 m (height)×0.08 m (thickness)×16 walls=275.968 m³

7. prefabricated reinforced concrete products: 2406 m³ in total

8. building construction area: 88 m (length)×11 m (width)×7 stories=6776 m²

9. construction material price: 2406 m³×350 RMB/m³ reinforced concrete material price=RMB 842,100

10. material price per square meter: RMB 842,100÷6776 m²=124 RMB/m²

11. prefabrication fee: 2406 m³×115 RMB/m³ prefabrication fee=RMB 276,690

12. waterway transportation fee: 2406 m³×1.5 ton/m³×0.05 RMB/ton per km×1000 km=RMB 180450÷6776 m²=27 RMB/m²

13. unship loading fee: 2406 m³×1.5 ton/m³×2 RMB/ton=RMB 7218

14. automobile transportation fee per ton for every 1 km: 2406 m³×1.5 ton/m³×0.8 RMB/ton per km×1 km=RMB 2887

15. house installation fee: 6776 m²×40 RMB/m² hoisting installation fee=RMB 271,040

16. pipelines, doors/windows, fuel gas, kitchens/sanitations, solar power: 56 houses×5000 RMB/house=RMB 280,000

17. external wall spraying: 19.6 m (height)×88 m (length)×2 walls+11 m×19.6 m×2=(3450 m²+431 m²)×30 RMB/m²=RMB 116,430

18. internal wall spraying: (3450 m²+3881 m²+6776 m²)×10 RMB/m²=RMB 141,070

19. total: RMB 2117885÷6776 m²=313 RMB/m²

[Animal/Plant Type House Artistic Module]

Besides the square, rectangular, circular, triangular, and other geometrically configured standardized house modules, the present invention may also provide an animal/plant type house artistic module through bionic techniques and arts for the urban and rural consumers. The provided animal/plant type house artistic module is not only applicable to the standardized urban products, but also to the old-city reform and removal/rebuild of old/dilapidated houses. The animal/plant type house artistic module provided by the present invention through bionic technical schemes is fabricated in the form of comics, sketch, animation, cartoon, paper-cut, iron picture, feather picture, sample picture, shell picture, oil painting, traditional Chinese painting, water color painting, computer drawing, spray painting, sculpture, ceramics, clay sculpture, aluminum alloy steel engraving, reinforcing steel bar cement, wood bamboo carving, clay rock, plastic sculpture, copper sculpture, glass artwork, bio-nano mixed material imitation, picture-story book, woodcut, fairy tale picture, story picture, film/TV program picture, or photograph.

The present invention is directed to an animal/plant type house artistic module fabricated with colors and vivid images of the animals and plants in the nature by construction, decoration, painting, and photography materials.

The animal/plant type house artistic products provided by the present invention are fabricated with colors and vivid images of the animals and plants in the nature by construction and decoration materials. The shapes of the animal/plant type house artistic modules portray the animals and plants in the nature. As for the house artistic modules in shapes of the animals and plants in the water, environmental color modules matching the animals and plants in the water are provided to serve as podium buildings of the aquatic animal/plant type house artistic modules. As for the house artistic modules in shapes of the animals and plants on the land, environmental color modules matching the animals and plants on the land are provided to serve as podium buildings of the terrestrial animal/plant type house artistic modules.

The podium buildings of the animal/plant type house artistic module provided by the present invention may enhance the structural stability and practicability of the animal/plant type house artistic module, and also increase the available area of the animal/plant type house, thus improving the economic benefits of the animal/plant type house artistic module.

In the animal/plant type house artistic module of the present invention, the walls, doors, windows, balconies, roofs, and internal/external decorations are artistic portrayal of the animal/plant or in consistent environmental colors. The walkways, bedrooms, kitchens, toilets, and various pipelines, etc., inside the animal/plant type house artistic module are fabricated by combining the inner structure of the conventional house with characteristics of the animals and plants. Thereby, the consumers actually experience in the animal/plant type house artistic modules fabricated by the construction, decoration, painting, and photography materials.

According to the present invention, various artistic images of the animal/plant type house artistic modules are provided to attract urban and rural consumers, and serve as advertisements to grab the market. In particular, the present invention adopts an artistic language of the animal/plant type house artistic products to reveal to the urban and rural consumers the colorful, vivid, and lively animals and plants, and the history of the appearance, evolution, food chains, natural enemies of the animal/plant as well as the taming of the wild animal/plant. Further, the philosophical concept of “Existence determines consciousness” is employed to enable the consumers in these beautiful and lovely animal/plant type house artistic products to learn about scientific knowledge and interesting stories of the animals and plants by what they constantly see and hear. Thereby, the knowledge and protection awareness of the consumers to the animals and plants will be enhanced. Moreover, the present invention adopts an artistic language of the wild animal/plant type restaurant house artistic products to reveal to the urban and rural consumers the harmfulness of hormones such as pesticides and chemical fertilizers to the wild animal/plant and the consumers. Thereby, the urban and rural consumers may realize that taking the animal/plant food in a wrong way may well lead to diseases. As such, the present invention informs the urban and rural consumers objectively through the artistic language of the wild animal/plant type restaurant house artistic products what kind of animal/plant products should be chosen in benefit of our health, youthfulness, and longevity.

The artistic language of the animal/plant type house artistic products adopted by the present invention may not only effectively inherit and develop particular animal/plant type house sculpture graphics art in the World Cultural Heritages, but also provide developing platforms for zoologists, botanists, cultural artists, painters, biologists, life scientists, nanometer material scientists, construction sculpture artists, construction engineering technicians, and painting sculpture craftsmen to create the animal/plant type house artistic modules, thereby adding a new chapter of animal/plant type house artistic products in the human history of civilization.

In a technical embodiment of the present invention, a whale or shark-shaped house artistic module is provided. The whale or shark-shaped house artistic module is fabricated with colors and vivid images of the animals and plants in the nature by construction, decoration, painting, and photography materials. The walls, doors, windows, balconies, roofs, and internal/external decorations of the whale or shark-shaped house artistic module are artistic portrayal of the animal/plant or in consistent environmental colors. The walkways, bedrooms, kitchens, toilets, and various pipelines, etc., inside the whale or shark-shaped house artistic module are fabricated by combining the inner structure of the conventional house with characteristics of the animals and plants. Further, the present invention may choose water color or sand color as the color of the podium buildings of the whale or shark-shaped house artistic module, and the entire whale or shark-shaped building is actually a whale or shark-shaped house artistic module manufactured by construction, decoration, painting, and photography materials. The internal/external decorations of the whale or shark-shaped house artistic module are meant to demonstrate the living environment, food chains, natural enemies, origins, evolution, scientific knowledge, and legend stories of the whales or sharks. Thereby, the consumers actually experience a in giant whale or shark-shaped house artistic modules. The whale or shark-shaped house artistic module is applicable to museums, gyms, theaters, stations, docks, markets, supermarkets, singing & dancing bars, office buildings, hotels, restaurants, and other buildings.

In a technical embodiment of the present invention, a house artistic module in the shape of a dinosaur, kylin, crocodile, elephant, lion, tiger, bear, giraffe, panda, fox, leopard, wolf, kangaroo, hawk, phoenix, peacock, or eagle is provided. The animal/plant type house artistic module provided by the present invention is fabricated with colors and vivid images of the animals and plants in the nature by construction, decoration, painting, and photography materials. The walls, doors, windows, balconies, roofs, and internal/external decorations of the dinosaur, kylin, crocodile, elephant, lion, tiger, bear, giraffe, panda, fox, leopard, wolf, kangaroo, hawk, phoenix, peacock, or eagle-shaped house artistic module are artistic portrayal of the animal/plant or in consistent environmental colors. The walkways, bedrooms, kitchens, toilets, and various pipelines, etc., inside the dinosaur, kylin, crocodile, elephant, lion, tiger, bear, giraffe, panda, fox, leopard, wolf, kangaroo, hawk, phoenix, peacock, or eagle-shaped house artistic module are fabricated by combining the inner structure of the conventional house with characteristics of the animals and plants. Further, color modules of rocks, flowers/grass, wetlands, deserts, or forests are provided as podium buildings of the dinosaur, kylin, crocodile, elephant, lion, tiger, bear, giraffe, panda, fox, leopard, wolf, kangaroo, hawk, phoenix, peacock, or eagle-shaped animal type house artistic module. The internal/external decorations of the dinosaur, kylin, crocodile, elephant, lion, tiger, bear, giraffe, panda, fox, leopard, wolf, kangaroo, hawk, phoenix, peacock, or eagle-shaped house artistic module are meant to demonstrate the origins, evolution, taming, living environment, food chains, natural enemies, scientific knowledge, and legend stories of the dinosaur, kylin, crocodile, elephant, lion, tiger, bear, giraffe, panda, fox, leopard, wolf, kangaroo, hawk, phoenix, peacock, or eagle. Thereby, the urban and rural consumers actually experience in the dinosaur, kylin, crocodile, elephant, lion, tiger, bear, giraffe, panda, fox, leopard or wolf, kangaroo, hawk, phoenix, peacock, or eagle-shaped house artistic modules manufactured by construction, decoration, painting, and photography materials. The house artistic module is applicable to museums, gyms, theaters, stations, docks, commercial streets, markets, supermarkets, singing & dancing bars, office buildings, hotels, restaurants, and other buildings.

In a technical embodiment of the present invention, a dragon-shaped house artistic module portraying a golden dragon, silver dragon, green dragon, white dragon, yellow dragon, blue dragon, colored dragon, or black dragon is provided. The dragon-shaped house artistic module is fabricated with colors and vivid images of the animals and plants in the nature by construction, decoration, painting, and photography materials. The walls, doors, windows, balconies, roofs, and internal/external decorations of the dragon-shaped house artistic module are artistic portrayal of the animal/plant or in consistent environmental colors. The walkways, bedrooms, kitchens, toilets, and various pipelines, etc., inside the dragon-shaped house artistic module are fabricated by combining the inner structure of the conventional house with characteristics of the animals and plants. Further, color modules like seawater or colorful cloud are provided as podium buildings of the dragon-shaped house artistic module. The internal/external decorations of the dragon-shaped house artistic module are meant to demonstrate the living environment and origins of the dragons, as well as legend stories about human beings and the dragons. Thereby, the urban and rural consumers actually experience in the golden dragon, silver dragon, green dragon, white dragon, yellow dragon, blue dragon, colored dragon, or black dragon-shaped house artistic modules manufactured by construction, decoration, painting, and photography materials. In addition, the dragon-shaped house artistic module is applicable to commercial streets, pedestrian streets, museums, scientific research/teaching places, gyms, theaters, markets, airports, stations, docks, supermarkets, singing & dancing bars, office buildings, hotels, restaurants, and other buildings.

In a technical embodiment of the present invention, a snake-shaped house artistic module portraying a golden snake, silver snake, green snake, white snake, yellow snake, spotted snake, black snake, or colored snake is provided. The snake-shaped house artistic module is fabricated with colors and vivid images of the animals and plants in the nature by construction, decoration, painting, and photography materials. The walls, doors, windows, balconies, roofs, and internal/external decorations of the snake-shaped house artistic module are artistic portrayal of the animal/plant or in consistent environmental colors. The walkways, bedrooms, kitchens, toilets, and various pipelines, etc., inside the snake-shaped house artistic module are fabricated by combining the inner structure of the conventional house with characteristics of the animals and plants. Further, modules of rocks, water color, flowers/grass, woods, or caves are provided as podium buildings of the snake-shaped house artistic module. The internal/external decorations of the snake-shaped house artistic module are meant to demonstrate the living environment, food chains, natural enemies, origins, evolution, taming, and scientific knowledge of the snakes, as well as legend stories about human beings and the snakes. Thereby, the urban and rural consumers actually experience and consume in the golden snake, silver snake, green snake, white snake, yellow snake, spotted snake, black snake, or colored snake-shaped house artistic modules manufactured by construction, decoration, painting, and photography materials. In addition, the snake-shaped house artistic module is applicable to commercial streets, pedestrian streets, museums, gyms, theaters, markets, airports, stations, supermarkets, singing & dancing bars, office buildings, hotels, restaurants, and other buildings.

In a technical embodiment of the present invention, a “carps jumping across the dragon gate”-type house artistic module is provided. The “carps jumping across the dragon gate”-type house artistic module is fabricated with colors and vivid images of the animals and plants in the nature by construction, decoration, painting, and photography materials. The walls, doors, windows, balconies, roofs, and internal/external decorations of the “carps jumping across the dragon gate”-type house artistic module are artistic portrayal of the animal/plant or in consistent environmental colors. The walkways, bedrooms, kitchens, toilets, and various pipelines, etc., inside the “carps jumping across the dragon gate”-type house artistic module are fabricated by combining the inner structure of the conventional house with characteristics of the animals and plants. Further, water colored modules are provided as podium buildings of the “carps jumping across the dragon gate”-type house artistic module. The internal/external decorations of the “carps jumping across the dragon gate”-type house artistic module are meant to demonstrate the living environment, origins, evolution, taming, and scientific knowledge of the carps, as well as legend stories about human beings and the carps. Thereby, the urban and rural consumers actually experience in the “carps jumping across the dragon gate”-type house artistic modules manufactured by construction, decoration, painting, and photography materials. In addition, the “carps jumping across the dragon gate”-type house artistic module is applicable to office buildings, dwelling houses, scientific research/teaching buildings, commercial buildings, hotels, restaurants, and other buildings.

In a technical embodiment of the present invention, a sea lion or dolphin diving-type house artistic module is provided. The sea lion or dolphin diving-type house artistic module is fabricated with colors and vivid images of the animals and plants in the nature by construction, decoration, painting, and photography materials. The walls, doors, windows, balconies, roofs, and internal/external decorations of the sea lion or dolphin diving-type house artistic module are artistic portrayal of the animal/plant or in consistent environmental colors. The walkways, bedrooms, kitchens, toilets, and various pipelines, etc., inside the sea lion or dolphin diving-type house artistic module are fabricated by combining the inner structure of the conventional house with characteristics of the animals and plants. Further, water colored modules are provided as podium buildings of the sea lion or dolphin diving-type house, and one or more sea lion/dolphin diving-type high buildings are set up above the water colored module podium buildings. The sea lion/dolphin diving-type high buildings are provided with internal/external decorations of white, blue, silver, green, black, golden, golden yellow, or colored sea lion/dolphin diving-type house artistic modules, so as to demonstrate the living environment, origins, evolution, taming, and scientific knowledge of the sea lions/dolphins, as well as legend stories about human beings and the sea lions/dolphins. Thereby, the urban and rural consumers actually experience in the sea lion/dolphin diving-type house artistic modules manufactured by construction, decoration, painting, and photography materials. In addition, the sea lion/dolphin diving-type house artistic module is applicable to office buildings, dwelling houses, commercial buildings, hotels, restaurants, and other buildings.

In a technical embodiment of the present invention, a high-rise house artistic module in the shape of a bamboo shoot, fishscale bamboo, sesame, bamboo flute, vertical bamboo flute, cowherd's flute, ball cactus, tree, or flower/grass is provided. The animal/plant type house artistic module of the present invention is fabricated with colors and vivid images of the animals and plants in the nature by construction, decoration, painting, and photography materials. The walls, doors, windows, balconies, roofs, and internal/external decorations of the bamboo shoot, fishscale bamboo, sesame, bamboo flute, vertical bamboo flute, cowherd's flute, ball cactus, tree, or flower/grass-shaped house artistic module are artistic portrayal of the animal/plant or in consistent environmental colors. The walkways, bedrooms, kitchens, toilets, and various pipelines, etc., inside the bamboo shoot, fishscale bamboo, sesame, bamboo flute, vertical bamboo flute, cowherd's flute, ball cactus, tree, or flower/grass-shaped house artistic module are fabricated by combining the inner structure of the conventional house with characteristics of the animals and plants. Further, the internal/external decorations and podium buildings of the bamboo shoot, fishscale bamboo, sesame, bamboo flute, vertical bamboo flute, cowherd's flute, ball cactus, tree, or flower/grass-shaped high-rise house decoration artistic module are meant to demonstrate the origins, evolution, living environment, scientific knowledge, and legend stories of the bamboo shoot, fishscale bamboo, sesame, bamboo flute, vertical bamboo flute, cowherd's flute, ball cactus, wood, or flower/grass. Thereby, the urban and rural consumers actually experience in the bamboo shoot, fishscale bamboo, sesame, bamboo flute, vertical bamboo flute, cowherd's flute, ball cactus, tree, or flower/grass-shaped high-rise house artistic modules manufactured by construction, decoration, painting, and photography materials. In addition, the high-rise house artistic module is applicable to office buildings, dwelling houses, hotels, restaurants, and other buildings.

In a technical embodiment of the present invention, a house artistic module in the form of a ball, badminton, water polo, hockey, baseball, embroider ball, ice hockey, bowling, tennis, pingpong, golf, football, basketball, rugby, volleyball, handball, crystal ball, colored ball, ball-shaped trophy cup, jade inkstone, jade ink stick, brush pen, lute, colored stone, jade stone, rock, or mountain is provided. The animal/plant type house artistic module of the present invention is fabricated with colors and vivid images of the animals and plants in the nature by construction, decoration, painting, and photography materials. The walls, doors, windows, balconies, roofs, and internal/external decorations of the ball, badminton, water polo, hockey, baseball, embroider ball, ice hockey, bowling, tennis, pingpong, golf, football, basketball, rugby, volleyball, handball, crystal ball, colored ball, ball-shaped trophy cup, jade inkstone, jade ink stick, brush pen, lute, colored stone, jade stone, rock, or mountain-shaped house artistic module are in consistent environmental colors. The walkways, bedrooms, kitchens, toilets, and various pipelines, etc., inside the house artistic module are fabricated by combining the inner structure of the conventional house with characteristics of the animals and plants. Further, the internal/external decorations and podium buildings of the house artistic module are meant to demonstrate the origins, exploitation, fabrication, scientific knowledge, and legend stories of the ball, badminton, water polo, hockey, baseball, embroider ball, ice hockey, bowling, tennis, pingpong, golf, football, basketball, rugby, volleyball, handball, crystal ball, colored ball, ball-shaped trophy cup, jade inkstone, jade ink stick, brush pen, lute, colored stone, jade stone, rock, or mountain. Thereby, the urban and rural consumers actually experience in the giant ball, badminton, water polo, hockey, baseball, embroider ball, ice hockey, bowling, tennis, pingpong, golf, football, basketball, rugby, volleyball, handball, crystal ball, colored ball, ball-shaped trophy cup, jade inkstone, jade ink stick, brush pen, lute, colored stone, jade stone, rock, or mountain-type house artistic modules manufactured by construction, decoration, painting, and photography materials. In addition, the house artistic module is applicable to stadium/gyms, cultural centers, art galleries, commercial buildings, villas, dwelling houses, office buildings, hotels, restaurants, and other buildings.

In a technical embodiment of the present invention, a house artistic module in the shape of a dew, waterdrop, pearl, water bubble, lotus leaf, mulberry leaf, maple leaf, bamboo leaf, red bean, butterfly, snowman, Snow White, mermaid, penguin, swan, or mandarin duck is provided. The animal/plant type house artistic module of the present invention is fabricated with colors and vivid images of the animals and plants in the nature by construction, decoration, painting, and photography materials. The walls, doors, windows, balconies, roofs, and internal/external decorations of the dew, waterdrop, pearl, water bubble, lotus leaf, mulberry leaf, maple leaf, bamboo leaf, red bean, butterfly, snowman, Snow White, mermaid, penguin, swan, or mandarin duck-shaped house artistic module are artistic portrayal of the animal/plant or in consistent environmental colors. The walkways, bedrooms, kitchens, toilets, and various pipelines, etc., inside the house artistic module are fabricated by combining the inner structure of the conventional house with characteristics of the animals and plants. Further, the internal/external decorations and podium buildings of the dew, waterdrop, pearl, water bubble, lotus leaf, mulberry leaf, maple leaf, bamboo leaf, red bean, butterfly, snowman, Snow White, mermaid, penguin, swan, or mandarin duck-shaped house artistic module are meant to demonstrate the living environment, food chains, natural enemies, origins, evolution, scientific knowledge, and stories of the dew, waterdrop, pearl, water bubble, lotus leaf, mulberry leaf, maple leaf, bamboo leaf, red bean, butterfly, snowman, Snow White, mermaid, penguin, swan, or mandarin duck. Thereby, the urban and rural consumers actually experience in the dew, waterdrop, pearl, water bubble, lotus leaf, mulberry leaf, maple leaf, bamboo leaf, red bean, butterfly, snowman, Snow White, mermaid, penguin, swan, or mandarin duck-shaped house artistic modules manufactured by construction, decoration, painting, and photography materials. In addition, the house artistic module is applicable to villas, dwelling houses, commercial buildings, tourism houses, and other buildings.

In a technical embodiment of the present invention, a house artistic module in the shape of cowpea, mung bean, pea, soybean, green soybean, kidney bean, peach, grape, tomato, persimmon, apple, rice, millet, sorghum, wheat, cherry, red bean, chufa, tangerine, cumquat, banana, pineapple, coconut, pear, watermelon, pawpaw, capsicum annuum, lettuce, lichee, plum, jujube, lotus seed, chesnut, Hami melon, pomelo, kiwi, megranate, strawberry, loquat, pumpkin, hawkthorn, mango, carambola, lemon, apricot, sweet melon, bitter melon, betelnut, radish, pistachio nut, Fructus momordica, corn-stick, waxgourd, coffee bean, potato, longan, mushroom, towel gourd, cucumber, snake melon, Malus asiatica Nakai, peanut, olive, lily, orange, cherry, oleaster, walnut, feinut, Climbing fig, wanurco, eggplant, fuzzy melon, acorn, cotton boll, ginkgo, tree fruit, plant fruit, grass seed, flower seed, or flower bud is provided. The animal/plant type house artistic module of the present invention is fabricated with colors and vivid images of the animals and plants in the nature by construction, decoration, painting, and photography materials. The walls, doors, windows, balconies, roofs, and internal/external decorations of the house artistic module are artistic portrayal of the wild/ecological animal/plant or in consistent environmental colors. The walkways, bedrooms, kitchens, toilets, and various pipelines, etc., inside the animal/plant type house artistic module are fabricated by combining the inner structure of the conventional house with characteristics of the wild/ecological animals and plants. The internal/external decorations and podium buildings of the house artistic module in the shape of a cowpea, mung bean, pea, soybean, green soybean, kidney bean, peach, grape, tomato, persimmon, apple, rice, millet, sorghum, wheat, cherry, red bean, chufa, tangerine, cumquat, banana, pineapple, coconut, pear, watermelon, pawpaw, capsicum annuum, lettuce, lichee, plum, jujube, lotus seed, chesnut, Hami melon, pomelo, kiwi, megranate, strawberry, loquat, pumpkin, hawkthorn, mango, carambola, lemon, apricot, sweet melon, bitter melon, betelnut, radish, pistachio nut, Fructus momordica, corn-stick, waxgourd, coffee bean, potato, longan, mushroom, towel gourd, cucumber, snake melon, Malus asiatica Nakai, peanut, olive, lily, orange, cherry, oleaster, walnut, feinut, Climbing fig, wanurco, eggplant, fuzzy melon, acorn, cotton boll, ginkgo, tree fruit, plant fruit, grass seed, flower seed, or flower bud are meant to demonstrate the living environment, food chains, natural enemies, origins, evolution, taming, nutritive value, scientific knowledge, and stories of the cowpea, mung bean, pea, soybean, green soybean, kidney bean, peach, grape, tomato, persimmon, apple, rice, millet, sorghum, wheat, cherry, red bean, chufa, tangerine, cumquat, banana, pineapple, coconut, pear, watermelon, pawpaw, capsicum annuum, lettuce, lichee, plum, jujube, lotus seed, chesnut, Hami melon, pomelo, kiwi, megranate, strawberry, loquat, pumpkin, hawkthorn, mango, carambola, lemon, apricot, sweet melon, bitter melon, betelnut, radish, pistachio nut, Fructus momordica, corn-stick, waxgourd, coffee bean, potato, longan, mushroom, towel gourd, cucumber, snake melon, Malus asiatica Nakai, peanut, olive, lily, orange, cherry, oleaster, walnut, feinut, Climbing fig, wanurco, eggplant, fuzzy melon, acorn, cotton boll, ginkgo, tree fruit, plant fruit, grass seed, flower seed, or flower bud. Thereby, the urban and rural consumers actually experience and consume in the house artistic modules portraying a cowpea, mung bean, pea, soybean, green soybean, kidney bean, peach, grape, tomato, persimmon, apple, rice, millet, sorghum, wheat, cherry, red bean, chufa, tangerine, cumquat, banana, pineapple, coconut, pear, watermelon, pawpaw, capsicum annuum, lettuce, lichee, plum, jujube, lotus seed, chesnut, Hami melon, pomelo, kiwi, megranate, strawberry, loquat, pumpkin, hawkthorn, mango, carambola, lemon, apricot, sweet melon, bitter melon, betelnut, radish, pistachio nut, Fructus momordica, corn-stick, waxgourd, coffee bean, potato, longan, mushroom, towel gourd, cucumber, snake melon, Malus asiatica Nakai, peanut, olive, lily, orange, cherry, oleaster, walnut, feinut, Climbing fig, wanurco, eggplant, fuzzy melon, acorn, cotton boll, ginkgo, tree fruit, plant fruit, grass seed, flower seed, or flower bud and manufactured by construction, decoration, painting, and photography materials. In addition, the house artistic module is applicable to villas, commercial buildings, tourism houses, dwelling houses, and other buildings.

[Wild/Ecological Animal/Plant Type Restaurant Module]

A standard of wild/ecological animal/plant type house artistic module is provided to change the current manufacturing, decoration, and advertisement marketing mode of the animal/plant restaurant house, so as to explore industry chains of high-quality wild animal/plant products. Thereby, not only the demands on flavor and recreation, but also the demands on people-oriented nutrition and interesting activities of the urban and rural consumers are satisfied. As such, the diseases brought by drinking or eating the animal/plant products can be prevented and controlled in a scientific and reasonable way, so as to eliminate the defects of the current animal/plant restaurant techniques.

The wild/ecological animal/plant type restaurant module is provided to meet the consumers' demands on knowledge, nutrition, flavor, ornament, exercise, and experience of the wild animal/plant, and demand on polite & thoughtful services. Oriented on the consumer market, the present invention promotes to recover the natural growth pattern of high-quality wild/ecological animal/plant, and to sell high-quality wild/ecological animal/plant food in ranges permitted by the state or local law, thereby enriching the visual, taste, exercise, fun, and catering culture enjoyment of the massive consumers. Further, a dietary method is provided to instruct the consumers to drink/eat scientifically, stay with reasonable nutrition, and prevent/cure diseases, in order to keep health and live a longer life.

The aforementioned wild animal/plant products are specifically nutritious wild/ecological animal/plant passing the nuisance-free scientific tests, or nutritious wild/ecological animal/plant tamed by human-beings and passing the nuisance-free scientific tests, or animals tamed in the natural environment and passing the nuisance-free scientific tests, such as soft-shelled turtles, cattle, donkeys, pigs, horses, dogs, rabbits, chicken, ducks, gooses, pigeons, wild chicken, deer, squirrels, ostriches, peacocks, roe deer, birds, masked civets, fishes, shrimps, crabs, shells, snails, sea cucumbers and abalones, snakes, eels, turtles, frogs, and insects. In the present invention, the wild animals are specifically animals fed in the natural environment through food searching activities. For example, the cattle, horses, donkeys, pigs, sheep, chicken, ducks, and gooses must be fed outside on the mountain areas or grass lands for most of the time, and those cattle, horse, donkey, pig, sheep, chicken, duck, and goose products raised by industrial hormone feedstuffs in a pen should be forbidden. Moreover, for instance, the hatched baby soft-shelled turtles must be released to the natural environment to recover their wild inherence of feeding in fishes, shrimps, and snails, such that the baby soft-shelled turtles may grow in accordance with the objective laws in the wild environment, and the products of soft-shelled turtles raised by industrial hormone feedstuffs in a pen should be forbidden. In the present invention, the wild plants are specifically plants cultivated in a natural environment without industrial pollution or pesticide/hormone. Thereby, according to the present invention, the wild/ecological animal/plant type restaurant module chain-stores are supplied with raw materials of high-quality wild animal/plant products cultivated, fed, checked, stored, packaged, transported, processed, and marketed in the wild environment.

In the present invention, the wild/ecological animal/plant type restaurant modules are forbidden to purchase or sell any animal/plant products with a shortened growth cycle by being fed with hormone feedstuffs, nor purchase toxic chemicals like pesticides to serve as animal/plant food preservatives/raising agents.

Upon actual requirements, wild/ecological animal/plant type construction/sculpture/photograph universities of arts, wild/ecological animal/plant type restaurant module construction/decoration/painting/sculpture/photograph colleges of arts, wild animal/plant products breeding & inspection universities, wild/ecological animal/plant nutrition universities of medical instructor/assistant, wild/ecological animal/plant standardized restaurant marketing management universities, wild/ecological animal/plant cooking universities, wild/ecological animal/plant cooking vocational schools, and wild/ecological animal/plant restaurant marketing waiter schools are provided. According to the present invention, the students are recruited through adult education and national unified entrance exam. Based on intellectual property rights, the present invention invites investment and combines social powers to run schools to train personnel for the wild/ecological animal/plant type restaurant module chain-stores. The aforementioned wild/ecological animal/plant restaurant instructors, assistants, and waiters are acknowledged by government departments or industrial associations through professional training and vocational certificate assessments in subjects like Chinese medicine, Western medicine, and dietary nutrition kinology. Moreover, the wild/ecological animal/plant restaurant instructors, assistants, and waiters provided by the present invention hold certificates, and wear noticeable service post licenses, so as to ensure the service quality and service standard of the wild/ecological animal/plant restaurants. Further, based on intellectual property rights, the present invention manufactures, decorates, and sculptures the wild/ecological animal/plant type restaurant modules to the same standard. In addition, the wild/ecological animal/plant raisers, quality inspectors, storage/packaging/transportation personnel, butchers, chefs, and waiters are dressed and trained uniformly. Moreover, the present invention unitedly inspects/purchases wild animal/plant products, unitedly stores/packages/transports wild animal/plant products, and unitedly provides wild animal/plant products and supporting products for the wild/ecological animal/plant type restaurant module chain-stores according to international/national standards and actual market demands of wild/ecological animal/plant type restaurant modules.

1. Wild/Ecological Soft-Shelled Turtle Type Restaurant Module

In a preferred technical embodiment of the present invention, a wild/ecological soft-shelled turtle type restaurant module is provided. The wild/ecological soft-shelled turtle type restaurant module is preferably set aside main arteries of the rivers, lakes, oceans, mountain areas, and scenic spots at rural-urban fringe areas, so as to meet the demands of tourism and urban leisure consumers in drive. The present invention adopts bionic techniques and arts to fabricate a house model imitating a soft-shelled turtle. Seen from afar, the wild/ecological soft-shelled turtle type restaurant module looks like a giant soft-shelled turtle lying beside the main arteries of the rivers, lakes, oceans, mountain areas, and scenic spots. In the present invention, rocks, flowers, or grass are provided as podium buildings of the soft-shelled turtle type house artistic module. The walls, doors, windows, balconies, roofs, and internal/external decorations of the soft-shelled turtle type house artistic module are artistic portrayal of the wild/ecological animal/plant or in consistent environmental colors. The walkways, bedrooms, kitchens, toilets, and various pipelines, etc., inside the soft-shelled turtle type house artistic module are fabricated by combining the inner structure of the conventional house with characteristics of the wild/ecological animals and plants. Thereby, the wild/ecological soft-shelled turtle type restaurant module is actually a soft-shelled turtle type house artistic module manufactured by construction, decoration, painting, and photography materials. As such, the consumers indeed experience and consume in the soft-shelled turtle type house artistic modules.

Upon actual requirements, a wild/ecological soft-shelled turtle type restaurant module is provided during the removal/rebuild of old/dilapidated houses in urban areas. The wild/ecological soft-shelled turtle type restaurant module of the present invention is provided with soft-shelled turtle shaped windows, which may be selectively painted with comics, cartoons, animations, traditional Chinese paintings, oil paintings, or sculptures portraying soft-shelled turtles looking at their eggs or old soft-shelled turtles carrying their baby soft-shelled turtles to enjoy the sun-shine. The welcome portals are decorated into doors with soft-shelled turtle pictures. The windows are decorated with cartoons, animations, comics, or sculptures of naughty baby soft-shelled turtles popping their heads and looking around. Besides, giant soft-shelled turtle sculptures are provided for the view of the consumers, and soft-shelled turtle electric toys are provided for the children to play with. Crystal palace type houses are selectively provided with aquatic weed water bubble painting/photograph type glass windows. Further, soft-shelled turtle leisure tables, chairs, gardening, parergon, and giant soft-shelled turtle ornamental specimens are selectively provided. Upon actual requirements, a sound-insulation glass kitchen may be selectively provided to enable the consumers to enjoy the cooking through the sound-insulation glass. Further, upon actual requirements, soft-shelled turtle raising rooms are selectively provided; underground and aboveground parking spaces are provided according to the area of the wild/ecological soft-shelled turtle type restaurant module and actual requirements; soft-shelled turtle sculptures are set with a poem dedicated thereto: “Long live the tortoise and even longer the soft-shelled turtle, both for beautification, nourishment, and invigoration of the blood circulation. Treat ‘3H’ and prevent the cancer, and a good choice for satisfying a craving for delicious food”; business grounds, for example, the hall and private rooms are decorated with comics, animations, cartoons, and traditional Chinese paintings portraying soft-shelled turtles, hills, and waters, with an inscription dedicated thereto: “The tortoises had better not mock the soft-shelled turtles, for they both live in the same caves”; the walls and roofs of the restaurant hall and private rooms are decorated with paintings/photographs like waters, water bubbles, aquatic weeds, and soft-shelled turtles fishing, catching shrimps, and eating snails. In addition, wild/ecological soft-shelled turtle dietary supplies such as soft-shelled turtle teapots and teacups, soft-shelled turtle soup boilers, soft-shelled turtle dish-plates, soft-shelled turtle trays, soft-shelled turtle food conveyors, soft-shelled turtle light fixtures, and soft-shelled turtle furniture are provided. Decorations, toys, and souvenirs of the dinning tables, chairs, and children dining chair in the restaurant are meant to demonstrate the living environment of the wild/ecological soft-shelled turtles as well as folk culture featured in eating soft-shelled turtles.

The Chinese-style, fast-food, buffet, and floating-type wild/ecological soft-shelled turtle type restaurant modules provided by the present invention can be replicated to form chain-stores and provided with professional or vocational dietary instructors, assistants, and waiters.

The fast-food and buffet type wild/ecological soft-shelled turtle type restaurant modules of the present invention supply (wild) soft-shelled turtle meat & vegetable hamburger in shape of a (wild) soft-shelled turtle, fast-food of (wild) soft-shelled turtle gravy & vegetable, black-bone chicken & (wild) soft-shelled turtle soup, fish & (wild) soft-shelled turtle soup, fresh mushroom & vegetable soup, and spiced, grilled, or smoked soft-shelled turtle.

In the present invention, the Chinese-style wild/ecological soft-shelled turtle type restaurant module supplies (wild) soft-shelled turtle braised in soy sauce by a traditional cooking method with slow fire, hot-pot (wild) soft-shelled turtle, spicy-hot (wild) soft-shelled turtle, spicy (wild) soft-shelled turtle, mild spicy (wild) soft-shelled turtle, not-spicy (wild) soft-shelled turtle, rustic (wild) soft-shelled turtle, urban (wild) soft-shelled turtle, steamed (wild) soft-shelled turtle, stewed (wild) soft-shelled turtle, roasted whole (wild) soft-shelled turtle, roasted (wild) soft-shelled turtle head, roasted (wild) soft-shelled turtle neck, roasted (wild) soft-shelled turtle leg, roasted (wild) soft-shelled turtle shell, smoked (wild) soft-shelled turtle, spiced whole (wild) soft-shelled turtle, spiced (wild) soft-shelled turtle head, spiced (wild) soft-shelled turtle neck, spiced (wild) soft-shelled turtle shell, and spiced (wild) soft-shelled turtle leg. To cater for different consumers, spiced thin sheets of bean curd, spiced chicken, spiced goose, spiced beef, wild fish, pigeon, free-range chicken, wild chicken, beef, gingers, pickled vegetables, radish head, blind weed, spinach, peanuts, melon seeds, tea, cedrela sinensis, potherb, wormwood cake, smoked fish, salted chicken, salted fish, salted goose, soft-shelled turtle hamburger, and soft-shelled turtle bread, etc., are provided additionally.

In the present invention, various types of soft-shelled turtles from different producing areas are purchased at different prices, then processed in varied methods, and sold at different prices. Soft-shelled turtles with varied values may be produced by different breeds and different taming environments. Thus, the wild/ecological soft-shelled turtle type restaurant module may put forward dishes at different prices based on soft-shelled turtles of varied quality.

In the present invention, text tablets inscribed with “wild/ecological soft-shelled turtle type restaurant” or “wild/ecological turtle type restaurant” are provided. Further, advertising films about the wild/ecological soft-shelled turtle are provided with the following main content.

The soft-shelled turtle animals first appeared at the end of Palaeozoic era, and have an evolution process for approximately 200 million years. The archaeological specimens or archaeological specimen replicas of the soft-shelled turtle, the birth and evolution of the soft-shelled turtle, worldwide breeds of (wild) soft-shelled turtle, food chains and natural enemies of the (wild) soft-shelled turtle, the taming of the wild soft-shelled turtle, the dietary and medical values of the (wild) soft-shelled turtle, the beneficial nutrition components of the (wild) soft-shelled turtle to human body, the rearing environment and method of the wild/ecological soft-shelled turtle, anecdotes about the soft-shelled turtle and the human, the motion modes and longevity secrets of the soft-shelled turtle, and the status of the soft-shelled turtle in life science research as an ancient secondary aquatic reptilia are provided. Besides, the soft-shelled turtle lives for about 60 years. The nutrition and nourishing value of the soft-shelled turtles are already known for 3000 years, and have been used in medicines for nearly 2000 years. In addition, the most critical economic value of the soft-shelled turtle reflects in table purpose. The soft-shelled turtle is high in protein content, and rich in amino acid and tasty amino acid necessary to human body. Above 70% of the fat in the soft-shelled turtle is unsaturated fatty acid, and above 25% is highly unsaturated fatty acid. In addition, the contents of the Docosahexaenoic acid (DHA) and Eicosapentaenoic Acid (EPA) are very high. These two highly unsaturated fatty acids play a very important role in the human body metabolism, and are referred to as “brain gold”, for restraining platelet clumping, preventing thrombosis and arteriosclerosis, and decreasing the content of “harmful” cholesterol in the human body. The soft-shelled turtle is also rich in vitamin, especially vitamin E with antioxidation function, so as to prevent the aging of the human cells and exclude malignancies. Compared with the compositions of other animals, among the abundant mineral components of the soft-shelled turtle, the contents of the trace elements Zn, Fe, and Se are high, so as to help building blood and beautify the features, thereby effectively improving the vitality of the human body. Therefore, the soft-shelled turtle is usually regarded as a precious and delicious dish with nourishing functions. The soft-shelled turtle, having dietary efficacies of nourishing yin, tonifying deficiency, cooling blood, softening hard masses, and anticancer, is applicable to people feeble in appearance, people with deficiency of liver-Yin and kidney-yin, kidney-steaming tidal fever, and malnutrition, people with continual low fever due to phthisis and extrapulmonary tuberculosis, people with chronic hepatitis, hepatocirrhosis, ascites due to cirrhosis, hepatolienomegaly, diabetes, and hydronephrosis, people with various cancers and after chemotherapy, people with Sjogren's syndrome, people with high blood fat, arteriosclerosis, coronary heart disease, and high blood pressure, people with hypoproteinemia, and people with beriberi. Further, every 100 g of soft-shelled turtle meat contains protein 16.5 g, fat 1.0 g, carbohydrate 1.6 g, Ca 107 mg, P 135 mg, Fe 1.4 mg, aneurin 0.62 mg, Violaxanthin 0.37 mg, and niacin 3.7 mg. The blood of the soft-shelled turtle is also drinkable, and especially applicable to those with asthenic disease and tidal fever, referring to “directly drinking soft-shelled turtle blood is effective in treating tidal fever caused by tuberculosis” in “Modern Practical Traditional Chinese Medicine”. Besides, the eggs of the soft-shelled turtle are cold in property, salty in flavor, and thus good for tonifying the Yin deficiency, referring to “boiling and eating the salted soft-shelled turtle eggs to tonify the Yin deficiency” in “Materia Medica Appreciation”. In addition, the fresh soft-shelled turtle shell has the same property and flavor, function, and compatibility/incompatibility as the soft-shelled turtle meat.

The soft-shelled turtle is adopted for medical purposes for a long time in China, and the shell, head, flesh, blood, and gallbladder of the soft-shelled turtle can all be used as medicine. In traditional Chinese medicines, the soft-shelled turtle head is used for treating anal prolapse and pile, and the soft-shelled turtle blood is used for treating feeble in appearance. Moreover, the Chinese soft-shelled turtle products have various functions such as anticancer and preventing hypocytosis.

In addition, as the turtle is greasy, long-term consumption may spoil the appetite, collapse the middle warmer energy, and lead to dyspepsia. Those pregnant or week after delivery, or having chronic enteritis, chronic dysentery, or chronic diarrhea should keep away from the turtle. According to predecessors' experience, the soft-shelled turtle meat cannot be taken together with peach, amaranth, purslane, white mustard seed, egg, pork, rabbit meat, duck, and mint.

2. Wild/Ecological Donkey Type Restaurant Module

In a preferred technical embodiment of the present invention, a wild/ecological donkey type restaurant module is provided. The wild/ecological donkey type restaurant module is preferably set aside main arteries of the scenic spots at rural-urban fringe areas, so as to meet the demands of tourism and urban leisure consumers in drive. The present invention adopts bionic techniques and arts to fabricate a house model imitating a donkey. Seen from afar, the wild/ecological donkey type restaurant module looks like a giant wild donkey lying beside the main arteries of the scenic spots. In the present invention, rocks, flowers, or grass are provided as podium buildings of the donkey type house artistic module. The walls, doors, windows, balconies, roofs, and internal/external decorations of the donkey type house artistic module are artistic portrayal of the wild/ecological animal/plant or in consistent environmental colors. The walkways, bedrooms, kitchens, toilets, and various pipelines, etc., inside the donkey type house artistic module are fabricated by combining the inner structure of the conventional house with characteristics of the wild/ecological animals and plants. Thereby, the wild/ecological donkey type restaurant module is actually a donkey type house artistic module manufactured by construction, decoration, painting, and photography materials. As such, the consumers indeed experience and consume in the donkey type house artistic modules.

Upon actual requirements, a wild/ecological donkey type restaurant module is provided during the removal/rebuild of old/dilapidated houses in urban areas. The wild/ecological donkey type restaurant module of the present invention is provided with donkey shaped windows, donkey-shaped huge paintings, huge relief sculptures, or glass decorative paintings. Besides, donkey sculptures are provided for the view of the consumers, and donkey electric toys are provided for the children to play with. Further, donkey-riding experiencing services are provided. The welcome portals are decorated into doors with donkey pictures. Leisure tables, chairs, gardening, parergon, and cross-sectional donkey ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological donkey type restaurant module and actual requirements. The welcoming hall is decorated with donkey sculptures having a poem dedicated thereto: “Dragon meat in heaven and donkey meat on earth are the most delicious. However, there is no dragon meat in heaven, but we still have donkey meat on earth”. In business places, for instance, the hall is decorated with pictures portraying a herd of wild/ecological donkeys galloping in the moorland or desert, and paintings/photographs about ecological donkeys feeding aside a brook or grassland. The private rooms are decorated with stories about donkeys in the form of comics, animations, cartoons, or traditional Chinese paintings. Decorations, toys, and souvenirs of the dinning tables, chairs, and children dining chair in the restaurant are meant to demonstrate the living environment of the wild/ecological donkey as well as folk culture features of the donkey.

The Chinese-style, fast-food, buffet, and floating-type wild/ecological donkey type restaurant modules provided by the present invention can be replicated to form chain-stores and provided with professional or vocational dietary instructors, assistants, and waiters.

The fast-food and buffet type wild/ecological donkey type restaurant modules of the present invention supply donkey meat & vegetable hamburger in shape of a donkey, fast-food of donkey meat & vegetable assorted cold dishes, spiced donkey meat, smoked donkey meat, sauced donkey meat, roasted donkey meat, tomato and egg soup, and mushroom/caraway pork soup.

In the present invention, the Chinese-style wild/ecological donkey type restaurant module supplies donkey meat braised in soy sauce, hot-pot donkey meat, spicy-hot donkey meat, spicy donkey meat, mild spicy donkey meat, not-spicy donkey meat, donkey lip, donkey tongue, donkey tripe, donkey liver, donkey dick, donkey tendon, donkey spare rib, and donkey tail. To cater for different consumers, other vegetables, meat, and fruit are also provided.

In the present invention, various types of donkeys from different producing areas are purchased at different prices, then processed in varied methods, and sold at different prices. Donkeys with varied values may be produced by different breeds and different taming environments. Thus, the wild/ecological donkey type restaurant module may put forward dishes at different prices based on donkeys of varied quality.

In the present invention, text tablets inscribed with “wild/ecological donkey meat restaurant” are provided. Further, advertising films about the wild/ecological donkey are provided with the following main content. The donkey lives for about 30 years. The birth, evolution, taming, worldwide breeds, food chains, natural enemies, dietary and medical values, nutrition components of the wild/ecological donkey, and their contribution to the human body are provided.

The nutritive value of donkey meat is revealed as follows. In folk, there is a saying “dragon meat in heaven and donkey meat on earth are the most delicious” to describe the tastiness of the donkey meat. As the donkey meat is able to nourish the vital energy and tonify deficiency, it is an ideal health food. The donkey meat has the following efficacies. Being a typical food high in protein and low in fat, the donkey meat has a protein content higher than beef and pork, while a fat content lower than beef and pork. Besides, the donkey meat containing components such as animal gum, bone marrow, calcium, and sulphur can replenish nutrition for those weak or recovering from an illness. Moreover, for being able to nourish blood and Qi, and benefit the viscera, the donkey meat is a good invigoration diet therapy for those internally injured due to overstrain, just recovered from an illness, Qi-and-blood deficient, short of breath and lacking in strength, or inappetent. Thereby, the donkey meat is generally suitable for all, especially those emaciated, at a proper amount of 50 g per meal. It should be noted that, as the donkey meat is usually taken cold and dressed with sauce as a pickled or preserved dish, those having deficiency-cold of the spleen and stomach, chronic enteritis, and alvine flux should keep away from it. In addition, one had better not drink tea immediately after taking the donkey meat.

3. Wild/Ecological Cattle Type Restaurant Module

In a preferred technical embodiment of the present invention, a wild/ecological cattle type restaurant module is provided. The wild/ecological cattle type restaurant module is preferably set aside main arteries of the scenic spots at rural-urban fringe areas, so as to meet the demands of tourism and urban leisure consumers in drive. The present invention adopts bionic techniques and arts to fabricate a house model imitating cattle. Seen from afar, the wild/ecological cattle type restaurant module looks like a giant wild cattle standing or lying beside the main arteries of the scenic spots. In the present invention, rocks, flowers, or grass are provided as podium buildings of the wild/ecological cattle type house artistic module. The walls, doors, windows, balconies, roofs, and internal/external decorations of the cattle type house artistic module are artistic portrayal of the wild/ecological animal/plant or in consistent environmental colors. The walkways, bedrooms, kitchens, toilets, and various pipelines, etc., inside the cattle type house artistic module are fabricated by combining the inner structure of the conventional house with characteristics of the wild/ecological animals and plants. Thereby, the whole wild/ecological cattle type restaurant module is actually a cattle type house artistic module manufactured by construction, decoration, painting, and photography materials. As such, the consumers indeed experience and consume in the cattle type house artistic modules.

Upon actual requirements, a wild/ecological cattle type restaurant module is provided during the removal/rebuild of old/dilapidated houses in urban areas. The wild/ecological cattle type restaurant module of the present invention is provided with cattle-shaped windows, cattle-shaped huge paintings, huge relief sculptures, or glass decorative paintings. Besides, cattle sculptures are provided for the view of the consumers, and cattle electric toys are provided for the children to play with. Further, cattle-riding experiencing services are provided. The welcome portals are decorated into doors with cattle pictures. Leisure tables, chairs, gardening, parergon, and cross-sectional cattle ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological cattle type restaurant module and actual requirements. The welcoming hall is decorated with cattle sculptures. In business places, for instance, the hall is decorated with pictures portraying a herd of wild/ecological cattle galloping in the moorland or desert, and paintings of cattle feeding aside a river shoal or grassland or showing a shepherd boy riding on the cattle back and playing a flute. The private rooms are decorated with stories about cattle in the form of comics, animations, cartoons, or traditional Chinese paintings. Decorations, toys, and souvenirs of the dinning tables, chairs, and children dining chair in the restaurant are meant to demonstrate the living environment of the wild/ecological cattle as well as folk culture features of the cattle.

The Chinese-style, fast-food, buffet, and floating-type wild/ecological cattle type restaurant modules provided by the present invention can be replicated to form chain-stores and provided with professional or vocational dietary instructors, assistants, and waiters.

The fast-food and buffet type wild/ecological cattle type restaurant modules of the present invention supply (wild) beef & vegetable hamburger in shape of a (wild) cattle, fast-food of (wild) beef & vegetable assorted cold dishes, spiced (wild) beef, smoked (wild) beef, sauced (wild) beef, roasted (wild) beef, (wild) beef wonton, (wild) beef dumpling, (wild) beef steamed stuffed bun, tomato and egg soup, and fresh mushroom & vegetable soup.

In the present invention, the Chinese-style wild/ecological cattle type restaurant module supplies (wild) beef braised in soy sauce, hot-pot (wild) beef, spicy-hot (wild) beef, spicy (wild) beef, mild spicy (wild) beef, not-spicy (wild) beef, (wild) cattle lip, (wild) cattle tongue, (wild) cattle tripe, (wild) cattle stomach, (wild) cattle large intestine, (wild) cattle dick, (wild) cattle tendon, (wild) cattle spare rib, and (wild) cattle tail. To cater for different consumers, other vegetables, meat, and fruit are also provided.

In the present invention, various types of (wild) cattle from different producing areas are purchased at different prices, then processed in varied methods, and sold at different prices. (Wild) cattle with varied values may be produced by different breeds and different taming environments. Thus, the wild/ecological cattle type restaurant module may put forward dishes at different prices based on (wild) cattle of varied quality.

In the present invention, text tablets inscribed with “wild/ecological beef restaurant” are provided. Further, advertising films about the wild/ecological cattle are provided with the following main content: the life-span, birth, evolution, taming, worldwide breeds, food chains, natural enemies, dietary and medical values, nutrition components of the (wild) cattle, and their contribution to the human body.

The nutritive value of beef is revealed as follows. Being rich in protein, and having amino acid compositions better satisfying the demands of the human body than pork, the beef may enhance the immunity of human body against diseases, and is especially good at enriching the blood and repairing tissue for those in growth and development, after operation, and recovering from an illness. The beef eaten in cold winter can warm the stomach, and is thus a good nourishing food in cold winter. According to Chinese medicine, beef can strengthen middle warmer and benefit vital energy, nourish the spleen and stomach, strengthen the bones and muscles, dissolve phlegm and dissipate bind, relieve thirst and achieve antisialic purpose. Thereby, beef is applicable to those collapsing of middle-warmer energy, short of breath and weak in health, having bones and muscles lassitude, anemic, sick for a long time, or having yellowish complexion and blurred vision. The beef is generally suitable for all, at a proper amount of 80 g each meal. It should be noted that, beef cannot be taken very often, and preferably once every week. As it is hard to cook the beef thoroughly, a hawkthorn, a piece of tangerine peel, or some tea can be put in to help. The nutrition components can be preserved very well in stewed beef. As the muscle fiber of the beef is rough and cannot be easily digested, and the beef is rich in cholesterol and fat, the old people, little children, and those having a poor digestion cannot eat too much beef or may only eat some tender beef. According to Western modern medical researches, beef belongs to red meat, and contains a kind of stinky aldehyde. Therefore, overtaking beef may harm the health. Moreover, those having skin, liver, and kidney diseases should eat with caution.

4. Wild/Ecological Pig Type Restaurant Module

In a preferred technical embodiment of the present invention, a wild/ecological pig type restaurant module is provided. The wild/ecological pig type restaurant module is preferably set aside main arteries of the scenic spots at rural-urban fringe areas, so as to meet the demands of tourism and urban leisure consumers in drive. The present invention adopts bionic techniques and arts to fabricate a house model imitating a wild/ecological pig. Seen from afar, the wild/ecological pig type restaurant module looks like a giant wild pig standing or lying beside the main arteries of the scenic spots. In the present invention, flowers, grass, or trees are provided as podium buildings of the pig type house artistic module. The walls, doors, windows, balconies, roofs, and internal/external decorations of the pig type house artistic module are artistic portrayal of the wild/ecological animal/plant or in consistent environmental colors. The walkways, bedrooms, kitchens, toilets, and various pipelines, etc., inside the pig type house artistic module are fabricated by combining the inner structure of the conventional house with characteristics of the wild/ecological animals and plants. Thereby, the whole wild/ecological pig type restaurant module is actually a pig type house artistic module manufactured by construction, decoration, painting, and photography materials. As such, the consumers indeed experience and consume in the pig type house artistic modules.

Upon actual requirements, a wild/ecological pig type restaurant module is provided during the removal/rebuild of old/dilapidated houses in urban areas. The wild/ecological pig type restaurant module of the present invention is provided with pig-shaped windows, pig-shaped huge paintings, huge relief sculptures, or glass decorative paintings. Besides, pig sculptures are provided for the view of the consumers, and pig electric toys are provided for the children to play with. Further, the welcome portals are decorated into doors with pig pictures. Leisure tables, chairs, gardening, parergon, and cross-sectional pig ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological pig type restaurant module and actual requirements. The welcoming hall is decorated with pig sculptures. In business places, for instance, the hall is decorated with pictures portraying a herd of wild/ecological pigs galloping in the virgin forest, and paintings/photographs about ecological pigs feeding aside a brook or grassland. The private rooms are decorated with stories about a shepherd boy grazing pigs or an old woman feeding pigs in the form of comics, animations, cartoons, or traditional Chinese paintings. Decorations, toys, and souvenirs of the dinning tables, chairs, and children dining chair in the restaurant are meant to demonstrate the living environment of the wild/ecological pig as well as folk culture features of the pig.

The Chinese-style, fast-food, buffet, and floating-type wild/ecological pig type restaurant modules provided by the present invention can be replicated to form chain-stores and provided with professional or vocational dietary instructors, assistants, and waiters.

The fast-food and buffet type wild/ecological pig type restaurant modules of the present invention supply (wild) pork & vegetable hamburger in shape of a (wild) pig, fast-food of (wild) pork & vegetable assorted cold dishes, spiced (wild) pork, smoked (wild) pork, sauced (wild) pork, roasted (wild) pork, tomato and egg soup, fresh mushroom & meat soup, (wild) pork wonton, (wild) pork dumpling, and (wild) pork steamed stuffed bun.

In the present invention, the Chinese-style wild/ecological pig type restaurant module supplies (wild) pork braised in soy sauce, hot-pot (wild) pork, spicy-hot (wild) pork, spicy (wild) pork, mild spicy (wild) pork, not-spicy (wild) pork, (wild) pig lip, (wild) pig tongue, (wild) pig heart, (wild) pig liver, (wild) pig tripe, (wild) pig stomach, (wild) pig large intestine, (wild) pig dick, (wild) pig tendon, (wild) pig spare rib, and (wild) pig tail. To cater for different consumers, other vegetables, meat, and fruit are also provided.

In the present invention, various types of pigs from different producing areas are purchased at different prices, then processed in varied methods, and sold at different prices. Pigs with varied values may be produced by different breeds and different taming environments. Thus, the wild/ecological pig type restaurant module may put forward dishes at different prices based on pigs of varied quality.

In the present invention, text tablets inscribed with “wild/ecological pork restaurant” are provided. Further, advertising films about the wild/ecological pig are provided with the following main content: the life-span, birth, evolution, taming, worldwide breeds, food chains, natural enemies, dietary and medical values, nutrition components of the (wild) pig, and their contribution to the human body.

The nutritive value of pork is revealed as follows. The pork fiber is fine and soft with few connective tissues, and the muscular tissue is rich in intramuscular fat. Therefore, after being cooked, the meat tastes especially good. Further, pork has the following efficacies: providing human beings with high-quality protein and necessary fat acid, and providing protoheme (organic iron) and cysteine for enhancing iron absorption, so as to combat iron-deficiency anemia. The pork is generally suitable for all, at a proper amount of 80-100 g for an adult or 50 g for a child each day. It should be noted that, being properly cooked, the pork may become a “longevous drug”. When the pork is stewed for a long time, the content of fat will be reduced by 30% to 50%, the content of unsaturated fatty acid will be increased, and the content of cholesterol will be greatly decreased. When cooked or stir-fried at a high temperature, the pork may release a chemical substance, and the chemical substance may further interact with the cancerogenic chemical substance in cigarettes, thus raising the cancer incidence. One had better not drink a lot of tea after taking the pork. In addition, fat people and those of high blood fat cannot eat too much pork, and charred meat is inedible.

5. Wild/Ecological Horse Type Restaurant Module

In a preferred technical embodiment of the present invention, a wild/ecological horse type restaurant module is provided. The wild/ecological horse type restaurant module is preferably set aside main arteries of the scenic spots at rural-urban fringe areas, so as to meet the demands of tourism and urban leisure consumers in drive. The present invention adopts bionic techniques and arts to fabricate a house model imitating a horse. Seen from afar, the wild/ecological horse type restaurant module looks like a giant wild horse standing or lying beside the main arteries of the scenic spots. In the present invention, flowers, grass, and trees are provided as podium buildings of the horse type house artistic module. The walls, doors, windows, balconies, roofs, and internal/external decorations of the house artistic module are artistic portrayal of the wild/ecological animal/plant or in consistent environmental colors. The walkways, bedrooms, kitchens, toilets, and various pipelines, etc., inside the horse type house artistic module are fabricated by combining the inner structure of the conventional house with characteristics of the wild/ecological animals and plants. Thereby, the whole wild/ecological horse type restaurant module is actually a horse type house artistic module manufactured by construction, decoration, painting, and photography materials. As such, the consumers indeed experience and consume in the horse type house artistic modules.

Upon actual requirements, a wild/ecological horse type restaurant module is provided during the removal/rebuild of old/dilapidated houses in urban areas. The wild/ecological horse type restaurant module of the present invention is provided with horse-shaped windows, horse-shaped huge paintings, huge relief sculptures, or glass decorative paintings. Besides, horse sculptures are provided for the view of the consumers, and horse electric toys are provided for the children to play with. Further, horse-riding experiencing services are provided. The welcome portals are decorated into doors with horse pictures. Leisure tables, chairs, gardening, parergon, and cross-sectional horse ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological horse type restaurant module and actual requirements. The welcoming hall is decorated with horse sculptures. In business places, for instance, the hall is decorated with pictures portraying a herd of wild/ecological horses galloping on the prairie, and paintings/photographs about ecological horses feeding aside a brook or grassland. The private rooms are decorated with stories about horses in the form of comics, animations, cartoons, or traditional Chinese paintings. Decorations, toys, and souvenirs of the dinning tables, chairs, and children dining chair in the restaurant are meant to demonstrate the living environment of the wild/ecological horse as well as folk culture features of the horse.

The Chinese-style, fast-food, buffet, and floating-type wild/ecological horse type restaurant modules provided by the present invention can be replicated to form chain-stores and provided with professional or vocational dietary instructors, assistants, and waiters.

The fast-food and buffet type wild/ecological horse type restaurant modules of the present invention supply (wild) horse meat & vegetable hamburger in shape of a (wild) horse, fast-food of (wild) horse meat & vegetable assorted cold dishes, spiced (wild) horse meat, smoked (wild) horse meat, sauced (wild) horse meat, roasted (wild) horse meat, tomato and egg soup, and fresh mushroom & vegetable soup.

In the present invention, the Chinese-style wild/ecological horse type restaurant module supplies (wild) horse meat braised in soy sauce, hot-pot (wild) horse meat, spicy-hot (wild) horse meat, spicy (wild) horse meat, mild spicy (wild) horse meat, not-spicy (wild) horse meat, (wild) horse lip, (wild) horse tongue, (wild) horse liver, (wild) horse heart, (wild) horse dick, and (wild) horse spare rib. To cater for different consumers, other vegetables, meat, and fruit are also provided.

In the present invention, various types of horses from different producing areas are purchased at different prices, then processed in varied methods, and sold at different prices. Horses with varied values may be produced by different breeds and different taming environments. Thus, the wild/ecological horse type restaurant module may put forward dishes at different prices based on horse of varied quality.

In the present invention, text tablets inscribed with “wild/ecological horse meat restaurant” are provided. Further, advertising films about the wild/ecological horse are provided with the following main content: the life-span, birth, evolution, taming, worldwide breeds, food chains, natural enemies, dietary and medical values, nutrition components of the (wild) horse, and their contribution to the human body.

The nutritive value of horse meat is revealed as follows. Being cold in property while sour and sweet in flavor, the horse meat can be taken to benefit bones and muscles, and strengthen waist and backbone. Therefore, the horse meat is suitable for those having insufficiency of the vital energy and blood, malnutrition, lumbago and weakness of the legs, old people, and those having arteriosclerosis, coronary heart disease, and high blood pressure. Further, the horse meat should be rinsed in clean water till the blood is gone, and then boiled thoroughly instead of fried. In addition, according to predecessors' experience, the horse meat cannot be taken together with ginger or pork, and those having diarrhea or psora should keep away from it.

6. Wild/Ecological Sheep Type Restaurant Module

In a preferred technical embodiment of the present invention, a wild/ecological sheep type restaurant module is provided. The wild/ecological sheep type restaurant module is preferably set aside main arteries of the scenic spots at rural-urban fringe areas, so as to meet the demands of tourism and urban leisure consumers in drive. The present invention adopts bionic techniques and arts to fabricate a house model imitating a sheep. Seen from afar, the wild/ecological sheep type restaurant module looks like a giant wild sheep standing or lying beside the main arteries of the scenic spots. In the present invention, flowers, grass, waters and brooks are provided as podium buildings of the sheep type house artistic module. The walls, doors, windows, balconies, roofs, and internal/external decorations of the sheep type house artistic module are artistic portrayal of the wild/ecological animal/plant or in consistent environmental colors. The walkways, bedrooms, kitchens, toilets, and various pipelines, etc., inside the sheep type house artistic module are fabricated by combining the inner structure of the conventional house with characteristics of the wild/ecological animals and plants. Thereby, the whole wild/ecological sheep type restaurant module is actually a sheep type house artistic module manufactured by construction, decoration, painting, and photography materials. As such, the consumers indeed experience and consume in the sheep type house artistic modules.

Upon actual requirements, a wild/ecological sheep type restaurant module is provided during the removal/rebuild of old/dilapidated houses in urban areas. The wild/ecological sheep type restaurant module of the present invention is provided with sheep-shaped windows, sheep-shaped huge paintings, huge relief sculptures, or glass decorative paintings. Besides, sheep sculptures are provided for the view of the consumers, and sheep electric toys are provided for the children to play with. Further, sheep fighting experiencing services are provided. The welcome portals are decorated into doors with sheep pictures. Leisure tables, chairs, gardening, parergon, and cross-sectional sheep ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological sheep type restaurant module and actual requirements. The welcoming hall is decorated with sheep sculptures. In business places, for instance, the hall is decorated with pictures portraying a flock of wild/ecological sheep galloping on the prairie, and paintings/photographs about ecological sheep feeding aside a brook or grassland. The private rooms are decorated with stories about sheep and human in the form of comics, animations, cartoons, or traditional Chinese paintings. Decorations, toys, and souvenirs of the dinning tables, chairs, and children dining chair in the restaurant are meant to demonstrate the living environment of the wild/ecological sheep as well as folk culture features of the sheep.

The Chinese-style, fast-food, buffet, and floating-type wild/ecological sheep type restaurant modules provided by the present invention can be replicated to form chain-stores and provided with professional or vocational dietary instructors, assistants, and waiters.

The fast-food and buffet type wild/ecological sheep type restaurant modules of the present invention supply (wild) mutton & vegetable hamburger in shape of a (wild) sheep, fast-food of (wild) mutton & vegetable assorted cold dishes, spiced (wild) mutton, smoked (wild) mutton, sauced (wild) mutton, roasted (wild) mutton, tomato and egg soup, and fresh mushroom & vegetable soup.

In the present invention, the Chinese-style wild/ecological horse type restaurant module supplies (wild) mutton braised in soy sauce, hot-pot (wild) mutton, spicy-hot (wild) mutton, spicy (wild) mutton, mild spicy (wild) mutton, not-spicy (wild) mutton, (wild) sheep lip, (wild) sheep tongue, (wild) sheep viscera, (wild) sheep dick, (wild) sheep tendon, and (wild) sheep spare rib. To cater for different consumers, other vegetables, meat, and fruit are also provided.

In the present invention, various types of sheep from different producing areas are purchased at different prices, then processed in varied methods, and sold at different prices. Sheep with varied values may be produced by different breeds and different taming environments. Thus, the wild/ecological sheep type restaurant module may put forward dishes at different prices based on sheep of varied quality.

In the present invention, text tablets inscribed with “wild/ecological mutton restaurant” are provided. Further, advertising films about the wild/ecological sheep are provided with the following main content: the life-span, birth, evolution, taming, worldwide breeds, food chains, natural enemies, dietary and medical values, nutrition components of the (wild) sheep, and their contribution to the human body.

The nutritive value of mutton is revealed as follows. Mutton is tender than pork, and contains less fat and cholesterol than pork and beef. Eaten in winter, the mutton can both achieve the purposes of tonification and keeping out the cold. Moreover, the mutton has the following efficacies. Mutton is often regarded as an important invigorating food in winter. Frequent taking of mutton in cold winter can nourish Qi and tonify deficiency, promote blood circulation, and enhance the capability of resisting cold. Besides, mutton may increase the digestive enzyme, protect the stomach wall, and help digestion. According to Chinese medicine, mutton can invigorate the kidney and support Yang, and is thus suitable for being frequently taken by men. In addition, mutton is generally eatable for all, especially those weak in health and having stomach cold, at a proper amount of 50 g each meal. It should be noted that, it is improper to eat mutton in hot and dry seasons, like summer and autumn. As mutton is extremely hot in property, those suffering from excessive internal heat with symptoms such as fever, toothache, aphtha of the mouth and tongue, and expectoration of yellowish sputum should stay away from mutton. Moreover, those having liver diseases, high blood pressure, acute enteritis or other infectious diseases, or with fever cannot eat mutton.

7. Wild/Ecological Dog Type Restaurant Module

In a preferred technical embodiment of the present invention, a wild/ecological dog type restaurant module is provided. The wild/ecological dog type restaurant module is preferably set aside main arteries of the scenic spots at rural-urban fringe areas, so as to meet the demands of tourism and urban leisure consumers in drive. The present invention adopts bionic techniques and arts to fabricate a house model imitating a dog. Seen from afar, the wild/ecological dog type restaurant module looks like a giant wild dog standing or lying beside the main arteries of the scenic spots. In the present invention, flowers, grass, and trees are provided as podium buildings of the dog type house artistic module. The walls, doors, windows, balconies, roofs, and internal/external decorations of the dog artistic module are artistic portrayal of the wild/ecological animal/plant or in consistent environmental colors. The walkways, bedrooms, kitchens, toilets, and various pipelines, etc., inside the dog type house artistic module are fabricated by combining the inner structure of the conventional house with characteristics of the wild/ecological animals and plants. Thereby, the whole wild/ecological dog type restaurant module is actually a dog type house artistic module manufactured by construction, decoration, painting, and photography materials. As such, the consumers indeed experience and consume in the dog type house artistic modules.

Upon actual requirements, a wild/ecological dog type restaurant module is provided during the removal/rebuild of old/dilapidated houses in urban areas. The wild/ecological dog type restaurant module of the present invention is provided with dog-shaped windows, dog-shaped huge paintings, huge relief sculptures, or glass decorative paintings. Besides, dog sculptures are provided for the view of the consumers, and dog electric toys are provided for the children to play with. Further, the welcome portals are decorated into doors with dog pictures. Leisure tables, chairs, gardening, parergon, and cross-sectional dog ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological dog type restaurant module and actual requirements. The welcoming hall is decorated with dog sculptures. In business places, for instance, the hall is decorated with pictures portraying a herd of wild/ecological dogs running in barren land, and paintings/photographs about ecological dog feeding aside a brook or grassland. The private rooms are decorated with stories about dog and human in the form of comics, animations, cartoons, or traditional Chinese paintings. Decorations, toys, and souvenirs of the dinning tables, chairs, and children dining chair in the restaurant are meant to demonstrate the living environment of the wild/ecological dog as well as folk culture features of the dog.

The Chinese-style, fast-food, buffet, and floating-type wild/ecological dog type restaurant modules provided by the present invention can be replicated to form chain-stores and provided with professional or vocational dietary instructors, assistants, and waiters.

The fast-food and buffet type wild/ecological dog type restaurant modules of the present invention supply dog meat & vegetable hamburger in shape of a dog, fast-food of dog meat & vegetable assorted cold dishes, spiced dog meat, smoked dog meat, sauced dog meat, roasted dog meat, tomato and egg soup, and fresh mushroom & vegetable soup.

In the present invention, the Chinese-style wild/ecological dog type restaurant module supplies dog meat braised in soy sauce, hot-pot dog meat, spicy-hot dog meat, spicy dog meat, mild spicy dog meat, not-spicy dog meat, dog tongue, dog liver, dog tripe, dog dick, dog tendon, and dog spare rib. To cater for different consumers, other vegetables, meat, and fruit are also provided.

In the present invention, various types of dog from different producing areas are purchased at different prices, then processed in varied methods, and sold at different prices. Dogs with varied values may be produced by different breeds and different taming environments. Thus, the wild/ecological dog type restaurant module may put forward dishes at different prices based on dogs of varied quality.

In the present invention, text tablets inscribed with “wild/ecological dog meat restaurant” are provided. Further, advertising films about the wild/ecological dog are provided with the following main content: the life-span, birth, evolution, taming, worldwide breeds, food chains, natural enemies, dietary and medical values, nutrition components of the (wild) dog, and their contribution to the human body.

The nutritive value of dog meat is revealed as follows. The dog meat is not only rich in protein, but has high-quality protein. Particularly, the dog meat contains a large proportion of globulin, which may significantly enhance the body resistance, cell viability, and organ functions. Further, the dog meat can enhance the physique, improve digestive ability, promote blood circulation, and improve sexual function of the human body. The dog meat may also be adopted to treat asthenia of old people, such as residual urine, cold clammy limbs, and lassitude. Frequently taking dog meat in winter may enhance the cold-resistant ability of the old people. According to Chinese medicine, dog meat has efficacies in warming kidney and activating Yang, enhancing the strength, and enriching the blood vessels. In addition, dog meat is generally suitable for all, especially those aged, at a proper amount of 50 g each meal. It should be noted that, those suffering from non-cold deficiency diseases like cough, catching a cold, fever, alvine flux, and Yin deficiency should stay away from the dog meat. The underdone dog meat cannot be taken in case of parasitic infection, and the meat of a mad dog cannot be taken. Moreover, patients with cerebrovascular diseases generally have complications of arteriosclerosis and high blood pressure, and the dog meat is very hot in property and high in tonification, those with cerebrovascular may experience a boost of blood pressure after taking the dog meat, or even the rupture and bleeding of cerebrovascular. Therefore, those with cerebrovascular diseases should eat dog meat with caution.

8. Wild/Ecological Rabbit Type Restaurant Module

In a preferred technical embodiment of the present invention, a wild/ecological rabbit type restaurant module is provided. The wild/ecological rabbit type restaurant module is preferably set aside main arteries of the scenic spots at rural-urban fringe areas, so as to meet the demands of tourism and urban leisure consumers in drive. The present invention adopts bionic techniques and arts to fabricate a house model imitating a crowd of rabbits. Seen from afar, the wild/ecological rabbit type restaurant module looks like a giant wild rabbit standing or lying beside the main arteries of the scenic spots. In the present invention, flowers, grass, and trees are provided as podium buildings of the rabbit type house artistic module. The walls, doors, windows, balconies, roofs, and internal/external decorations of the rabbit artistic module are artistic portrayal of the wild/ecological animal/plant or in consistent environmental colors. The walkways, bedrooms, kitchens, toilets, and various pipelines, etc., inside the rabbit type house artistic module are fabricated by combining the inner structure of the conventional house with characteristics of the wild/ecological animals and plants. Thereby, the whole wild/ecological rabbit type restaurant module is actually a rabbit type house artistic module manufactured by construction, decoration, painting, and photography materials. As such, the consumers indeed experience and consume in the rabbit type house artistic modules.

Upon actual requirements, a wild/ecological rabbit type restaurant module is provided during the removal/rebuild of old/dilapidated houses in urban areas. The wild/ecological rabbit type restaurant module of the present invention is provided with rabbit-shaped windows, rabbit-shaped huge paintings, huge relief sculptures, or glass decorative paintings. Besides, rabbit sculptures are provided for the view of the consumers, and rabbit electric toys are provided for the children to play with. Further, rabbit hunting experiencing services are provided. The welcome portals are decorated into doors with rabbit pictures. Leisure tables, chairs, gardening, parergon, and cross-sectional rabbit ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological rabbit type restaurant module and actual requirements. The welcoming hall is decorated with rabbit sculptures. In business places, for instance, the hall is decorated with pictures portraying a herd of wild/ecological rabbits galloping in barren land, and paintings/photographs about ecological rabbit feeding aside a brook or grassland. The private rooms are decorated with stories about rabbit and human in the form of comics, animations, cartoons, or traditional Chinese paintings. Decorations, toys, and souvenirs of the dinning tables, chairs, and children dining chair in the restaurant are meant to demonstrate the living environment of the wild/ecological rabbit as well as folk culture features of the rabbit.

The Chinese-style, fast-food, buffet, and floating-type wild/ecological rabbit type restaurant modules provided by the present invention can be replicated to form chain-stores and provided with professional or vocational dietary instructors, assistants, and waiters.

The fast-food and buffet type wild/ecological rabbit type restaurant modules of the present invention supply (wild) rabbit meat & vegetable hamburger in shape of a (wild) rabbit, fast-food of (wild) rabbit meat & vegetable assorted cold dishes, spiced (wild) rabbit meat, smoked (wild) rabbit meat, sauced (wild) rabbit meat, roasted (wild) rabbit meat, tomato and egg soup, and fresh mushroom & vegetable soup.

In the present invention, the Chinese-style wild/ecological rabbit type restaurant module supplies (wild) rabbit meat braised in soy sauce, hot-pot (wild) rabbit meat, spicy-hot (wild) rabbit meat, spicy (wild) rabbit meat, mild spicy (wild) rabbit meat, not-spicy (wild) rabbit meat, and (wild) rabbit spare rib. To cater for different consumers, other vegetables, meat, and fruit are also provided.

In the present invention, various types of rabbit from different producing areas are purchased at different prices, then processed in varied methods, and sold at different prices. Rabbits with varied values may be produced by different breeds and different taming environments. Thus, the wild/ecological rabbit type restaurant module may put forward dishes at different prices based on rabbit of varied quality.

In the present invention, text tablets inscribed with “wild/ecological rabbit meat restaurant” are provided. Further, advertising films about the wild/ecological rabbit are provided with the following main content: the life-span, birth, evolution, taming, worldwide breeds, food chains, natural enemies, dietary and medical values, nutrition components of the (wild) rabbit, and their contribution to the human body.

The nutritive value of rabbit meat is revealed as follows. The rabbit meat is high in protein, but low in fat and cholesterol. Generally, in the rabbit meat, the content of protein reaches 70% higher than any other meat, while the contents of fat and cholesterol are lower than any other meat, so the rabbit meat is also regarded as “vegetable in meat”. Further, being rich in vitellose which is vital to the development of brain and other organs for children and youngsters, the rabbit meat is beneficial to both health and intelligence. For those suffering from high blood pressure, the rabbit meat may prevent the formation of thrombosis and greatly protect the vessel wall, so it is also referred to as “health meat”. Further, the rabbit meat is tender with few connective tissues and fibers, and is more easily digested than other meat like pork, beef, and mutton. Thus, the rabbit meat is particularly suitable for old people. Having both advantages of animal and plant food, the rabbit meat can improve the health condition, build up the muscles, and resist slacking and ageing without putting on weight. Moreover, due to its capability of keeping the cell viability and elasticity of skin, the rabbit meat is greatly favored by people, especially young women, and is regarded as “beauty meat”. According to Chinese medicine, being cold in property, the rabbit meat can nourish Yin and cool the blood, nourish Qi and moisturize the skin, detoxify and dispel excessive body heat. The rabbit meat is generally suitable for all, especially old people and women. Further, the rabbit meat is also ideal for those with obesity, liver diseases, cardiovascular diseases, or diabetes. The proper taking amount of rabbit meat is 80 g each meal. It should be noted that, being cold in property, it is best to eat the rabbit meat in summer, and generally improper in cold winter and early spring. When cooked with other food, the rabbit meat may be tainted by odour, and is thus regarded as “multi-taste meat”. In addition, women suffering from Yang deficiency with well defined symptoms like limbs afraid of cold should stay away from the rabbit meat. Moreover, the rabbit meat cannot be taken together with the duck blood for fear of causing alvine flux.

9. Wild/Ecological Chicken Type Restaurant Module

In a preferred technical embodiment of the present invention, a wild/ecological chicken type restaurant module is provided. The wild/ecological chicken type restaurant module is preferably set aside main arteries of the scenic spots at rural-urban fringe areas, so as to meet the demands of tourism and urban leisure consumers in drive. The present invention adopts bionic techniques and arts to fabricate a house model imitating a chicken. Seen from afar, the wild/ecological chicken type restaurant module looks like a giant chicken standing or lying beside the main arteries of the scenic spots. In the present invention, rocks and grass are provided as podium buildings of the chicken type house artistic module. The walls, doors, windows, balconies, roofs, and internal/external decorations of the chicken artistic module are artistic portrayal of the wild/ecological animal/plant or in consistent environmental colors. The walkways, bedrooms, kitchens, toilets, and various pipelines, etc., inside the chicken type house artistic module are fabricated by combining the inner structure of the conventional house with characteristics of the wild/ecological animals and plants. Thereby, the whole wild/ecological chicken type restaurant module is actually a chicken type house artistic module manufactured by construction, decoration, painting, and photography materials. As such, the consumers indeed experience and consume in the chicken type house artistic modules.

Upon actual requirements, a wild/ecological chicken type restaurant module is provided during the removal/rebuild of old/dilapidated houses in urban areas. The wild/ecological chicken type restaurant module of the present invention is provided with chicken-shaped windows, chicken-shaped huge paintings, huge relief sculptures, or glass decorative paintings. Besides, chicken sculptures are provided for the view of the consumers, and chicken electric toys are provided for the children to play with. Further, the welcome portals are decorated into doors with chicken pictures. Leisure tables, chairs, gardening, parergon, and cross-sectional chicken ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological chicken type restaurant module and actual requirements. The welcoming hall is decorated with chicken sculptures. In business places, for instance, the hall is decorated with pictures portraying a flock of chicken running in barren land, and paintings/photographs about ecological chicken feeding aside a brook or grassland. The private rooms are decorated with stories about chicken in the form of comics, animations, cartoons, or traditional Chinese paintings. Decorations, toys, and souvenirs of the dinning tables, chairs, and children dining chair in the restaurant are meant to demonstrate the living environment of the wild/ecological chicken as well as folk culture features of the chicken.

The Chinese-style, fast-food, buffet, and floating-type wild/ecological chicken type restaurant modules provided by the present invention can be replicated to form chain-stores and provided with professional or vocational dietary instructors, assistants, and waiters.

The fast-food and buffet type wild/ecological chicken type restaurant modules of the present invention supply (wild) chicken & vegetable hamburger in shape of a (wild) chicken, fast-food of (wild) chicken & vegetable assorted cold dishes, spiced (wild) chicken, smoked (wild) chicken, sauced (wild) chicken, roasted (wild) chicken, tomato and egg soup, and fresh mushroom & vegetable soup.

In the present invention, the Chinese-style wild/ecological chicken type restaurant module supplies (wild) chicken braised in soy sauce, hot-pot (wild) chicken, spicy-hot (wild) chicken, spicy (wild) chicken, mild spicy (wild) chicken, not-spicy (wild) chicken, (wild) chicken head, (wild) chicken feet, (wild) chicken giblets, (wild) chicken wing, (wild) chicken blood, and (wild) chicken spare rib. To cater for different consumers, other vegetables, meat, and fruit are also provided.

In the present invention, various types of chicken from different producing areas are purchased at different prices, then processed in varied methods, and sold at different prices. Chicken with varied values may be produced by different breeds and different taming environments. Thus, the wild/ecological chicken type restaurant module may put forward dishes at different prices based on chicken of varied quality.

In the present invention, text tablets inscribed with “wild/ecological chicken type restaurant” are provided. Further, advertising films about the wild/ecological chicken are provided with the following main content: the life-span, birth, evolution, taming, worldwide breeds, food chains, natural enemies, dietary and medical values, nutrition components of the (wild) chicken, and their contribution to the human body.

The nutritive value of chicken is revealed as follows. Chicken is tender and tasty, adapted to various cooking methods, rich in nutrition, and can be used for tonification. Moreover, chicken can not only be fried, stewed, but also eaten cold and dressed with sauce. Further, chicken is high in the content and variety of protein, and is easy to digest, so it can be easily absorbed by the human body to enhance the physical power and improve the general health. Besides, phospholipid classes contained in chicken play an important role in the growth and development of the human body, and constitute a key source for providing fat and phospholipid in diet. Chicken is also a good diet therapy for malnutrition, intolerance of cold, hypodynamia, abnormal menstruation, anemia, asthenia, and so on. According to Chinese medicine, chicken is advantageous in warming middle-jiao and nourishing Qi, tonifying deficiency and replenishing essence, benefiting the spleen and stomach, invigorating the circulation of blood, and strengthening the bones and muscles. Chicken is generally suitable for all, especially the old, sick, and weak, at a proper amount of 100 g each meal. It should be noted that, the nutrition of chicken exceeds that of the chicken soup. Chicken as is a part with the most concentrated lymph, and is like a storehouse for pathogenic bacteria, virus, and carcinogen, so this part should be discarded. Patients with gout cannot drink chicken soup. Further, the nutritive value of wild/ecological chicken is revealed as follows. The wild/ecological chicken is also referred to as blackcock or pheasant. The edible wild/ecological chicken also includes sandgrouse, bamboo partridge, partridge, turtledove, and so on. The wild/ecological chicken is the most tender in autumn and winter, and is ideal for diet therapy. The pearl chicken and turkey, imported from Africa or America, have the same nutritive values as the common cursorial birds and can be cooked in similar ways. The wild/ecological chicken even contains more Ca, P, Fe, and is rich in protein and amino acid, so it is an ideal diet therapy for those with anemia and constitutional debility. Moreover, the wild/ecological chicken can also invigorate the spleen and nourish the stomach, stimulate the appetite, and stop diarrhea. The meat of partridge can be particularly used to resolve phlegm, nourish the brain, cure expectoration, and prevent senile dementia, and is rare in the wild/ecological fowl. According to Chinese medicine, the meat of turtledove can improve acuity of vision, and nourish Qi, preserve health, and benefit liver and kidney through frequent taking. The wild/ecological chicken is generally suitable for all, at a proper amount of 50-80 g each meal. It should be noted that, the male wild/ecological chicken is usually braised in soy sauce, and female wild/ecological chicken is usually stewed. Further, those having pile or psora cannot eat wild/ecological chicken. If taken together with bamboo shoot, the meat of partridge may cause headache and throat abscess.

10. Wild/Ecological Duck Type Restaurant Module

In a preferred technical embodiment of the present invention, a wild/ecological duck type restaurant module is provided. The wild/ecological duck type restaurant module is preferably set aside main arteries of the scenic spots at rural-urban fringe areas, so as to meet the demands of tourism and urban leisure consumers in drive. The present invention adopts bionic techniques and arts to fabricate a house model imitating a duck. Seen from afar, the wild/ecological chicken type restaurant module looks like a giant duck standing or lying beside the main arteries of the scenic spots. In the present invention, rocks and aquatic weeds are provided as podium buildings of the duck type house artistic module. The walls, doors, windows, balconies, roofs, and internal/external decorations of the duck artistic module are artistic portrayal of the wild/ecological animal/plant or in consistent environmental colors. The walkways, bedrooms, kitchens, toilets, and various pipelines, etc., inside the duck type house artistic module are fabricated by combining the inner structure of the conventional house with characteristics of the wild/ecological animals and plants. Thereby, the whole wild/ecological duck type restaurant module is actually a duck type house artistic module manufactured by construction, decoration, painting, and photography materials. As such, the consumers indeed experience and consume in the duck type house artistic modules.

Upon actual requirements, a wild/ecological duck type restaurant module is provided during the removal/rebuild of old/dilapidated houses in urban areas. The wild/ecological duck type restaurant module of the present invention is provided with duck-shaped windows, duck-shaped huge paintings, huge relief sculptures, or glass decorative paintings. Besides, duck sculptures are provided for the view of the consumers, and duck electric toys are provided for the children to play with. Further, the welcome portals are decorated into doors with duck pictures. Leisure tables, chairs, gardening, parergon, and cross-sectional duck ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological duck type restaurant module and actual requirements. The welcoming hall is decorated with duck sculptures. In business places, for instance, the hall is decorated with pictures portraying a flock of duck rustling in the meadow, and paintings/photographs about ecological duck feeding aside a brook or grassland. The private rooms are decorated with stories about duck in the form of comics, animations, cartoons, or traditional Chinese paintings. Decorations, toys, and souvenirs of the dinning tables, chairs, and children dining chair in the restaurant are meant to demonstrate the living environment of the wild/ecological duck as well as folk culture features of the duck.

The Chinese-style, fast-food, buffet, and floating-type wild/ecological duck type restaurant modules provided by the present invention can be replicated to form chain-stores and provided with professional or vocational dietary instructors, assistants, and waiters.

The fast-food and buffet type wild/ecological duck type restaurant modules of the present invention supply (wild) duck & vegetable hamburger in shape of a (wild) duck, fast-food of (wild) duck & vegetable assorted cold dishes, spiced (wild) duck, smoked (wild) duck, sauced (wild) duck, roasted (wild) duck, salted (wild) duck, salted (wild) duck egg, tomato and egg soup, and fresh mushroom & vegetable soup.

In the present invention, the Chinese-style wild/ecological duck type restaurant module supplies (wild) duck braised in soy sauce, hot-pot (wild) duck, spicy-hot (wild) duck, spicy (wild) duck, mild spicy (wild) duck, not-spicy (wild) duck, (wild) duck head, (wild) duck tongue, (wild) duck blood, and (wild) duck giblets. To cater for different consumers, other vegetables, meat, and fruit are also provided.

In the present invention, various types of duck from different producing areas are purchased at different prices, then processed in varied methods, and sold at different prices. Ducks with varied values may be produced by different breeds and different taming environments. Thus, the wild/ecological duck type restaurant module may put forward dishes at different prices based on duck of varied quality.

In the present invention, text tablets inscribed with “wild/ecological duck type restaurant” are provided. Further, advertising films about the wild/ecological duck are provided with the following main content: the life-span, birth, evolution, taming, worldwide breeds, food chains, natural enemies, dietary and medical values, nutrition components of the (wild) duck, and their contribution to the human body.

The nutritive value of duck is revealed as follows. Duck, normally referred to as aigret meat or white duck, is cold in property and sweet in flavor. Duck can nourish Yin, tonify deficiency, benefit the stomach, and promote diuresis. Therefore, duck is applicable to those with malnutrition, dropsy, and weak after delivery or recovering from an illness, those having inner heat, especially low fever, asthenia, deficiency of food, dry stool, night sweat, apontaneous emission, small amount of catamenia, dry throat and thirst, those with cancer and taken after chemotherapies, those suffering from diabetes, ascites due to cirrhosis, phthisis, or edema due to chronic nephritis. In addition, those always in cold deficiency, inappetent by catching a cold, with cold pain in stomach, clear and thin alvine flux, lumbar myalgia, and cold dysmenorrhoea should keep away from the duck.

11. Wild/Ecological Goose Type Restaurant Module

In a preferred technical embodiment of the present invention, a wild/ecological goose type restaurant module is provided. The wild/ecological goose type restaurant module is preferably set aside main arteries of the scenic spots at rural-urban fringe areas, so as to meet the demands of tourism and urban leisure consumers in drive. The present invention adopts bionic techniques and arts to fabricate a house model imitating a goose. Seen from afar, the wild/ecological goose type restaurant module looks like a giant goose standing or lying beside the main arteries of the scenic spots. In the present invention, grasslands or aquatic weeds are provided as podium buildings of the goose type house artistic module. The walls, doors, windows, balconies, roofs, and internal/external decorations of the goose artistic module are artistic portrayal of the wild/ecological animal/plant or in consistent environmental colors. The walkways, bedrooms, kitchens, toilets, and various pipelines, etc., inside the goose type house artistic module are fabricated by combining the inner structure of the conventional house with characteristics of the wild/ecological animals and plants. Thereby, the whole wild/ecological goose type restaurant module is actually a goose type house artistic module manufactured by construction, decoration, painting, and photography materials. As such, the consumers indeed experience and consume in the goose type house artistic modules.

Upon actual requirements, a wild/ecological goose type restaurant module is provided during the removal/rebuild of old/dilapidated houses in urban areas. The wild/ecological goose type restaurant module of the present invention is provided with goose-shaped windows, goose-shaped huge paintings, huge relief sculptures, or glass decorative paintings. Besides, goose sculptures are provided for the view of the consumers, and goose electric toys are provided for the children to play with. Further, goose fighting experiencing services are provided. The welcome portals are decorated into doors with goose pictures. Leisure tables, chairs, gardening, parergon, and cross-sectional goose ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological goose type restaurant module and actual requirements. The welcoming hall is decorated with goose sculptures. In business places, for instance, the hall is decorated with pictures portraying a flock of geese running in the meadow, and paintings/photographs about ecological geese feeding aside a brook or grassland. The private rooms are decorated with stories about goose in the form of comics, animations, cartoons, or traditional Chinese paintings. Decorations, toys, and souvenirs of the dinning tables, chairs, and children dining chair in the restaurant are meant to demonstrate the living environment of the wild/ecological goose as well as folk culture features of the goose.

The Chinese-style, fast-food, buffet, and floating-type wild/ecological goose type restaurant modules provided by the present invention can be replicated to form chain-stores and provided with professional or vocational dietary instructors, assistants, and waiters.

The fast-food and buffet type wild/ecological goose type restaurant modules of the present invention supply (wild) goose & vegetable hamburger in shape of a (wild) goose, fast-food of (wild) goose & vegetable assorted cold dishes, spiced (wild) goose, smoked (wild) goose, sauced (wild) goose, roasted (wild) goose, salted (wild) goose, salted (wild) goose egg, tomato and egg soup, and fresh mushroom & vegetable soup.

In the present invention, the Chinese-style wild/ecological duck type restaurant module supplies (wild) goose braised in soy sauce, roasted (wild) goose, hot-pot (wild) goose, spicy-hot (wild) goose, spicy (wild) goose, mild spicy (wild) goose, not-spicy (wild) goose, (wild) goose head, (wild) goose tongue, (wild) goose gizzard, (wild) goose bowel, (wild) goose blood, and (wild) goose giblets. To cater for different consumers, other vegetables, meat, and fruit are also provided.

In the present invention, various types of goose from different producing areas are purchased at different prices, then processed in varied methods, and sold at different prices. Geese with varied values may be produced by different breeds and different taming environments. Thus, the wild/ecological goose type restaurant module may put forward dishes at different prices based on goose of varied quality.

In the present invention, text tablets inscribed with “wild/ecological goose type restaurant” are provided. Further, advertising films about the wild/ecological goose are provided with the following main content: the life-span, birth, evolution, taming, worldwide breeds, food chains, natural enemies, dietary and medical values, nutrition components of the (wild) goose, and their contribution to the human body.

The nutritive value of goose is revealed as follows. Goose is neutral in property and sweet in flavor. Goose can be used to nourish Qi and tonify the kidney, and is applicable to those weak, insufficient of the vital energy and blood, and malnourished. Those having accumulation of damp-heat in the body and thick, yellow, and greasy fur on tongue should keep away from the goose. According to folk traditional experience, as goose, goose blood, and goose egg are all stimulating food, those suffering from intractable skin diseases, lymphtuberculosis, swelling and pain, bite poisoning, or different tumours cannot eat goose. In addition, those having high blood pressure, lipaemia, or arteriosclerosis should also stay away from the goose.

12. Wild/Ecological Pigeon Type Restaurant Module

In a preferred technical embodiment of the present invention, a wild/ecological pigeon type restaurant module is provided. The wild/ecological pigeon type restaurant module is preferably set aside main arteries of the scenic spots at rural-urban fringe areas, so as to meet the demands of tourism and urban leisure consumers in drive. The present invention adopts bionic techniques and arts to fabricate a house model imitating a pigeon. Seen from afar, the wild/ecological pigeon type restaurant module looks like a giant pigeon standing or lying beside the main arteries of the scenic spots. In the present invention, rocks, flowers, or grass are provided as podium buildings of the pigeon type house artistic module. The walls, doors, windows, balconies, roofs, and internal/external decorations of the pigeon artistic module are artistic portrayal of the wild/ecological animal/plant or in consistent environmental colors. The walkways, bedrooms, kitchens, toilets, and various pipelines, etc., inside the pigeon type house artistic module are fabricated by combining the inner structure of the conventional house with characteristics of the wild/ecological animals and plants. Thereby, the whole wild/ecological pigeon type restaurant module is actually a pigeon type house artistic module manufactured by construction, decoration, painting, and photography materials. As such, the consumers indeed experience and consume in the pigeon type house artistic modules.

Upon actual requirements, a wild/ecological pigeon type restaurant module is provided during the removal/rebuild of old/dilapidated houses in urban areas. The wild/ecological pigeon type restaurant module of the present invention is provided with pigeon-shaped windows, pigeon-shaped huge paintings, huge relief sculptures, or glass decorative paintings. Besides, pigeon sculptures are provided for the view of the consumers, and pigeon electric toys are provided for the children to play with. Further, pigeon releasing experiencing services are provided. The welcome portals are decorated into doors with pigeon pictures. Leisure tables, chairs, gardening, parergon, and cross-sectional pigeon ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological pigeon type restaurant module and actual requirements. The welcoming hall is decorated with pigeon sculptures. In business places, for instance, the hall is decorated with pictures portraying a flock of pigeons flying on the barren land, and paintings/photographs about ecological pigeons feeding aside a brook or grassland. The private rooms are decorated with stories about pigeon in the form of comics, animations, cartoons, or traditional Chinese paintings. Decorations, toys, and souvenirs of the dinning tables, chairs, and children dining chair in the restaurant are meant to demonstrate the living environment of the wild/ecological pigeon as well as folk culture features of the pigeon.

The Chinese-style, fast-food, buffet, and floating-type wild/ecological pigeon type restaurant modules provided by the present invention can be replicated to form chain-stores and provided with professional or vocational dietary instructors, assistants, and waiters.

The fast-food and buffet type wild/ecological pigeon type restaurant modules of the present invention supply (wild) pigeon & vegetable hamburger in shape of a (wild) pigeon, fast-food of (wild) pigeon & vegetable assorted cold dishes, spiced (wild) pigeon, smoked (wild) pigeon, sauced (wild) pigeon, roasted (wild) pigeon, tomato and egg soup, and fresh mushroom & pigeon soup.

In the present invention, the Chinese-style wild/ecological pigeon type restaurant module supplies (wild) pigeon braised in soy sauce, hot-pot (wild) pigeon, spicy-hot (wild) pigeon, spicy (wild) pigeon, mild spicy (wild) pigeon, not-spicy (wild) pigeon, and (wild) pigeon giblets. To cater for different consumers, other vegetables, meat, and fruit are also provided.

In the present invention, various types of pigeon from different producing areas are purchased at different prices, then processed in varied methods, and sold at different prices. Pigeons with varied values may be produced by different breeds and different taming environments. Thus, the wild/ecological pigeon type restaurant module may put forward dishes at different prices based on pigeon of varied quality.

In the present invention, text tablets inscribed with “wild/ecological pigeon type restaurant” are provided. Further, advertising films about the wild/ecological pigeon are provided with the following main content: the life-span, birth, evolution, taming, worldwide breeds, food chains, natural enemies, dietary and medical values, nutrition components of the (wild) pigeon, and their contribution to the human body.

The nutritive value of pigeon is revealed as follows. Pigeon, also named white phoenix, is tasty, rich in nutrition, and can be used for supplementary medical treatment. The famous Chinese herbal medicine “Wuji Baifeng Wan white phoenix bolus of black-bone chicken” is made by black-bone chicken and white phoenix. According to the old saying “one pigeon is better than nine chicken”, pigeon is high in nutritive value, and is very much suitable for the old and weak in health or from illness, those after operation and pregnant, and children. Pigeon has above 15% of protein, and a digestion rate as high as 97%. Further, the contents of elements such as Ca, Fe, Cu and vitamins A, B, E in the pigeon are all higher than those in chicken, fish, beef, and mutton. The pigeon liver contains optimal gallbladder bile, so as to help the utilization of cholesterol and prevent and cure arteriosclerosis. In folk, pigeon is also called “sweet blood animal”, and is beneficial to the recovery from anemia. The suckling pigeon contains abundant condroitin in the bone, and can be compared to the condroitin in the hairy antler. Frequent taking of the suckling pigeon may improve the cell viability and elasticity of skin, invigorate blood circulation, and achieve a ruddy complexion. The pigeon also contains abundant pantothenic acid, which has good curative effect on phalacrosis, leucotrichia, and ageing without growing hair. Moreover, being rich in branched-chain amino acid and arginine, the suckling pigeon may facilitate the protein synthesis and accelerate the healing of wound. According to Chinese medicine, pigeon is easy to digest, and is able to nourish Qi, dispel pathogenic wind, and detoxify. Thereby, pigeon has good invigoration and therapeutic effects on those weak from illness, and suffering from blood deficiency and amenorrhea, dizziness and mental weariness, or memory fading. Therefore, pigeon is an ideal food for nourishing adults, pregnant women, children, those weak in health or from illness, and patients, at a proper amount of half a pigeon each meal (about 80-100 g), or two pigeon eggs each day. It should be noted that, pigeon is most suitable to be steamed or boiled, so as to best preserve the nutrition.

13. Wild/Ecological Deer Type Restaurant Module

In a preferred technical embodiment of the present invention, a wild/ecological deer type restaurant module is provided. The wild/ecological deer type restaurant module is preferably set aside main arteries of the scenic spots at rural-urban fringe areas, so as to meet the demands of tourism and urban leisure consumers in drive. The present invention adopts bionic techniques and arts to fabricate a house model imitating a deer. Seen from afar, the wild/ecological deer type restaurant module looks like a giant deer standing or lying beside the main arteries of the scenic spots. In the present invention, flowers, grass, or trees are provided as podium buildings of the deer type house artistic module. The walls, doors, windows, balconies, roofs, and internal/external decorations of the deer artistic module are artistic portrayal of the wild/ecological animal/plant or in consistent environmental colors. The walkways, bedrooms, kitchens, toilets, and various pipelines, etc., inside the deer type house artistic module are fabricated by combining the inner structure of the conventional house with characteristics of the wild/ecological animals and plants. Thereby, the whole wild/ecological deer type restaurant module is actually a deer type house artistic module manufactured by construction, decoration, painting, and photography materials. As such, the consumers indeed experience and consume in the deer type house artistic modules.

Upon actual requirements, a wild/ecological deer type restaurant module is provided during the removal/rebuild of old/dilapidated houses in urban areas. The wild/ecological deer type restaurant module of the present invention is provided with deer-shaped windows, deer-shaped huge paintings, huge relief sculptures, or glass decorative paintings. Besides, deer sculptures are provided for the view of the consumers, and deer electric toys are provided for the children to play with. The welcome portals are decorated into doors with deer pictures. Leisure tables, chairs, gardening, parergon, and cross-sectional deer ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological deer type restaurant module and actual requirements. The welcoming hall is decorated with deer sculptures. In business places, for instance, the hall is decorated with pictures portraying a herd of wild/ecological deer running on the barren land, and paintings/photographs about ecological deer feeding aside a brook or grassland. The private rooms are decorated with stories about deer in the form of comics, animations, cartoons, or traditional Chinese paintings. Decorations, toys, and souvenirs of the dinning tables, chairs, and children dining chair in the restaurant are meant to demonstrate the living environment of the wild/ecological deer as well as folk culture features of the deer.

The Chinese-style, fast-food, buffet, and floating-type wild/ecological deer type restaurant modules provided by the present invention can be replicated to form chain-stores and provided with professional or vocational dietary instructors, assistants, and waiters.

The fast-food and buffet type wild/ecological deer type restaurant modules of the present invention supply venison & vegetable hamburger in shape of a deer, fast-food of venison & vegetable assorted cold dishes, spiced venison, smoked venison, sauced venison, roasted venison, tomato and egg soup, and fresh mushroom & meat soup.

In the present invention, the Chinese-style wild/ecological deer type restaurant module supplies venison braised in soy sauce, hot-pot venison, spicy-hot venison, spicy venison, mild spicy venison, not-spicy venison, deer lip, deer tongue, deer tripe, deer stomach, deer large intestine, deer dick, deer tendon, deer sinew, deer spare rib, and deer tail. To cater for different consumers, other vegetables, meat, and fruit are also provided.

In the present invention, various types of deer from different producing areas are purchased at different prices, then processed in varied methods, and sold at different prices. Deer with varied values may be produced by different breeds and different taming environments. Thus, the wild/ecological deer type restaurant module may put forward dishes at different prices based on deer of varied quality.

In the present invention, text tablets inscribed with “wild/ecological venison restaurant” are provided. Further, advertising films about the wild/ecological deer are provided with the following main content: the life-span, birth, evolution, taming, worldwide breeds, food chains, natural enemies, dietary and medical values, nutrition components of the (wild) deer, and their contribution to the human body.

The nutritive value of venison is revealed as follows. Venison, a high-class wild/ecological meat, is fine, tender, and tasty with much lean meat and few connective tissues, and can be cooked in various ways. Venison is rich in protein, fat, inorganic salts, sugar, and has a certain amount of vitamin. Besides, venison is easy to be digested and absorbed. Venison is mild in property, and can be used to invigorate the spleen, nourish Qi, warm the kidney, and replenish vital essence. According to traditional Chinese medicine, venison is pure Yang, and ranks the first in all kinds of meat for invigorating kidney-Qi. Thus, venison is an ideal nourishing food for newly-married couples and the old with weakening kidney-Qi. Besides, venison can also warm those always having cold limbs. Venison is high in protein, low in fat and cholesterol, and contains various active substances. Thus, venison is good at adjusting the blood circulation system and nervous system of the human body. Further, venison is generally suitable for all, especially those with deficiency of the kidney-Yang, at a proper amount of 30-80 g each meal. It should be noted that, as the venison, just like beef and mutton, belongs to red meat, long-term consumption may induce diseases of the stomach and intestine. Besides, as the venison is warm, invigorating, and can activate the circulation of blood, those with surgical trauma, fever due to infection, excessive Yang, or suffering from excessive internal hear should stay away from the venison.

14. Wild/Ecological Squirrel Type Restaurant Module

In a preferred technical embodiment of the present invention, a wild/ecological squirrel type restaurant module is provided. The wild/ecological squirrel type restaurant module is preferably set aside main arteries of the scenic spots at rural-urban fringe areas, so as to meet the demands of tourism and urban leisure consumers in drive. The present invention adopts bionic techniques and arts to fabricate a house model imitating a squirrel. Seen from afar, the wild/ecological squirrel type restaurant module looks like a giant squirrel standing or lying beside the main arteries of the scenic spots. In the present invention, pine forests, flowers, or grass are provided as podium buildings of the squirrel type house artistic module. The walls, doors, windows, balconies, roofs, and internal/external decorations of the squirrel artistic module are artistic portrayal of the wild/ecological animal/plant or in consistent environmental colors. The walkways, bedrooms, kitchens, toilets, and various pipelines, etc., inside the squirrel type house artistic module are fabricated by combining the inner structure of the conventional house with characteristics of the wild/ecological animals and plants. Thereby, the whole wild/ecological squirrel type restaurant module is actually a squirrel type house artistic module manufactured by construction, decoration, painting, and photography materials. As such, the consumers indeed experience and consume in the squirrel type house artistic modules.

Upon actual requirements, a wild/ecological squirrel type restaurant module is provided during the removal/rebuild of old/dilapidated houses in urban areas. The wild/ecological squirrel type restaurant module of the present invention is provided with squirrel-shaped windows, squirrel-shaped huge paintings, huge relief sculptures, or glass decorative paintings. Besides, squirrel sculptures are provided for the view of the consumers, and squirrel electric toys are provided for the children to play with. Further, squirrel feeding experiencing services are provided. The welcome portals are decorated into doors with squirrel pictures. Leisure tables, chairs, gardening, parergon, and cross-sectional squirrel ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological squirrel type restaurant module and actual requirements. The welcoming hall is decorated with squirrel sculptures. In business places, for instance, the hall is decorated with pictures portraying a herd of wild/ecological squirrel running in the pine forest, and paintings/photographs about ecological squirrels feeding aside a brook or grassland. The private rooms are decorated with stories about squirrel in the form of comics, animations, cartoons, or traditional Chinese paintings. Decorations, toys, and souvenirs of the dinning tables, chairs, and children dining chair in the restaurant are meant to demonstrate the living environment of the wild/ecological squirrel as well as folk culture features of the squirrel.

The Chinese-style, fast-food, buffet, and floating-type wild/ecological squirrel type restaurant modules provided by the present invention can be replicated to form chain-stores and provided with professional or vocational dietary instructors, assistants, and waiters.

The fast-food and buffet type wild/ecological squirrel type restaurant modules of the present invention supply squirrel meat & vegetable hamburger in shape of a squirrel, fast-food of squirrel meat & vegetable assorted cold dishes, spiced squirrel meat, smoked squirrel meat, sauced squirrel meat, roasted squirrel meat, tomato and egg soup, and fresh mushroom & vegetable soup.

In the present invention, the Chinese-style wild/ecological deer type restaurant module supplies squirrel meat braised in soy sauce, hot-pot squirrel meat, spicy-hot squirrel meat, spicy squirrel meat, mild spicy squirrel meat, not-spicy squirrel meat, squirrel stomach, squirrel spare rib, squirrel cooked with ginkgo nut, squirrel cooked with pork, and squirrel cooked with bamboo shoot. To cater for different consumers, other vegetables, meat, and fruit are also provided.

In the present invention, various types of squirrel from different producing areas are purchased at different prices, then processed in varied methods, and sold at different prices. Squirrels with varied values may be produced by different breeds and different taming environments. Thus, the wild/ecological squirrel type restaurant module may put forward dishes at different prices based on squirrel of varied quality.

In the present invention, text tablets inscribed with “wild/ecological squirrel type restaurant” are provided. Further, advertising films about the wild/ecological squirrel are provided with the following main content: the life-span, birth, evolution, taming, worldwide breeds, food chains, natural enemies, dietary and medical values, nutrition components of the (wild) squirrel, and their contribution to the human body.

15. Wild/Ecological Ostrich Type Restaurant Module

In a preferred technical embodiment of the present invention, a wild/ecological ostrich type restaurant module is provided. The wild/ecological ostrich type restaurant module is preferably set aside main arteries of the scenic spots at rural-urban fringe areas, so as to meet the demands of tourism and urban leisure consumers in drive. The present invention adopts bionic techniques and arts to fabricate a house model imitating an ostrich. Seen from afar, the wild/ecological ostrich type restaurant module looks like a giant ostrich standing or lying beside the main arteries of the scenic spots. In the present invention, deserts, flowers, or grass are provided as podium buildings of the ostrich type house artistic module. The walls, doors, windows, balconies, roofs, and internal/external decorations of the ostrich artistic module are artistic portrayal of the wild/ecological animal/plant or in consistent environmental colors. The walkways, bedrooms, kitchens, toilets, and various pipelines, etc., inside the ostrich type house artistic module are fabricated by combining the inner structure of the conventional house with characteristics of the wild/ecological animals and plants. Thereby, the whole wild/ecological ostrich type restaurant module is actually an ostrich type house artistic module manufactured by construction, decoration, painting, and photography materials. As such, the consumers indeed experience and consume in the ostrich type house artistic modules.

Upon actual requirements, a wild/ecological ostrich type restaurant module is provided during the removal/rebuild of old/dilapidated houses in urban areas. The wild/ecological ostrich type restaurant module of the present invention is provided with ostrich-shaped windows, ostrich-shaped huge paintings, huge relief sculptures, or glass decorative paintings. Besides, ostrich sculptures are provided for the view of the consumers, and ostrich electric toys are provided for the children to play with. Further, ostrich-riding experiencing services are provided. The welcome portals are decorated into doors with ostrich pictures. Leisure tables, chairs, gardening, parergon, and cross-sectional ostrich ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological ostrich type restaurant module and actual requirements. The welcoming hall is decorated with ostrich sculptures. In business places, for instance, the hall is decorated with pictures portraying a flock of wild/ecological ostriches running in the desert or barren land, and paintings/photographs about ecological ostriches feeding aside a brook or grassland. The private rooms are decorated with stories about ostrich and human in the form of comics, animations, cartoons, or traditional Chinese paintings. Decorations, toys, and souvenirs of the dinning tables, chairs, and children dining chair in the restaurant are meant to demonstrate the living environment of the wild/ecological ostrich as well as folk culture features of the ostrich.

The Chinese-style, fast-food, buffet, and floating-type wild/ecological ostrich type restaurant modules provided by the present invention can be replicated to form chain-stores and provided with professional or vocational dietary instructors, assistants, and waiters.

The fast-food and buffet type wild/ecological ostrich type restaurant modules of the present invention supply ostrich meat & vegetable hamburger in shape of a ostrich, fast-food of ostrich meat & vegetable assorted cold dishes, spiced ostrich meat, smoked ostrich meat, sauced ostrich meat, roasted ostrich meat, tomato and egg soup, and fresh mushroom & vegetable soup.

In the present invention, the Chinese-style wild/ecological ostrich type restaurant module supplies ostrich meat braised in soy sauce, hot-pot ostrich meat, spicy-hot ostrich meat, spicy ostrich meat, mild spicy ostrich meat, not-spicy ostrich meat, ostrich tongue, and ostrich spare rib. To cater for different consumers, other vegetables, meat, and fruit are also provided.

In the present invention, various types of ostrich from different producing areas are purchased at different prices, then processed in varied methods, and sold at different prices. Ostriches with varied values may be produced by different breeds and different taming environments. Thus, the wild/ecological ostrich type restaurant module may put forward dishes at different prices based on ostrich of varied quality.

In the present invention, text tablets inscribed with “wild/ecological ostrich meat restaurant” are provided. Further, advertising films about the wild/ecological ostrich are provided with the following main content: the life-span, birth, evolution, taming, worldwide breeds, food chains, natural enemies, dietary and medical values, nutrition components of the (wild) ostrich, and their contribution to the human body.

The nutritive value of ostrich meat is revealed as follows. The ostrich meat contains 21 kinds of amino acids indispensable to the human body, and is characterized in “five high and three low”, i.e., high in the contents of protein, Fe, Ca, Se, active sugar, and low in the contents of fat, cholesterol, heat. The ostrich meat, a pure red meat like beef, is tasty, rich in nutrition, and easy to digest and absorb. Thus, the ostrich meat is conferred by nutritionists as “the best natural calcium among all kinds of calcium”, and is an ideal green health meat for those having high blood pressure, high blood fat, diabetes, arteriosclerosis, obesity, and seeking for health and longevity. The ostrich egg is the biggest of all eggs, and is called “king of all eggs”. An ostrich egg, weighing about 1.5 kg, has crystal clear egg white, golden and alluring egg yolk, and tastes exquisite and delicious. Moreover, the ostrich egg is rich in nutrition, with the contents of protein, Ca, Fe, etc., all higher than other eggs, and is thus regarded by nutritionists as “soft gold”. Therefore, the ostrich egg is an ideal diet therapy to improve health condition and enhance immunity. Long-term consumption of ostrich egg may achieve the efficacies of beautification, invigorating the Yang, improving the intelligence, benefiting the health, and decreasing blood fat and blood sugar. Further, the shell of the ostrich egg is hard, smooth, exquisite, and as glossy as ivory and as mellow as jade. Thereby, the ostrich eggshell, superior for fabricating high-class arts and crafts and capable of being used to substitute ivory in coloured drawing and sculpture, has high ornamental and collecting values. By retrieving the origin, the ostrich eggshell is an ideal substance for warding off evil in the past and a symbol of wealth and lucky in the present.

16. Wild/Ecological Peacock Type Restaurant Module

In a preferred technical embodiment of the present invention, a wild/ecological peacock type restaurant module is provided. The wild/ecological peacock type restaurant module is preferably set aside main arteries of the scenic spots at rural-urban fringe areas, so as to meet the demands of tourism and urban leisure consumers in drive. The present invention adopts bionic techniques and arts to fabricate a house model imitating a peacock. Seen from afar, the wild/ecological peacock type restaurant module looks like a giant peacock standing or lying beside the main arteries of the scenic spots. In the present invention, flowers, grass, or trees are provided as podium buildings of the peacock type house artistic module. The walls, doors, windows, balconies, roofs, and internal/external decorations of the peacock artistic module are artistic portrayal of the wild/ecological animal/plant or in consistent environmental colors. The walkways, bedrooms, kitchens, toilets, and various pipelines, etc., inside the peacock type house artistic module are fabricated by combining the inner structure of the conventional house with characteristics of the wild/ecological animals and plants. Thereby, the whole wild/ecological peacock type restaurant module is actually a peacock type house artistic module manufactured by construction, decoration, painting, and photography materials. As such, the consumers indeed experience and consume in the peacock type house artistic modules.

Upon actual requirements, a wild/ecological peacock type restaurant module is provided during the removal/rebuild of old/dilapidated houses in urban areas. The wild/ecological peacock type restaurant module of the present invention is provided with peacock-shaped windows, peacock-shaped huge paintings, huge relief sculptures, or glass decorative paintings. Besides, peacock sculptures are provided for the view of the consumers, and peacock electric toys are provided for the children to play with. Further, the welcome portals are decorated into doors with peacock pictures. Leisure tables, chairs, gardening, parergon, and cross-sectional peacock ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological peacock type restaurant module and actual requirements. The welcoming hall is decorated with peacock sculptures. In business places, for instance, the hall is decorated with pictures portraying a flock of wild/ecological peacocks running on the barren land, and paintings/photographs about ecological peacocks feeding aside a brook or grassland. The private rooms are decorated with stories about peacock and human in the form of comics, animations, cartoons, or traditional Chinese paintings. Decorations, toys, and souvenirs of the dinning tables, chairs, and children dining chair in the restaurant are meant to demonstrate the living environment of the wild/ecological peacock as well as folk culture features of the peacock.

The Chinese-style, fast-food, buffet, and floating-type wild/ecological peacock type restaurant modules provided by the present invention can be replicated to form chain-stores and provided with professional or vocational dietary instructors, assistants, and waiters.

The fast-food and buffet type wild/ecological peacock type restaurant modules of the present invention supply peacock meat & vegetable hamburger in shape of a peacock, fast-food of peacock meat & vegetable assorted cold dishes, spiced peacock meat, smoked peacock meat, sauced peacock meat, roasted peacock meat, tomato and egg soup, and fresh mushroom & vegetable soup.

In the present invention, the Chinese-style wild/ecological peacock type restaurant module supplies peacock meat braised in soy sauce, hot-pot peacock meat, spicy-hot peacock meat, spicy peacock meat, mild spicy peacock meat, not-spicy peacock meat, peacock tongue, and peacock spare rib. To cater for different consumers, other vegetables, meat, and fruit are also provided.

In the present invention, various types of peacock from different producing areas are purchased at different prices, then processed in varied methods, and sold at different prices. Peacocks with varied values may be produced by different breeds and different taming environments. Thus, the wild/ecological peacock type restaurant module may put forward dishes at different prices based on peacock of varied quality.

In the present invention, text tablets inscribed with “wild/ecological peacock meat restaurant” are provided. Further, advertising films about the wild/ecological peacock are provided with the following main content: the life-span, birth, evolution, taming, worldwide breeds, food chains, natural enemies, dietary and medical values, nutrition components of the (wild) peacock, and their contribution to the human body.

The nutritive value of peacock meat is revealed as follows. With successful large-scale rearing of the peacock, more and more people have the opportunity to taste the peacock meat. The peacock lays a lot of meat, and has an eviscerated dressing percentage of 80%. The peacock meat is a health food high in protein and low in fat, in which the content of protein reaches 23.2% and the content of fat is only 0.8%. Moreover, the peacock meat is rich in above 10 kinds of amino acids and a variety of vitamins and trace elements. Thereby, the peacock meat is highly praised by consumers. In high-class banquets, a diet therapy soup menu usually contains whole peacock stuffed with premium shark's, stewed peacock with cordyceps, stewed peacock with gastrodia tuber, and stewed peacock with American ginseng, etc., for curing diseases and recovering the body condition. Further, the peacock is a good raw material for exploiting health food, and is an ideal raw material for medicine. Through preliminary tests of scientific research institutions, the nourishing efficacy of peacock extracts is much higher than those of turtle, snake, lobster, and chicken. The peacock meat can be used to improve human immunity and enhance human resistance to disease. Thus, the peacock is rich in nutrition and tasty, and can be made into peacock beverages and peacock canned meat as a nourishing food. Further, the peacock is also a good raw material for medicine. The medical value of peacock has already been described in detail in “Compendium of Materia Medica” composed by Li Shizhen in Ming dynasty that “Meat for removing deadly medicines/venomous worms; blood drunk directly to remove venomous worms; excrement for treating abnormal vaginal discharge, difficult urination, and malignant boil; and gallbladder for removing serious poisons, simple poisons, and deadly medicine”. According to modern Chinese medicine, it is confirmed that the peacock is capable of nourishing Yin and clearing away heat, calming the liver to stop the wind, softening and resolving hard masses, and is mainly used for treating liver cancer and sore. Through continuous breeding and introduction, the peacock serial products are kept in exploitation, thus achieving boosting economic benefits. Moreover, being a high-class and rare meat, the peacock is only available to emperors, generals, and premiers in ancient times. The blue peacock has a lot of meat, and its eviscerated dressing percentage reaches 80%. Besides, the peacock meat is not only fine and tender, but with strong wild/ecological flavor and very delicate. More particularly, the peacock soup smells and tastes indescribably good, and the smell will not be impaired with water added in several times. According to modern science and technology, the protein content in peacock meat reaches 23.2%, which is much higher than ordinary fowls, and the peacock meat contains all the 18 kinds of amino acids indispensable to the human body. Moreover, the peacock meat produces heat energy of 100 Kcal/100 g with only 0.4% of saturated fat, and cholesterol of 49 mg/100 g much lower than cursorial birds and egg. Thus, the peacock meat is a nutrition meat with high protein, low fat, low heat, and low cholesterol. As the peacock is raised in the mountain areas, and fed with pollution-free green forages, its meat products are green food and beneficial to the human health. Moreover, the nutrition components in peacock meat are very close to the ideal mode proposed by the Food & Agriculture Organization and World Health Organization (FAO/WHO). According to food and food management label laws issued by American Sanitation & Public Affairs Department, the peacock meat completely meets the standard of “extremely lean” meat.

17. Wild/Ecological Roe Deer Type Restaurant Module

In a preferred technical embodiment of the present invention, a wild/ecological roe deer type restaurant module is provided. The wild/ecological roe deer type restaurant module is preferably set aside main arteries of the scenic spots at rural-urban fringe areas, so as to meet the demands of tourism and urban leisure consumers in drive. The present invention adopts bionic techniques and arts to fabricate a house model imitating a roe deer. Seen from afar, the wild/ecological roe deer type restaurant module looks like a giant roe deer lying beside the main arteries of the scenic spots. In the present invention, flowers, grass, or trees are provided as podium buildings of the roe deer type house artistic module. The walls, doors, windows, balconies, roofs, and internal/external decorations of the roe deer artistic module are artistic portrayal of the wild/ecological animal/plant or in consistent environmental colors. The walkways, bedrooms, kitchens, toilets, and various pipelines, etc., inside the roe deer type house artistic module are fabricated by combining the inner structure of the conventional house with characteristics of the wild/ecological animals and plants. Thereby, the whole wild/ecological roe deer type restaurant module is actually a roe deer type house artistic module manufactured by construction, decoration, painting, and photography materials. As such, the consumers indeed experience and consume in the roe deer type house artistic modules.

Upon actual requirements, a wild/ecological roe deer type restaurant module is provided during the removal/rebuild of old/dilapidated houses in urban areas. The wild/ecological roe deer type restaurant module of the present invention is provided with roe deer-shaped windows, roe deer-shaped huge paintings, huge relief sculptures, or glass decorative paintings. Besides, roe deer sculptures are provided for the view of the consumers, and roe deer electric toys are provided for the children to play with. Further, the welcome portals are decorated into doors with roe deer pictures. Leisure tables, chairs, gardening, parergon, and cross-sectional roe deer ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological roe deer type restaurant module and actual requirements. The welcoming hall is decorated with roe deer sculptures. In business places, for instance, the hall is decorated with pictures portraying a herd of wild/ecological roe deer running on the barren land, and paintings/photographs about ecological roe deer feeding aside a brook or grassland. The private rooms are decorated with stories about roe deer in the form of comics, animations, cartoons, or traditional Chinese paintings. Decorations, toys, and souvenirs of the dinning tables, chairs, and children dining chair in the restaurant are meant to demonstrate the living environment of the wild/ecological roe deer as well as folk culture features of the roe deer.

The Chinese-style, fast-food, buffet, and floating-type wild/ecological roe deer type restaurant modules provided by the present invention can be replicated to form chain-stores and provided with professional or vocational dietary instructors, assistants, and waiters.

The fast-food and buffet type wild/ecological roe deer type restaurant modules of the present invention supply roe deer meat & vegetable hamburger in shape of a roe deer, fast-food of roe deer meat & vegetable assorted cold dishes, spiced roe deer meat, smoked roe deer meat, sauced roe deer meat, roasted roe deer meat, tomato and egg soup, and fresh mushroom & meat soup.

In the present invention, the Chinese-style wild/ecological roe deer type restaurant module supplies roe deer meat braised in soy sauce, hot-pot roe deer meat, spicy-hot roe deer meat, spicy roe deer meat, mild spicy roe deer meat, not-spicy roe deer meat, roe deer lip, roe deer tongue, roe deer tripe, roe deer tendon, and roe deer spare rib. To cater for different consumers, other vegetables, meat, and fruit are also provided.

In the present invention, various types of roe deer from different producing areas are purchased at different prices, then processed in varied methods, and sold at different prices. Roe deer with varied values may be produced by different breeds and different taming environments. Thus, the wild/ecological roe deer type restaurant module may put forward dishes at different prices based on roe deer of varied quality.

In the present invention, text tablets inscribed with “wild/ecological roe deer type restaurant” are provided. Further, advertising films about the wild/ecological roe deer are provided with the following main content: the life-span, birth, evolution, taming, worldwide breeds, food chains, natural enemies, dietary and medical values, nutrition components of the (wild) roe deer, and their contribution to the human body.

The nutritive value of roe deer meat is revealed as follows. Roe deer is a kind of wild/ecological animal inhabiting in the Forest of Changbai Mountain, and belongs to grazing animals. The roe deer not only has high nutritive value, but also has certain medical value for preventing various diseases, especially cancer and tumour diseases. As the roe deer feeds in herbs in the Forest of Changbai Mountain, its meat is fine, tender, and rich in nutrition. Moreover, the roe deer meat is specialized in delicate and tender taste with strong wild/ecological flavor.

18. Wild/Ecological Bird Type Restaurant Module

In a preferred technical embodiment of the present invention, a wild/ecological bird type restaurant module is provided. The wild/ecological bird type restaurant module is preferably set aside main arteries of the scenic spots at rural-urban fringe areas, so as to meet the demands of tourism and urban leisure consumers in drive. The present invention adopts bionic techniques and arts to fabricate a house model imitating a bird. Seen from afar, the wild/ecological bird type restaurant module looks like a giant bird lying beside the main arteries of the scenic spots. In the present invention, rocks, flowers, or grass are provided as podium buildings of the bird type house artistic module. The walls, doors, windows, balconies, roofs, and internal/external decorations of the bird type house artistic module are artistic portrayal of the wild/ecological animal/plant or in consistent environmental colors. The walkways, bedrooms, kitchens, toilets, and various pipelines, etc., inside the bird type house artistic module are fabricated by combining the inner structure of the conventional house with characteristics of the wild/ecological animals and plants. Thereby, the whole wild/ecological bird type restaurant module is actually a bird type house artistic module manufactured by construction, decoration, painting, and photography materials. As such, the consumers indeed experience and consume in the bird type house artistic modules.

Upon actual requirements, a wild/ecological bird type restaurant module is provided during the removal/rebuild of old/dilapidated houses in urban areas. The wild/ecological bird type restaurant module of the present invention is provided with bird-shaped windows, bird-shaped huge paintings, huge relief sculptures, or glass decorative paintings. Besides, bird sculptures are provided for the view of the consumers, and bird electric toys are provided for the children to play with. Further, the welcome portals are decorated into doors with bird pictures. Leisure tables, chairs, gardening, parergon, and cross-sectional bird ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological bird type restaurant module and actual requirements. The welcoming hall is decorated with bird sculptures. In business places, for instance, the hall is decorated with pictures portraying a flock of birds flying above the barren land, and paintings/photographs about ecological bird feeding aside a brook or grassland. The private rooms are decorated with stories about bird in the form of comics, animations, cartoons, or traditional Chinese paintings. Decorations, toys, and souvenirs of the dinning tables, chairs, and children dining chair in the restaurant are meant to demonstrate the living environment of the wild/ecological bird as well as folk culture features of the bird.

The Chinese-style, fast-food, buffet, and floating-type wild/ecological bird type restaurant modules provided by the present invention can be replicated to form chain-stores and provided with professional or vocational dietary instructors, assistants, and waiters.

The fast-food and buffet type wild/ecological bird type restaurant modules of the present invention supply bird meat & vegetable hamburger in shape of a bird, fast-food of bird meat & vegetable assorted cold dishes, spiced bird meat, smoked bird meat, sauced bird meat, roasted bird meat, tomato and egg soup, and fresh mushroom & vegetable soup.

In the present invention, the Chinese-style wild/ecological bird type restaurant module supplies bird meat braised in soy sauce, hot-pot bird meat, spicy-hot bird meat, spicy bird meat, mild spicy bird meat, not-spicy bird meat, fried bird, grilled bird, and steamed bird. To cater for different consumers, other vegetables, meat, and fruit are also provided.

In the present invention, various types of bird from different producing areas are purchased at different prices, then processed in varied methods, and sold at different prices. Birds with varied values may be produced by different breeds and different taming environments. Thus, the wild/ecological bird type restaurant module may put forward dishes at different prices based on birds of varied quality.

In the present invention, text tablets inscribed with “wild/ecological bird type restaurant” are provided. Further, advertising films about the wild/ecological bird are provided with the following main content: the life-span, birth, evolution, taming, worldwide breeds, food chains, natural enemies, dietary and medical values, nutrition components of the (wild) bird, and their contribution to the human body.

The nutritive value of bird meat is revealed as follows. For instance, sparrow, normally called guest sparrow, can be used to invigorate the Yang, strengthen the essence, warm the waist and knees, reduce urinate, and stop flooding and vaginal discharge. Therefore, the sparrow is suitable to be taken, especially by those insufficient of Yang-Qi, impotent, declining in sexual function, or with frequent incontinence of urination, thin and clear leukorrh, or having disease due to asthenia of viscera and emaciation, intolerance of cold and cold limbs, or whooping cough. Besides, the sparrow is properly taken in winter. Further, quail, neutral in property and sweet in flavor, can be used to invigorate the five internal organs, nourish Qi, and enrich the blood. Thus, the quail is suitable to be taken, especially by those malnourished, weak in health and lacking in strength, anemic and feeling dizzy, or those having infantile malnutrition, nephritis and edema, or diarrhea. In addition, the quail egg is suitable for those suffering from high blood pressure, vascular sclerosis, tuberculosis, gastric diseases, nervous exhaustion, bronchial asthma, or skin allergy.

19. Wild/Ecological Masked Civet Type Restaurant Module

In a preferred technical embodiment of the present invention, a wild/ecological masked civet type restaurant module is provided. The wild/ecological masked civet type restaurant module is preferably set aside main arteries of the scenic spots at rural-urban fringe areas, so as to meet the demands of tourism and urban leisure consumers in drive. The present invention adopts bionic techniques and arts to fabricate a house model imitating a masked civet. Seen from afar, the wild/ecological masked civet type restaurant module looks like a giant masked civet standing or lying beside the main arteries of the scenic spots. In the present invention, flowers, grass, or trees are provided as podium buildings of the masked civet type house artistic module. The walls, doors, windows, balconies, roofs, and internal/external decorations of the masked civet artistic module are artistic portrayal of the wild/ecological animal/plant or in consistent environmental colors. The walkways, bedrooms, kitchens, toilets, and various pipelines, etc., inside the masked civet type house artistic module are fabricated by combining the inner structure of the conventional house with characteristics of the wild/ecological animals and plants. Thereby, the whole wild/ecological masked civet type restaurant module is actually a masked civet type house artistic module manufactured by construction, decoration, painting, and photography materials. As such, the consumers indeed experience and consume in the masked civet type house artistic modules.

Upon actual requirements, a wild/ecological masked civet type restaurant module is provided during the removal/rebuild of old/dilapidated houses in urban areas. The wild/ecological masked civet type restaurant module of the present invention is provided with masked civet-shaped windows, masked civet-shaped huge paintings, huge relief sculptures, or glass decorative paintings. Besides, masked civet sculptures are provided for the view of the consumers, and masked civet electric toys are provided for the children to play with. Further, the welcome portals are decorated into doors with masked civet pictures. Leisure tables, chairs, gardening, parergon, and cross-sectional masked civet ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological masked civet type restaurant module and actual requirements. The welcoming hall is decorated with masked civet sculptures. In business places, for instance, the hall is decorated with pictures portraying a flock of masked civets rustling at night on the barren land, and paintings/photographs about ecological masked civet feeding aside a brook or grassland. The private rooms are decorated with stories about masked civet in the form of comics, animations, cartoons, or traditional Chinese paintings. Decorations, toys, and souvenirs of the dinning tables, chairs, and children dining chair in the restaurant are meant to demonstrate the living environment of the wild/ecological masked civet as well as folk culture features of the masked civet.

The Chinese-style, fast-food, buffet, and floating-type wild/ecological masked civet type restaurant modules provided by the present invention can be replicated to form chain-stores and provided with professional or vocational dietary instructors, assistants, and waiters.

The fast-food and buffet type wild/ecological masked civet type restaurant modules of the present invention supply masked civet meat & vegetable hamburger in shape of a masked civet, fast-food of masked civet meat & vegetable assorted cold dishes, spiced masked civet meat, smoked masked civet meat, sauced masked civet meat, roasted masked civet meat, tomato and egg soup, and fresh mushroom & vegetable soup.

In the present invention, the Chinese-style wild/ecological masked civet type restaurant module supplies masked civet meat braised in soy sauce, hot-pot masked civet meat, spicy-hot masked civet meat, spicy masked civet meat, mild spicy masked civet meat, not-spicy masked civet meat, and masked civet cooked with dried bamboo shoot. To cater for different consumers, other vegetables, meat, and fruit are also provided.

In the present invention, various types of masked civet from different producing areas are purchased at different prices, then processed in varied methods, and sold at different prices. Masked civets with varied values may be produced by different breeds and different taming environments. Thus, the wild/ecological masked civet type restaurant module may put forward dishes at different prices based on masked civets of varied quality.

In the present invention, text tablets inscribed with “wild/ecological masked civet type restaurant” are provided. Further, advertising films about the wild/ecological masked civet are provided with the following main content: the life-span, birth, evolution, taming, worldwide breeds, food chains, natural enemies, dietary and medical values, nutrition components of the (wild) masked civet, and their contribution to the human body.

20. Wild/Ecological Snake Type Restaurant Module

In a preferred technical embodiment of the present invention, a wild/ecological snake type restaurant module is provided. The wild/ecological snake type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a snake. Seen from afar, the wild/ecological snake type restaurant module looks like a giant wild snake standing or lying against the roads of the scenic spots. In the present invention, rocks, flowers, and grass are provided as podium buildings of the snake type house artistic module. The walls, doors, windows, balconies, roofs, and internal/external decorations of the snake type house artistic module profile are artistic portrayal of wild/ecological animals and plants or in consistent environmental colors. The walkways, bedrooms, kitchens, toilets, and various pipelines, etc., inside the snake type house artistic module are fabricated by combining the inner structure of the conventional house with characteristics of the wild/ecological animals and plants. Thereby, the whole wild/ecological snake type restaurant module is actually a snake type house artistic module manufactured by construction, decoration, painting, and photography materials. As such, the consumers indeed experience and consume in the snake type house artistic module.

Upon actual requirements, a wild/ecological snake type restaurant module is provided during the removal/rebuild of old/dilapidated houses in urban areas. The wild/ecological snake type restaurant module of the present invention is provided with snake type windows, huge paintings, huge relief sculptures, or glass decorative paintings. Besides, snake type sculptures are provided for the view of the consumers, and cartoon snake type electric toys are provided for the children to play with. The welcome portals are decorated into doors with snake pictures. Leisure tables, chairs, gardening, parergon, and cross-sectional snake ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological snake type restaurant module and actual requirements. The welcoming hall is decorated with snake sculptures. In business places, for instance, the hall is decorated with pictures portraying snakes prowling on wetlands, and paintings/photographs about ecological snakes pastured beside mountain streams and grass. The private rooms are decorated with stories about snakes in the form of comics, animations, cartoons, or traditional Chinese paintings. Decorations, toys, and souvenirs of the dining tables, chairs, and children dining chairs of the restaurant are meant to demonstrate the living environment of wild/ecological snakes as well as folk cultural features of snakes.

The Chinese-style, fast-food, buffet, and floating-type wild/ecological snake type restaurant modules provided by the present invention can be to form chain-stores and provided with professional or vocational dietary instructors, assistants, and waiters.

The fast-food and buffet style wild/ecological snake type restaurant modules of the present invention supply snake meat & vegetable hamburger in shape of a snake, fast-food of snake meat & vegetable assorted cold dishes, spiced snake meat, smoked snake meat, sauced snake meat, roasted snake meat, salted snake meat, tomato and egg soup, and fresh mushroom & vegetable soup.

In the present invention, the Chinese-style wild/ecological snake type restaurant modules supplies snake meat braised in soy sauce, hot-pot snake meat, spicy-hot snake meat, spicy snake meat, mild-spicy snake, non-spicy snake meat, steamed snake meat, and snake meat cooked with chicken. To cater for different consumers, other vegetables, meat, and fruit are provided.

In the present invention, various types of snakes from different producing areas are purchased at different prices, then processed in varied methods, and sold at different prices. Snakes with varied values may be produced by different breeds and different taming environments. Thus, the wild/ecological snake type restaurant module may put forward dishes at different prices based on snake products of varied quality.

In the present invention, text tablets inscribed with “wild/ecological snake meat restaurant” are provided. Besides, advertising films about the wild/ecological snakes are provided with the following main content: the life-span, birth, evolution, taming, worldwide breeds, food chains, natural enemies, dietary and medical values, nutrition components of snakes, and their contribution to the human body.

The nutritive value of the snake is revealed as follows. The snake meat is tender and delicious in taste and is a delicacy with rich nutrition. The snake meat is high in protein and low in cholesterol, and has the following efficacies. The snake meat contains various kinds of amino acids necessary to the human body including the glutamic acid enhancing activities of brain cells, the aspartic acid capable of relieving the fatigue of the human body, and other nutritional ingredients, thus being a good food for brainworkers. The snake meat has the efficacy of strengthening nerves and prolonging life. Due to the eight amino acids contained in the protein thereof necessary to the human body and the very low cholesterol content, the snake meat has some effect in preventing and curing the angiosclerosis and meanwhile the function of moisturizing the skin, keeping youthfulness, and regulating the human body's metabolism. The snake meat is also a good food for invigorating Yang. The snake gallbladder has the efficacies of dispersing pathogenic wind, reducing heat, eliminating phlegm, and improving eyesight, and therefore is a good medicine for treating rheumatic diseases such as the rheumatoid arthritis and eye diseases such as the keratitis. The Fritillary Bulb Extract Oral Liquid made primarily of the snake bile and unibract fritillary bulb is currently a good medicine in the clinic for stopping cough and eliminating phlegm which is convenient in use and effective in treatment. The snake meat is eatable for ordinary adults. It should be noted that the snake meat is safe to eat only if well-done. Do not soak the snake meat in water before cooking; otherwise it will be tough and difficult to get thoroughly cooked. Drinking the raw snake blood and swallowing the raw snake gallbladder is very unsanitary and certainly dangerous, which may cause the acute gastroenteritis and verminosis. The snake is a food which aggravates or induces diseases, so that those with chronic illnesses and pyogenic infections of skin should not eat it.

21. Wild/Ecological Standardized Eel Type Restaurant Module

In a preferred technical embodiment of the present invention, a wild/ecological eel type restaurant module is provided. The wild/ecological eel type restaurant module is preferably set aside main arteries of the scenic spots at rural-urban fringe areas, so as to meet the requirements of tourism and urban leisure consumers in drive. The present invention adopts bionic techniques and arts to fabricate a house model imitating an eel. Seen from afar, the wild/ecological eel type restaurant module looks like a giant wild eel standing or lying against the roads of the scenic spots. In the present invention, wetlands and water weeds are provided as podium buildings of the eel type house artistic module. The walls, doors, windows, balconies, roofs, and internal/external decorations of the eel type house artistic module profile are artistic portrayal of wild/ecological animals and plants or in consistent environmental colors. The walkways, bedrooms, kitchens, toilets, and various pipelines, etc., inside the eel type house artistic module are fabricated by combining the inner structure of the conventional house with characteristics of the wild/ecological animals and plants. Thereby, the whole wild/ecological eel type restaurant module is actually an eel type house artistic module manufactured by construction, decoration, painting, and photography materials. As such, the consumers indeed experience and consume in the eel type house artistic module.

Upon actual requirements, a wild/ecological eel type restaurant module is provided during the removal/rebuild of old/dilapidated houses in urban areas. The wild/ecological eel type restaurant modules of the present invention is provided with eel type windows, huge paintings, huge relief sculptures, or glass decorative paintings. Besides, eel type sculptures are provided for the view of the consumers, and cartoon eel type electric toys are provided for the children to play with. The welcome portals are decorated into doors with eel pictures. Leisure tables, chairs, gardening, parergon, and cross-sectional eel ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological eel type restaurant module and actual requirements. The welcoming hall is decorated with eel sculptures. In business places, for instance, the hall is decorated with pictures portraying eels prowling on wetlands, and paintings/photographs about ecological eels pastured on grass and wetlands. The private rooms are decorated with stories about eels in the form of comics, animations, cartoons, or traditional Chinese paintings. Decorations, toys, and souvenirs of the dining tables, chairs, and children dining chairs of the restaurant are meant to demonstrate the living environment of wild/ecological eels as well as folk cultural features of eels.

The Chinese-style, fast-food, buffet, and floating-type wild/ecological eel type restaurant modules provided by the present invention can be replicated to form chain-stores and provided with professional or vocational dietary instructors, assistants, and waiters.

The fast-food and buffet style wild/ecological eel type restaurant modules of the present invention supply (wild) eel meat & vegetable hamburger in shape of an eel, fast-food of (wild) eel meat & vegetable assorted cold dishes, spiced (wild) eel meat, smoked (wild) eel meat, sauced (wild) eel meat, roasted (wild) eel meat, salted (wild) eel meat, tomato and egg soup, and fresh mushroom & vegetable soup.

In the present invention, the Chinese-style wild/ecological eel type restaurant modules supply (wild) eel meat braised in soy sauce, hot-pot (wild) eel meat, spicy-hot (wild) eel meat, spicy (wild) eel meat, mild-spicy (wild) eel, non-spicy (wild) eel meat, (wild) eel sections cooked with preserved pork, and stir-fried shredded (wild) eel. To cater for different consumers, other vegetables, meat, and fruit are provided.

In the present invention, various types of eel from different producing areas are purchased at different prices, then processed in varied methods, and sold at different prices. Eels of different values may be produced by different breeds and different taming environments. The wild/ecological eel type restaurant module may put forward dishes at different prices based on eel products of varied quality.

In the present invention, text tablets inscribed with “wild/ecological eel meat restaurant” are provided. Besides, advertising films about wild/ecological eels are provided with the following main content: the life-span, birth, evolution, taming, worldwide breeds, food chains, natural enemies, dietary and medical values, nutrition components of (wild) eels, and their contribution to the human body.

The nutritive value of the eel (yellow eel, long fish, sea snake) is revealed as follows. The eel is also called the yellow eel, long fish, sea snake, etc. It is said that the strong men in ancient times often ate eels. In old times, people going around to sell medicines were generally called strong pill sellers. In fact, the ancient medical work Ben Jing Feng Yuan really records the formulation of the “strong pill”, a basic remedy of which is the eel. The eel is delicious in taste, has less bones and thick meat, and is tender. The eel is unique compared with other freshwater fishes. People are difficult to forget the delicious eel after eating it if appropriately cooked. The summer eel before and after one month of the Slight Heat is most restorative and delicious. Therefore, it is said that the eel in the Slight Heat is better than the ginseng. The eel has the following efficacies. The eel contains rich DHA and lecithin which is the main ingredient of the cell membrane of various organic tissues and essential to brain cells. According to American experimental research data, a frequent intake of the lecithin may improve the memory by 20%. Therefore, the eel meat has the efficacy of nourishing the brain and building the body. The special substance “eel essence” contained therein may reduce and regulate the blood sugar and has good therapeutic effect on the diabetes. In addition, the eel contains very little fat and therefore is an ideal food for diabetic patients. The eel contains an astonishing amount of vitamin A which may improve eyesight and facilitate the metabolism of the skin. It is said that the eel is an eye medicine. Those suffering from eye diseases in the past all know the benefit of eating the eel. A frequent intake of the eel has a strong tonifying function especially for the weak, post-illness and postpartum people. Besides, the eel blood may cure the eye-mouth deviation. Chinese medicine believes that the eel has the medical and healthcare function of restoring qi and nourishing the blood, warming Yang and invigorating the spleen, restoring the liver and kidney, dispersing pathogenic wind, and freeing channels, etc. The eel meat is eatable for ordinary people as well as patients suffering from eye diseases and diabetes, at a proper amount of 50 g each meal. It should be noted that the eel is better to be killed and cooked on site and the dead eel is inedible. Although the eel is good, the excessive eating is inadvisable; otherwise, the eel is indigestible and may cause a return of the illness.

22. Wild/Ecological Fish Type Restaurant Module

In a preferred technical embodiment of the present invention, a wild/ecological fish type restaurant module is provided. The wild/ecological fish type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a fish. Seen from afar, the wild/ecological fish type restaurant module looks like a giant wild fish lying against the roads of the scenic spots. In the present invention, aquatic weeds and water surfaces are provided as podium buildings of the fish type house artistic module. The walls, doors, windows, balconies, roofs, and internal/external decorations of the fish type house artistic module profile are artistic portrayal of wild/ecological animals and plants or in consistent environmental colors. The walkways, bedrooms, kitchens, toilets, and various pipelines, etc., inside the fish type house artistic module are fabricated by combining the inner structure of the conventional house with characteristics of the wild/ecological animals and plants. Thereby, the whole wild/ecological fish type restaurant module is actually a fish type house artistic module manufactured by construction, decoration, painting, and photography materials. As such, the consumers indeed experience and consume in the fish type house artistic module.

Upon actual requirements, a wild/ecological fish type restaurant module is provided during the removal/rebuild of old/dilapidated houses in urban areas. The wild/ecological fish type restaurant modules of the present invention is provided with fish type windows, huge paintings, huge relief sculptures, or glass decorative paintings. Besides, fish type sculptures are provided for the view of the consumers, and cartoon fish type electric toys are provided for the children to play with. Further The service for viewing the fishes is provided. The welcome portals are decorated into doors with fish pictures. Leisure tables, chairs, gardening, parergon, and cross-sectional fish ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological fish type restaurant module and actual requirements. The welcoming hall is decorated with fish sculptures. In business places, for instance, a hall is decorated with a wild fish stock prowling in the water, and paintings/photographs about ecological fishes pastured beside mountain streams and grass. The private rooms are decorated with stories about fishes in the form of comics, animations, cartoons, or traditional Chinese paintings. Decorations, toys, and souvenirs of the dining tables, chairs, and children dining chairs of the restaurant are meant to demonstrate the living environment of wild/ecological fishes as well as folk cultural features of fishes.

The Chinese-style, fast-food, buffet, and floating-type wild/ecological fish type restaurant modules provided by the present invention can be replicated to form chain-stores and provided with professional or vocational dietary instructors, assistants, and waiters.

The fast-food and buffet style wild/ecological fish type restaurant modules of the present invention supply (wild) fish meat & vegetable hamburger in shape of a (wild) fish, fast-food of (wild) fish meat & vegetable assorted cold dishes, spiced (wild) fish meat, smoked (wild) fish meat, sauced (wild) fish meat, roasted (wild) fish meat, salted (wild) fish meat, tomato and egg soup, and fish soup with fresh mushrooms.

In the present invention, the Chinese-style wild/ecological fish type restaurant modules supply (wild) fish meat braised in soy sauce, hot-pot (wild) fish meat, spicy-hot (wild) fish meat, spicy (wild) fish meat, mild-spicy (wild) fish, non-spicy (wild) fish meat, (wild) fish head hop-pot, and fresh (wild) fish soup. To cater for different consumers, other vegetables, meat, and fruit are provided.

In the present invention, various types of fish from different producing areas are purchased at different prices, then processed in varied methods, and sold at different prices. Fishes of different values may be produced by different breeds and different taming environments. The wild/ecological fish type restaurant module may put forward dishes at different prices based on fish products of varied quality.

In the present invention, text tablets inscribed with “wild/ecological fish restaurant” are provided. Besides, advertising films about wild/ecological fishes are provided with the following main content: the life-span, birth, evolution, taming, worldwide breeds, food chains, natural enemies, dietary and medical values, nutrition components of (wild) fishes, and their contribution to the human body.

The nutritive value of the fish is revealed as follows. There are many kinds of fishes. Edible freshwater fishes mainly include carps, grass carps, crucian carps, mandarin fishes, etc. Seawater fishes include yellow fishes, belt fishes, flat fishes, etc. They are all tender and delicious in meat with rich nutrition and are good sources of some vitamins and inorganic salts. The fish has the following efficacies. The fish meat contains the folic acid and vitamins such as vitamin B2 and vitamin B12, and has the efficacies of restoring and strengthening the stomach, inducing diuresis for removing edema, stimulating milk secretion, reducing fever and detoxification, and stopping cough and depressing Qi. The fish meat is effective for all kinds of edema, abdominal distention, oliguresis, icterus, and milk obstruction. An intake of the fish meat has good effect on pregnant women's fetal irritability and pregnancy edema. The fish meat contains rich Mg and thus has good protective effect on the cardiovascular system and favors the prevention of cardiovascular diseases such as the high blood pressure and myocardinal infarction. The fish meat contains rich vitamin A, Fe, Ca, P, etc. In addition, a frequent intake of the fish has the efficacies of nourishing the liver and enriching the blood, lustering the skin, caring the hair, and keeping strong and handsome. The fish is eatable for ordinary people, at a proper amount of 100 g each meal. It should be noted that add little salt to the fish when used as a diet for stimulating milk secretion. Add no sodium glutamate to the fish meat when cooking it, because the fish itself is delicious. It should be kept in mind that the fish is a food which aggravates or induces diseases and therefore is not suitable for those with chronic illnesses.

23. Wild/Ecological Shrimp/Crab Type Restaurant Module

In a preferred technical embodiment of the present invention, a wild/ecological shrimp/crab type restaurant module is provided. The wild/ecological shrimp/crab type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a shrimp/crab. Seen from afar, the wild/ecological shrimp/crab type restaurant module looks like a giant shrimp/crab standing or lying against the roads of the scenic spots. In the present invention, aquatic weeds are provided as podium buildings of the shrimp/crab type house artistic module. The walls, doors, windows, balconies, roofs, and internal/external decorations of the shrimp/crab type house artistic module profile are artistic portrayal of wild/ecological animals and plants or in consistent environmental colors. The walkways, bedrooms, kitchens, toilets, and various pipelines, etc., inside the shrimp/crab type house artistic module are fabricated by combining the inner structure of the conventional house with characteristics of the wild/ecological animals and plants. Thereby, the whole wild/ecological shrimp/crab type restaurant module is actually a shrimp/crab type house artistic module manufactured by construction, decoration, painting, and photography materials. As such, the consumers indeed experience and consume in the shrimp/crab type house artistic module.

Upon actual requirements, a wild/ecological shrimp/crab type restaurant module is provided during the removal/rebuild of old/dilapidated houses in urban areas. The wild/ecological shrimp/crab type restaurant modules of the present invention are provided with shrimp/crab type windows, huge paintings, huge relief sculptures, or glass decorative paintings. Besides, shrimp/crab type sculptures are provided for the view of the consumers, and cartoon shrimp/crab type electric toys are provided for the children to play with. The welcome portals are decorated into doors with shrimp/crab pictures. Leisure tables, chairs, gardening, parergon, and cross-sectional shrimps/crab ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological shrimp/crab type restaurant module and actual requirements. The welcoming hall is decorated with sculptures shrimp/crab. In business places, for instance, the hall is decorated with pictures portraying beautiful shrimps/crabs prowling in the water, and paintings/photographs about ecological shrimps/crabs pastured beside mountain streams and grass. The private rooms are decorated with stories about shrimps/crabs in the form of Comics, animations, cartoons, or traditional Chinese paintings. Decorations, toys, and souvenirs of the dining tables, chairs, and children dining chairs of the restaurant are meant to demonstrate the living environment of wild/ecological shrimps/crabs as well as folk cultural features of shrimps/crabs.

The Chinese-style, fast-food, buffet, and floating-type wild/ecological shrimp/crab type restaurant modules provided by the present invention can be replicated to form chain-stores and provided with professional or vocational dietary instructors, assistants, and waiters.

The fast-food and buffet style wild/ecological shrimp/crab type restaurant modules of the present invention supply shrimp/crab meat & vegetable hamburger in shaped of a shrimp/crab, fast-food of shrimp/crab meat & vegetable assorted cold dishes, spiced shrimp/crab meat, smoked shrimp/crab meat, sauced shrimp/crab meat, roasted shrimp/crab meat, salted shrimp cooked with pork, tomato and egg soup, and shrimp soup with fresh mushrooms.

In the present invention, the Chinese-style wild/ecological shrimp/crab type restaurant modules supply shrimp/crab braised in soy sauce, hot-pot shrimp/crab, spicy-hot shrimp/crab, spicy shrimp/crab, mild-spicy shrimp/crab, non-spicy shrimp/crab, steamed shrimp/crab, and water-boiled shrimp/crab. To cater for different consumers, other vegetables, meat, and fruit are provided.

In the present invention, various types of shrimp/crab from different producing areas are purchased at different prices, then processed in varied methods, and sold at different prices. Shrimps/crabs of different values may be provided by different breeds and different taming environments. The wild/ecological shrimp/crab type restaurant module may put forward dishes at different prices based on shrimp/crab products of varied quality.

In the present invention, text tablets inscribed with “wild/ecological shrimp/crab restaurant” are provided. Besides, advertising films of wild/ecological shrimp/crabs are provided with the following main content: the life-span, birth, evolution, taming, worldwide breeds, food chains, natural enemies, dietary and medical values, nutrition components of shrimps/crabs, and their contribution to the human body.

The nutritive value of the shrimp is revealed as follows. The shrimp meat has always been regarded as a food of delicious taste and having effect of restoring and strengthening Yang. The shrimp has the following efficacies. The shrimp contains extremely rich nutrition and protein several times to dozens of times of that in the fish, egg, and milk. Besides, the shrimp contains rich minerals such as K, I, Mg, and P and other ingredients such as vitamin A and euphylline with the same soft and digestible meat as the fish, and thus is still an excellent nutrient for old people, and a wonderful food for those who are weak and need the aftercare. The Mg has an important regulating effect on the heart activity and good protection of the cardiovascular system. It is capable of reducing the cholesterol content in the blood, preventing the arteriosclerosis, and meanwhile dilating the coronary artery and favoring the prevention of high blood pressure and myocardial infarction. The shrimp contains rich Mg, and thus a frequent intake thereof may supplement the deficiency of Mg. The shrimp has a strong effect of stimulating milk secretion and contains rich P and Ca, and thus has a tonifying efficacy especially on children and pregnant women. Scientists from Osaka University of Japan have recently discovered that the astaxanthin in the shrimp body helps to eliminate the “jet lag” resulted from the time difference reaction. The shrimp shell has a sedative effect and is often used to treat various diseases such as the neurasthenia and vegetative nerve functional disturbance. Among others, for old people, a frequent intake of the shrimp shell may prevent the osteoporosis caused by the calcium deficiency of their own, and some shrimp shells in meals of old people are good for both improving the appetite and building up the health. The shrimp roe (the shrimp egg) contains the high protein and has a good efficacy of supporting Yang, and therefore can be frequently eaten by those with kidney deficiency. The shrimp is eatable for both young and old, especially for middle-aged and aged people, pregnant women, and patients with cardiovascular diseases, at a proper amount of 30-50 g each meal. It should be noted that the shrimp is a food which aggravates or induces diseases and is inedible for people with inveterate diseases. The shrimp is inedible when getting excessive internal heat. For few old people, especially some patients with anaphylactic diseases, such as the allergic rhinitis, bronchitis, and recurrent allergic dermatitis, the shrimp is inedible.

The nutritive value of the crab is revealed as follows. There are over 500 kinds of crabs. The crab is surprisingly delicious with rich nutrition, is a tonic for the high protein, and is of great benefit to the body. The crab has the following efficacies. The crab contains rich protein and trace element and has a good nourishing effect on the body. It has been discovered in the research from recent years that, the crab also has an antitubercular effect, so that an intake of the crab is tonifying for the healing of the tuberculosis. The freshwater crab is generally thought to be good for medical use, while the seawater crab is only for diet. In traditional Chinese medicine, the crab is considered to have the efficacies of heat-clearing and detoxifying, mending bond and adding marrow, nourishing the muscle and tendon and invigorating the circulation of blood, dredging main and collateral channels, benefiting podite, healing the wound, nourishing the liver Yin, and supplementing the gastric juice. The crab has a certain dietetic treatment effect on diseases such as the gore, injury, icterus, lumbago and scelalgia, and rheumatoid arthritis. The crab is eatable for ordinary people, at a proper amount of around 80 g each meal. It should be noted that the crab is salted and cold in nature and is also a saprovore. Therefore, the crab must be dipped in the minced ginger and vinegar juice to dispel cold and be sterilized and is not suitable for being eaten alone. Lots of bacteria and toxins are contained in the gill, sandbag, and internal organs of the crab and must be removed when eating. The crab which is not well-done such as wine-preserved or salted crab is inedible and should be eaten after steamed and hard-boiled. The well-done over-stored crab is also inedible. The crab meat is cold in nature and cannot be eaten too much, especially for those with spleen and stomach deficiency and cold. A drinking of tea during eating the crab and in 1 hour after eating the crab is avoided. The crab cannot be eaten with the persimmon. The crab is not suitable for patients suffering from the cold, fever, stomachache, and diarrhea and people with the inflammation of digestive canal, ulcer, cholecystitis, gall-stone, or at the active stage of hepatitis. People suffering from the coronary heart disease, high blood pressure, arteriosclerosis, and hyperlipemia should eat less or no crab spawn and less crab meat. The crab is inedible for people with allergic constitution. The crab meat is cold and has the effect of invigorating the circulation of blood and expelling the gore, and therefore is harmful to pregnant women, especially the crab claw which has an apparent abortion effect.

24. Wild/Ecological Shellfish/Snail Type Restaurant Module

In a preferred technical embodiment of the present invention, a wild/ecological shellfish/snail type restaurant module is provided. The wild/ecological shellfish/snail type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a shellfish/snail. Seen from afar, the wild/ecological shellfish/snail type restaurant module looks like a giant wild shellfish/snail standing or lying against the roads of the scenic spots. In the present invention, aquatic weeds, sand and stones are provided as podium buildings of the shellfish/snail type house artistic module. The walls, doors, windows, balconies, roofs, and internal/external decorations of the shellfish/snail type house artistic module profile are artistic portrayal of wild/ecological animals and plants or in consistent environmental colors. The walkways, bedrooms, kitchens, toilets, and various pipelines, etc., inside the shellfish/snail type house artistic module are fabricated by combining the inner structure of the conventional house with characteristics of the wild/ecological animals and plants. Thereby, the whole wild/ecological shellfish/snail type restaurant module is actually a shellfish/snail type house artistic module manufactured by construction, decoration, painting, and photography materials. As such, the consumers indeed experience and consume in the shellfish/snail type house artistic module.

Upon actual requirements, a wild/ecological shellfish/snail type restaurant module is provided during the removal/rebuild of old/dilapidated houses in urban areas. The wild/ecological shellfish/snail type restaurant modules of the present invention are provided with shellfish/snail type windows, huge paintings, huge relief sculptures, or glass decorative paintings. Besides, shellfish/snail type sculptures are provided for the view of the consumers, and cartoon shellfish/snail type electric toys are provided for the children to play with. The welcome portals are decorated into doors with shellfish/snail pictures. Leisure tables, chairs, gardening, parergon, and cross-sectional shellfishes/snail ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological shellfish/snail type restaurant module and actual requirements. The welcoming hall is decorated with shellfish/snail sculptures. In business places, for instance, the hall is decorated with pictures portraying shellfishes/snails playing in the seawater, and paintings/photographs about ecological shellfishes/snails pastured beside mountain streams and grass. The private rooms are decorated with stories about shellfishes/snails in the form of Comics, animations, cartoons, or traditional Chinese. Decorations, toys, and souvenirs of the dining tables, chairs, and children dining chairs of the restaurant are meant to demonstrate the living environment of wild/ecological shellfishes/snails as well as folk cultural features of shellfishes/snails.

The Chinese-style, fast-food, buffet, and floating-type wild/ecological shellfish/snail type restaurant modules provided by the present invention can be replicated to form chain-stores and provided with professional or vocational dietary instructors, assistants, and waiters.

The fast-food and buffet style wild/ecological shellfish/snail type restaurant modules of the present invention supply shellfish/snail meat & vegetable hamburger in shape of a shellfish/snail, fast-food of shellfish/snail meat & vegetable assorted cold dishes, spiced shellfish/snail meat, smoked shellfish/snail meat, sauced shellfish/snail meat, roasted shellfish/snail meat, and shellfish/snail soup with fresh mushrooms.

In the present invention, the Chinese-style wild/ecological shellfish/snail type restaurant modules supply shellfish/snail meat in braised soy sauce, hot-pot shellfish/snail meat, spicy-hot shellfish/snail meat, spicy shellfish/snail meat, mild-spicy shellfish/snail, non-spicy shellfish/snail meat, steamed shellfish/snail, and water-boiled shellfish/snail. To cater for different consumers, other vegetables, meat, and fruit are provided.

In the present invention, various types shellfish/snail from different producing areas are purchased at different prices, then processed in varied methods, and sold at different prices. Shellfishes/snails of different values may be produced by different breeds and different taming environments. The wild/ecological shellfish/snail type restaurant module may put forward dishes at different prices based on shellfish/snail products of varied quality.

In the present invention, text tablets inscribed with “wild/ecological shellfish/snail restaurant” are provided. Besides, advertising films of wild/ecological shellfishes/snails are provided with the following main content: the life-span, birth, evolution, taming, worldwide breeds, food chains, natural enemies, dietary and medical values, nutrition components of shellfishes/snails, and their contribution to the human body.

The nutritive value of the shellfish/snail is revealed as follows. Various shellfishes and snails on the dining table are high in trace element, Fe, and Ca, and are important food sources of some nutrients. The shellfish/snail has the following efficacies. The shellfish contains rich trace elements such as K, I, Mg, and P and ingredients such as vitamin A and euphylline, has the same soft and digestible meat as the fish, and thus is still an excellent nutrient for the health of the old, and a wonderful food for those who are weak and need the aftercare. A large amount of Ca and P elements are contained in their meat and shells. A frequent intake may supplement the deficiency of osteoplastic elements, contribute to the growth and development, and effectively prevent and cure the osteoporosis. The shellfish contains rich Mg, which has an important regulating effect on the heart activity and good protection of the cardiovascular system. It is capable of reducing the cholesterol content in the blood, preventing the arteriosclerosis, and meanwhile dilating the coronary artery and favoring the prevention of high blood pressure and myocardial infarction. The shellfish contains signature nutrients such as nicotinic acid, vitamin B6, and vitamin E, and has the effect of reducing the cholesterol in the blood serum and delaying aging. The shellfish is eatable for all people including those with high cholesterol and hyperlipemia, at a proper amount of around 50 g each meal. It should be noted that never add the sodium glutamate or much salt when cooking the shellfish, so as not to lose the flavor, because the shellfish itself is amply delicious. The slimy guts and sandbags in the shellfish must be eliminated. It should be noted that never eat the shellfish food which is not well-done in a lust for the flavor, thus avoiding being infected with hepatitis and other diseases. This kind of food generally aggravates or induces diseases, so that people with inveterate diseases should eat it with caution. The shellfish is mostly cold in nature, so that people with spleen and stomach deficiency and cold should not eat much. The field snail has thick and exquisite meat and delicious taste and is refreshing and tasty, which serves as not only a dish on the banquet but also a distinctive snack in the street snack booth, and is much loved by urban and rural residents. The snail has the reputation of “pearl in the plate” and contains rich protein and vitamin as well as amino acids and trace elements necessary to the human body, and therefore is a typical natural and animalized healthcare food with high protein, low fat, and high Ca. The snail contains low heat and is an ideal food for dieters. The snail meat has efficacies of reducing fever and improving eyesight as well as promoting urination, and has a dietetic treatment effect on diseases such as the conjunctival congestion, icterus, dermatophytosis, and hemorrhoids. In addition, the field snail has certain effect on the armpit odor. The snails are eatable for ordinary people, at a proper amount of 8 field snails (about 40 g) each meal, and 3 sea snails (about 30 g) each meal. It should be noted that in order to prevent the infection of germs and parasites, the snails must be hard-boiled, generally for over 10 minutes. The dead snail is inedible. Since the field snail is cold in nature, those having a poor digestion and old people and children should eat it moderately to avoid the indigestion. In addition, people with a cold stomach should refrain from eating it to prevent harm to the body. The secretion of cranial nerves of the sea snail may cause a food poisoning. The food poisoning caused by the sea snail has a short latent period (1 to 2 hours) with symptoms of sickness, spewing, and dizziness. Therefore, the head of the sea snail must be removed before cooking. The snails are also food which aggravates or induces diseases, so that patients with an allergic history and pyogenic infection of skin should refrain from eating them. The snail is not suitable for being taken with the Chinese medicine gecko and western medicine terramycin.

25. Standardized Wild/Ecological Sea Cucumber/Abalone Restaurant Module

In a preferred technical embodiment of the present invention, a wild/ecological sea cucumber/abalone type restaurant module is provided. The wild/ecological sea cucumber/abalone type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a sea cucumber/abalone. Seen from afar, the wild/ecological sea cucumber/abalone type restaurant module looks like a giant sea cucumber/abalone standing or lying against the roads of the scenic spots. In the present invention, seawater and sand and stones are provided as podium buildings of the sea cucumber/abalone type house artistic module. The walls, doors, windows, balconies, roofs, and internal/external decorations of the sea cucumber/abalone type house artistic module profile are artistic portrayal of wild/ecological animals and plants or in consistent environmental colors. The walkways, bedrooms, kitchens, toilets, and various pipelines, etc., inside the sea cucumber/abalone type house artistic module are fabricated by combining the inner structure of the conventional house with characteristics of the wild/ecological animals and plants. Thereby, the whole wild/ecological sea cucumber/abalone type restaurant module is actually a sea cucumber/abalone type house artistic module manufactured by construction, decoration, painting, and photography materials. As such, the consumers indeed experience and consume in the sea cucumber/abalone type house artistic module.

Upon actual requirements, a wild/ecological sea cucumber/abalone type restaurant module is provided during the removal/rebuild of old/dilapidated houses in urban areas. The wild/ecological sea cucumber/abalone type restaurant modules of the present invention are provided with sea cucumber/abalone type windows, huge paintings, huge relief sculptures, or glass decorative paintings. Besides, sea cucumber/abalone type sculptures are provided for the view of the consumers, and cartoon sea cucumber/abalone type electric toys are provided for the children to play with. The welcome portals are decorated into doors with sea cucumber/abalone pictures. Leisure tables, chairs, gardening, parergon, and cross-sectional sea cucumber/abalone ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological sea cucumber/abalone type restaurant module and actual requirements. The welcoming hall is decorated with sea cucumber/abalone sculptures. In business places, for instance, the hall is decorated with pictures portraying sea cucumbers/abalones playing in the beautiful seawater, and paintings/photographs about ecological sea cucumbers/abalones pastured beside mountain streams and grass. The private rooms are decorated with stories about sea cucumbers/abalones in the form of comics, animations, cartoons, or traditional Chinese paintings. Decorations, toys, and souvenirs of the dining tables, chairs, and children dining chairs of the restaurant are meant to demonstrate the living environment of wild/ecological sea cucumbers/abalones as well as folk cultural features of sea cucumbers/abalones.

The Chinese-style, fast-food, buffet, and floating-type wild/ecological sea cucumber/abalone type restaurant modules provided by the present invention can be replicated to form chain-stores and provided with professional or vocational dietary instructors, assistants, and waiters.

The fast-food and buffet style standardized wild/ecological sea cucumber/abalone restaurant module of the present invention supply sea cucumber/abalone meat & vegetable hamburger in shape of a sea cucumber/abalone, fast-food of sea cucumber/abalone meat & vegetable assorted cold dishes, spiced sea cucumber/abalone, smoked sea cucumber/abalone, sauced sea cucumber/abalone, roasted sea cucumber/abalone, steamed sea cucumber/abalone, tomato and egg soup, and fresh mushroom & vegetable soup.

In the present invention, the Chinese-style wild/ecological sea cucumber/abalone type restaurant modules supply sea cucumber/abalone braised in soy sauce, hot-pot sea cucumber/abalone, spicy-hot sea cucumber/abalone, spicy sea cucumber/abalone, mild-spicy sea cucumber/abalone, non-spicy sea cucumber/abalone, and steamed sea cucumber/abalone. To cater for different consumers, other vegetables, meat, and fruit are provided.

In the present invention, various types of sea cucumber/abalone from different producing areas are purchased at different prices, then processed in varied methods, and sold at different prices. Sea cucumbers/abalones of different values may be produced by different breeds and different taming environments. The wild/ecological sea cucumber/abalone type restaurant module may put forward dishes at different prices based on sea cucumber/abalone products of varied quality.

In the present invention, text tablets inscribed with “wild/ecological sea cucumber/abalone restaurant” are provided. Besides, advertising films of wild/ecological sea cucumbers/abalones are provided with the following main content: the life-span, birth, evolution, taming, worldwide breeds, food chains, natural enemies, dietary and medical values, nutrition components of sea cucumbers/abalones, and their contribution to the human body.

The nutritive value of the sea cucumber is revealed as follows. The sea cucumber, also called beche-de-mer and sea slug, has low cholesterol and relatively low fat content, and therefore is a typical food with high protein, low fat, and low cholesterol, an excellent dietetic treatment for patients with high blood pressure, coronary heart disease, and hepatitis as well as the old, and is a great help to illness treatment and body strengthening. The chondroitin sulfate contained in the sea cucumber is helpful to the growth and development of the human body, capable of delaying muscle aging and strengthening the body immunity. The sea cucumber ranks first among various foods in the content of trace element V which may participate in the transport of Fe in the blood and strengthen the hematopoietic function. Recently, American researchers have extracted a special substance, namely, sea cucumber toxin, from the sea cucumber. This compound is capable of effectively inhibiting the growth and transfer of many kinds of mould fungi and some human cancer cells. An intake of the sea cucumber is effective in the aplastic anemia, diabetes, and gastric ulcer. In traditional Chinese medicine, the sea cucumber is considered to have the effects of nourishing kidney and enriching essence, eliminating dampness and strengthening Yang, nourishing blood and moistening dryness, and relaxing bowels and promoting urination. The sea cucumber is eatable for ordinary people and for those with deficiency of energy, deficiency of qi and blood, ascites due to cirrhosis, and neurasthenia, at a proper amount of 50-100 g swollen product each meal. It should be noted that since the sea cucumber is lubricating in nature, people having weak spleen and stomach, abundance of phlegm and loose bowels must not eat it. The sea cucumber is not suitable for being taken with the liquorice. The nutritive value of the abalone is revealed as follows. The abalone has a high nutritive value and contains rich globulin in its meat. Being a hypobenthos, the abalone has the efficacy of nourishing Yin and tonifying. In traditional Chinese medicine, the abalone is thought to be a marine product tonifying without causing dryness and without any side effect of toothache or nosebleed, and has no harm in eating more. Besides, an ingredient called “abalone essence” is contained in the abalone meat and can destroy the metabolism substance necessary to the cancer cell. The abalone is also an anticancer food on the dining table. The effect of the abalone is not depressurization but bi-directional blood pressure regulation, because the abalone is capable of “nourishing Yin, calming liver, and strengthening kidney”, and adjusting the adrenal gland secretion. The abalone has effects of regulating menstruation and moistening dryness to clean intestines, and may cure sufferings such as irregular menstruation and constipation. The abalone is eatable for ordinary people, and particularly for those with frequent nocturnal urination, Qi deficiency and asthma, blood pressure destabilization, and distracted mind. The abalone may also be used as an adjuvant therapy for diabetic patients and must be braised with medicine to be effective. One abalone is taken each meal. It should be noted that the abalone must be cooked thoroughly. Someone gets a stomachache whenever eating the abalone, that is because the high protein thereof is difficult to digest. Not the abalone meat but a little soup is suitable for patients with the gout and high uric acid. Although everyone likes the abalone, it is inedible for people having the cold and fever or Yin deficiency and laryngalgia.

26. Wild/Ecological Tortoise Type Restaurant Module

In a preferred technical embodiment of the present invention, a wild/ecological tortoise type restaurant module is provided. The wild/ecological tortoise type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a tortoise. Seen from afar, the wild/ecological tortoise type restaurant module looks like a giant wild tortoise standing or lying against the roads of the scenic spots. In the present invention, water grass and rocks are provided as podium buildings of the tortoise type house artistic module. The walls, doors, windows, balconies, roofs, and internal/external decorations of the tortoise type house artistic module profile are artistic portrayal of wild/ecological animals and plants or in consistent environmental colors. The walkways, bedrooms, kitchens, toilets, and various pipelines, etc., inside the tortoise type house artistic module are fabricated by combining the inner structure of the conventional house with characteristics of the wild/ecological animals and plants. Thereby, the whole wild/ecological tortoise type restaurant module is actually a tortoise type house artistic module manufactured by construction, decoration, painting, and photography materials. As such, the consumers indeed experience and consume in the tortoise type house artistic module.

Upon actual requirements, a wild/ecological tortoise type restaurant module is provided during the removal/rebuild of old/dilapidated houses in urban areas. The wild/ecological tortoise type restaurant modules of the present invention are provided with tortoise type windows, huge paintings, huge relief sculptures, or glass decorative paintings. Besides, tortoise type sculptures are provided for the view of the consumers, and tortoise type electric toys are provided for the children to play with. The service for teasing the tortoise is provided. The welcome portals are decorated into doors with tortoise pictures. Leisure tables, chairs, gardening, parergon, and cross-sectional tortoise ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological tortoise type restaurant module and actual requirements. The welcoming hall is decorated with tortoise sculptures. In business places, for instance, the hall is decorated with pictures portraying a tortoise crowd playing in hills and ponds, and paintings/photographs about ecological tortoises pastured beside streams and grass. The private rooms are decorated with stories about tortoises in the form of comics, animations, cartoons, or traditional Chinese paintings. Decorations, toys, and souvenirs of the dining tables, chairs, and children dining chairs of the restaurant are meant to demonstrate the living environment of wild/ecological tortoises as well as folk cultural features of tortoises.

The Chinese-style, fast-food, buffet, and floating-type wild/ecological tortoise type restaurant modules provided by the present invention can be replicated to form chain-stores and provided with professional or vocational dietary instructors, assistants, and waiters.

The fast-food and buffet style wild/ecological tortoise type restaurant modules of the present invention supply tortoise meat & vegetable hamburger in shape of a tortoise, fast-food of tortoise meat & vegetable assorted cold dishes, spiced tortoise meat, smoked tortoise meat, sauced tortoise meat, roasted tortoise meat, tomato and egg soup, and tortoise soup with fresh mushrooms.

In the present invention, the Chinese-style wild/ecological tortoise type restaurant modules supply tortoise meat braised in soy sauce, hot-pot tortoise meat, spicy-hot tortoise meat, spicy tortoise meat, mild-spicy tortoise meat, non-spicy tortoise meat, stewed tortoise with chicken, stewed tortoise with rock pigeon, and stewed tortoise meat. To cater for different consumers, other vegetables, meat, and fruit are provided.

In the present invention, various types of tortoise from different producing areas are purchased at different prices, then processed in varied methods, and sold at different prices. Tortoises of different values may be produced by different breeds and different taming environments. The wild/ecological tortoise type restaurant module may put forward dishes at different prices based on tortoise products of varied quality.

In the present invention, text tablets inscribed with “wild/ecological tortoise meat restaurant” are provided. Besides, advertisings film of wild/ecological tortoises are provided with the following main content: the life-span, birth, evolution, taming, worldwide breeds, food chains, natural enemies, dietary and medical values, nutrition components of tortoises, and their contribution to the human body.

The nutritive value of the tortoise is revealed as follows. The tortoise meat is delicious in taste with rich nutrition. As the ancient saying goes, the tortoise contains five kinds of meat. That is, the tortoise meat has the taste and nutrition of five kinds of meat, namely, beef, mutton, pork, chicken, and fish. Modern science has shown that, every 100 g tortoise meat contains 16.5 g protein, 1.0 g fat, and 1.6 g saccharide, and is rich in various nutritional ingredients such as VA, VB1, VB2, fatty acid, myoinositol, K, and Na required by the human body. From ancient to now, the tortoise is used as a high-grade tonic and an excellent dietetic treatment for preventing and curing diseases. Especially the food which is cooked with the tortoise meat as the main ingredient, such as tortoise meat braised in soy sauce, tortoise meat congee, and clear-simmered tortoise with chicken, has become fashionable and delicious precious dishes on high-grade banquets. The herbal meals cooked by the tortoise meat with many kinds of Chinese medicines, such as the tortoise soup with matrimony vine, tortoise soup with ginseng, and tortoise soup with angelica, are especially regarded as the treasure among dishes. The dishes and soup thereof are delicious and tasty and are suitable for both young and old. In addition to the dietary value, the largest value of the tortoise lies in medical use. As far back as in the Qin and Han dynasties, the first book specialized in the materia medica of our country “ShenNong's Herbal Classic” has recorded the medical use of the tortoise in detail. The great medical scientist Li Shizhen in the Ming dynasty recorded in his “Compendium of Materia Medica” that, “the tortoise is the most intelligent and long-lived among 360 kinds of crustaceans.” “The tortoise is capable of opening up the Ren meridian, and thus the shell thereof is used to invigorate the heart, tonify the kidney, and enrich the blood so as to nourish Yin.” He pointed out that, “The tortoise shell has the same detoxification and fever-reducing effect as the rhinoceros horn.” The tortoise meat is sweet in taste, salty, neutral, warm in nature, and has the effect of strengthening the kidney, invigorating the heart, and strengthening Yang. The tortoise mainly treats tuberculosis consumptive diseases and bone steaming, chronic cough and emptysis, blood dysentery, arthralgia and myalgia, and post-illness Yin deficiency and weak blood circulation, and has a good effect especially on children weakness and postpartum weakness, hysteroptosis, and sexual hypofunction of women. The shell thereof is fishy in smell, salty in taste, and cold in nature, and mainly consists of ossein, protein, fat, calcium, phosphorus, peptides, and many kinds of enzymes as well as many kinds of trace elements necessary to the human body. The shell has a variety of efficacies of nourishing Yin to reduce pathogenic fire, suppressing Yang and reducing heat, tonifying the kidney and strengthening the bones, and nourishing the blood and invigorating the heart. According to research, the tortoise shell also has a certain effect on the tumor. The tortoise blood may be used to cure the rectocele and injuries from falls. The wine with the blood thereof and white sugar may cure the tracheitis, dry cough, and asthma. The scientific research shows that, the tortoise blood also has the function of inhibiting tumor cells. The bile thereof is bitter in taste and cold in nature, and mainly treats post-pox eye edema and menstruation obstruction. Modern medical research also shows that, the bile has inhibitive effect on the sarcoma. The bone thereof mainly treats the chronic cough. The head thereof may cure the sequela of cerebral concussion, dizziness, and headache. The skin thereof mainly treats blood diseases and relieves drug poison. It was also used to treat the knife and arrow poison in ancient times. The urine thereof may be dropped in the ear to treat deafness, and has a dramatic effect on treating adult stroke, dull tongue, and children convulsion and aphasia by dropping little tortoise urine under the tongue.

27. Wild/Ecological Frog Type Restaurant Module

In a preferred technical embodiment of the present invention, a wild/ecological frog type restaurant module is provided. The wild/ecological frog type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a frog. Seen from afar, the wild/ecological frog type restaurant module looks like a giant wild frog standing or lying against the roads of the scenic spots. In the present invention, rocks and aquatic weeds are provided as podium buildings of the frog type house artistic module. The walls, doors, windows, balconies, roofs, and internal/external decorations of the frog type house artistic module profile are artistic portrayal of wild/ecological animals and plants or in consistent environmental colors. The walkways, bedrooms, kitchens, toilets, and various pipelines, etc., inside the frog type house artistic module are fabricated by combining the inner structure of the conventional house with characteristics of the wild/ecological animals and plants. Thereby, the whole wild/ecological frog type restaurant module is actually a frog type house artistic module manufactured by construction, decoration, painting, and photography materials. As such, the consumers indeed experience and consume in the frog type house artistic module.

Upon actual requirements, a wild/ecological frog type restaurant module is provided during the removal/rebuild of old/dilapidated houses in urban areas. The wild/ecological frog type restaurant modules of the present invention are provided with frog type windows, huge paintings, huge relief sculptures, or glass decorative paintings. Besides, frog type sculptures are provided for the view of the consumers, and frog type electric toys are provided for the children to play with. The service for teasing the frog is provided. The welcome portals are decorated into doors with frog pictures. Leisure tables, chairs, gardening, parergon, and cross-sectional frog ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological frog type restaurant module and actual requirements. The welcoming hall is decorated with frog sculptures. In business places, for instance, the hall is decorated with pictures portraying a frog crowd playing in hills and ponds, and paintings/photographs about ecological frogs pastured beside streams and grass. The private rooms are decorated with stories about frogs in the form of comics, animations, cartoons, or traditional Chinese paintings. Decorations, toys, and souvenirs of the dining tables, chairs, and children dining chairs of the restaurant are meant to demonstrate the living environment of wild/ecological frogs as well as folk cultural features of frogs.

The Chinese-style, fast-food, buffet, and floating-type wild/ecological frog type restaurant modules provided by the present invention can be replicated to form chain-stores and provided with professional or vocational dietary instructors, assistants, and waiters.

The fast-food and buffet style wild/ecological frog type restaurant modules of the present invention supply frog meat & vegetable hamburger in shape of a frog, fast-food of frog meat & vegetable assorted cold dishes, spiced frog meat, smoked frog meat, sauced frog meat, roasted frog meat, tomato and egg soup, and fresh mushroom & vegetable soup.

In the present invention, the Chinese-style wild/ecological frog type restaurant modules supply frog meat braised in soy sauce, hot-pot frog meat, spicy-hot frog meat, spicy frog meat, mild-spicy frog meat, non-spicy frog meat, steamed frog meat, and clear-simmered frog meat. To cater for different consumers, other vegetables, meat, and fruit are provided.

In the present invention, various types of frog from different producing areas are purchased at different prices, then processed in varied methods, and sold at different prices. Frogs of different values may be produced by different breeds and different taming environments. The wild/ecological frog type restaurant module may put forward dishes at different prices based on frog products of varied quality.

In the present invention, text tablets inscribed with “wild/ecological frog meat restaurant” are provided. Besides, advertising films of wild/ecological frogs are provided with the following main content: the life-span, birth, evolution, taming, worldwide breeds, food chains, natural enemies, dietary and medical values, nutrition components of frogs, and their contribution to the human body.

The nutritive value of the field chicken is revealed as follows. The field chicken also called the frog, forest frog, water chicken, rock chicken, and sitting fish, and including common frogs and bullfrogs, gets the name because the meat thereof is tender and better than the chicken. The field chicken contains rich protein, saccharide, water, and little fat, and is delicious in taste which is fresh in spring and delicious in autumn, and therefore is a delicacy on the dining table. However, they are beneficial animals, and cultivated frogs for food exist now. Therefore, it is recommended not to eat wild frogs. The frog has the following efficacies. The frog is considered a nutritional food greatly invigorating primordial Qi and treating spleen deficiency and suitable for deficiency of energy, hypoproteinemia, and various Yin deficiency symptoms among the people. The frog contains rich protein, Ca, and P, and is beneficial to the growth and development of teenagers and menopausal osteoporosis. For people with the cardial or renal edema, the dietetic treatment of the frog has a good efficacy of promoting urination for removing edema. The frog contains trace elements such as Zn and Se, and antioxides such as vitamin E which can delay the body aging and moisten the skin and have the efficacy of cancer prevention and anticancer. The frog is eatable for ordinary people, especially for patients weak and having edema and neurasthenia, at a proper amount of around 40 g each meal. It should be noted that the frog easily contains the eggs of parasites, and therefore must be well-done before eating.

28. Wild/Ecological Insect Type Restaurant Module

In a preferred technical embodiment of the present invention, a wild/ecological insect type restaurant module is provided. The wild/ecological insect type restaurant module is preferably set aside main arteries of the scenic spots at rural-urban fringe areas, so as to meet the requirements of tourism and urban leisure consumers in drive. The present invention adopts bionic techniques and arts to fabricate a house model imitating an insect. Seen from afar, the wild/ecological insect type restaurant module looks like a giant insect standing or lying against the roads of the scenic spots. In the present invention, flowers, grass, and trees are provided as podium buildings of the insect type house artistic module. The walls, doors, windows, balconies, roofs, and internal/external decorations of the insect type house artistic module profile are artistic portrayal of wild/ecological animals and plants or in consistent environmental colors. The walkways, bedrooms, kitchens, toilets, and various pipelines, etc., inside the insect type house artistic module are fabricated by combining the inner structure of the conventional house with characteristics of the wild/ecological animals and plants. Thereby, the whole wild/ecological insect type restaurant module is actually an insect type house artistic module manufactured by construction, decoration, painting, and photography materials. As such, the consumers indeed experience and consume in the insect type house artistic module.

Upon actual requirements, a wild/ecological insect type restaurant module is provided during the removal/rebuild of old/dilapidated houses in urban areas. The wild/ecological insect type restaurant modules of the present invention are provided with insect type windows, huge paintings, huge relief sculptures, or glass decorative paintings. Besides, insect type sculptures are provided for the view of the consumers, and insect type electric toys are provided for the children to play with. The service for experiencing the insect fighting is provided. The welcome portals are decorated into doors with insect pictures. Leisure tables, chairs, gardening, parergon, and cross-sectional insect ornamental specimens are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological insect type restaurant module and actual requirements. The welcoming hall is decorated with insect sculptures. In business places, for instance, the hall is decorated with pictures portraying insect communities living, and paintings/photographs about ecological insects pastured beside streams and grass. The private rooms are decorated with stories about insects in the form of comics, animations, cartoons, or traditional Chinese paintings. Decorations, toys, and souvenirs of the dining tables, chairs, and children dining chairs of the restaurant are meant to demonstrate the living environment of wild/ecological insects as well as folk cultural features of insects.

The Chinese-style, fast-food, buffet, and floating-type wild/ecological insect type restaurant modules provided by the present invention can be replicated to form chain-stores and provided with professional or vocational dietary instructors, assistants, and waiters.

The fast-food and buffet style wild/ecological insect type restaurant modules of the present invention supply insect meat & vegetable hamburger in shape of insects, fast-food of insect meat & vegetable assorted cold dishes, spiced insect, smoked insect, sauced insect, roasted insect, stir-fried insect, tomato and egg soup, and fresh mushroom & vegetable soup.

In the present invention, the Chinese-style wild/ecological insect type restaurant modules supply insect braised in soy sauce, hot-pot insect, spicy-hot insect, spicy insect, mild-spicy insect, non-spicy insect, braised pork with insects, braised chicken with insects, braised duck with insects, and Sautéed insects. To cater for different consumers, other vegetables, meat, and fruit are provided.

In the present invention, various types of insect from different producing areas are purchased at different prices, then processed in varied methods, and sold at different prices. Insects of different values may be produced by different breeds and different taming environments. The wild/ecological insect type restaurant module may put forward dishes at different prices based on insect products of varied quality.

In the present invention, text tablets inscribed with “wild/ecological insect restaurant” are provided. Besides, advertising films of wild/ecological insects are provided with the following main content: the life-span, birth, evolution, taming, worldwide breeds, food chains, natural enemies, dietary and medical values, nutrition components of insects, and their contribution to the human body.

The nutritive value of the insect is revealed as follows. The silkworm pupa is warm in nature and sweet, spicy, and salty in taste, and has the efficacies of lowering blood fat, lowering blood sugar, making up for deficiency and damage, and strengthening male sexuality. The silkworm pupa is eatable for people with high blood pressure, fatty liver, hyperlipidemia, and diabetes; people with tuberculosis and thin and weak body; people with chronic gastritis and gastroptosis; children with rickets and thin body; middle-aged and aged people with lassitude in loin and knee, frequent nocturnal urination, and impotence and prospermia.

29. Wild/Ecological Bean/Tomato Type Restaurant Module

In a preferred technical embodiment of the present invention, a wild/ecological bean/tomato type restaurant module is provided. The wild/ecological bean/tomato type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a soybean/tomato. Seen from afar, the wild/ecological bean/tomato type restaurant module looks like a giant soybean/tomato standing or lying against the roads of the scenic spots. In the present invention, flowers and grass are provided as podium buildings of the soybean/tomato type house artistic module. The walls, doors, windows, balconies, roofs, and internal/external decorations of the soybean/tomato type house artistic module profile are artistic portrayal of wild/ecological animals and plants or in consistent environmental colors. The walkways, bedrooms, kitchens, toilets, and various pipelines, etc., inside the soybean/tomato type house artistic module are fabricated by combining the inner structure of the conventional house with characteristics of the wild/ecological animals and plants. Thereby, the whole wild/ecological bean/tomato type restaurant module is actually a bean/tomato type house artistic module manufactured by construction, decoration, painting, and photography materials. As such, the consumers indeed experience and consume in the bean/tomato type house artistic module.

Upon actual requirements, a wild/ecological bean/tomato type restaurant module is provided during the removal/rebuild of old/dilapidated houses in urban areas. The wild/ecological bean/tomato type restaurant modules of the present invention are provided with bean/tomato type windows, huge paintings, huge relief sculptures, or glass decorative paintings. Besides, bean/tomato type sculptures are provided for the view of the consumers, and bean/tomato type electric toys are provided for the children to play with. The welcome portals are decorated into doors with bean/tomato pictures. Leisure tables, chairs, gardening, parergon are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological bean/tomato type restaurant module and actual requirements. The welcoming hall is decorated with bean/tomato sculptures. In business places, for instance, the hall is decorated with pictures portraying wild beans/tomatoes on desolate mountains, and paintings/photographs about ecological beans/tomatoes growing beside mountain streams and grass. The private rooms are decorated with stories about beans/tomatoes in the form of comics, animations, cartoons, or traditional Chinese paintings. Decorations, toys, and souvenirs of the dining tables, chairs, and children dining chairs of the restaurant are meant to demonstrate the living environment of wild/ecological beans/tomatoes as well as folk cultural features of beans/tomatoes.

The Chinese-style, fast-food, buffet, and floating-type wild/ecological bean/tomato type restaurant modules provided by the present invention can be replicated to form chain-stores and provided with professional or vocational dietary instructors, assistants, and waiters.

The fast-food and buffet style wild/ecological bean/tomato type restaurant modules of the present invention supply bean/tomato hamburger in shape of a bean/tomato, fast-food of bean/tomato assorted cold dishes, braised pork with beans/tomatoes, spiced dried beancurd, smoked beancurd, sauced dried beancurd, roasted bean cake, bean milk, uncongealed beancurd, beancurd sheet and rice rolls, tomato and egg soup, tomato soup with fresh mushrooms, and potherb cooked in various ways.

In the present invention, the Chinese-style wild/ecological bean/tomato type restaurant modules supply braised pork with beancurd, hot-pot beancurd, spicy-hot beancurd, home-style beancurd, mild-spicy beancurd, non-spicy beancurd, dried kidney beans braised in soy sauce, green kidney beans, braised pork with kidney beans, steamed bun stuffed with kidney beans, steamed bun stuffed with beancurd, dumpling stuffed with beancurd, and potherb cooked in various ways. To cater for different consumers, other vegetables, meat, and fruit are provided.

In the present invention, various types of bean/tomato from different producing areas are purchased at different prices, then processed in varied methods, and sold at different prices. Beans/tomatoes of different values may be produced by different breeds and different taming environments. The wild/ecological bean/tomato type restaurant module may put forward dishes at different prices based on bean/tomato products of varied quality.

In the present invention, text tablets inscribed with “wild/ecological bean/tomato restaurant” are provided. Besides, advertising films of wild/ecological beans/tomatoes are provided with the following main content: the life-span, birth, evolution, taming, worldwide breeds, food chains, natural enemies, dietary and medical values, nutrition components of beans/tomatoes, and their contribution to the human body.

The nutritive value of the bean/tomato is revealed as follows. The yellow beans together with the green beans and black beans are collectively called soybeans which can be used for both food and oil extraction. Due to the high nutritional value, the soybean is called the “king of beans”, “meat in the field”, and “green milk” and is the most highly praised food among hundreds of kinds of natural foods by nutritionist. The fermented products of soybeans, including lobster sauce, bean juice, yellow sauce, and various preserved beancurd, are all made of fermented soybeans or soybean products inoculated with the mould fungi. Factors inhibiting the nutrition are eliminated and a variety of aromatic substances are generated through the action of microorganism on soybeans and products thereof, and thus the soybeans and products thereof are more easily digested and absorbed by the human body. More importantly, the content of vitamin B12 is increased. The soybean has the following efficacies. The trace element such as Cr in the yellow bean has the effect of participating in regulating the glycometabolism and meanwhile facilitating the discharge of excretions from the body to avoid the rising of blood sugar. Therefore, the yellow bean is an ideal food for the diabetic patients. The soybean is rich in anticancer ingredients such as Mo, Se, Zn, and isoflavone which have an inhibitive effect on almost all the cancers such as prostatic cancer, skin cancer, intestinal cancer, and esophagus cancer. This is the reason why people often eating yellow beans and products thereof rarely get cancers. The soybean is also rich in the Ca, P, K, and B elements which have a good preventing and curing effect on the menopausal osteoporosis. An intake of the yellow beans can supplement the B vitamins, S, etc., and is a great help to the skin dryness and roughness and hair dryness, which may improve the skin's metabolism and promote an expelling of toxins of the skin to keep the skin young. The saponins in the yellow bean can reduce the fat absorption function and facilitate the fat metabolism. Besides, the soybean fiber may quicken the process of passing through the intestinal canal of the food, so that those dieters are sure to reduce their body weight if eating yellow beans more. The green bean is mainly eaten when green and has the efficacies of invigorating the liver and nourishing the stomach and tonifying and strengthening the constitution. The black bean has the highest protein content and is rich in Ca, P, B, etc., and helps to grow bones and muscles, delight the face, blacken the hair and improve eyesight, and prolong life. The soybeans are eatable for ordinary people; ideal for menopausal women and patients with diabetes and cardiovascular diseases; and also for brain workers and dieters, at a proper amount of 40 g each day. It should be noted that since raw soybeans contain the antitrypsin and thrombin disadvantageous to the health, they are not suitable for being eaten fresh, and half-cooked yellow beans are also inedible. It should be kept in mind that people suffering from serious hepatopathy, nephropathy, gout, peptic ulcer, arteriosclerosis, and low iodine should refrain from eating the soybeans. The yellow beans will produce excessive gas which causes a stomach swelling in the digestion and absorption process. Therefore, people having the indigestion and chronic digestive diseases should eat as little as possible. Children growing up on the soy milk will have a high risk of triggering diseases of thyroid gland and reproductive system in adult life. According to the research of a specialized agency in United States, this has something to do with the totally different reactions to the phytoestrogen in the soybeans between infants and adults. Thus, the infants are advised to drink less soy milk. The nutritive value of the tomato is revealed as follows. The tomato contains rich renieratene, vitamins B and C, and ranks first among vegetables in the content of vitamin P. The tomato has the following efficacies. The lycopene contains vitamins and mineral elements which have a protective effect on the angiocarpy and can reduce the heart attack. The lycopene has unique antioxidant ability and is able to scavenge free radicals and protect cells, so as to prevent the deoxyribonucleic acid (DNA) and genes from being damaged and prevent the canceration process. In addition to preventing the prostatic cancer, the tomato is able to effectively reduce an outbreak risk of cancers such as the pancreatic cancer, rectal cancer, laryngeal cancer, oral cavity cancer, and breast cancer. The tomato contains vitamin C, and thus has the efficacies of promoting salivation and quenching thirst, strengthening the stomach to promote digestion, cooling blood and calming liver, clearing away heat and toxic material, and reducing blood pressure, and has a good adjuvant therapeutic effect on patients with high blood pressure and kidney diseases. A frequent intake of tomatoes has the effect of anti-aging and keeping the skin fair. The nicotinic acid is able to maintain the normal secretion of gastric juice, facilitate the formation of red blood cells, and favors the maintenance of the elasticity of vessel walls and the protection of skin. Therefore, an intake of tomatoes is also helpful to the prevention and cure of arteriosclerosis, high blood pressure, and coronary heart disease. The tomato is juicy, and can promote urination, thus is suitable for nephritis patients. The tomato is eatable for ordinary people at a proper amount of 2-3 tomatoes each day to meet daily demands. It should be noted that don't boil the tomato for a long time, and add some vinegar during cooking to destroy the harmful substance tomatidine therein. It should be kept in mind that green and unripe tomato is inedible. The tomato is inedible for patients with acute enteritis, bacillary dysentery, and at the active stage of ulcer.

30. Wild/Ecological Potato/Eggplant Type Restaurant Module

In a preferred technical embodiment of the present invention, a wild/ecological potato/eggplant type restaurant module is provided. The wild/ecological potato/eggplant type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a potato/eggplant. Seen from afar, the wild/ecological potato/eggplant type restaurant module looks like a giant potato/eggplant standing or lying against the roads of the scenic spots. In the present invention, grasslands are provided as podium buildings of the potato/eggplant type house artistic module. The walls, doors, windows, balconies, roofs, and internal/external decorations of the potato/eggplant type house artistic module profile are artistic portrayal of wild/ecological animals and plants or in consistent environmental colors. The walkways, bedrooms, kitchens, toilets, and various pipelines, etc., inside the potato/eggplant type house artistic module are fabricated by combining the inner structure of the conventional house with characteristics of the wild/ecological animals and plants. Thereby, the whole wild/ecological potato/eggplant type restaurant module is actually a potato/eggplant type house artistic module manufactured by construction, decoration, painting, and photography materials. As such, the consumers indeed experience and consume in the potato/eggplant type house artistic module.

Upon actual requirements, a wild/ecological potato/eggplant type restaurant module is provided during the removal/rebuild of old/dilapidated houses in urban areas. The wild/ecological potato/eggplant type restaurant modules of the present invention are provided with potato/eggplant type windows, huge paintings, huge relief sculptures, or glass decorative paintings. Besides, potato/eggplant type sculptures are provided for the view of the consumers, and cartoon potato/eggplant type electric toys are provided for the children to play with. The welcome portals are decorated into doors with potato/eggplant pictures. Leisure tables, chairs, gardening, and parergon are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological potato/eggplant type restaurant module and actual requirements. The welcoming hall is decorated with potato/eggplant sculptures. In business places, for instance, the hall is decorated with pictures portraying wild potatoes/eggplants growing on desolate mountains, and paintings/photographs about ecological potatoes/eggplants growing beside mountain streams and grass. The private rooms are decorated with stories about potatoes/eggplants in the form of comics, animations, cartoons, or traditional Chinese paintings. Decorations, toys, and souvenirs of the dining tables, chairs, and children dining chairs of the restaurant are meant to demonstrate the living environment of wild/ecological potatoes/eggplants as well as folk cultural features of potatoes/eggplants.

The Chinese-style, fast-food, buffet, and floating-type wild/ecological potato/eggplant type restaurant modules provided by the present invention can be replicated to form chain-stores and provided with professional or vocational dietary instructors, assistants, and waiters.

The fast-food and buffet style wild/ecological potato/eggplant type restaurant modules supply potato/eggplant and vegetable hamburger in shape of a potato/eggplant, fast-food of potato/eggplant assorted cold dishes, braised beef with potatoes, braised pork with potatoes, stir-fried potato strips, tomato and egg soup, fresh mushroom & vegetable soup, and potherb cooked in various ways.

In the present invention, the Chinese-style wild/ecological potato/eggplant type restaurant modules supply braised beef with potatoes, braised pork with potatoes, braised duck with potatoes, braised pigeon with potatoes, stir-fried potato and green pepper, stir-fried eggplant and green pepper, braised pork with eggplant, steamed eggplant, sauced eggplant, eggplant pancake, and potherb cooked in various ways. To cater for different consumers, other vegetables, meat, and fruit are provided.

In the present invention, various types of potato/eggplant from different producing areas are purchased at different prices, then processed in varied methods, and sold at different prices. Potatoes/eggplants of different values may be produced by different breeds and different taming environments. The wild/ecological potato/eggplant type restaurant module may put forward dishes at different prices based on potato/eggplant products of varied quality.

In the present invention, text tablets inscribed with “wild/ecological potato/eggplant restaurant” are provided. Besides, advertising films of wild/ecological potatoes/eggplants are provided with the following main content: the life-span, birth, evolution, taming, worldwide breeds, food chains, natural enemies, dietary and medical values, nutrition components of potatoes/eggplants, and their contribution to the human body.

The nutritive value of the potato is revealed as follows. The potato is a vegetable used as both foodstuff and dish. It is a food low in heat, and rich in vitamin and trace element, and is an ideal slimming food. Science proves that the food with high K may reduce the incidence of stroke. Every 100 g potato contains up to 300 Mg K. Experts agree that 5 to 6 potatoes per weak may reduce the stroke risk by 40%. In traditional Chinese medicine, the potato is thought to be neutral in nature and sweet in taste, have efficacies of harmonizing stomach and regulating middle Qi, replenishing Qi to invigorate the spleen, strengthening the body and tonifying the kidney, diminishing inflammation, invigorate the circulation of blood, and diminishing edema, and assist in treating the indigestion, habitual constipation, fatigue and asthenia, chronic stomachache, arthralgia, skin eczema, and other diseases. The potato is effective in the adjuvant therapy of indigestion, and is an excellent healthcare food for patients with stomach and heart diseases. The nutritive value of the eggplant is revealed as follows. The eggplant is one of the few purple vegetables, and is a home-style vegetable commonly seen on the dining table. The purple peel thereof contains rich vitamin E and P, in which aspect the eggplant is superior to other vegetables. The eggplant has the following efficacies. The rich vitamin P in the purple eggplant may soften tiny blood vessel and prevent the hemorrhage of small blood vessels, and is beneficial to patients with high blood pressure, arteriosclerosis, emptysis, purpura (subcutaneous hemorrhage, stagnation of blood), and scurvy. The vitamin C and saponin contained in the eggplant fiber have the efficacy of reducing the cholesterol. An intake of eggplants is one of the “12 methods for reducing the cholesterol” proposed by experts and scholars. In addition, the B vitamins contained in the eggplant has a certain adjuvant therapeutic effect on the dysmenorrhea, and chronic gastritis and nephritis with edema.

31. Wild/Ecological Calabash/Capsicum Type Restaurant Module

In a preferred technical embodiment of the present invention, a wild/ecological calabash/capsicum type restaurant module is provided. The wild/ecological calabash/capsicum type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a calabash/capsicum. Seen from afar, the wild/ecological calabash/capsicum type restaurant module looks like a giant calabash/capsicum standing or lying against the roads of the scenic spots. In the present invention, grasslands are provided as podium buildings of the calabash/capsicum type house artistic module. The walls, doors, windows, balconies, roofs, and internal/external decorations of the calabash/capsicum type house artistic module profile are artistic portrayal of wild/ecological animals and plants or in consistent environmental colors. The walkways, bedrooms, kitchens, toilets, and various pipelines, etc., inside the calabash/capsicum type house artistic module are fabricated by combining the inner structure of the conventional house with characteristics of the wild/ecological animals and plants. Thereby, the whole wild/ecological calabash/capsicum type restaurant module is actually a calabash/capsicum type house artistic module manufactured by construction, decoration, painting, and photography materials. As such, the consumers indeed experience and consume in the calabash/capsicum type house artistic module.

Upon actual requirements, a wild/ecological calabash/capsicum type restaurant module is provided during the removal/rebuild of old/dilapidated houses in urban areas. The wild/ecological calabash/capsicum type restaurant modules of the present invention are provided with calabash/capsicum type windows, huge paintings, huge relief sculptures, or glass decorative paintings. Besides, calabash/capsicum type sculptures are provided for the view of the consumers, and calabash/capsicum type electric toys are provided for the children to play with. The welcome portals are decorated into doors with calabash/capsicum pictures. Leisure tables, chairs, gardening, and parergon are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological calabash/capsicum type restaurant module and actual requirements. The welcoming hall is decorated with calabash/capsicum sculptures. In business places, for instance, the hall is decorated with pictures portraying wild calabash/capsicum on desolate mountains, and paintings/photographs about ecological calabash/capsicum growing beside mountain streams and grass. The private rooms are decorated with stories about calabash/capsicum in the form of comics, animations, cartoons, or traditional Chinese paintings. Decorations, toys, and souvenirs of the dining tables, chairs, and children dining chairs of the restaurant are meant to demonstrate the living environment of wild/ecological calabash/capsicum as well as folk cultural features of calabash/capsicum.

The Chinese-style, fast-food, buffet, and floating-type wild/ecological calabash/capsicum type restaurant modules provided by the present invention can be replicated to form chain-stores and provided with professional or vocational dietary instructors, assistants, and waiters.

The fast-food and buffet style wild/ecological calabash/capsicum type restaurant modules of the present invention supply calabash/capsicum type hamburger, fast-food of assorted cold dishes, braised pork with capsicum, steamed calabash, stir-fried capsicum and calabash, tomato and egg soup, and potherb cooked in various ways.

In the present invention, the Chinese-style wild/ecological calabash/capsicum type restaurant modules supply calabash braised in soy sauce, calabash with minced pork, pan-seared green pepper, braised chicken with capsicum, braised duck with capsicum, braised goose with capsicum, stir-fried capsicum and dried beancurd, capsicum with beancurd, stir-fried green pepper and calabash, shredded pork with green pepper, tomato and egg soup, calabash soup with fresh mushrooms, and potherb cooked in various ways. To cater for different consumers, other vegetables, meat, and fruit are provided.

In the present invention, various types of calabash/capsicum from different producing areas are purchased at different prices, then processed in varied methods, and sold at different prices. Bottle gourds/capsicums of different values may be produced by different breeds and different taming environments. The wild/ecological calabash/capsicum type restaurant module may put forward dishes at different prices based on calabash/capsicum products of varied quality.

In the present invention, text tablets inscribed with “wild/ecological calabash/capsicum restaurant” are provided. Besides, advertising films of wild/ecological calabash/capsicum are provided with the following main content: the life-span, birth, evolution, taming, worldwide breeds, food chains, natural enemies, dietary and medical values, nutrition components of calabash/capsicum, and their contribution to the human body.

The nutritive value of the calabash/capsicum is revealed as follows. The capsicum is also called hot pepper. The green hot pepper can be eaten as a vegetable, while the dry red pepper is a seasoning loved by many people. The capsicum has the following efficacies. The capsicum contains rich vitamin C, and thus able to control the heart disease and coronary artery arteriosclerosis and reduce the cholesterol, and contains many antioxides, thus may prevent cancers and other chronic diseases and make the respiratory tract unclogged. The capsicum is used to treat the cough and cold. Some capsicum in the dish may improve the appetite. The capsicum has a strong effect of aiding blood circulation and may improve symptoms of cold fear, freezing injuries, vascular headache, etc. It contains a special substance which is able to accelerate the metabolism to achieve a remarkable effect of burning internal fat so as to lose weight. Such substance can also facilitate the hormone secretion and has a good beautifying and healthcare effect on the skin, and therefore is a “tonic” for the women. The capsicum is eatable for ordinary healthy people, at a proper amount of 100 g fresh capsicum each meal, and 10 g dry capsicum each meal. It should be noted that the fire control is important when processing the hot green pepper. Since the vitamin C is thermolabile and easily damaged especially in a copper ware, the copper tableware is avoided. It should be kept in mind that an excessive intake will harm human health. Excessive capsaicin will acutely irritate the mucous membrane of stomach and intestines to cause a stomachache and diarrhea as well as burning and sting in the anus, so as to induce diseases of stomach and intestines and cause the hemorrhoids to bleed. Therefore, everyone suffering from diseases such as the oesophagitis, gastric ulcer, and hemorrhoids should eat less capsicum or refrain from eating it. The capsicum is a food extremely spicy and hot, so that people with febrile diseases or fire excess from Yin deficiency, high blood pressure, and tuberculosis should eat it with caution.

32. Wild/Ecological Waxgourd/Chinese Cabbage Type Restaurant Module

In a preferred technical embodiment of the present invention, a wild/ecological waxgourd/Chinese cabbage type restaurant module is provided. The wild/ecological waxgourd/Chinese cabbage type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a waxgourd/Chinese cabbage. Seen from afar, the wild/ecological waxgourd/Chinese cabbage type restaurant module looks like a giant waxgourd/Chinese cabbage standing or lying against the roads of the scenic spots. In the present invention, grasslands are provided as podium buildings of the waxgourd/Chinese cabbage type house artistic module. The walls, doors, windows, balconies, roofs, and internal/external decorations of the waxgourd/Chinese cabbage type house artistic module profile are artistic portrayal of wild/ecological animals and plants or in consistent environmental colors. The walkways, bedrooms, kitchens, toilets, and various pipelines, etc., inside the waxgourd/Chinese cabbage type house artistic module are fabricated by combining the inner structure of the conventional house with characteristics of the wild/ecological animals and plants. Thereby, the whole wild/ecological waxgourd/Chinese cabbage type restaurant module is actually a waxgourd/Chinese cabbage type house artistic module manufactured by construction, decoration, painting, and photography materials. As such, the consumers indeed experience and consume in the waxgourd/Chinese cabbage type house artistic module.

Upon actual requirements, a wild/ecological waxgourd/Chinese cabbage type restaurant module is provided during the removal/rebuild of old/dilapidated houses in urban areas. The wild/ecological waxgourd/Chinese cabbage type restaurant modules of the present invention are provided with waxgourd/Chinese cabbage type windows, huge paintings, huge relief sculptures, or glass decorative paintings. Besides, waxgourd/Chinese cabbage type sculptures are provided for the view of the consumers, and waxgourd/Chinese cabbage type electric toys are provided for the children to play with. The welcome portals are decorated into doors with waxgourd/Chinese cabbage pictures. Leisure tables, chairs, gardening, and parergon are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological waxgourd/Chinese cabbage type restaurant module and actual requirements. The welcoming hall is decorated with waxgourd/Chinese cabbage sculptures. In business places, for instance, the hall is decorated with paintings/photographs about wild/ecological waxgourds/Chinese cabbages growing beside mountain streams and grass. The private rooms are decorated with stories about waxgourds/Chinese cabbages in the form of comics, animations, cartoons, or traditional Chinese paintings. Decorations, toys, and souvenirs of the dining tables, chairs, and children dining chairs of the restaurant are meant to demonstrate the living environment of wild/ecological waxgourds/Chinese cabbages as well as folk cultural features of waxgourds/Chinese cabbages.

The Chinese-style, fast-food, buffet, and floating-type wild/ecological waxgourd/Chinese cabbage type restaurant modules provided by the present invention can be replicated to form chain-stores and provided with professional or vocational dietary instructors, assistants, and waiters.

The fast-food and buffet style wild/ecological waxgourd/Chinese cabbage type restaurant modules of the present invention supply waxgourd/Chinese cabbage type hamburger, fast-food of assorted cold dishes, braised pork with waxgourd/Chinese cabbage, Chinese cabbage soup with tomato, rib soup with waxgourd, and potherb cooked in various ways.

In the present invention, the Chinese-style wild/ecological waxgourd/Chinese cabbage type restaurant modules supply waxgourd braised in soy sauce, braised pork with waxgourd, braised vegetarian Chinese cabbage, Chinese cabbage and vermicelli, spiced duck with waxgourd, waxgourd and seatangle, braised chicken with waxgourd, braised duck with waxgourd, braised goose with waxgourd, waxgourd/Chinese cabbage soup, and other dishes. To cater for different consumers, other vegetables, meat, and fruit are provided.

In the present invention, various types of waxgourd/Chinese cabbage from different producing areas are purchased at different prices, then processed in varied methods, and sold at different prices. White gourds/Chinese cabbages of different values may be produced by different breeds and different taming environments. The wild/ecological waxgourd/Chinese cabbage type restaurant module may put forward dishes at different prices based on waxgourd/Chinese cabbage products of varied quality.

In the present invention, text tablets inscribed with “wild/ecological waxgourd/Chinese cabbage restaurant” are provided. Besides, advertising films of wild/ecological waxgourds/Chinese cabbages is provided with the following main content: the life-span, birth, evolution, taming, worldwide breeds, food chains, natural enemies, dietary and medical values, nutrition components of waxgourds/Chinese cabbages, and their contribution to the human body.

The nutritive value of the Chinese cabbage is revealed as follows. The Chinese cabbage has a high nutritional value. The Chinese cabbage has the following efficacies. The Chinese cabbage contains rich vitamin C and E and a frequent intake thereof may have a good skin care and youthfulness-keeping effect. Scientists from New York Hormone Research Institute in US have found that Chinese and Japanese women have a much lower incidence of breast cancer than that of western women because they often eat the Chinese cabbage. Some trace elements in the Chinese cabbage may help to break down the estrogens associated with the breast cancer. The cellulose in the Chinese cabbage not only lubricates the intestines to facilitate the expelling of toxins, but also facilitates the absorption of the animal protein of the human body. In traditional Chinese medicine, the Chinese cabbage is thought to be slightly cold in nature and sweet in taste, and have the effect of nourishing the stomach and promoting salivation, relieving fidgetness and quenching thirst, promoting urination and relaxing bowels, and clearing away heat and toxic material. The nutritive value of the waxgourd is revealed as follows. The waxgourd, also called pillow gourd, mainly yields in summer. The waxgourd has the following efficacies. A variety of vitamins and trace elements necessary to the human body contained therein may regulate the metabolic balance of human body. The waxgourd is cold in nature and can nourish the stomach and promote salivation, clear stomach fire, decrease the appetite, and cause the conversion of in vivo starch and sugar into heat instead of fat. Thus, the waxgourd is an ideal vegetable for fat people. The waxgourd has an anti-aging effect and an intake thereof for a long time may keep the skin white, shiny, and smooth and the body beautiful and strong. It is said that Empress Michiko of Japan uses the waxgourd for beauty. The waxgourd has a good efficacy of reducing fever and relieving summer-heat. Larger intake of the waxgourd in summer not only quenches thirst, relieves summer-heat, and promotes urination, but also avoids the furuncle. Since the waxgourd promotes urination and contains little Na, it is an excellent detumescent food for chronic nephritis with edema, nutritional edema, and pregnant edema. The waxgourd is eatable for ordinary people, especially for people with kidney disease, diabetes, high blood pressure, and coronary heart disease, at a proper amount of 60 g each day. It should be noted that the waxgourd is an ideal daily food for relieving the heat and promoting urination with a more obvious effect if boiled together with the peel. It should be kept in mind that the waxgourd is cold in nature and thus is inedible for people with aeipathia and fire excess from Yin deficiency.

33. Wild/Ecological Spring Bamboo Shoot/Blind Weed Type Restaurant Module

In a preferred technical embodiment of the present invention, a wild/ecological spring bamboo shoot/blind weed type restaurant module is provided. The wild/ecological spring bamboo shoot/blind weed type restaurant module is preferably set aside main arteries of the scenic spots at rural-urban fringe areas, so as to meet the requirements of tourism and urban leisure consumers in drive. The present invention adopts bionic techniques and arts to fabricate a house model imitating a spring bamboo shoot/blind weed. Seen from afar, the wild/ecological spring bamboo shoot/blind weed type restaurant module looks like a giant spring bamboo shoot/blind weed standing against the roads of the scenic spots. In the present invention, rocks, flowers, and grass are provided as podium buildings of the spring bamboo shoot/blind weed type house artistic module. The walls, doors, windows, balconies, roofs, and internal/external decorations of the spring bamboo shoot/blind weed type house artistic module profile are artistic portrayal of wild/ecological animals and plants or in consistent environmental colors. The walkways, bedrooms, kitchens, toilets, and various pipelines, etc., inside the spring bamboo shoot/blind weed type house artistic module are fabricated by combining the inner structure of the conventional house with characteristics of the wild/ecological animals and plants. Thereby, the whole wild/ecological spring bamboo shoot/blind weed type restaurant module is actually a spring bamboo shoot/blind weed type house artistic module manufactured by construction, decoration, painting, and photography materials. As such, the consumers indeed experience and consume in the spring bamboo shoot/blind weed type house artistic module.

Upon actual requirements, a wild/ecological spring bamboo shoot/blind weed type restaurant module is provided during the removal/rebuild of old/dilapidated houses in urban areas. The wild/ecological spring bamboo shoot/blind weed type restaurant modules of the present invention are provided with spring bamboo shoot/blind weed type windows, huge paintings, huge relief sculptures, or glass decorative paintings. Besides, spring bamboo shoot/blind weed type sculptures are provided for the view of the consumers, and spring bamboo shoot/blind weed type electric toys are provided for the children to play with. The welcome portals are decorated into doors with spring bamboo shoot/blind weed pictures. Leisure tables, chairs, gardening, and parergon are provided. Upon actual requirements, a sound-insulation glass kitchen may be selectively provided to enable the consumers to enjoy the cooking through the sound-insulation glass. A warehouse is provided beside the kitchen. Underground and aboveground parking spaces are provided according to the area of the wild/ecological spring bamboo shoot/blind weed type restaurant module and actual requirements. The welcoming hall is decorated with spring bamboo shoot/blind weed sculptures. In business places, for instance, the hall is decorated with pictures portraying spring bamboo shoots/blind weeds growing on desolate mountains and in bamboo groves, and paintings/photographs about ecological spring bamboo shoots/blind weeds growing beside mountain streams and grass. The private rooms are decorated with stories about spring bamboo shoots/blind weeds in the form of comics, animations, cartoons, or traditional Chinese paintings. Decorations, toys, and souvenirs of the dining tables, chairs, and children dining chairs of the restaurant are meant to demonstrate the living environment of wild/ecological spring bamboo shoots/blind weeds as well as folk cultural features of spring bamboo shoots/blind weeds.

The Chinese-style, fast-food, buffet, and floating-type wild/ecological spring bamboo shoot/blind weed type restaurant modules provided by the present invention can be replicated to form chain-stores and provided with professional or vocational dietary instructors, assistants, and waiters.

The fast-food and buffet style wild/ecological spring bamboo shoot/blind weed type restaurant modules of the present invention supply spring bamboo shoot/blind weed type hamburger, fast-food of spring bamboo shoot/blind weed assorted cold dishes, braised pork with spring bamboo shoots, dumpling stuffed with blind weed, wonton stuffed with blind weed, cold and dressed blind weed with sauce, blind weed soup with tomatoes, and potherb cooked in various ways.

In the present invention, the Chinese-style wild/ecological spring bamboo shoot/blind weed type restaurant modules supply spring bamboo shoots braised in soy sauce, braised pork with spring bamboo shoots, braised chicken with spring bamboo shoots, braised duck with spring bamboo shoots, braised beef with bamboo shoot skin, blind weed balls, and fired blind weed, and potherb cooked in various ways. To cater for different consumers, other vegetables, meat, and fruit are provided.

In the present invention, various types of spring bamboo shoot/blind weed from different producing areas are purchased at different prices, then processed in varied methods, and sold at different prices. Spring bamboo shoots/blind weeds of different values may be provided by different breeds and different taming environments. The wild/ecological spring bamboo shoot/blind weed type restaurant module may put forward dishes at different prices based on spring bamboo shoot/blind weed products of varied quality.

In the present invention, text tablets inscribed with “wild/ecological spring bamboo shoot/blind weed restaurant” are provided. Besides, advertising films of wild/ecological spring bamboo shoots/blind weeds are provided with the following main content: the life-span, birth, evolution, taming, worldwide breeds, food chains, natural enemies, dietary and medical values, nutrition components of spring bamboo shoots/blind weeds, and their contribution to the human body.

The nutritive value of the spring bamboo shoot/blind weed is revealed as follows. The bamboo shoot exists all the year around, but only the spring and winter bamboo shoot tastes best. The bamboo shoot is rich in signature nutrients such as B vitamins and nicotinic acid, characterized by low fat, low sugar, and rich fiber, and can adsorb a large amount of oil and fat to add flavor. If a fat person often eats bamboo shoots, the bamboo shoots will adsorb the oil and fat taken in every meal to reduce the absorption and accumulation of fat by the mucous membrane of stomach and intestines, thereby achieving the purpose of losing weight and reducing diseases related to high fat. The rich nicotine acid, cellulose, etc., contained in the bamboo shoot may promote the intestinal canal to squirm, aid digestion, remove retention of food, and prevent constipation. Therefore, the bamboo shoot has a certain efficacy of preventing digestive canal tumors. From the perspective of traditional Chinese medicine, the bamboo shoot is cold in nature and sweet in taste, and has the efficacies of nourishing Yin and cooling blood, reducing fever and eliminating phlegm, quenching thirst and relieving fidgetness, promoting urination and relaxing bowels, nourishing the liver and improving eyesight. The bamboo shoots are eatable for ordinary people, especially for people with fatness and habitual constipation, at a proper amount of 25 g each meal. It should be noted that the bamboo shoots should be scalded in the boiling water to remove the oxalic acid therein before eating. The tips thereof should be cut longitudinally, while the lower parts should be cut transversely, so that the bamboo shoots are easily cooked and get tasty. The fresh bamboo shoots should not be peeled when stored; otherwise the fragrance thereof will be lost. It should be noted that the bamboo shoot contains much oxalic acid which will influence the absorption of Ca by human body. Therefore, children at the growing up stage should eat less bamboo shoots. The bamboo shoot is also inedible for people with urinary calculus and those sensitive thereto. The nutrition of the blind weed is described as follows. The blind weed is an annual herbaceous wild plant of Cruciferae. The complete plant is edible and has been collected as a precious vegetable since ancient times. The Book of Odes intoned the blind weed in the verse “as sweet as the blind weed”. Besides, Xin Qiji had the felicity of phrase “while the urban peach and plum trees are fearing about the cold rains, the spring is revealed in the blooms of the blind weeds at stream-side”. As a potherb, the blind weed does not accidentally get such praise. According to the research of modern medical science, the blind weed contains rich nutrient substances. Every kilogram blind weed contains 42.4 g protein, 3.2 g fat, 48 g sugar, 11.2 g coarse fiber, a higher vitamin C content than that of tomato, and a renieratene content comparable to that of the carrot. In addition, the blind weed contains much Ca, Fe, K, Mg, and other trace elements. The blind weed has a special smell, and can be used as the stuffing of the spring roll, wonton, dumpling, and steamed bun. If tasted carefully, the blind weed has a slightly meat-like taste in addition to the vegetable flavor and is sweet, and therefore is superior to other vegetables. The blind weed not only has rich nutrition but also has a high medical value. The blind weed contains bursinic acid, and is cold and neutral in nature and sweet and light in taste. It is capable of stopping bleeding and treating hematemesis, hemafecia, hematuria, uterine bleeding, and menorrhagia. A daily dose of 100 g blind weed boiled in water has an obvious effect of reducing blood pressure. The blind weed is capable of promoting urination for removing edema, treating the nephritis with edema, stomach convulsion, gastric ulcer, diarrhea, enteritis, conjunctival congestion and gall as well as strengthening the stomach to promote digestion. Although it is a potherb, the blind weed is an excellent vegetable with rich and well-distributed nutrition, and can be eaten fresh in spring and picked and desiccated for the long-time reserve.

34. Wild/Ecological Mushroom/Caraway Type Restaurant Module

In a preferred technical embodiment of the present invention, a wild/ecological mushroom/caraway type restaurant module is provided. The wild/ecological mushroom/caraway type restaurant module is preferably set aside main arteries of the scenic spots at rural-urban fringe areas, so as to meet the demands of tourism and urban leisure consumers in drive. The present invention adopts bionic techniques and arts to fabricate a house model imitating a mushroom/caraway. Seen from afar, the wild/ecological mushroom/caraway type restaurant module looks like a giant mushroom/caraway standing or lying beside the main arteries of the scenic spots. In the present invention, grassland is provided as podium buildings of the mushroom/caraway type house artistic module. The walls, doors, windows, balconies, roofs, and internal/external decorations of the mushroom/caraway artistic module are artistic portrayal of the wild/ecological animal/plant or in consistent environmental colors. The walkways, bedrooms, kitchens, toilets, and various pipelines, etc., inside the mushroom/caraway type house artistic module are fabricated by combining the inner structure of the conventional house with characteristics of the wild/ecological animals and plants. Thereby, the whole wild/ecological mushroom/caraway type restaurant module is actually a mushroom/caraway type house artistic module manufactured by construction, decoration, painting, and photography materials. As such, the consumers indeed experience and consume in the mushroom/caraway type house artistic modules.

Upon actual requirements, a wild/ecological mushroom/caraway type restaurant module is provided during the removal/rebuild of old/dilapidated houses in urban areas. The wild/ecological mushroom/caraway type restaurant module of the present invention is provided with mushroom/caraway-shaped windows, mushroom/caraway-shaped huge paintings, huge relief sculptures, or glass decorative paintings. Besides, mushroom/caraway sculptures are provided for the view of the consumers, and mushroom/caraway electric toys are provided for the children to play with. Further, the welcome portals are decorated into doors with mushroom/caraway pictures. Leisure tables, chairs, gardening, and parergon are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological mushroom/caraway type restaurant module and actual requirements. The welcoming hall is decorated with mushroom/caraway sculptures. In business places, for instance, the hall is decorated with pictures portraying wild/ecological mushroom/caraway on the barren land, and paintings/photographs about ecological mushroom/caraway growing aside a brook or grassland. The private rooms are decorated with stories about mushroom/caraway in the form of comics, animations, cartoons, or traditional Chinese paintings. Decorations, toys, and souvenirs of the dinning tables, chairs, and children dining chair in the restaurant are meant to demonstrate the living environment of the wild/ecological mushroom/caraway as well as folk culture features of the mushroom/caraway.

The Chinese-style, fast-food, buffet, and floating-type wild/ecological mushroom/caraway type restaurant modules provided by the present invention can be replicated to form chain-stores and provided with professional or vocational dietary instructors, assistants, and waiters.

The fast-food and buffet type wild/ecological mushroom/caraway type restaurant modules of the present invention supply mushroom/caraway hamburger in shape of a mushroom/caraway, fast-food of mushroom/caraway assorted cold dishes, mushroom cooked with meat, mushroom meat soup, mushroom & sliced meat, mushroom/caraway cooked with diced chicken, mushroom/caraway fried with bamboo shoot, stewed old duck with mushroom/caraway, peanut mixed with caraway, and potherb cooked in various ways.

In the present invention, the Chinese-style wild/ecological mushroom/caraway type restaurant module supplies meat cooked with mushroom/caraway, mushroom/caraway soup, mushroom/caraways fish soup, mushroom/caraway chicken soup, mushroom with green vegetable, mushroom with bamboo shoot, mushroom fried with caraway, mushroom/caraway cooked with beef, caraway in sauce, mushroom/caraway fried with green vegetable, and potherb cooked in various ways. To cater for different consumers, other vegetables, meat, and fruit are also provided.

In the present invention, various types of mushroom/caraway from different producing areas are purchased at different prices, then processed in varied methods, and sold at different prices. Mushroom & caraway with varied values may be produced by different breeds and different taming environments. Thus, the wild/ecological mushroom/caraway type restaurant module may put forward dishes at different prices based on mushroom/caraway of varied quality.

In the present invention, text tablets inscribed with “wild/ecological mushroom/caraway type restaurant” are provided. Further, advertising films about the wild/ecological mushroom/caraway are provided with the following main content: the life-span, birth, evolution, taming, worldwide breeds, food chains, natural enemies, dietary and medical values, nutrition components of the (wild) mushroom/caraway, and their contribution to the human body.

The nutritive values of mushroom/caraway are revealed as follows. Pasania fungus, also named fragrant fungus or winter mushroom, not only tastes and smells good, but is rich in nutrition. Ranking higher than straw mushroom and level mushroom, the pasania fungus is regarded as “Queen of all plants”, and ascends one of the “delicacies from land”. Further, the pasania fungus is high in protein, low in fat, with various sugars, amino acids, and vitamins. As the pasania fungus contains agartitine, tricholomic acid, etc., rarely found in other food, it tastes especially exquisite. Moreover, the pasania fungus contains vitamin C, and thus can decrease cholesterol and blood pressure. The pasania fungus juice can completely substitute antihypertensive drugs without causing any side effects. The pasania fungus further contains a kind of hydrin rarely seen in common vegetables. This hydrin can be converted into vitamin D, so as to facilitate the absorption of Ca and enhance the disease resistibility of the human body. Normal people may eat a lot of pasania fungus to prevent cancer, and those with cancer may eat much pasania fungus to suppress the growth of the tumor cell. Moreover, the pasania fungus diet therapy may help those having thick fat on the abdominal wall to lose weight. The pasania fungus, neutral and cold in property while sweet in flavor, can be used to invigorate the liver and the kidney, strengthen the spleen and the stomach, benefit the intelligence, soothe the nerves, and beautify the features. The pasania fungus is generally suitable for all at a proper amount of 8 pieces each meal. It should be noted that, the soaked pasania fungus should be preserved in the refrigerator for fear of impairing its nutrition. The water for soaking the pasania fungus is dissolved with plenty of nutritive substances and can be employed for other purposes. It should be kept in mind that, large-sized fresh pasania fungus cannot be eaten for they are generally fattened by hormones, and large amount of consumption may cause negative impact on the human body.

Caraway, also named coriander, is introduced by Zhang Qian from his mission to the western regions in Western Han dynasty. The delicate stem and fresh leaf of the caraway have a special scent, and are usually adopted to dress or enhance the flavor of other dishes. Thus, caraway is one of the vegetables fond by people. Further, the caraway containing a large amount of volatile oil emanates a special fragrance, and this special fragrance can dispel the smell of meat. Thus, the caraway is added in some dishes to dispel the smell of meat and further enhance the flavor. According to “Compendium of Materia Medica”, caraway is described as “coriander is acrid in flavor with warm fragrance, reaching the heart and spleen inside and the limbs outside”. In real life, the caraway is fragrant and can invigorate the stomach, expel pathogenic wind and detoxify, relieve superficial affection and treat the cold, benefit the large intestine and promote urination, as well as activate the blood circulation. The caraway is suitable for the old and the young, especially those catching a cold, inappetent, or with infantile measles, at a proper amount of 3-10 g each meal. It should be kept in mind that, the caraway cannot be taken together with invigorators and Chinese traditional medicines like atractylodes ovata or moutan bark, for fear of impairing the curative effect of the invigorators. In addition, those having halitosis, armpit odor, severe dental caries, gastric ulcer, or growing a boil should not eat much caraway.

35. Wild/Ecological Radish/Celery Type Restaurant Module

In a preferred technical embodiment of the present invention, a wild/ecological radish/celery type restaurant module is provided. The wild/ecological radish/celery type restaurant module is preferably set aside main arteries of the scenic spots at rural-urban fringe areas, so as to meet the demands of tourism and urban leisure consumers in drive. The present invention adopts bionic techniques and arts to fabricate a house model imitating a radish/celery. Seen from afar, the wild/ecological radish/celery type restaurant module looks like a giant radish/celery standing or lying beside the main arteries of the scenic spots. In the present invention, grassland is provided as podium buildings of the radish/celery type house artistic module. The walls, doors, windows, balconies, roofs, and internal/external decorations of the radishes and celeries artistic module are artistic portrayal of the wild/ecological animal/plant or in consistent environmental colors. The walkways, bedrooms, kitchens, toilets, and various pipelines, etc., inside the radish/celery type house artistic module are fabricated by combining the inner structure of the conventional house with characteristics of the wild/ecological animals and plants. Thereby, the whole wild/ecological radish/celery type restaurant module is actually a radish/celery type house artistic module manufactured by construction, decoration, painting, and photography materials. As such, the consumers indeed experience and consume in the radish/celery type house artistic modules.

Upon actual requirements, a wild/ecological radish/celery type restaurant module is provided during the removal/rebuild of old/dilapidated houses in urban areas. The wild/ecological radish/celery type restaurant module of the present invention is provided with radish/celery-shaped windows, radish/celery-shaped huge paintings, huge relief sculptures, or glass decorative paintings. Besides, radishes and celeries sculptures are provided for the view of the consumers, and radishes and celeries electric toys are provided for the children to play with. Further, the welcome portals are decorated into doors with radishes and celeries pictures. A particular environment parergon for growing radishes and celeries is provided. Leisure tables, chairs, gardening, and parergon are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological radish/celery type restaurant module and actual requirements. The welcoming hall is decorated with radishes and celeries sculptures. In business places, for instance, the hall is decorated with pictures portraying radishes and celeries on the barren land, and paintings/photographs about ecological radishes and celeries growing aside a brook or grassland. The private rooms are decorated with stories about radishes and celeries in the form of comics, animations, cartoons, or traditional Chinese paintings. Decorations, toys, and souvenirs of the dinning tables, chairs, and children dining chair in the restaurant are meant to demonstrate the living environment of the wild/ecological radishes and celeries as well as folk culture features of the radishes and celeries.

The Chinese-style, fast-food, buffet, and floating-type wild/ecological radish/celery type restaurant modules provided by the present invention can be replicated to form chain-stores and provided with professional or vocational dietary instructors, assistants, and waiters.

The fast-food and buffet type wild/ecological radish/celery type restaurant modules of the present invention supply radish/celery hamburger in shape of a radish/celery, fast-food of radish/celery assorted cold dishes, radish cooked with meat, radish meat soup, radish and celery cooked with sliced meat, radish cooked with diced chicken, celery cooked with sliced meat, stewed old duck with radish, stewed spare rib with radish, and potherb cooked in various ways.

In the present invention, the Chinese-style wild/ecological radish/celery type restaurant module supplies meat cooked with radish/celery, radish soup, radish chicken soup, radish/celery cooked with bamboo shoot, radish with beef, radish/celery fried with green vegetable, and potherb cooked in various ways. To cater for different consumers, other vegetables, meat, and fruit are also provided.

In the present invention, various types of radishes and celeries from different producing areas are purchased at different prices, then processed in varied methods, and sold at different prices. Radishes and celeries with varied values may be produced by different breeds and different taming environments. Thus, the wild/ecological radish/celery type restaurant module may put forward dishes at different prices based on radishes and celeries of varied quality.

In the present invention, text tablets inscribed with “wild/ecological radish/celery restaurant” are provided. Further, advertising films about the wild/ecological radishes and celeries are provided with the following main content: the life-span, birth, evolution, taming, worldwide breeds, food chains, natural enemies, dietary and medical values, nutrition components of the (wild) radishes and celeries, and their contribution to the human body. The nutritive values of radishes and celeries are revealed as follows. Radish is rich in nutrition, and has high dietary and medical values. There is an old saying that “taking radish in winter and ginger in summer will keep the doctor away”. Moreover, as radish contains various kinds of trace elements capable of inducing the human body to generate interferons, it may enhance the body immunity, suppress the growth of the cancer cell, and is critical to prevent and combat cancer. The B vitamins and mineral substances such as K and Mg in radish can stimulate gastrointestinal peristalsis and facilitate the disposal of body wastes. Frequent consumption of radish may decrease blood fat, soften blood vessel, stabilize blood pressure, and prevent diseases like coronary heart disease, arteriosclerosis, and cholelithiasis. Further, radish is also a Chinese traditional medicine, and is cold in property and acrid-sweet in flavor, for dispersing accumulation and stagnation, eliminating phlegm and clearing away heat, expelling flatulence and relieving epigastric distention, and detoxifying. It should be kept in mind that, as radish is a cold and cool vegetable, those with excess of Yin and in extremely cold constitution or with deficiency-cold of the spleen and stomach should not eat much radish. Besides, those suffering from gastric ulcer, duodenal ulcer, chronic gastritis, simple goiter, threatened abortion, or metroptosis should eat radish with caution. Radish cannot be taken together with ginseng or American ginseng, for fear of impairing the invigoration due to opposite medical effects. Celery, a commonly-seen vegetable either fried or eaten cold with sauce, is much favored by people. Recently, many researches point out that, celery is a plant with high medical value. In particular, celery, rich in Fe, is a vegetable beneficial to those with iron-deficiency anemia. Celery is an ideal food for assisting the treatment of hypertension and complications thereof, vascular sclerosis, or nervous exhaustion. Further, the leaf and stem of the celery contain volatile matters with special fragrance capable of stimulating the appetite. The celery juice can also decrease the blood sugar. Frequent consumption of celery may neutralize acidic materials contained in uric acid and the human body, and effectively prevent gout. In addition, celery, containing Zn, is a sexual function food capable of stimulating sexual arousal. Thus, celery is regarded as “couple dish” in the west, and was once prohibited among monks in ancient Greece. According to certain research in Thailand, frequent consumption of celery may reduce the quantity of sperm, and thus may help the contraception. Moreover, celery is generally suitable for all at a proper amount of 50 g each meal. It should be kept in mind that, as celery can reduce the blood pressure, those with hypotension should eat with caution.

36. Wild/Ecological Coffee Bean Standardized Cafe Module

In a preferred technical embodiment of the present invention, a wild/ecological coffee bean standardized cafe module is provided. The wild/ecological coffee bean standardized cafe module is preferably set aside main arteries of the scenic spots at rural-urban fringe areas, so as to meet the demands of tourism and urban leisure consumers in drive. The present invention adopts bionic techniques and arts to fabricate a house model imitating a coffee bean. Seen from afar, the wild/ecological coffee bean standardized cafe module looks like a giant coffee bean standing or lying beside the main arteries of the scenic spots. In the present invention, grassland is provided as podium buildings of the coffee bean type house artistic module. The walls, doors, windows, balconies, roofs, and internal/external decorations of the coffee bean type house artistic module are artistic portrayal of the wild/ecological animal/plant or in consistent environmental colors. The walkways, bedrooms, kitchens, toilets, and various pipelines, etc., inside the coffee bean type house artistic module are fabricated by combining the inner structure of the conventional house with characteristics of the wild/ecological animals and plants. Thereby, the whole wild/ecological coffee bean standardized cafe module is actually a coffee bean type house artistic module manufactured by construction, decoration, painting, and photography materials. As such, the consumers indeed experience and consume in the coffee bean type house artistic modules.

Upon actual requirements, a wild/ecological coffee bean restaurant module is provided during the removal/rebuild of old/dilapidated houses in urban areas. The wild/ecological coffee bean type restaurant module of the present invention is provided with coffee bean-shaped windows, coffee bean-shaped huge paintings, huge relief sculptures, or glass decorative paintings. Besides, coffee bean sculptures are provided for the view of the consumers, and coffee bean electric toys are provided for the children to play with. Further, the welcome portals are decorated into doors with coffee bean pictures. Leisure tables, chairs, gardening, parergon, and cross-sectional coffee bean ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological coffee bean standardized cafe module and actual requirements. The welcoming hall is decorated with coffee bean sculptures. In business places, for instance, the hall is decorated with pictures portraying wild/ecological coffee beans on the barren land, and paintings/photographs about ecological coffee beans growing aside a brook or grassland. The private rooms are decorated with stories about coffee beans in the form of comics, animations, cartoons, or traditional Chinese paintings. Decorations, toys, and souvenirs of the dinning tables, chairs, and children dining chair in the restaurant are meant to demonstrate the living environment of the wild/ecological coffee beans as well as folk culture features of the coffee beans.

The wild/ecological coffee bean standardized cafe module also provides other vegetables, meat, and fruit.

In the present invention, various types of coffee beans from different producing areas are purchased at different prices, then processed in varied methods, and sold at different prices. Coffee beans with varied values may be produced by different breeds and different taming environments. Thus, the wild/ecological coffee bean standardized cafe module may put forward coffee at different prices based on coffee beans of varied quality.

In the present invention, text tablets inscribed with “wild/ecological cafe” are provided. Further, advertising films about the wild/ecological coffee beans are provided with the following main content: the life-span, birth, evolution, taming, worldwide breeds, food chains, natural enemies, dietary and medical values, nutrition components of the (wild) coffee, and their contribution to the human body.

The nutritive value of coffee is revealed as follows. As people are inevitably exposed to various radiations like light waves and electromagnetic waves in life, and those radiations have different harms to the human body in the long run, drinking proper amount of coffee may ease the above-mentioned negative impacts. According to the research of Japanese Medical University, one cup of coffee a day can suppress the liver cancer. The coffee, containing caffeine, is capable of stimulating central nerve, facilitating the dissolution of liver starch, and raising the blood sugar. People drinking proper amount of coffee will be full of energy and acquire quick thinking ability temporarily. Drinking coffee after exercise may dissipate fatigue, restore physical strength, and enhance the vigor. Moreover, coffee is generally suitable for all at a proper amount of 1 or 2 cups a day, and it is better not to exceed 5 cups a day. It should be kept in mind that, those frequently drinking coffee should take in more Ca, and those having cardiovascular diseases should not drink much coffee. In addition, old women who drink a lot of coffee are prone to fractures due to osteoporosis, and those having gastric disease or vitamin B1 deficiency should try not to drink coffee. Besides, pregnant women drinking too much coffee may result in fetal malformation or miscarriage. Too much coffee may also put normal people in potential risk of cancer, and it is better for those already having cancer to keep away from coffee.

37. Wild/Ecological Ginkgo Type Restaurant Module

In a preferred technical embodiment of the present invention, a wild/ecological ginkgo type restaurant module is provided. The wild/ecological ginkgo type restaurant module is preferably set aside main arteries of the scenic spots at rural-urban fringe areas, so as to meet the demands of tourism and urban leisure consumers in drive. The present invention adopts bionic techniques and arts to fabricate a house model imitating a ginkgo. Seen from afar, the wild/ecological ginkgo type restaurant module looks like a giant ginkgo standing or lying beside the main arteries of the scenic spots. In the present invention, grassland is provided as podium buildings of the ginkgo type house artistic module. The walls, doors, windows, balconies, roofs, and internal/external decorations of the ginkgo type house artistic module are artistic portrayal of the wild/ecological animal/plant or in consistent environmental colors. The walkways, bedrooms, kitchens, toilets, and various pipelines, etc., inside the ginkgo type house artistic module are fabricated by combining the inner structure of the conventional house with characteristics of the wild/ecological animals and plants. Thereby, the whole wild/ecological ginkgo standardized ginkgo type restaurant module is actually a ginkgo type house decoration and sculpture artistic module manufactured by construction, decoration, painting, and photography materials. As such, the consumers indeed experience and consume in the ginkgo type house artistic modules.

Upon actual requirements, a wild/ecological ginkgo type restaurant module is provided during the removal/rebuild of old/dilapidated houses in urban areas. The wild/ecological ginkgo type restaurant module of the present invention is provided with ginkgo-shaped windows, ginkgo-shaped huge paintings, huge relief sculptures, or glass decorative paintings. Besides, ginkgo sculptures are provided for the view of the consumers, and ginkgo electric toys are provided for the children to play with. Further, the wild/ecological ginkgo type restaurant module is planted with ginkgo trees. The welcome portals are decorated into doors with ginkgo pictures. Leisure tables, chairs, gardening, parergon, and cross-sectional ginkgo ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological ginkgo type restaurant module and actual requirements. The welcoming hall is decorated with ginkgo sculptures. Moreover, the wild/ecological ginkgo type restaurant module is decorated with paintings of Lao Zi, the founder of Taoism, and the emperor of Zhou sitting under a ginkgo nut tree, tasting the ginkgo nut, and drinking the ginkgo tea; or Confucian and Zhuang Zi, also an ancient philosopher, sitting under a ginkgo nut tree, tasting the ginkgo nut, and drinking the ginkgo tea; or Hua Tuo recommending the ginkgo nut and ginkgo tea to Guan gong, a celebrated ancient general; or Zhu Geliang tasting the ginkgo nut and drinking the ginkgo tea at the yard in Wolong Hillock; or Li Bai, a poet of the Tang Dynasty, accompanying Tang Minghuang and his favorite concubine Lady Yang sitting under a ginkgo tree, tasting the ginkgo nut, and drinking the ginkgo tea; or ministers of Song dynasty offering the ginkgo nut and ginkgo tea to the emperor as tributes; or Li Shizhen writing down the efficacies of ginkgo “entering the lung channel, replenishing the spleen-Qi, relieving the dyspnea and cough, and reducing the urinate” under a ginkgo tree. In business places, for instance, the hall is decorated with pictures portraying girls picking wild/ecological ginkgoes on the moorland, and paintings/photographs about ecological ginkgoes growing aside a brook or grassland. The private rooms are decorated with stories about ginkgoes in the form of comics, animations, cartoons, or traditional Chinese paintings. Decorations, toys, and souvenirs of the dinning tables, chairs, and children dining chair in the restaurant are meant to demonstrate the living environment of the wild/ecological ginkgoes as well as folk culture features of the ginkgoes.

The wild/ecological ginkgo standardized restaurant also provides ginkgo tea, ginkgo beverage, and ginkgo wine services.

The Chinese-style, fast-food, buffet, and floating-type wild/ecological ginkgo standardized restaurant modules provided by the present invention can be replicated to form chain-stores and provided with professional or vocational dietary instructors, assistants, and waiters.

The fast-food and buffet type wild/ecological ginkgo type restaurant module of the present invention supply (wild) ginkgo & vegetable hamburger in shape of a ginkgo, fast-food of (wild) ginkgo assorted cold dishes, (wild) ginkgo cooked with meat, spiced dried (wild) ginkgo slice, smoked rotten (wild) ginkgo, sauced (wild) ginkgo slice, roasted (wild) ginkgo biscuit, (wild) ginkgo eight ingredient porridge, (wild) ginkgo soybean milk, (wild) ginkgo mushroom/caraway soup, (wild) ginkgo beverage, rice and vegetable roll with (wild) ginkgo & thin sheets of bean curd, and ginkgo rice pudding.

In the present invention, the Chinese-style wild/ecological ginkgo type restaurant module supplies ginkgo nut with salted chicken, (wild) ginkgo nut broiler chicken soup, (wild) ginkgo nut mushroom/caraway soup, steamed pigeon with (wild) ginkgo nut, (wild) ginkgo nut with mock pakchoi, (wild) ginkgo nut with beancurd, (wild) ginkgo nut with peanut, (wild) ginkgo nut with chicken, stewed duck with (wild) ginkgo nut, stewed pigeon with (wild) ginkgo nut, (wild) ginkgo nut with wild/ecological rabbit, (wild) ginkgo nut with pheasant, steamed bun stuffed with (wild) ginkgo nut & vegetable, (wild) ginkgo nut & blind weed dumpling, (wild) ginkgo nut egg soup, (wild) ginkgo nut tomato soup, (wild) ginkgo nut with bamboo shoot, (wild) ginkgo nut fish soup, (wild) ginkgo nut glutinous rice cake, (wild) ginkgo nut rice cake, and (wild) ginkgo nut cake. To cater for different consumers, other vegetables, meat, and fruit are also provided.

In the present invention, various types of ginkgoes from different producing areas are purchased at different prices, then processed in varied methods, and sold at different prices. Ginkgoes with varied values may be produced by different breeds and different taming environments. Thus, the wild/ecological ginkgo type restaurant module may put forward dishes at different prices based on ginkgoes of varied quality.

In the present invention, text tablets inscribed with “wild/ecological ginkgo restaurant” are provided. Further, advertising films about the wild/ecological ginkgoes are provided with the following main content: the life-span, birth, evolution, taming, worldwide breeds, food chains, natural enemies, dietary and medical values, nutrition components of the (wild) ginkgoes, and their contribution to the human body.

Ginkgo is the oldest living tree species among the seed plants. Botanists often compare ginkgo with dinosaur, and ginkgo is also regarded as panda in plantage. Ginkgo nut, a kind of nut, ranks the third of the nuts in terms of economic value, and the value of ginkgo nut mainly lies in dietary and medical purposes. Eating ginkgo nut can prolong life, so ginkgo nut is chosen as a royal tribute in Song dynasty. The Japanese people have cultivated the habit of eating ginkgo nut every day, and the westerners serve ginkgo nut on every Christmas. Further, ginkgo nut is generally fried, roasted, steamed, served as a side dish, cookie, sweetie, canned food, beverage, and wine.

The medical value of ginkgo nut mainly reflects in medicine, pesticide, and animal remedy. Li Shizhen in Ming dynasty once said “(ginkgo nut can) enter the lung channel, replenish the spleen-Qi, relieve the dyspnea and cough, and reduce the urinate”. “Ben Jing Feng Yuan” composed by Zhang Lulu in Qing dynasty mentioned that, ginkgo nut can reduce the phlegm, detoxify, kill parasites, and treat diseases such as “sore, psora, abscess, and neoplasm, breast carbuncle and ulceration, decayed tooth, infantile alvine flux, leukorrhea with reddish discharge, chronic stranguria with turbid urine, apontaneous emission and enuresis”. In areas of Jiangsu and Sichuan in Ming dynasty, Chinese herbal medicines prepared by ginkgo nut appeared for clinical purposes. The external seed coat of ginkgo contains plenty of hydroginkgoic acid and ginkgo flavone. The water soluble components of the external seed coat can effectively arrest cough and resolve phlegm, similar to cyclophosphane and carulon. The cedrol intermediate of the external seed coat may combat 22 kinds of common clinical pathogenic fungi with a suppression rate of 81%. 0.1% of hydroginkgoic acid may combat 25 kinds of clinical pathogenic fungi with a suppression rate of 92%. Further, the extracts of the external seed coat may combat 11 kinds of plant pathogenic bacteria like apple anthracnose with a suppression rate of 88% to 100%. The alcohol extracts of the external seed coat can prevent and combat silk & cotton golden loopworms with a success ratio of 100% in three days, and can prevent and combat pests like leaf mites, green peach aphids, and asiatic rice borer.

The ginkgo leaf also has high medical value. So far, chemical compositions of more than 160 different kinds of extracts from ginkgo leaf are already known, including flavonoids, terpenoids, phenols, alkaloid, polyisoprene, quininic acid, linoleic acid, shikimic acid, avitamic acid, a-hexenal, ginnol, and bilobanone. Injection of Ginkgo biloba extract developed by organizations like Institute of Botany, the Chinese Academy of Sciences from ginkgo leaf in the 1960s is proved by test to have certain effect on curing coronary heart disease, angina, and cerebrovascular diseases.

At present, hair-care & body-care products prepared by extracts from ginkgo leaf exceed 50 different kinds. Further, health products such as beverage prepared by ginkgo leaf, ginkgo & peach fruit juice, ginkgo beer, and ginkgo tea have already been circulated in the market, and achieved good effects.

38. Wild/Ecological Tea House Module

In a preferred technical embodiment of the present invention, a wild/ecological tea house module is provided. The wild/ecological tea house module is preferably set aside main arteries of the scenic spots at rural-urban fringe areas, so as to meet the demands of tourism and urban leisure consumers in drive. The present invention adopts bionic techniques and arts to fabricate a house model imitating a teapot, teacup, or tea seed. Seen from afar, the wild/ecological tea house module looks like a giant teapot, teacup, and tea seed standing or lying beside the main arteries of the scenic spots. The walls, doors, windows, balconies, roofs, and internal/external decorations of the teapot, teacup, or tea seed house artistic module are artistic portrayal of the wild/ecological animal/plant or in consistent environmental colors. The walkways, bedrooms, kitchens, toilets, and various pipelines, etc., inside the tea plant type house artistic module are fabricated by combining the inner structure of the conventional house with characteristics of the wild/ecological animals and plants. Thereby, the whole wild/ecological tea house module is actually a teapot, teacup, or tea seed type house artistic module manufactured by construction, decoration, painting, and photography materials. As such, the consumers indeed experience and consume in the teapot, teacup, or tea seed type house artistic modules.

Upon actual requirements, a wild/ecological teapot, teacup, or tea seed type restaurant module is provided during the removal/rebuild of old/dilapidated houses in urban areas. The wild/ecological teapot, teacup, or tea seed type restaurant module of the present invention is provided with teapot, teacup, or tea seed-shaped windows, teapot, teacup, or tea seed-shaped huge paintings, huge relief sculptures, or glass decorative paintings. Besides, teapot, teacup, or tea seed sculptures are provided for the view of the consumers, and teapot, teacup, or tea seed type electric toys are provided for the children to play with. Further, the welcome portals are decorated into doors with teapot, teacup, or tea seed pictures. Leisure tables, chairs, gardening, parergon, and cross-sectional tea seed or tea plant ornamental specimens are provided. Upon actual requirements, a sound-insulation glass kitchen may be selectively provided to enable the consumers to enjoy the cooking through the sound-insulation glass. A storehouse is set beside the kitchen. Underground and aboveground parking spaces are provided according to the area of the wild/ecological tea house module and actual requirements. The welcoming hall is decorated with teapot, teacup, or tea seed sculptures. In business places, for instance, the hall is decorated with pictures portraying girls picking wild tea-leaves on the barren land, and paintings/photographs about ecological tea plants aside a brook or grassland. The private rooms are decorated with stories about tea in the form of comics, animations, cartoons, or traditional Chinese paintings. Decorations, toys, and souvenirs of the dinning tables, chairs, and children dining chair in the restaurant are meant to demonstrate the living environment of the wild/ecological tea plants as well as folk culture features of the tea.

To cater for different consumers, the wild/ecological tea house module also provides other vegetables, meat, and fruit.

The wild/ecological tea house module of the present invention is provided with professional or vocational dietary instructors, assistants, and waiters.

In the present invention, various types of tea from different producing areas are purchased at different prices, then processed in varied methods, and sold at different prices. Tea with varied values may be produced by different breeds and different taming environments. Thus, the wild/ecological tea standardized tea house module may put forward tea at different prices based on varied quality.

In the present invention, text tablets inscribed with “wild/ecological tea house” are provided. Further, advertising films about the wild/ecological tea are provided with the following main content: the life-span, birth, evolution, taming, worldwide breeds, food chains, natural enemies, dietary and medical values, nutrition components of the (wild) tea, and their contribution to the human body.

The nutritive value of tea-leaf is revealed as follows. Tea is a kind of beverage rich in vitamin K, and also containing vitamin C. Thus, tea can be used to restrain platelet aggregation, facilitate the dissolution of fibrin, decrease blood pressure, and reduce blood fat, so as to prevent and cure cardiovascular diseases. Further, as tea contains components such as fluorin and tea polyphenols, drinking tea may prevent caries and consolidate the teeth. Tea is also rich in vitamins A and E, and has various types of anticancer and anti-aging trace elements. Therefore, tea is natural beautification beverage, capable of maintaining the skin smooth, white, and tender, reducing the wrinkles, being antioxidation and radiation-proof, improving immunity, and preventing tumour. Besides, tea can be also used to refresh the brain and regain consciousness, enhance the vigour, improve immunity, and dissipate fatigue. In addition, black tea is capable of warming the stomach and relieving the cold, and oolong is good for losing weight. Except the pregnant and children, tea is generally suitable for all at a proper amount of 3-8 g of tea-leaves each time. It should be noted that, tea-leaves cannot be soaked for too long, and vacuum cup cannot be used to make tea. It is better not to drink over-strong tea, nor overnight tea. It should be kept in mind that, those having fever, nonfunctional kidney, cardiovascular diseases, habitual constipation, peptic ulcer, nervous exhaustion, or insomnia should not drink tea. Besides, pregnant women, women in breast feeding period, or children should stay away from tea. Further, do not take medicines by tea, and do not drink tea in an hour after taking medicines.

39. Wild/Ecological Animal/Plant Weight Reduction, Beautification, and Longevity Food Specialty Store Module

In a preferred technical embodiment of the present invention, a wild animal/plant weight reduction, beautification, and longevity food specialty store module is provided. The wild/ecological animal/plant weight reduction, beautification, and longevity food specialty store module is preferably set aside main arteries of the scenic spots at rural-urban fringe areas, so as to meet the demands of tourism and urban leisure consumers in drive. Seen from afar, the wild/ecological animal/plant weight reduction, beautification, and longevity food specialty store module looks like people picking wild plants or taming wild animals. The walls, doors, windows, balconies, roofs, and internal/external decorations of the wild/ecological animal/plant weight reduction, beautification, and longevity food specialty store module are artistic portrayal of the wild/ecological animal/plant or in consistent environmental colors. The walkways, bedrooms, kitchens, toilets, and various pipelines, etc., inside the wild/ecological animal/plant weight reduction, beautification, and longevity food specialty store module are fabricated by combining the inner structure of the conventional house with characteristics of the wild/ecological animals and plants. Thereby, the whole wild/ecological animal/plant weight reduction, beautification, and longevity food specialty store module is actually a human picking/taming wild/ecological animal/plant type house artistic module manufactured by construction, decoration, painting, and photography materials. As such, the consumers indeed experience and consume in the giant human picking/taming wild/ecological animal/plant type house artistic modules.

The wild/ecological animal/plant weight reduction, beautification, and longevity food specialty store module may also decorate the built house with huge paintings, huge relief sculptures, or glass decorative paintings of human picking/taming wild/ecological animal/plant. Besides, sculptures of Nü Wa creating human beings and wild/ecological animal/plant are provided for the view of the consumers, and wild animal type electric toys are provided for the children to play with. Further, the welcome portals are decorated into doors with wild animal pictures. Leisure tables, chairs, gardening, parergon, and cross-sectional wild/ecological animal/plant ornamental specimens are provided. Upon actual requirements, a sound-insulation glass kitchen may be selectively provided to enable the consumers to enjoy the cooking through the sound-insulation glass. The welcoming hall is decorated with sculptures of Nü Wa. In business places, for instance, the hall is decorated with pictures portraying the story of Nü Wa patching up the sky; or stories showing the harm of pesticide, chemical fertilizer, and hormone to the human body in the form of photographs or paintings; or pictures advising the urban consumers to eat certain types of wild/ecological animal/plant, and the ways of taking the wild/ecological animal/plant in order to achieve weight reduction, beautification, and longevity effects; or stories about the origin and evolution of the wild/ecological animal/plant and human beings, as well as stories about human taming the wild/ecological animal/plant and about the interdependency between human beings and the wild/ecological animal/plant; or scientific knowledge on the importance of protecting wild/ecological animal/plant.

The wild/ecological animal/plant weight reduction, beautification, and longevity food specialty stores, specialty halls, specialty stalls, and specialty counters provided by the present invention are provided with professional or vocational dietary instructors, assistants, and waiters for weight reduction, beautification, and longevity food. The instructors, assistants, and waiters for the wild/ecological animal/plant weight reduction, beautification, and longevity food are acknowledged by government departments or industrial associations through professional training and vocational certificate assessments in subjects like Chinese medicine, Western medicine, and dietary nutrition kinology. Those instructors, assistants, and waiters holding certificates and wearing noticeable service post licenses provide consumers with scientific consultation, nutrition preparation, and dietary methods of weight reduction, beautification, and longevity food according to health conditions and actual circumstances of the consumers. The wild/ecological animal/plant weight reduction, beautification, and longevity food specialty stores, specialty halls, specialty stalls, and specialty counters are further provided with sports supplies, medical supplies, and other commodities beneficial to the weight reduction, beautification, and longevity functions. Further, the wild/ecological animal/plant weight reduction, beautification, and longevity food specialty stores, specialty halls, specialty stalls, and specialty counters are provided with text tablets or graphic advertisements indicating “specialty” and advertising films about the wild/ecological animal/plant weight reduction, beautification, and longevity food specialty store.

Thanks to the colorful nature, our world is so splendid; and thanks to the multiplication of the animals and plants, our world is so full of vitality. The provided animal/plant type house artistic module is not only applicable to the standardized urban products, but also to the old-city reform and removal/rebuild of old/dilapidated houses in old urban areas. Therefore, the animal/plant type house artistic module of the present invention is suitable for worldwide integration of urban and rural areas and the renovation of the old city. The animal/plant type house artistic module provided by the present invention through bionic technical schemes is fabricated in the form of comics, sketch, animation, cartoon, paper-cut, iron picture, feather picture, sample picture, shell picture, oil painting, traditional Chinese painting, water color painting, computer drawing, spray painting, sculpture, ceramics, clay sculpture, aluminum alloy steel engraving, reinforced bar cement, wood bamboo carving, clay rock, plastic sculpture, copper sculpture, glass artwork, bio-nano mixed material imitation, picture-story book, woodcut, fairy tale picture, story picture, film/TV program picture, or photograph.

The artistic language of the animal/plant type house artistic products adopted by the present invention may not only effectively inherit and develop particular animal/plant type house sculpture graphics art in the World Cultural Heritages, but also provide developing platforms for zoologists, botanists, cultural artists, painters, biologists, life scientists, nanometer material scientists, construction sculpture artists, construction engineering technicians, and painting sculpture craftsmen to create the animal/plant type house artistic modules, thereby adding a new chapter of animal/plant type house artistic products in the human history of civilization.

For example, according to the technical scheme of animal/plant type house artistic module, factories and dangerous old buildings are removed during old city renovation of the place where the inventor lives around Baohe park in the city of Hefei, China, so as to build Baohe wild/ecological animal/plant restaurant module areas and weight reduction, beautification, and longevity food specialty tourism areas in Baohe scenic spots. Moreover, wild/ecological animal/plant restaurant module tourism areas are selectively built around Da Shushan scenic spot and Chaohu scenic spot in Hefei, so as to expand the tourism resources of Hefei.

Further, the present invention can be implemented in the standardized urban product, such that the house model in the standardized urban product becomes more splendid due to the added animal/plant type house artistic products.

[Cost Estimation on Mesh-Sheet Standardized Block Underground Space Module]

Upon actual requirements, the mesh-sheet standardized block module is provided with an underground space module of 800,000 m². According to related codes, calculated by an underground parking space being 30 m², the 800,000 m² underground space module can provide 26666 underground parking spaces.

1. Calculation of Project Volume of Mesh-Sheet Standardized Block Underground Space Module

If the column pitch in the underground space module is calculated by 9 m×9 m, the clear height of the column is 4.5 m, and the columnar order is 0.4 m×0.4 m; the foundation is an extended foundation 1 m long, 1 m wide, and 0.3 m thick; the concrete grade is C25; the total number of columns is 101×101=10,201 units; and the already existing columns taking up a proportion of about 30% under the house foundation is deducted, the number of columns to be built is 10201×70%=7141 units.

(1) Amount of Concrete and Number of Reinforced Bars Required for Fabricating the Columns

1. C25 concrete: 0.4 m×0.4 m×4.5 m×7141=5141.52 m³

2. reinforced bar: the required number of reinforced bars with a diameter of 25 mm and spaced by 15 cm×15 cm:

6 pieces×4.7 m/piece×3.856 kg/m×7141=776,506.63 kg

the required number of reinforced bars with a diameter of 8 mm and spaced by 15 cm×15 cm:

30 pieces×1.7 m/piece×0.395 kg/m×7141=143855.45 kg

(2) Amount of Concrete and Number of Reinforced Bars Required for Fabricating the Foundation

(1) C25 concrete: 1.0 m×1.0 m×0.3 m×7141=2142.3 m³

(2) reinforced bar: the required number of reinforced bars with a diameter of 16 mm and spaced by 40 cm×40 cm:

6 pieces×0.9 m/piece×1.58 kg/m×7141=60927.01 kg

the required number of reinforced bars with a diameter of 8 mm and spaced by 10 cm×10 cm:

11 pieces×2.6 m/piece×0.395 kg/m×7141=80671.88 kg

(3) required volume of C25 ground concrete:

(900 m×900 m−0.4 m×0.4 m×10201)×0.15 m=121255.18 m³

(4) The concrete adopted for the top surface is C30, and deduct the proportion of 30% of the house ground as the top surface, the actual required volume is:

900 m×900 m×0.3 m×70%=170,100 m³

(5) number of reinforced bars required for fabricating the top surface:

the required number of reinforced bars with a diameter of 16 mm and spaced by 20 cm×20 cm:

180 pieces/unit×8.95 m/piece×1.58 kg/m×10000 units×70%=17817660.0 kg

the required number of reinforced bars with a diameter of 8 mm and spaced by 40 cm×40 cm:

920 pieces/unit×0.346 m/piece×0.395 kg/m×10000 units×70%=880154.8 kg

(6) project volume of earthwork: 900 m×900 m×4.95 m=4009500 m³

In view of the above, the project volume of the underground space module is:

(i) C25 concrete: 5141.52 m³+2142.3 m³+121255.18 m³=128539.0 m³; (ii) C30 concrete: 170100.0 m³; (iii) excavated and delivered earthwork: 4009500.0 m³; (iv) reinforced bar: 776506.63 kg+143855.45 kg+60927.01 kg+80671.88 kg+17817660 kg+880154.8 kg=19759.78 ton.

2. Project Cost Estimation on 1 km² Underground Space Module

(1) cost estimation on C25 concrete:

labor cost: 3.12 workday/m³×128539.0 m³×27.64 RMB/workday=RMB 11084792.04

material cost: 128539.0 m³×107.91 RMB/m³=RMB 13870643.49.

(2) cost estimation on C30 concrete:

labor cost: 3.12 workday/m³×170100.0 m³×27.64 RMB/workday=RMB 14668879.68;

material costs: 170100.0 m³×124.05 RMB/m³=RMB 21100905.

(3) cost estimation on reinforced bars:

labor cost: 19759.78 ton×13.6 workday/ton×27.64 RMB/workday=RMB 7427780.34;

material costs: 19759.78 ton×3500 RMB/ton=RMB 69159230.0.

(4) comprehensive fee of earthwork: 4009500 m³×4.16 RMB/m³=RMB 16679520.0.
Total: RMB 153,991,750.55

3. Project Cost Estimation on Underground Space Module in a Sheet-Like Standardized Urban Module

In a preferred technical embodiment of the present invention, the sheet-like standardized urban module preferably provides 40%-80% underground space. Calculating as 80%, the underground space is 153,991,750.55 RMB/km²×100 km²×80%=RMB 12,319,340,044.

Since the total fabrication cost of the underground space module in the sheet-like standardized urban module should take transportation fee, installation fee, machine cost, field fee, unpredictable fee and so on into account, those fees occupy about 25% of project cost estimation, that is, RMB 12,319,340,044×25%=RMB 3,079,835,011. Therefore, it is known that the total investment to the underground space module in the sheet-like standardized urban module is RMB 12,319,340,044+3,079,835,011=RMB 15,399,175,055; the fabrication cost of per square meter is RMB 15,399,175,055÷1 hundred million square meters=153.99 RMB/m²; and the fabrication cost of the sheet-like standardized block underground space module is 0.8 million m² sheet-like standardized block underground space module×153.99 RMB/m²=RMB 123,192,000.

1. Business Invitation Industry Standardized Urban Product

With the development of the global economy integration, the worldwide market of business invitation industry has been enlarging. In state governments and corporations all over the world, the demand on business invitation is more and more imperative; meanwhile, the demands on the business invitation talent and the business invitation information are more and more extensive. The business invitation industry has become the most important work in state governments and corporations all over the world.

There are no integrally planned business invitation office areas for the state governments and corporations all over the world to reside, the traffic inconvenience and information obstruction there between make the corporations unable to know the resources, projects, and goods in all the countries of the world as soon as possible. Even if the business invitation project has been found, the information cost would be very high, which limits the business invitation efficiency in state governments and corporations all over the world.

Upon actual requirements, the present invention provides business invitation industry standardized urban products in countries with large population and adequate resource The business invitation industry standardized urban products are provided with business invitation and investment office areas, market areas, resource and project exhibition areas, residence areas, recreation and entertainment areas, business areas, logistic storage areas, real estate exchange centers, business invitation industrial parks, business invitation industrial museums, business invitation book centers, business invitation cultural and artistic media centers, business invitation industry commercial centers, business invitation industry exploration institution, business invitation square, business invitation industrial universities, business invitation industrial technical schools, standardized senior high schools, standardized kindergarten, primary, and middle schools, construction infrastructure and social infrastructure of standardized urban product. The business invitation industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, office automation (OA) service offices, and civilized and considerate life service offices.

The present invention may choose, every ten days, enterprises from several countries and regions to carry out business invitation and exhibition in the business invitation standardized urban product. One of the preferred technical embodiments of the present invention is to provide ethnic flavor culture parade performance of different countries, so as to enlarge the influence of business invitation. Thus, this activity is used as a business invitation interactive platform to facilitate the rapid blending of the worldwide economy. Meanwhile, it also provides enterprises with the fast knowledge of various countries' resources, projects, products, and the expedited efficiency of investment to various countries' resources, projects, products.

Upon actual requirements, the present invention provides “Worldwide Business Invitation Culture Festival” activity annually, so as to improve the science/technology content and cultural artistic taste of the worldwide business invitation industry, and promote the marketing ability of worldwide business invitation.

2. Aircraft Industry Standardized Urban Product

In a preferred technical embodiment of the present invention, a required quantity of aircraft industrial manufacturing and commercial/residential mesh-sheet standardized block modules are assembled to form an aircraft industry standardized urban product. In a further preferred technical embodiment of the present invention, a required quantity of aircraft R&D transactional mesh-sheet standardized block modules are assembled to form a R&D transactional aircraft industry standardized urban product. In a still further preferred technical embodiment of the present invention, the aircraft industrial manufacturing and commercial/residential as well as the R&D transactional mesh-sheet standardized block modules are assembled to form an aircraft industry standardized urban product.

The aircraft industry standardized urban product includes worldwide various aircrafts, aircraft parts and members, aircraft materials, aircraft manufacturing machineries, aircraft manufacturing machinery materials, parts and members of aircraft manufacturing machinery, accessories of aircraft manufacturing machinery, accessories of aircraft, airport equipments, airport equipment materials, parts and members of airport equipment, accessories of airport equipment. The aircraft industry standardized urban product includes worldwide aircraft research and development, manufacturing, marketing, operation managing enterprises, and performs intensive marketing to the world market.

Upon actual requirements, the aircraft industry standardized urban products are provided with business invitation and investment office areas, market areas, standardized workshop areas, residence areas, recreation and entertainment areas, business areas, logistic storage areas, aircraft complaint centers, aircraft maintenance service centers, aircraft industrial parks, aircraft industrial museums, aircraft industry book centers, real estate investment and trade centers, intellectual property and various property trade centers of aircraft and accessories, aircraft cultural and artistic media centers, talent labor exchange centers of aircraft industry, science and technology exploration institution of aircraft industry, aircraft industrial universities, aircraft industrial technical schools, aircraft exhibition and performance areas, standardized senior high schools, standardized kindergarten, primary, and middle schools, construction infrastructure and social infrastructure of standardized urban product. The aircraft industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Aircraft Culture Festival” activity annually, so as to improve the science/technology content and cultural artistic taste of the worldwide aircraft industry, and promote the marketing ability of worldwide aircraft.

3. Shipping Industry Standardized Urban Product

In a preferred technical embodiment of the present invention, a required quantity of shipping product industrial manufacturing and commercial/residential mesh-sheet standardized block modules are assembled to form a shipping industry standardized urban product. In a further preferred technical embodiment of the present invention, a required quantity of shipping industry R&D transactional mesh-sheet standardized block modules are assembled to form a R&D transactional shipping industry standardized urban product. In a still further preferred technical embodiment of the present invention, the shipping product industrial manufacturing and commercial/residential as well as R&D transactional mesh-sheet standardized block modules are assembled to form a shipping industry standardized urban product.

The shipping industry standardized urban product includes worldwide (under)water shipping machines, shipping machine materials, parts and members of shipping machine, accessories of shipping machine, shipping machine manufacturing machineries, shipping machine manufacturing machinery materials, parts and members of shipping machine manufacturing machinery, accessories of shipping machine manufacturing machinery, and provides shipping machine mesh-sheet standardized block modules; includes worldwide shipping products, shipping product materials, parts and members of shipping product, shipping product manufacturing machinery, shipping product manufacturing machinery materials, parts and members of shipping product manufacturing machinery, accessories of shipping product manufacturing machinery, accessories of shipping product, and provides shipping product mesh-sheet standardized block modules; includes worldwide port equipments, port equipment materials, parts and members of port equipment, accessories of port equipment, and provides port equipment mesh-sheet standardized block modules. The shipping industry standardized urban product includes worldwide shipping product research and development, manufacturing, marketing, operation managing enterprises, and perform intensive marketing to the world market.

Upon actual requirements, the shipping industry standardized urban products are provided with business invitation and investment office areas, market areas, residence areas, recreation and entertainment areas, standardized workshop areas, logistic storage areas, intellectual property and various property trade centers of shipping products and accessories, shipping industry cultural and artistic media centers, shipping product complaint centers, shipping product maintenance service centers, shipping industry commercial centers, real estate investment and trade centers, talent labor exchange centers of shipping industry, shipping industrial parks, shipping industrial museums, shipping industry book centers, water exhibition and performance areas, science and technology exploration institution of shipping industry, shipping industrial universities, shipping industrial technical schools, standardized senior high schools, standardized kindergarten, primary, and middle schools, construction infrastructure and social infrastructure of standardized urban product. The shipping industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Shipping Products Culture Festival” activity annually, so as to improve the science/technology content and cultural artistic taste of the worldwide shipping industry, and promote the marketing ability of worldwide shipping products.

4. Rail Industry Standardized Urban Product

In a preferred technical embodiment of the present invention, a required quantity of rail product industrial manufacturing and commercial/residential mesh-sheet standardized block modules are assembled to form a rail industry standardized urban product. In a further preferred technical embodiment of the present invention, a required quantity of rail product R&D transactional mesh-sheet standardized block modules are assembled to form a R&D transactional rail industry standardized urban product. In a still further preferred technical embodiment of the present invention, the rail product industrial manufacturing and commercial/residential as well as R&D transactional mesh-sheet standardized block modules assembled to form a rail industry standardized urban product.

The rail industry standardized urban product includes worldwide rail products, rail product materials, parts and members of rail product, rail product manufacturing machineries, rail product manufacturing machinery materials, parts and members of rail product manufacturing machinery, accessories of rail product manufacturing machinery, accessories of rail product. The rail industry standardized urban product includes worldwide rail product research and development, manufacturing, marketing, operation managing enterprises, and perform intensive marketing to the world market.

Upon actual requirements, the rail industry standardized urban product is provided with business invitation and investment office areas, market areas, standardized workshop areas, residence areas, recreation and entertainment areas, business areas, logistic storage areas, intellectual property and various property trade centers of rail products and accessories, rail product cultural and artistic media centers, rail industry commercial centers, rail product complaint centers, rail product maintenance service centers, real estate investment and trade centers, talent labor exchange centers of rail industry, rail industrial museums, rail industry book centers, science and technology exploration institution of rail industry, rail industrial parks, rail industrial universities, rail industrial technical schools, standardized senior high schools, standardized kindergarten, primary, and middle schools, construction infrastructure and social infrastructure of standardized urban product. The rail industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Rail Products Culture Festival” activity annually, so as to improve the science/technology content and cultural artistic taste of the worldwide rail industry, and promote the marketing ability of worldwide rail products.

5. Automobile Industry Standardized Urban Product

In a preferred technical embodiment of the present invention, a required quantity of automobile industrial manufacturing and commercial/residential mesh-sheet standardized block modules are assembled to form an automobile industry standardized urban product. In a further preferred technical embodiment of the present invention, a required quantity of automobile R&D transactional mesh-sheet standardized block modules are assembled to form a R&D transactional automobile industry standardized urban product. In a still further preferred technical embodiment of the present invention, a required quantity of automobile industrial manufacturing and commercial/residential as well as the R&D transactional mesh-sheet standardized block modules are assembled to form an automobile industry standardized urban product.

The automobile industry standardized urban product includes worldwide automobiles, automobile manufacturing materials, parts and members of automobile, automobile manufacturing machineries, automobile manufacturing machinery materials, parts and members of automobile manufacturing machinery, accessories of automobile manufacturing machinery, accessories of automobile product. The automobile industry standardized urban product includes worldwide automobile research and development, manufacturing, marketing, operation managing enterprises, and perform intensive marketing to the world market.

Upon actual requirements, the automobile industry standardized urban product is provided with business invitation and investment office areas, market areas, standardized workshop areas, residence areas, recreation and entertainment areas, business areas, logistic storage areas, automobile industrial parks, automobile industrial museums, automobile industry book centers, real estate investment and trade centers, intellectual property and various property trade centers of automobile and accessories, automobile cultural and artistic media centers, automobile industry commercial centers, talent labor exchange centers of automobile industry, parking lots, test-driving lanes of automobile sales, automobile complaint centers, automobile maintenance service centers, science and technology exploration institution of automobile industry, automobile industrial universities, automobile industrial technical schools, standardized senior high schools, standardized kindergarten, primary, and middle schools, construction infrastructure and social infrastructure of standardized urban product. The automobile commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Automobile Culture Festival” activity annually, so as to improve the science/technology content and cultural artistic taste of the worldwide automobile industry, and promote the marketing ability of worldwide automobile.

6. Motorcycle Industry Standardized Urban Product

In a preferred technical embodiment of the present invention, a required quantity of motorcycle industrial manufacturing and commercial/residential mesh-sheet standardized block modules are assembled to form a motorcycle industry standardized urban product. In a further preferred technical embodiment of the present invention, a required quantity of motorcycle R&D transactional mesh-sheet standardized block modules are assembled to form a R&D transactional motorcycle industry standardized urban product. In a still further preferred technical embodiment of the present invention, motorcycle industrial manufacturing and commercial/residential as well as the R&D transactional mesh-sheet standardized block modules are assembled to form a motorcycle industry standardized urban product.

The motorcycle industry standardized urban product includes worldwide motorcycles, motorcycle decoration accessories, motorcycle materials, parts and members of motorcycle, motorcycle manufacturing machineries, motorcycle manufacturing machinery materials, parts and members of motorcycle manufacturing machinery, accessories of motorcycle manufacturing machinery, accessories of motorcycle. The motorcycle industry standardized urban product includes worldwide motorcycle research and development, manufacturing, marketing, operation managing enterprises, and perform intensive marketing to the world market.

Upon actual requirements, the motorcycle industry standardized urban product is provided with business invitation and investment office areas, market areas, standardized workshop areas, residence areas, recreation and entertainment areas, business areas, logistic storage areas, motorcycle industrial parks, motorcycle industrial museums, motorcycle industry book centers, real estate investment and trade centers, intellectual property and various property trade centers of motorcycle and accessories, motorcycle cultural and artistic media centers, motorcycle commercial centers, motorcycle complaint centers, motorcycle maintenance service centers, talent labor exchange centers of motorcycle industry, science and technology exploration institution of motorcycle industry, motorcycle industrial universities, motorcycle industrial technical schools, standardized senior high schools, standardized kindergarten, primary, and middle schools, construction infrastructure and social infrastructure of standardized urban product. The motorcycle industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Motorcycle Culture Festival” activity annually, so as to improve the science/technology content and cultural artistic taste of the worldwide motorcycle industry, and promote the marketing ability of worldwide motorcycle.

7. Bicycle Industry Standardized Urban Product

In a preferred technical embodiment of the present invention, a required quantity of bicycle industrial manufacturing and commercial/residential mesh-sheet standardized block modules are assembled to form a bicycle industry standardized urban product. In a further preferred technical embodiment of the present invention, a required quantity bicycle industry R&D transactional mesh-sheet standardized block modules are assembled to form a R&D transactional standardized urban products of bicycle. In a still further preferred technical embodiment of the present invention, bicycle industrial manufacturing and commercial/residential as well as R&D transactional mesh-sheet standardized block modules are assembled to form a bicycle industry standardized urban product.

The bicycle industry standardized urban product includes worldwide bicycles, bicycle materials, parts and members of bicycle, bicycle decoration accessories, bicycle manufacturing machineries, bicycle manufacturing machinery materials, parts and members of bicycle manufacturing machinery, accessories of bicycle manufacturing machinery, accessories of bicycle. The bicycle industry standardized urban product includes worldwide bicycle research and development, manufacturing, marketing, operation managing enterprises, and perform intensive marketing to the world market.

Upon actual requirements, the bicycle industry standardized urban product is provided with business invitation and investment office areas, market areas, standardized workshop areas, residence areas, business areas, recreation and entertainment areas, logistic storage areas, bicycle industrial parks, bicycle industrial museums, bicycle industry book centers, real estate investment and trade centers, intellectual property and various property trade centers of bicycle and accessories, bicycle cultural and artistic media centers, bicycle industry commercial centers, bicycle complaint centers, bicycle maintenance service centers, talent labor exchange centers of bicycle industry, science and technology exploration institution of bicycle industry, bicycle industrial universities, bicycle industrial technical schools, standardized senior high schools, standardized kindergarten, primary, and middle schools, construction infrastructure and social infrastructure of standardized urban product. The bicycle commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Bicycle Culture Festival” activity annually, so as to improve the science/technology content and cultural artistic taste of the worldwide bicycle industry, and promote the marketing ability of worldwide bicycle.

8. Construction Machinery Industry Standardized Urban Product

In a preferred technical embodiment of the present invention, a required quantity of construction machinery industrial manufacturing and commercial/residential mesh-sheet standardized block modules are assembled to form a construction machinery industry standardized urban product. In a further preferred technical embodiment of the present invention, a required quantity of construction machinery R&D transactional mesh-sheet standardized block modules are assembled to form a R&D transactional construction machinery industry standardized urban product. In a still further preferred technical embodiment of the present invention, construction machinery industrial manufacturing and commercial/residential as well as R&D transactional mesh-sheet standardized block modules are assembled to form a construction machinery industry standardized urban product.

The construction machinery industry standardized urban product includes worldwide construction machines, construction machinery materials, parts and members of construction machinery, construction machinery manufacturing machines, construction machinery manufacturing machine materials, parts and members of construction machinery manufacturing machine, accessories of construction machinery manufacturing machine, accessories of construction machinery. The construction machinery industry standardized urban product includes worldwide construction machinery research and development, manufacturing, marketing, operation managing enterprises, and perform intensive marketing to the world market.

Upon actual requirements, the construction machinery industry standardized urban product is provided with business invitation and investment office areas, market areas, standardized workshop areas, residence areas, recreation and entertainment areas, business areas, logistic storage areas, real estate investment and trade centers, intellectual property and various property trade centers of construction machinery and accessories, construction machinery cultural and artistic media centers, construction machinery industry commercial centers, talent labor exchange centers of construction machinery industry, construction machinery complaint centers, construction machinery maintenance service centers, science and technology exploration institution of construction machinery industry, blueprint industrial parks, construction machinery industrial museums, construction machinery industry book centers, construction machinery industrial universities, construction machinery industrial technical schools, standardized senior high schools, standardized kindergarten, primary, and middle schools, construction infrastructure and social infrastructure of standardized urban product. The construction machinery commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Construction Machinery Culture Festival” activity annually, so as to improve the science/technology content and cultural artistic taste of the worldwide construction machinery industry, and promote the marketing ability of worldwide construction machinery.

9. Construction Material Industry Standardized Urban Product

In a preferred technical embodiment of the present invention, a required quantity construction material industrial manufacturing and commercial/residential mesh-sheet standardized block modules are assembled to form a construction material industry standardized urban product. In a further preferred technical embodiment of the present invention, a required quantity of construction material R&D transactional mesh-sheet standardized block modules are assembled to form a R&D transactional construction material industry standardized urban product. In a still further preferred technical embodiment of the present invention, construction material industrial manufacturing and commercial/residential as well as R&D transactional mesh-sheet standardized block modules are assembled to form a construction material industry standardized urban product.

The construction material industry standardized urban product includes worldwide construction steel materials and accessories, and provides construction steel material mesh-sheet standardized block modules; includes worldwide construction copper materials and accessories, and provides construction copper material mesh-sheet standardized block modules; includes worldwide aluminum alloy construction materials and accessories, and provides aluminum alloy construction material mesh-sheet standardized block modules; includes worldwide construction cements, cement manufacturing machineries, cement manufacturing machinery materials, parts and members of cement manufacturing machinery, accessories of cement manufacturing machinery, accessories of cement, and provides construction cement mesh-sheet standardized block modules; includes worldwide construction ceramic tiles, ceramic tile manufacturing machineries, ceramic tile manufacturing machinery materials, parts and members of ceramic tile manufacturing machinery, accessories of ceramic tile manufacturing machinery, accessories of ceramic tile, and provides construction ceramic tile mesh-sheet standardized block modules; includes worldwide construction stone materials, construction stone material manufacturing machineries, stone material manufacturing machinery materials, parts and members of stone material manufacturing machinery, accessories of stone material manufacturing machinery, accessories of stone material, and provides construction stone material mesh-sheet standardized block modules; includes worldwide construction glasses and corollary machines and accessories, and provides construction glass mesh-sheet standardized block modules; includes worldwide metallic construction materials and corollary machines and accessories, and provides metallic construction material mesh-sheet standardized block modules; includes worldwide new construction materials and corollary machines and accessories, and provides new construction material mesh-sheet standardized block modules; includes worldwide pitch concrete construction materials, pitch concrete construction material manufacturing machineries, pitch concrete construction material manufacturing machinery materials, parts and members of pitch concrete construction material manufacturing machinery, accessories of pitch concrete construction material manufacturing machinery, accessories of pitch concrete construction material, and provides pitch concrete construction material mesh-sheet standardized block modules; includes worldwide office building decoration materials and corollary machines and accessories, and provides office building's construction material mesh-sheet standardized block modules; includes worldwide household decoration materials and corollary machines and accessories, and provides household decoration construction material mesh-sheet standardized block modules; includes worldwide hotel and restaurant decoration materials and corollary machines and accessories, and provides hotel and restaurant decoration construction material mesh-sheet standardized block modules; includes worldwide industrial and mineral enterprise decoration materials and corollary machines and accessories, and provides industrial and mineral enterprise decoration construction material mesh-sheet standardized block modules; includes worldwide kitchen decoration materials and corollary machines and accessories, and provides kitchen decoration construction material mesh-sheet standardized block modules; includes worldwide bathroom decoration materials and corollary machines and accessories, and provides bathroom decoration construction material mesh-sheet standardized block modules; includes worldwide door and window decoration materials and corollary machines and accessories, and provides door and window decoration construction material mesh-sheet standardized block modules; includes worldwide lamps, lamp materials, parts and members of lamp, lamp manufacturing machineries, lamp manufacturing machinery materials, parts and members of lamp manufacturing machinery, accessories of lamp manufacturing machinery, accessories of lamp, and provides lamp mesh-sheet standardized block modules; includes worldwide paintings/coatings, painting/coating manufacturing machineries, painting/coating manufacturing machinery materials, parts and members of painting/coating manufacturing machinery, accessories of painting/coating manufacturing machinery, painting/coating manufacturing materials, accessories of painting/coating, and provides painting/coating standardized block products; includes worldwide water proof, fire proof, rot proof construction materials and corollary machines and accessories, and provides water proof, fire proof, rot proof construction material mesh-sheet standardized block modules. The construction material industry standardized urban product includes worldwide research and development, manufacturing, marketing, operation managing enterprises, and perform intensive marketing to the world market.

Upon actual requirements, the construction material industry standardized urban product is provided with business invitation and investment office areas, market areas, standardized workshop areas, residence areas, recreation and entertainment areas, business areas, logistic storage areas, construction material industrial parks, construction material industrial museums, construction material industry book centers, real estate investment and trade centers, intellectual property and various property trade centers of construction material and accessories, construction material complaint centers, construction material maintenance service centers, construction material cultural and artistic media centers, construction material industry commercial centers, talent labor exchange centers of construction material industry, science and technology exploration institution of construction material industry, construction material industrial universities, construction material industrial technical schools, standardized senior high schools, standardized kindergarten, primary, and middle schools, construction infrastructure and social infrastructure of standardized urban product. The construction material industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Construction Material Culture Festival” activity annually, so as to improve the science/technology content and cultural artistic taste of the worldwide construction material industry, and promote the marketing ability of worldwide construction material.

10. Steel Industry Standardized Urban Product

In a preferred technical embodiment of the present invention, a required quantity of steel product industrial manufacturing and commercial/residential mesh-sheet standardized block modules are assembled to form a steel industry standardized urban product. In a further preferred technical embodiment of the present invention, a required quantity of steel product R&D transactional mesh-sheet standardized block are assembled to form a R&D transactional steel industry standardized urban product. In a still further preferred technical embodiment of the present invention, steel product industrial manufacturing and commercial/residential as well as R&D transactional mesh-sheet standardized block modules are assembled to form a steel industry standardized urban product.

The steel industry standardized urban product includes worldwide steels, steel materials, machines of steel plant, machine materials of steel plant, parts and members of steel plant machine, accessories of steel plant machine, steel products, steel product manufacturing machineries, steel product manufacturing machinery materials, parts and members of steel product manufacturing machinery, accessories of steel product manufacturing machinery, accessories of steel product. The steel industry standardized urban product includes worldwide steel product research and development, manufacturing, marketing, operation managing enterprises, and perform intensive marketing to the world market.

Upon actual requirements, the steel industry standardized urban product is provided with business invitation and investment office areas, market areas, standardized workshop areas, residence areas, business areas, recreation and entertainment areas, logistic storage areas, real estate investment and trade centers, intellectual property and various property trade centers of steel product and accessories, steel product cultural and artistic media centers, steel industry commercial centers, talent labor exchange centers of steel industry, steel product complaint centers, steel product maintenance service centers, science and technology exploration institution of steel industry, steel industrial parks, steel industrial museums, steel industry book centers, steel industrial universities, steel industrial technical schools, standardized senior high schools, standardized kindergarten, primary, and middle schools, construction infrastructure and social infrastructure of standardized urban product. The steel product commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Steel Culture Festival” activity annually, so as to improve the science/technology content and cultural artistic taste of the worldwide steel industry, and promote the marketing ability of worldwide steel product.

11. Copper Material Industry Standardized Urban Product

In a preferred technical embodiment of the present invention, a required quantity of copper material product industrial manufacturing and commercial/residential mesh-sheet standardized block modules are assembled to form a copper material industry standardized urban product. In a further preferred technical embodiment of the present invention, a required quantity of copper material product R&D transactional mesh-sheet standardized block modules are assembled to form a R&D transactional copper material industry standardized urban product. In a still further preferred technical embodiment of the present invention, copper material product industrial manufacturing and commercial/residential as well as R&D transactional mesh-sheet standardized block modules are assembled to form a copper material industry standardized urban product.

The copper material industry standardized urban product includes worldwide copper materials, materials of copper material, machines of copper plant, machine materials of copper plant, parts and members of copper plant machine, accessories of copper plant machine; copper material products, copper material product materials, parts and members of copper material product, accessories of copper material product; copper material product manufacturing machineries, copper material product manufacturing machinery materials, parts and members of copper material product manufacturing machinery, accessories of copper material product manufacturing machinery. The copper material industry standardized urban product includes worldwide copper material product research and development, manufacturing, marketing, operation managing enterprises, and perform intensive marketing to the world market.

Upon actual requirements, the copper material industry standardized urban product is provided with business invitation and investment office areas, market areas, standardized workshop areas, residence areas, recreation and entertainment areas, business areas, logistic storage areas, real estate investment and trade centers, intellectual property and various property trade centers of copper material product and accessories, copper material product cultural and artistic media centers, copper material industry commercial centers, copper material product complaint centers, copper material product maintenance service centers, talent labor exchange centers of copper material industry, science and technology exploration institution of copper material industry, copper material industrial parks, copper material industrial museums, copper material industry book centers, copper material industrial universities, copper material industrial technical schools, standardized senior high schools, standardized kindergarten, primary, and middle schools, construction infrastructure and social infrastructure of standardized urban product. The copper material product commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Copper Material Product Culture Festival” activity annually, so as to improve the science/technology content and cultural artistic taste of the worldwide copper material industry, and promote the marketing ability of worldwide copper material product.

12. Aluminum Material Industry Standardized Urban Product

In a preferred technical embodiment of the present invention, a required quantity of aluminum material product industrial manufacturing and commercial/residential mesh-sheet standardized block modules are assembled to form an aluminum material industry standardized urban product. In a further preferred technical embodiment of the present invention, a required quantity of aluminum material product R&D transactional mesh-sheet standardized block modules are assembled to form a R&D transactional aluminum material industry standardized urban product. In a still further preferred technical embodiment of the present invention, aluminum material product industrial manufacturing and commercial/residential as well as R&D transactional mesh-sheet standardized block modules are assembled to form an aluminum material industry standardized urban product.

The aluminum material industry standardized urban product includes worldwide aluminum materials, materials of aluminum material, aluminum material products, aluminum material product materials, parts and members of aluminum material product, aluminum material product manufacturing machineries, aluminum material product manufacturing machinery materials, parts and members of aluminum material product manufacturing machinery, accessories of aluminum material product manufacturing machinery, accessories of aluminum material product. The aluminum material industry standardized urban product includes worldwide aluminum material product research and development, manufacturing, marketing, operation managing enterprises, and perform intensive marketing to the world market.

Upon actual requirements, the aluminum material industry standardized urban product is provided with business invitation and investment office areas, market areas, standardized workshop areas, residence areas, recreation and entertainment areas, business areas, logistic storage areas, real estate investment and trade centers, intellectual property and various property trade centers of aluminum material product and accessories, aluminum material product cultural and artistic media centers, aluminum material industry commercial centers, aluminum material product complaint centers, aluminum material product maintenance service centers, talent labor exchange centers of aluminum material industry, science and technology exploration institution of aluminum material industry, Lvhai industrial parks, aluminum material industrial museums, aluminum material industry book centers, aluminum material industrial universities, aluminum material industrial technical schools, standardized senior high schools, standardized kindergarten, primary, and middle schools, construction infrastructure and social infrastructure of standardized urban product. The aluminum material industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Aluminum Material Product Culture Festival” activity annually, so as to improve the science/technology content and cultural artistic taste of the worldwide aluminum material industry, and promote the marketing ability of worldwide aluminum material product.

13. Mining Industry Standardized Urban Product

In a preferred technical embodiment of the present invention, a required quantity of mining product industrial manufacturing and commercial/residential mesh-sheet standardized block modules are assembled to form a mining industry standardized urban product. In a further preferred technical embodiment of the present invention, a required quantity of mining product R&D transactional mesh-sheet standardized block modules are assembled to form a R&D transactional mining industry standardized urban product. In a still further preferred technical embodiment of the present invention, mining product industrial manufacturing and commercial/residential as well as R&D transactional mesh-sheet standardized block modules are assembled to form a mining industry standardized urban product.

The mining industry standardized urban product includes worldwide mining products, mine resources, mine resource exploiting machines, mine resource exploiting machine materials, parts and members of mine resource exploiting machine, accessories of mine resource exploiting machine, mining product manufacturing machineries, mining product manufacturing machinery materials, parts and members of mining product manufacturing machinery, accessories of mining product manufacturing machinery, accessories of mining product. The mining industry standardized urban product includes worldwide mining product research and development, manufacturing, marketing, operation managing enterprises, and perform intensive marketing to the world market.

Upon actual requirements, the mining industry standardized urban product is provided with business invitation and investment office areas, market areas, standardized workshop areas, residence areas, recreation and entertainment areas, business areas, logistic storage areas, real estate investment and trade centers, intellectual property and various property trade centers of mining product and accessories, mining product cultural and artistic media centers, mining industry commercial centers, mining product complaint centers, mining product maintenance service centers, talent labor exchange centers of mining industry, science and technology exploration institution of mining industry, mining treasure industrial parks, mining industrial museums, mining industry book centers, mining industrial universities, mining industrial technical schools, standardized senior high schools, standardized kindergarten, primary, and middle schools, construction infrastructure and social infrastructure of standardized urban product. The mining product commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Mining Product Culture Festival” activity annually, so as to improve the science/technology content and cultural artistic taste of the worldwide mining product, and promote the marketing ability of worldwide mining product.

14. Petrochemical Industry Standardized Urban Product

In a preferred technical embodiment of the present invention, a required quantity petrochemical industrial manufacturing and commercial/residential mesh-sheet standardized block modules are assembled to form a petrochemical industry standardized urban product. In a further preferred technical embodiment of the present invention, a required quantity of petrochemical R&D transactional mesh-sheet standardized block modules are assembled to form a R&D transactional petrochemical industry standardized urban product. In a still further preferred technical embodiment of the present invention, petrochemical industrial manufacturing and commercial/residential as well as R&D transactional mesh-sheet standardized block modules are assembled to form a petrochemical industry standardized urban product.

The petrochemical industry standardized urban product includes worldwide petroleum resources, petroleum exploiting machines, petroleum exploiting machine materials, parts and members of petroleum exploiting machine, accessories of petroleum exploiting machine, petrochemical product manufacturing machineries, petrochemical product manufacturing machinery materials, parts and members of petrochemical product manufacturing machinery, accessories of petrochemical product manufacturing machinery, petrochemical products, accessories of petrochemical product. The petrochemical industry standardized urban product includes worldwide petrochemical research and development, manufacturing, marketing, operation managing enterprises, and perform intensive marketing to the world market.

Upon actual requirements, the petrochemical industry standardized urban product of is provided with business invitation and investment office areas, market areas, standardized workshop areas, residence areas, recreation and entertainment areas, business areas, logistic storage areas, intellectual property and various property trade centers of petrochemical product and accessories, petrochemical product cultural and artistic media centers, petrochemical industry commercial centers, petrochemical product complaint centers, petrochemical product maintenance service centers, talent labor exchange centers of petrochemical industry, real estate investment and trade centers, science and technology exploration institution of petrochemical industry, petrochemical industrial parks, petrochemical industrial museums, petrochemical industry book centers, petrochemical industrial universities, petrochemical industrial technical schools, standardized senior high schools, standardized kindergarten, primary, and middle schools, construction infrastructure and social infrastructure of standardized urban product. The petrochemical commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Petrochemical Industry Culture Festival” activity annually, so as to improve the science/technology content and cultural artistic taste of the worldwide petrochemical industry, and promote the marketing ability of worldwide petrochemical product.

15. Fuel Gas Industry Standardized Urban Product

In a preferred technical embodiment of the present invention, a required quantity fuel gas product industrial manufacturing and commercial/residential mesh-sheet standardized block modules are assembled to form a fuel gas industry standardized urban product. In a further preferred technical embodiment of the present invention, a required quantity of fuel gas product R&D transactional mesh-sheet standardized block modules are assembled to form a R&D transactional fuel gas industry standardized urban product. In a still further preferred technical embodiment of the present invention, fuel gas product industrial manufacturing and commercial/residential as well as R&D transactional mesh-sheet standardized block modules are assembled to form a fuel gas industry standardized urban product.

The fuel gas industry standardized urban product includes worldwide fuel gas resources, fuel gas resource exploiting machines, fuel gas resource exploiting machine materials, parts and members of fuel gas resource exploiting machine, accessories of fuel gas resource exploiting machine, fuel gas product manufacturing machineries, fuel gas product manufacturing machinery materials, parts and members of fuel gas product manufacturing machinery, accessories of fuel gas product manufacturing machinery, fuel gas products, accessories of fuel gas product. The fuel gas industry standardized urban product includes worldwide fuel gas product research and development, manufacturing, marketing, operation managing enterprises, and perform intensive marketing to the world market.

Upon actual requirements, the fuel gas industry standardized urban product is provided with business invitation and investment office areas, market areas, standardized workshop areas, residence areas, recreation and entertainment areas, business areas, logistic storage areas, real estate investment and trade centers, talent labor exchange centers of fuel gas industry, intellectual property and various property trade centers of fuel gas product and accessories, fuel gas product cultural and artistic media centers, fuel gas industry commercial centers, fuel gas product complaint centers, fuel gas product maintenance service centers, science and technology exploration institution of fuel gas industry, fuel gas industrial parks, fuel gas industrial museums, fuel gas industry book centers, fuel gas industrial universities, fuel gas industrial technical schools, standardized senior high schools, standardized kindergarten, primary, and middle schools, construction infrastructure and social infrastructure of standardized urban product. The fuel gas product commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Fuel Gas Product Culture Festival” activity annually, so as to improve the science/technology content and cultural artistic taste of the worldwide fuel gas industry, and promote the marketing ability of worldwide fuel gas product.

16. Environmental Protection Industry Standardized Urban Product

In a preferred technical embodiment of the present invention, a required quantity of environment protection product industrial manufacturing and commercial/residential mesh-sheet standardized block modules are assembled to form an environmental protection industry standardized urban product. In a further preferred technical embodiment of the present invention, a required quantity of environment protection product R&D transactional mesh-sheet standardized block modules are assembled to form a R&D transactional environmental protection industry standardized urban product. In a still further preferred technical embodiment of the present invention, environment protection product industrial manufacturing and commercial/residential as well as R&D transactional mesh-sheet standardized block modules are assembled to form an environmental protection industry standardized urban product.

The environmental protection industry standardized urban product includes worldwide environment protection products, environment protection product manufacturing machineries, environment protection product manufacturing machinery materials, parts and members of environment protection product manufacturing machinery, accessories of environment protection product manufacturing machinery, environment protection product materials, parts and members of environment protection product, accessories of environment protection product. The environmental protection industry standardized urban product includes worldwide environment protection product research and development, manufacturing, marketing, operation managing enterprises, and perform intensive marketing to the world market.

Upon actual requirements, the environmental protection industry standardized urban product is provided with business invitation and investment office areas, market areas, standardized workshop areas, residence areas, recreation and entertainment areas, business areas, logistic storage areas, industrial parks, environment protection industrial museums, environment protection industry book centers, intellectual property and various property trade centers of environment protection product and accessories, environment protection product cultural and artistic media centers, environment protection industry commercial centers, environment protection product complaint centers, environment protection product maintenance service centers, talent labor exchange centers of environment protection industry, real estate investment and trade centers, science and technology exploration institution of environment protection industry, environment protection industrial universities, environment protection industrial technical schools, standardized senior high schools, standardized kindergarten, primary, and middle schools, construction infrastructure and social infrastructure of standardized urban product. The environment protection industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Environment Protection Product Culture Festival” activity annually, so as to improve the science/technology content and cultural artistic taste of the worldwide environment protection industry, and promote the marketing ability of worldwide environment protection product.

17. Electric Power Industry Standardized Urban Product

In a preferred technical embodiment of the present invention, a required quantity electric power product industrial manufacturing and commercial/residential mesh-sheet standardized block modules are assembled to form an electric power industry standardized urban product. In a further preferred technical embodiment of the present invention, a required quantity of electric power product R&D transactional mesh-sheet standardized block modules are assembled to form a R&D transactional electric power industry standardized urban product. In a still further preferred technical embodiment of the present invention, electric power product industrial manufacturing and commercial/residential as well as R&D transactional mesh-sheet standardized block modules are assembled to form an electric power industry standardized urban product.

The electric power industry standardized urban product includes worldwide power generating resources, power plant machines, power generating machines, power generating machine materials, parts and members of power generating machine, accessories of power generating machine, electric power products, electric power product materials, parts and members of electric power product, accessories of electric power product. The electric power industry standardized urban product includes worldwide electric power product research and development, manufacturing, marketing, operation managing enterprises, and perform intensive marketing to the world market.

Upon actual requirements, the electric power industry standardized urban product is provided with business invitation and investment office areas, market areas, standardized workshop areas, residence areas, recreation and entertainment areas, business areas, logistic storage areas, intellectual property and various property trade centers of electric power product and accessories, electric power product cultural and artistic media centers, electric power industry commercial centers, real estate investment and trade centers, talent labor exchange centers of electric power industry, electric power product complaint centers, electric power product maintenance service centers, science and technology exploration institution of electric power industry, photoelectrical industrial parks, photoelectrical industrial museums, electric power industry book centers, electric power industrial universities, electric power industrial technical schools, standardized senior high schools, standardized kindergarten, primary, and middle schools, construction infrastructure and social infrastructure of standardized urban product. The electric power industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Photoelectrical Culture Festival” activity annually, so as to improve the science/technology content and cultural artistic taste of the worldwide electric power industry, and promote the marketing ability of worldwide electric power product.

18. Agricultural Product Industry Standardized Urban Product

In a preferred technical embodiment of the present invention, a required quantity of agricultural product industrial manufacturing and commercial/residential mesh-sheet standardized block modules are assembled to form an agricultural product industry standardized urban product. In a further preferred technical embodiment of the present invention, a required quantity of agricultural product R&D transactional mesh-sheet standardized block modules are assembled to form a R&D transactional agricultural product industry standardized urban product. In a still further preferred technical embodiment of the present invention, agricultural product industrial manufacturing and commercial/residential as well as R&D transactional mesh-sheet standardized block modules are assembled to form an agricultural product industry standardized urban product.

The agricultural product industry standardized urban product includes worldwide agriculture machines, agriculture machine materials, parts and members of agriculture machine, accessories of agriculture machine, and provides agriculture machine mesh-sheet standardized block modules; includes worldwide pesticides, original materials of pesticide, pesticide manufacturing machineries, pesticide manufacturing machinery materials, parts and members of pesticide manufacturing machinery, accessories of pesticide manufacturing machinery, accessories of pesticide, and provides pesticide mesh-sheet standardized block modules; includes worldwide fertilizers, original materials of fertilizer, fertilizer manufacturing machineries, fertilizer manufacturing machinery materials, parts and members of fertilizer manufacturing machinery, accessories of fertilizer manufacturing machinery, and provides fertilizer mesh-sheet standardized block modules; includes worldwide agriculture plastic films, agriculture tools, agriculture automatic and semiautomatic irrigating tools, and provides agriculture tool mesh-sheet standardized block modules; includes worldwide agricultural product, agricultural product process and manufacturing machinery, agricultural product process and manufacturing machinery materials, parts and members of agricultural product process and manufacturing machinery, accessories of agricultural product process and manufacturing machinery, accessories of agricultural product, and provides agricultural product mesh-sheet standardized block modules. The agricultural product industry standardized urban product includes worldwide research and development, manufacturing, marketing, operation managing enterprises, and perform intensive marketing to the world market.

Upon actual requirements, the agricultural product industry standardized urban product is provided with business invitation and investment office areas, market areas, standardized workshop areas, residence areas, recreation and entertainment areas, business areas, logistic storage areas, intellectual property and various property trade centers of agricultural product and accessories, agricultural product cultural and artistic media centers, agricultural product industry commercial centers, agricultural product complaint centers, agricultural product maintenance service centers, talent labor exchange centers of agricultural product industry, real estate investment and trade centers, science and technology exploration institution of agricultural product industry, agriculture industrial parks, agricultural product industrial museums, agricultural product book centers, agricultural product industrial universities, agricultural product industrial technical schools, standardized senior high schools, standardized kindergarten, primary, and middle schools, construction infrastructure and social infrastructure of standardized urban product. The agricultural product industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Agricultural Product Culture Festival” activity annually, so as to improve the science/technology content and cultural artistic taste of the worldwide agricultural product industry, and promote the marketing ability of worldwide agricultural product.

19. Ethnic Customs Dietary Culture Industry Standardized Urban Product

In a preferred technical embodiment of the present invention, a required quantity of ethnic customs dietary culture industrial manufacturing and commercial/residential mesh-sheet standardized block modules are assembled to form an ethnic customs dietary culture industry standardized urban product. In a further preferred technical embodiment of the present invention, a required quantity of ethnic customs dietary culture R&D transactional mesh-sheet standardized block modules are assembled to form a R&D transactional ethnic customs dietary culture industry standardized urban product. In a still further preferred technical embodiment of the present invention, ethnic customs dietary culture industrial manufacturing and commercial/residential as well as R&D transactional mesh-sheet standardized block modules are assembled to form an ethnic customs dietary culture industry standardized urban product.

There are more than 2000 nationalities in the world. Many of them have own architectural styles, handicraft articles, dietary customs, dietary characteristics, dietary habits, dietary cultures, dietary utensils, dietary machines.

The ethnic customs dietary culture industry standardized urban product includes worldwide different nationalities' architectural styles, different complexions' and different nationalities' handicraft articles, dietary categories, dietary customs, dietary characteristics, dietary cultures; includes different complexions' and different nationalities' dietary utensils, dietary machines, dietary machine materials, parts and members of dietary machine, accessories of dietary machine, kitchen utensils, kitchen utensil materials, parts and members of kitchen utensil, accessories of kitchen utensil, kitchen utensil manufacturing machineries, kitchen utensil manufacturing machinery materials, parts and members of kitchen utensil manufacturing machinery, accessories of kitchen utensil manufacturing machinery, dietary supplies, dietary decorations, dietary advertisements, accessories of dietary culture. The ethnic customs dietary culture industry standardized urban product includes worldwide ethnic customs dietary culture product research and development, manufacturing, marketing, operation managing enterprises, and perform intensive tested trade to the world market.

In the preferred technical embodiment of the present invention, that project is provided as portal base, and the poverty alleviation is developed as overall plan to worldwide poor regions in the field of resources, projects, products, labor services, talents, cultures and arts, etc. Characteristic projects, characteristic labor services, cultures and arts of characteristic product in the worldwide poor regions are taken as characteristics. After operating and integrating the ethnic customs dietary culture standardized urban products, characteristic products of poor regions are developed and marketed in the world market. In the present invention, the investment and cooperating management of ethnic enterprises and ethnic artists are preferred in every country all over the world, so as to facilitate the introduction of every country's most sterling culture characteristics with ethnic flavor.

Upon actual requirements, the ethnic customs dietary culture industry standardized urban product is provided with business invitation and investment office areas, market areas, standardized workshop areas, residence areas, recreation and entertainment areas, business areas, logistic storage areas, intellectual property and various property trade centers of ethnic customs dietary culture product and accessories, ethnic customs dietary cultural and artistic media centers, ethnic customs dietary culture industry commercial centers, ethnic customs dietary culture product complaint centers, ethnic customs dietary culture product maintenance service centers, talent labor exchange centers of ethnic customs dietary culture industry, real estate investment and trade centers, science and technology exploration institution of ethnic customs dietary culture industry, dietary culture industrial parks, ethnic customs dietary culture industrial museums, ethnic customs dietary culture book centers, ethnic customs dietary culture industrial universities, ethnic customs dietary culture industrial universities, ethnic customs dietary culture industry school, standardized senior high schools, standardized kindergarten, primary, and middle schools, construction infrastructure and social infrastructure of standardized urban product. The ethnic customs dietary culture industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Ethnic Customs Dietary Culture Festival” activity annually, so as to improve the science/technology content and cultural artistic taste of the worldwide ethnic customs dietary culture product, and promote the marketing ability of worldwide ethnic customs dietary culture product.

20. Furniture Industry R&D Transactional Standardized Urban Product

In a preferred technical embodiment of the present invention, a required quantity furniture product industrial manufacturing and commercial/residential mesh-sheet standardized block modules are assembled to form a furniture industry standardized urban product. In a further preferred technical embodiment of the present invention, a required quantity of furniture product R&D transactional mesh-sheet standardized block modules are assembled to form a R&D transactional furniture industry standardized urban product. In a still further preferred technical embodiment of the present invention, furniture product industrial manufacturing and commercial/residential as well as R&D transactional mesh-sheet standardized block modules are assembled to form a furniture industry standardized urban product.

The furniture industry standardized urban product includes worldwide furniture, furniture materials, parts and members of furniture, furniture manufacturing machineries, furniture manufacturing machinery materials, parts and members of furniture manufacturing machinery, accessories of furniture manufacturing machinery, accessories of furniture product. The furniture industry standardized urban product includes worldwide furniture product research and development, manufacturing, marketing, operation managing enterprises, and perform intensive marketing to the world market.

Upon actual requirements, the furniture industry standardized urban product is provided with business invitation and investment office areas, market areas, standardized workshop areas, residence areas, recreation and entertainment areas, business areas, logistic storage areas, intellectual property and various property trade centers of furniture product and accessories, furniture product cultural and artistic media centers, furniture industry commercial centers, furniture product complaint centers, furniture product maintenance service centers, talent labor exchange centers of furniture industry, real estate investment and trade centers, science and technology exploration institution of furniture industry, furniture industrial parks, furniture industrial museums, furniture industry book centers, furniture industrial universities, furniture industrial technical schools, standardized senior high schools, standardized kindergarten, primary, and middle schools, construction infrastructure and social infrastructure of standardized urban product. The furniture industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Furniture Culture Festival” activity annually, so as to improve the science/technology content and cultural artistic taste of the worldwide furniture product, and promote the marketing ability of worldwide furniture product.

21. Office Industry Standardized Urban Product

In a preferred technical embodiment of the present invention, a required quantity of office supply industrial manufacturing and commercial/residential mesh-sheet standardized block modules are assembled to form an office industry standardized urban product. In a further preferred technical embodiment of the present invention, a required quantity of office supply R&D transactional mesh-sheet standardized block modules are assembled to form a R&D transactional office industry standardized urban product. In a still further preferred technical embodiment of the present invention, office supply industrial manufacturing and commercial/residential as well as R&D transactional mesh-sheet standardized block modules are assembled to form an office industry standardized urban product.

The office industry standardized urban product includes worldwide office supplies, office supply materials, parts and members of office supply, office supply manufacturing machineries, office supply manufacturing machinery materials, parts and members of office supply manufacturing machinery, accessories of office supply manufacturing machinery, accessories of office supply. The office industry standardized urban product includes worldwide office supply research and development, manufacturing, marketing, operation managing enterprises, and perform intensive marketing to the world market.

Upon actual requirements, the office industry standardized urban product is provided with business invitation and investment office areas, market areas, standardized workshop areas, residence areas, recreation and entertainment areas, business areas, logistic storage areas, intellectual property and various property trade centers of office supply and accessories, office supply cultural and artistic media centers, office industry commercial centers, office supply complaint centers, office supply maintenance service centers, talent labor exchange centers of office industry, real estate investment and trade centers, science and technology exploration institution of office industry, office industrial parks, office supply museums, office industry book centers, office industrial universities, office industrial technical schools, standardized senior high schools, standardized kindergarten, primary, and middle schools, construction infrastructure and social infrastructure of standardized urban product. The industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Office Supply Culture Festival” activity annually, so as to improve the science/technology content and cultural artistic taste of the worldwide office industry, and promote the marketing ability of worldwide office supplies.

22. Cultural and Artistic Industry Standardized Urban Product

In a preferred technical embodiment of the present invention, a required quantity of cultural and artistic supply industrial manufacturing and commercial/residential mesh-sheet standardized block modules are assembled to form a cultural and artistic industry standardized urban product. In a further preferred technical embodiment of the present invention, a required quantity of cultural and artistic supply R&D transactional mesh-sheet standardized block modules are assembled to form a R&D transactional cultural and artistic industry standardized urban product. In a still further preferred technical embodiment of the present invention, cultural and artistic supply industrial manufacturing and commercial/residential as well as R&D transactional mesh-sheet standardized block modules are assembled to form a cultural and artistic industry standardized urban product.

The cultural and artistic industry standardized urban product includes worldwide cultural relics/antiques and accessories of cultural relic/antique, and provides cultural relic/antique mesh-sheet standardized block modules; includes worldwide books, book manufacturing machineries, book manufacturing machinery materials, parts and members of book manufacturing machinery, accessories of book manufacturing machinery, book materials, accessories of book, and provides book mesh-sheet standardized block modules; includes worldwide sound image, sound image manufacturing machinery, sound image manufacturing machinery materials, parts and members of sound image manufacturing machinery, accessories of sound image manufacturing machinery, sound image manufacturing materials, accessories of sound image, and provides sound image mesh-sheet standardized block module; includes worldwide movie industry/television industry/optical disk industry, movie-television digital products, movie-television products, movie-television network products, movie-television network manufacturing machinery, movie-television network manufacturing machinery materials, parts and members of movie-television network manufacturing machinery, accessories of movie-television network manufacturing machinery, movie-television network manufacturing materials, accessories of movie-television network, and provides movie-television culture supply mesh-sheet standardized block modules; includes worldwide musical instruments, musical instrument manufacturing materials, parts and members of musical instrument, musical instrument manufacturing machinery, musical instrument manufacturing machinery materials, parts and members of musical instrument manufacturing machinery, accessories of musical instrument manufacturing machinery, accessories of musical instrument, and provides musical instrument mesh-sheet standardized block modules; includes worldwide tourism culture artworks, tourism culture artwork manufacturing machinery, tourism culture artwork manufacturing machinery materials, parts and members of tourism culture artwork manufacturing machinery, accessories of tourism culture artwork manufacturing machinery, tourism culture artwork manufacturing materials, accessories of tourism culture artwork, and provides tourism culture artwork mesh-sheet standardized block modules; includes worldwide news media, news media products, news media manufacturing machinery, news media manufacturing machinery materials, parts and members of news media manufacturing machinery, accessories of news media manufacturing machinery, news media product manufacturing materials, accessories of news media, and provides news media mesh-sheet standardized block modules; includes worldwide advertisement culture artworks, advertisement culture artwork materials, advertisement culture artwork manufacturing machinery, advertisement culture artwork manufacturing machinery materials, parts and members of advertisement culture artwork manufacturing machinery, accessories of advertisement culture artwork manufacturing machinery, accessories of advertisement culture artwork, and provides advertisement culture artwork mesh-sheet standardized block modules; includes worldwide wedding culture artworks, wedding culture artwork manufacturing machinery, wedding culture artwork manufacturing machinery materials, parts and members of wedding culture artwork manufacturing machinery, accessories of wedding culture artwork manufacturing machinery, wedding culture artwork manufacturing materials, accessories of wedding culture artwork, and provides wedding culture artwork mesh-sheet standardized block modules; includes worldwide religion culture artworks, religion culture artwork manufacturing machinery, religion culture artwork manufacturing machinery materials, parts and members of religion culture artwork manufacturing machinery, accessories of religion culture artwork manufacturing machinery, religion culture artwork manufacturing materials, accessories of religion culture artwork, and provides religion culture artwork mesh-sheet standardized block modules; includes worldwide funeral and interment culture artworks, funeral and interment culture artwork manufacturing machinery, funeral and interment culture artwork manufacturing machinery materials, parts and members of funeral and interment culture artwork manufacturing machinery, accessories of funeral and interment culture artwork manufacturing machinery, funeral and interment culture artwork manufacturing materials, accessories of funeral and interment culture artwork, and provides funeral and interment culture artwork mesh-sheet standardized block modules; includes worldwide culture artworks, culture artwork manufacturing machinery, culture artwork manufacturing machinery materials, parts and members of culture artwork manufacturing machinery, accessories of culture artwork manufacturing machinery, culture artwork materials, parts and members of culture artwork, accessories of culture artwork, and provides culture artwork mesh-sheet standardized block modules. The standardized urban products of culture artwork industry includes worldwide culture artwork research and development, manufacturing, marketing, operation managing enterprises, and perform intensive marketing to the world market.

Upon actual requirements, the cultural and artistic industry standardized urban product is provided with business invitation and investment office areas, market areas, standardized workshop areas, residence areas, recreation and entertainment areas, business areas, logistic storage areas, movie-television and sound-image producing centers, culture artwork publishing centers, intellectual property and various property trade centers of culture artwork and accessories, culture artwork media centers, cultural and artistic industry commercial centers, culture artwork complaint centers, culture artwork maintenance service centers, talent labor exchange centers of cultural and artistic industry, real estate investment and trade centers, science and technology exploration institution of cultural and artistic industry, cinema, culture industrial parks, cultural and artistic industrial museums, cultural and artistic industry book centers, culture artwork industrial universities, culture artwork industrial technical schools, standardized senior high schools, standardized kindergarten, primary, and middle schools, construction infrastructure and social infrastructure of standardized urban product. The culture artwork commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Culture Artwork Culture Festival” activity annually, so as to improve the science/technology content and cultural artistic taste of the worldwide culture artwork, and promote the marketing ability of worldwide culture artwork.

23. Sports Industry Standardized Urban Product

In a preferred technical embodiment of the present invention, a required quantity of sports supplies industrial manufacturing and commercial/residential mesh-sheet standardized block modules are assembled to form a sports industry standardized urban product. In a further preferred technical embodiment of the present invention, a required quantity sports supplies R&D transactional mesh-sheet standardized block modules are assembled to form a R&D transactional sports industry standardized urban product. In a still further preferred technical embodiment of the present invention, sports supplies industrial manufacturing and commercial/residential as well as R&D transactional mesh-sheet standardized block modules are assembled to form a sports industry standardized urban product.

The sports industry standardized urban product includes worldwide sports supplies, sports supplies manufacturing machineries, sports supplies manufacturing machinery materials, parts and members of sports supplies manufacturing machinery, accessories of sports supplies manufacturing machinery, sports supplies materials, parts and members of sports supplies, accessories of sports supplies. The sports industry standardized urban product includes worldwide sports supplies research and development, manufacturing, marketing, operation managing enterprises, and perform intensive marketing to the world market.

Upon actual requirements, the sports industry standardized urban product is provided with business invitation and investment office areas, market areas, standardized workshop areas, residence areas, recreation and entertainment areas, business areas, logistic storage areas, intellectual property and various property trade centers of sports supplies and accessories, sports supplies media cultural and artistic centers, sports industry commercial centers, sports supplies complaint centers, sports supplies maintenance service centers, talent labor exchange centers of sports industry, real estate investment and trade centers, science and technology exploration institution of sports industry, international standard golf course, international standard formula racing track, international standard football, basketball, volleyball, tennis, badminton, table tennis courts, etc., gymnasium, international standard rail and field playground, international racecourse, sports industrial parks, sports industrial museums, sports industry book centers, sports industrial universities, sports industrial technical schools, standardized senior high schools, standardized kindergarten, primary, and middle schools, construction infrastructure and social infrastructure of standardized urban product. The sports industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Sports Supplies Culture Festival” activity annually, so as to improve the science/technology content and cultural artistic taste of the worldwide sports industry, and promote the marketing ability of worldwide sports supplies.

24. Medical Health Industry Standardized Urban Product

In a preferred technical embodiment of the present invention, a required quantity of medical health industrial manufacturing and commercial/residential mesh-sheet standardized block modules are assembled to form a medical health industry standardized urban product. In a further preferred technical embodiment of the present invention, a required quantity of medical health R&D transactional mesh-sheet standardized block modules are assembled to form a R&D transactional medical health industry standardized urban product. In a still further preferred technical embodiment of the present invention, medical health industrial manufacturing and commercial/residential as well as R&D transactional mesh-sheet standardized block modules are assembled to form a medical health industry standardized urban product.

The medical health industry standardized urban product includes worldwide medicines, medicine materials, biologic medical materials, medical machines, medical machine materials, parts and members of medical machine, accessories of medical machine, health products, health product materials, parts and members of health product, health product manufacturing machineries, health product manufacturing machinery materials, parts and members of health product manufacturing machinery, accessories of health product manufacturing machinery, accessories of health product. The medical health industry standardized urban product includes worldwide medical health product research and development, manufacturing, marketing, operation managing enterprises, and perform intensive marketing to the world market.

Upon actual requirements, the medical health industry standardized urban product is provided with business invitation and investment office areas, market areas, standardized workshop areas, residence areas, recreation and entertainment areas, business areas, logistic storage areas, intellectual property and various property trade centers of medical health product and accessories, medical health product media cultural and artistic centers, medical health industry commercial centers, health care centers of old people apartment, medical health product complaint centers, medical health product maintenance service centers, talent labor exchange centers of medical health industry, real estate investment and trade centers, science and technology exploration institution of medical health product, health parks, medical health industrial museums, medical health industry book centers, medical health industrial universities, biologic health care product industrial universities, medical health industrial technical schools, standardized senior high schools, standardized kindergarten, primary, and middle schools, construction infrastructure and social infrastructure of standardized urban product. The medical health industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Medical Health Culture Festival” activity annually, so as to improve the science/technology content and cultural artistic taste of the worldwide medical health industry, and promote the marketing ability of worldwide medical health products.

25. Education Industry Standardized Urban Product

In a preferred technical embodiment of the present invention, a required quantity of education product industrial manufacturing and commercial/residential mesh-sheet standardized block modules are assembled to form an education industry standardized urban product. In a further preferred technical embodiment of the present invention, a required quantity of education product R&D transactional mesh-sheet standardized block modules are assembled to form a R&D transactional education industry standardized urban product. In a still further preferred technical embodiment of the present invention, education product industrial manufacturing and commercial/residential as well as R&D transactional mesh-sheet standardized block modules are assembled to form an education industry standardized urban product.

The education industry standardized urban product includes worldwide education resources, education products, education product materials, parts and members of education product, education product manufacturing machineries, education product manufacturing machinery materials, parts and members of education product manufacturing machinery, accessories of education product manufacturing machinery, accessories of education product. The education industry standardized urban product includes worldwide education resources, education product research and development, manufacturing, marketing, operation managing enterprises, and perform intensive marketing to the world market.

Upon actual requirements, the education industry standardized urban product is provided with business invitation and investment office areas, market areas, standardized workshop areas, residence areas, recreation and entertainment areas, business areas, logistic storage areas, intellectual property and various property trade centers of education product and accessories, education product cultural and artistic media centers, education industry commercial centers, education product complaint centers, education product maintenance service centers, talent labor exchange centers of education product, real estate investment and trade centers, science and technology exploration institution of education industry, education industrial parks, education industrial museums, education industry book centers, education industrial universities, education industrial technical schools, standardized senior high schools, standardized kindergarten, primary, and middle schools, construction infrastructure and social infrastructure of standardized urban product. The education industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Education Product Culture Festival” activity annually, so as to improve the science/technology content and cultural artistic taste of the worldwide education industry, and promote the marketing ability of worldwide education product.

26. Communication Information Industry Standardized Urban Product

In a preferred technical embodiment of the present invention, a required quantity of communication information industrial manufacturing and commercial/residential mesh-sheet standardized block modules are assembled to form a communication information industry standardized urban product. In a further preferred technical embodiment of the present invention, a required quantity of communication information R&D transactional mesh-sheet standardized block modules are assembled to form a R&D transactional communication information industry standardized urban product. In a still further preferred technical embodiment of the present invention, communication information industrial manufacturing and commercial/residential as well as R&D transactional mesh-sheet standardized block modules are assembled to form a communication information industry standardized urban product.

The communication information industry standardized urban product includes worldwide communication information, mobile phones, mobile phone materials, parts and members of mobile phone, mobile phone manufacturing machineries, mobile phone manufacturing machinery materials, parts and members of mobile phone manufacturing machinery, accessories of mobile phone manufacturing machinery, accessories of mobile phone, and provides mobile phone mesh-sheet standardized block modules; includes worldwide electronic communication products, electronic communication product manufacturing materials, parts and members of electronic communication product, electronic communication product manufacturing machineries, electronic communication product manufacturing machinery materials, parts and members of electronic communication product manufacturing machinery, accessories of electronic communication product manufacturing machinery, accessories of electronic communication product, and provides electronic communication product mesh-sheet standardized block modules; includes worldwide computers, computer materials, parts and members of computer, computer manufacturing machineries, computer manufacturing machinery materials, parts and members of computer manufacturing machinery, accessories of computer manufacturing machinery, computer software, accessories of computer, and provides computer mesh-sheet standardized block modules; includes worldwide information network products, information network product manufacturing materials, information network product manufacturing machineries, information network product manufacturing machinery materials, parts and members of information network product manufacturing machinery, accessories of information network product manufacturing machinery, accessories of information network product, and provides information network product mesh-sheet standardized block modules; includes worldwide radars, radar materials, parts and members of radar, radar manufacturing machineries, radar manufacturing machinery materials, parts and members of radar manufacturing machinery, accessories of radar manufacturing machinery, accessories of radar, and provides radar mesh-sheet standardized block modules; includes worldwide weather forecast equipments, weather forecast equipment materials, parts and members of weather forecast equipment, weather forecast equipment manufacturing machineries, weather forecast equipment manufacturing machinery materials, parts and members of weather forecast equipment manufacturing machinery, accessories of weather forecast equipment manufacturing machinery, accessories of weather forecast equipment, and provides weather forecast equipment mesh-sheet standardized block modules; includes worldwide post products, post product manufacturing materials, parts and members of post product, post equipment, post equipment materials, parts and members of post equipment, accessories of post equipment, post product manufacturing machinery, post product manufacturing machinery materials, parts and members of post product manufacturing machinery, accessories of post product manufacturing machinery, accessories of post product, and provides post mesh-sheet standardized block modules; includes worldwide burglar alarm and accessories of burglar alarm, and provides burglar alarm mesh-sheet standardized block modules; includes worldwide communication equipment, communication equipment manufacturing machinery, communication equipment manufacturing machinery materials, parts and members of communication equipment manufacturing machinery, accessories of communication equipment manufacturing machinery, communication equipment materials, parts and members of communication equipment, accessories of communication equipment, and provides communication equipment mesh-sheet standardized block modules. The communication information industry standardized urban product includes worldwide communication information research and development, manufacturing, marketing, operation managing enterprises, and perform intensive marketing to the world market.

Upon actual requirements, the communication information industry standardized urban product is provided with business invitation and investment office areas, market areas, standardized workshop areas, residence areas, recreation and entertainment areas, business areas, logistic storage areas, intellectual property and various property trade centers of communication information product and accessories, communication information cultural and artistic media centers, communication information industry commercial centers, communication information complaint centers, communication information maintenance service centers, real estate investment and trade centers, talent labor exchange centers of communication information, science and technology exploration institution of communication information industry, information industrial parks, communication information industrial museums, communication information industry book centers, communication information industrial universities, communication information industrial technical schools, standardized senior high schools, standardized kindergarten, primary, and middle schools, construction infrastructure and social infrastructure of standardized urban product. The communication information industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Communication Information Culture Festival” activity annually, so as to improve the science/technology content and cultural artistic taste of the worldwide communication information industry, and promote the marketing ability of worldwide communication information product.

27. Household Appliances Industry Standardized Urban Product

In a preferred technical embodiment of the present invention, a required quantity of household appliance industrial manufacturing and commercial/residential mesh-sheet standardized block modules are assembled to form a household appliances industry standardized urban product. In a further preferred technical embodiment of the present invention, a required quantity of household appliance R&D transactional mesh-sheet standardized block modules are assembled to form a R&D transactional household appliances industry standardized urban product. In a still further preferred technical embodiment of the present invention, household appliance industrial manufacturing and commercial/residential as well as R&D transactional mesh-sheet standardized block modules are assembled to form household appliances industry standardized urban product.

The household appliances industry standardized urban product includes worldwide household appliances, household appliance manufacturing machineries, household appliance manufacturing machinery materials, parts and members of household appliance manufacturing machinery, accessories of household appliance manufacturing machinery, parts and members of household appliance, household appliance materials, accessories of household appliance. The household appliances industry standardized urban product includes worldwide household appliance research and development, manufacturing, marketing, operation managing enterprises, and perform intensive marketing to the world market.

Upon actual requirements, the household appliances industry standardized urban product is provided with business invitation and investment office areas, market areas, standardized workshop areas, residence areas, recreation and entertainment areas, business areas, logistic storage areas, intellectual property and various property trade centers of household appliance and accessories, household appliance cultural and artistic media centers, household appliance industry commercial centers, household appliance complaint centers, household appliance maintenance service centers, real estate investment and trade centers, talent labor exchange centers of household appliance industry, science and technology exploration institution of household appliance industry, household appliance industrial parks, household appliance industrial museums, household appliance industry book centers, household appliance industrial universities, household appliance industrial technical schools, standardized senior high schools, standardized kindergarten, primary, and middle schools, construction infrastructure and social infrastructure of standardized urban product. The household appliance commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Household Appliance Culture Festival” activity annually, so as to improve the science/technology content and cultural artistic taste of the worldwide household appliance industry, and promote the marketing ability of worldwide household appliance.

28. Textile Industry Standardized Urban Product

In a preferred technical embodiment of the present invention, a required quantity of textile industrial manufacturing and commercial/residential mesh-sheet standardized block modules are assembled to form a textile industry standardized urban product. In a further preferred technical embodiment of the present invention, a required quantity of textile R&D transactional mesh-sheet standardized block modules are assembled to form a R&D transactional textile industry standardized urban product. In a still further preferred technical embodiment of the present invention, textile industrial manufacturing and commercial/residential as well as R&D transactional mesh-sheet standardized block modules are assembled to form a textile industry standardized urban product.

The textile industry standardized urban product includes worldwide cotton, and provides cotton mesh-sheet standardized block module; includes worldwide textile semi-finished goods, and provides textile semi-finished goods mesh-sheet standardized block modules; includes worldwide silk cloth, and provides silk cloth mesh-sheet standardized block modules; includes worldwide piece goods, and provides piece goods mesh-sheet standardized block modules; includes worldwide children wears, and provides children wear mesh-sheet standardized block modules; includes worldwide garments, and provides garment mesh-sheet standardized block modules; includes worldwide professional uniform, and provides professional uniform mesh-sheet standardized block modules; includes worldwide shoes and hats, and provides shoes and hats mesh-sheet standardized block modules; includes worldwide textile decorations, and provides textile decoration mesh-sheet standardized block modules; includes worldwide weaving machines, parts and members of weaving machine, weaving machine materials, accessories of weaving machine, and provides weaving machine mesh-sheet standardized block modules; includes worldwide garment machines, garment machine materials, parts and members of garment machine, accessories of garment machine, and provides garment machine mesh-sheet standardized block modules; includes worldwide shoes and hats machines, shoes and hats machine materials, parts and members of shoes and hats machine, accessories of shoes and hats machine, and provides shoes and hats machine mesh-sheet standardized block modules; includes worldwide garments and shoes and hats decorations, and provides garments and shoes and hats decorations mesh-sheet standardized block modules; includes worldwide garments and shoes and hats of livestock product, livestock product machine, livestock product machine materials, parts and members of livestock product machine, accessories of livestock product machine, and provides garments and shoes and hats of livestock product mesh-sheet standardized block modules. The textile industry standardized urban product includes worldwide textile research and development, manufacturing, marketing, operation managing enterprises, and perform intensive marketing to the world market.

Upon actual requirements, the textile industry standardized urban product is provided with business invitation and investment office areas, market areas, standardized workshop areas, residence areas, recreation and entertainment areas, business areas, logistic storage areas, intellectual property and various property trade centers of textile and accessories, textile cultural and artistic media centers, textile industry commercial centers, textile complaint centers, textile maintenance service centers, real estate investment and trade centers, talent labor exchange centers of textile industry, science and technology exploration institution of textile industry, textile industrial parks, textile industrial museums, textile industry book centers, textile industrial universities, textile industrial technical schools, standardized senior high schools, standardized kindergarten, primary, and middle schools, construction infrastructure and social infrastructure of standardized urban product. The textile commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Textile Culture Festival” activity annually, so as to improve the science/technology content and cultural artistic taste of the worldwide textile industry, and promote the marketing ability of worldwide textile.

29. Industrial Machinery Industry Standardized Urban Product

In a preferred technical embodiment of the present invention, a required quantity of industrial machinery industrial manufacturing and commercial/residential mesh-sheet standardized block modules are assembled to form an industrial machinery industry standardized urban product. In a further preferred technical embodiment of the present invention, a required quantity of industrial machinery R&D transactional mesh-sheet standardized block modules are assembled to form a R&D transactional industrial machinery industry standardized urban product. In a still further preferred technical embodiment of the present invention, industrial machinery industrial manufacturing and commercial/residential as well as R&D transactional mesh-sheet standardized block modules are assembled to form an industrial machinery industry standardized urban product.

The industrial machinery industry standardized urban product includes worldwide industrial machineries, industrial machinery materials, parts and members of industrial machinery, accessories of industrial machinery. The industrial machinery industry standardized urban product includes worldwide industrial machinery research and development, manufacturing, marketing, operation managing enterprises, and perform intensive marketing to the world market.

Upon actual requirements, the industrial machinery industry standardized urban product is provided with business invitation and investment office areas, market areas, standardized workshop areas, residence areas, recreation and entertainment areas, business areas, logistic storage areas, intellectual property and various property trade centers of industrial machineries and accessories, industrial machinery cultural and artistic media centers, industrial machinery industry commercial centers, industrial machinery complaint centers, industrial machinery maintenance service centers, real estate investment and trade centers, talent labor exchange centers of industrial machinery industry, science and technology exploration institution of industrial machinery industry, industrial parks, industrial machinery industrial museums, industrial machinery industry book centers, industrial machinery industrial universities, industrial machinery industrial technical schools, standardized senior high schools, standardized kindergarten, primary, and middle schools, construction infrastructure and social infrastructure of standardized urban product. The industrial machinery industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Industrial Machinery Culture Festival” activity annually, so as to improve the science/technology content and cultural artistic taste of the worldwide industrial machinery industry, and promote the marketing ability of worldwide industrial machine.

30. Commodity Industry Standardized Urban Product

In a preferred technical embodiment of the present invention, a required quantity of commodity industrial manufacturing and commercial/residential mesh-sheet standardized block modules are assembled to form a commodity industry standardized urban product. In a further preferred technical embodiment of the present invention, a required quantity of commodity R&D transactional mesh-sheet standardized block modules are assembled to form a R&D transactional commodity industry standardized urban product. In a still further preferred technical embodiment of the present invention, commodity industrial manufacturing and commercial/residential as well as R&D transactional mesh-sheet standardized block modules are assembled to form a commodity industry standardized urban product.

The commodity industry standardized urban product includes worldwide electronic products, electronic product materials, parts and members of electronic product, electronic product manufacturing machineries, electronic product manufacturing machinery materials, parts and members of electronic product manufacturing machinery, accessories of electronic product manufacturing machinery, accessories of electronic product, and provides electronic product mesh-sheet standardized block modules; includes worldwide toys, toy manufacturing machinery, toy manufacturing machinery materials, parts and members of toy manufacturing machinery, accessories of toy manufacturing machinery, toy materials, parts and members of toy, accessories of toy, and provides toy mesh-sheet standardized block modules; includes worldwide handicraft and accessories of handicraft, and provides handicraft mesh-sheet standardized block modules; includes worldwide hardware products, hardware product materials, parts and members of hardware product, hardware product manufacturing machinery, hardware product manufacturing machinery materials, parts and members of hardware product manufacturing machinery, accessories of hardware product manufacturing machinery, accessories of hardware product, and provides hardware product mesh-sheet standardized block modules; includes worldwide women's products, women's product manufacturing machinery, women's product manufacturing machinery materials, parts and members of women's product manufacturing machinery, accessories of women's product manufacturing machinery, women's product materials, accessories of women's product, and provides women's product mesh-sheet standardized block modules; includes worldwide men's products, men's product manufacturing machinery, men's product manufacturing machinery materials, parts and members of men's product manufacturing machinery, accessories of men's product manufacturing machinery, men's product materials, parts and members of men's product, accessories of men's product, and provides men's product mesh-sheet standardized block modules; includes worldwide children's products, children's product manufacturing machinery, children's product manufacturing machinery materials, parts and members of children's product manufacturing machinery, accessories of children's product manufacturing machinery, children's product materials, parts and members of children's product, accessories of children's product, and provides children's product mesh-sheet standardized block modules; includes worldwide old people's products, old people's product manufacturing machinery, old people's product manufacturing machinery materials, parts and members of old people's product manufacturing machinery, accessories of old people's product manufacturing machinery, old people's product materials, parts and members of old people's product, accessories of old people's product, and provides old people's product mesh-sheet standardized block modules; includes worldwide plastic products, plastic supply materials, parts and members of plastic product, plastic product manufacturing machinery, plastic product manufacturing machinery materials, parts and members of plastic product manufacturing machinery, accessories of plastic product manufacturing machinery, accessories of plastic product, and provides plastic product mesh-sheet standardized block modules; includes worldwide glass products, glass product manufacturing machineries, glass product manufacturing machinery materials, parts and members of glass product manufacturing machinery, accessories of glass product manufacturing machinery, glass product materials, accessories of glass product, and provides glass product mesh-sheet standardized block modules; includes worldwide ceramic products, ceramic product manufacturing machinery, ceramic product manufacturing machinery materials, parts and members of ceramic product manufacturing machinery, accessories of ceramic product manufacturing machinery, ceramic product manufacturing materials, accessories of ceramic product, and provides ceramic product mesh-sheet standardized block modules; includes worldwide cosmetic products, cosmetic product manufacturing machinery, cosmetic product manufacturing machinery materials, parts and members of cosmetic product manufacturing machinery, accessories of cosmetic product manufacturing machinery, cosmetic product materials, accessories of cosmetic product, and provides cosmetic product mesh-sheet standardized block modules; includes worldwide cleaning products, cleaning product manufacturing machinery, cleaning product manufacturing machinery materials, parts and members of cleaning product manufacturing machinery, accessories of cleaning product manufacturing machinery, cleaning product materials, accessories of cleaning product, and provides cleaning product mesh-sheet standardized block modules; includes worldwide beautification and hairdressing, beautification and hairdressing products, beautification and hairdressing materials, beautification and hairdressing equipments, beautification and hairdressing equipment materials, parts and members of beautification and hairdressing equipment, accessories of beautification and hairdressing equipment, beautification and hairdressing equipment manufacturing machinery, beautification and hairdressing equipment manufacturing machinery materials, parts and members of beautification and hairdressing equipment manufacturing machinery, accessories of beautification and hairdressing equipment manufacturing machinery, accessories of beautification and hairdressing, and provides beautification and hairdressing equipment mesh-sheet standardized block modules; includes worldwide glasses, glasses materials, parts and members of glasses, glasses manufacturing machinery, glasses manufacturing machinery materials, parts and members of glasses manufacturing machinery, accessories of glasses manufacturing machinery, accessories of glasses, and provides glasses mesh-sheet standardized block modules; includes worldwide telescopes, microscopes, magnifiers and corollary mechanical equipments and accessories, and provides telescope, microscope, magnifier mesh-sheet standardized block modules; includes worldwide bijouterie, bijouterie manufacturing machineries, bijouterie manufacturing machinery materials, parts and members of bijouterie manufacturing machinery, accessories of bijouterie manufacturing machinery, bijouterie materials, parts and members of bijouterie, accessories of bijouterie, and provides bijouterie mesh-sheet standardized block modules; includes worldwide cases and bags, case and bag manufacturing machineries, case and bag manufacturing machinery materials, parts and members of case and bag manufacturing machinery, accessories of case and bag manufacturing machinery, case and bag manufacturing materials, accessories of case and bag, and provides case and bag mesh-sheet standardized block modules; includes worldwide gifts, gift manufacturing machinery, gift manufacturing machinery materials, parts and members of gift manufacturing machinery, accessories of gift manufacturing machinery, gift materials, parts and members of gift, accessories of gift, and provides gift mesh-sheet standardized block modules; includes worldwide photographic apparatus, photographic apparatus manufacturing machinery, photographic apparatus manufacturing machinery materials, parts and members of photographic apparatus manufacturing machinery, accessories of photographic apparatus manufacturing machinery, photographic apparatus materials, parts and members of photographic apparatus, accessories of photographic apparatus, and provides photographic apparatus mesh-sheet standardized block modules; includes worldwide firecrackers and fireworks, firecrackers and fireworks manufacturing machinery, firecrackers and fireworks manufacturing machinery materials, parts and members of firecrackers and fireworks manufacturing machinery, accessories of firecrackers and fireworks manufacturing machinery, firecrackers and fireworks manufacturing materials, accessories of firecrackers and fireworks, and provides firecrackers and fireworks mesh-sheet standardized block modules; includes worldwide mapping supplies, mapping supply materials, parts and members of mapping supply, mapping supply manufacturing machineries, mapping supply manufacturing machinery materials, parts and members of mapping supply manufacturing machinery, accessories of mapping supply manufacturing machinery, accessories of mapping supply, and provides mapping supply mesh-sheet standardized block modules; includes worldwide small commodities, small commodity manufacturing machinery, small commodity manufacturing machinery materials, parts and members of small commodity manufacturing machinery, accessories of small commodity manufacturing machinery, small commodity materials, parts and members of small commodity, accessories of small commodity, and provides small commodity mesh-sheet standardized block modules; includes worldwide horologes, horologe manufacturing machinery, horologe manufacturing machinery materials, parts and members of horologe manufacturing machinery, accessories of horologe manufacturing machinery, horologe materials, parts and members of horologe, accessories of horologe, and provides horologe mesh-sheet standardized block modules. The commodity industry standardized urban product includes worldwide commodity research and development, manufacturing, marketing, operation managing enterprises, and perform intensive marketing to the world market.

Upon actual requirements, the commodity industry standardized urban product is provided with business invitation and investment office areas, market areas, standardized workshop areas, residence areas, recreation and entertainment areas, business areas, logistic storage areas, commodity complaint centers, commodity maintenance service centers, general merchandise industrial parks, commodity industrial museums, commodity industry book centers, intellectual property and various property trade centers of commodity and accessories, commodity cultural and artistic media centers, commodity industry commercial centers, talent labor exchange centers of commodity industry, real estate investment and trade centers, science and technology exploration institution of commodity industry, commodity industrial universities, commodity industrial technical schools, standardized senior high schools, standardized kindergarten, primary, and middle schools, construction infrastructure and social infrastructure of standardized urban product. The commodity commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Commodity Culture Festival” activity annually, so as to improve the science/technology content and cultural artistic taste of the worldwide commodity industry, and promote the marketing ability of worldwide commodity.

31. Heater/Cooler Industry Standardized Urban Product

In a preferred technical embodiment of the present invention, a required quantity of heater/cooler industrial manufacturing and commercial/residential mesh-sheet standardized block modules are assembled to form a heater/cooler industry standardized urban product. In a further preferred technical embodiment of the present invention, a required quantity of heater/cooler R&D transactional mesh-sheet standardized block modules are assembled to form a R&D transactional heater/cooler industry standardized urban product. In a still further preferred technical embodiment of the present invention, heater/cooler industrial manufacturing and commercial/residential as well as R&D transactional mesh-sheet standardized block modules are assembled to form a heater/cooler industry standardized urban product.

The heater/cooler industry standardized urban product includes worldwide heater/cooler, such as, air conditioners, boilers and so on, heater/cooler manufacturing machineries, heater/cooler manufacturing machinery materials, parts and members of heater/cooler manufacturing machinery, accessories of heater/cooler manufacturing machinery, heater/cooler materials, parts and members of heater/cooler, accessories of heater/cooler. The heater/cooler industry standardized urban product includes worldwide heater/cooler research and development, manufacturing, marketing, operation managing enterprises, and perform intensive marketing to the world market.

Upon actual requirements, the heater/cooler industry standardized urban product is provided with business invitation and investment office areas, market areas, standardized workshop areas, residence areas, recreation and entertainment areas, business areas, logistic storage areas, intellectual property and various property trade centers of heater/cooler and accessories, heater/cooler complaint centers, heater/cooler maintenance service centers, heater/cooler cultural and artistic media centers, heater/cooler industry commercial centers, real estate investment and trade centers, talent labor exchange centers of heater/cooler industry, science and technology exploration institution of heater/cooler industry, Ever Spring industrial parks, heater/cooler industrial museums, heater/cooler industry book centers, heater/cooler industrial universities, heater/cooler industrial technical schools, standardized senior high schools, standardized kindergarten, primary, and middle schools, construction infrastructure and social infrastructure of standardized urban product. The heater/cooler commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Heater/Cooler Culture Festival” activity annually, so as to improve the science/technology content and cultural artistic taste of the worldwide heater/cooler industry, and promote the marketing ability of worldwide heater/cooler.

32. Elevator Industry Standardized Urban Product

In a preferred technical embodiment of the present invention, a required quantity of elevator industrial manufacturing and commercial/residential mesh-sheet standardized block modules are assembled to form an elevator industry standardized urban product. In a further preferred technical embodiment of the present invention, a required quantity of elevator R&D transactional mesh-sheet standardized block modules are assembled to form a R&D transactional elevator industry standardized urban product. In a still further preferred technical embodiment of the present invention, elevator industrial manufacturing and commercial/residential as well as R&D transactional mesh-sheet standardized block modules are assembled to form an elevator industry standardized urban product.

The elevator industry standardized urban product includes worldwide elevators, elevator manufacturing machineries, elevator manufacturing machinery materials, parts and members of elevator manufacturing machinery, accessories of elevator manufacturing machinery, elevator product materials, parts and members of elevator product, accessories of elevator product. The elevator industry standardized urban product includes worldwide elevator research and development, manufacturing, marketing, operation managing enterprises, and perform intensive marketing to the world market.

Upon actual requirements, the elevator industry standardized urban product is provided with business invitation and investment office areas, market areas, standardized workshop areas, residence areas, recreation and entertainment areas, business areas, logistic storage areas, intellectual property and various property trade centers of elevator and accessories, elevator cultural and artistic media centers, elevator industry commercial centers, real estate investment and trade centers, talent labor exchange centers of elevator industry, elevator product complaint centers, elevator maintenance service centers, science and technology exploration institution of elevator industry, industrial parks, elevator industrial museums, elevator industry book centers, elevator industrial universities, elevator industrial technical schools, standardized senior high schools, standardized kindergarten, primary, and middle schools, construction infrastructure and social infrastructure of standardized urban product. The elevator industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Elevator Culture Festival” activity annually, so as to improve the science/technology content and cultural artistic taste of the worldwide elevator industry, and promote the marketing ability of worldwide elevator.

33. Food Industry Standardized Urban Product

In a preferred technical embodiment of the present invention, a required quantity of food industrial manufacturing and commercial/residential mesh-sheet standardized block modules are assembled to form a food industry standardized urban product. In a further preferred technical embodiment of the present invention, a required quantity of food R&D transactional mesh-sheet standardized block modules are assembled to form a R&D transactional food industry standardized urban product. In a still further preferred technical embodiment of the present invention, food industrial manufacturing and commercial/residential as well as R&D transactional mesh-sheet standardized block modules are assembled to form a food industry standardized urban product.

The food industry standardized urban product includes worldwide native products, native product materials, native product manufacturing machineries, native product manufacturing machinery materials, parts and members of native product manufacturing machinery, accessories of native product manufacturing machinery, accessories of native product, and provides native product mesh-sheet standardized block modules; includes worldwide livestock products, livestock product culturing butchering equipments, livestock product culturing butchering equipment materials, parts and members of livestock product culturing butchering equipment, accessories of livestock product culturing butchering equipment, livestock product manufacturing machinery, livestock product manufacturing machinery materials, parts and members of livestock product manufacturing machinery, accessories of livestock product manufacturing machinery, accessories of livestock product, and provides livestock product mesh-sheet standardized block modules; includes worldwide aquatic products, aquatic product culturing catching equipments, aquatic product culturing catching equipment materials, parts and members of aquatic product culturing catching equipment, accessories of aquatic product culturing catching equipment, aquatic product manufacturing machinery, aquatic product manufacturing machinery materials, parts and members of aquatic product manufacturing machinery, accessories of aquatic product manufacturing machinery, accessories of aquatic product, and provides aquatic product mesh-sheet standardized block modules; includes worldwide tea, tea manufacturing machinery, tea manufacturing machinery materials, parts and members of tea manufacturing machinery, accessories of tea manufacturing machinery, accessories of tea, and provides tea mesh-sheet standardized block modules; includes worldwide fruit, fruit manufacturing machinery, fruit manufacturing machinery materials, parts and members of fruit manufacturing machinery, accessories of fruit manufacturing machinery, accessories of fruit product, and provides fruit mesh-sheet standardized block modules; includes worldwide coffee, coffee manufacturing machinery, coffee manufacturing machinery materials, parts and members of coffee manufacturing machinery, accessories of coffee manufacturing machinery, coffee manufacturing materials, accessories of coffee, and provides coffee mesh-sheet standardized block modules; includes worldwide vegetable, vegetable manufacturing machinery, vegetable manufacturing machinery materials, parts and members of vegetable manufacturing machinery, accessories of vegetable manufacturing machinery, accessories of vegetable, and provides vegetable mesh-sheet standardized block modules; includes worldwide food beverage, food beverage process machine, food beverage process machine materials, parts and members of food beverage process machine, accessories of food beverage process machine, accessories of food beverage, and provides food beverage mesh-sheet standardized block modules; includes worldwide health care food beverage, health care food beverage manufacturing machinery, health care food beverage manufacturing machinery materials, parts and members of health care food beverage manufacturing machinery, accessories of health care food beverage manufacturing machinery, accessories of health care food beverage, and provides health care food beverage mesh-sheet standardized block modules; includes worldwide alcohol, alcohol manufacturing machinery, alcohol manufacturing machinery materials, parts and members of alcohol manufacturing machinery, accessories of alcohol manufacturing machinery, accessories of alcohol, and provides alcohol mesh-sheet standardized block modules; includes worldwide cigarettes, cigarette manufacturing machinery, cigarette manufacturing machinery materials, parts and members of cigarette manufacturing machinery, accessories of cigarette manufacturing machinery, cigarette materials, accessories of cigarette, and provides cigarette mesh-sheet standardized block modules. The food industry standardized urban product includes worldwide food research and development, manufacturing, marketing, operation managing enterprises, and perform intensive marketing to the world market.

Upon actual requirements, the food industry standardized urban product is provided with business invitation and investment office areas, market areas, standardized workshop areas, residence areas, recreation and entertainment areas, business areas, logistic storage areas, intellectual property and various property trade centers of food and accessories, food cultural and artistic media centers, food commercial centers, food complaint centers, food machine maintenance service centers, real estate investment and trade centers, talent labor exchange centers of food, science and technology exploration institution of food, food industrial parks, food industrial museums, food industry book centers, food industrial universities, food industrial technical schools, standardized senior high schools, standardized kindergarten, primary, and middle schools, construction infrastructure and social infrastructure of standardized urban product. The food industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Food Culture Festival” activity annually, so as to improve the science/technology content and cultural artistic taste of the worldwide food industry, and promote the marketing ability of worldwide food.

34. Paper Printing Industry Standardized Urban Product

In a preferred technical embodiment of the present invention, a required quantity of paper printing industrial manufacturing and commercial/residential mesh-sheet standardized block modules are assembled to form a paper printing industry standardized urban product. In a further preferred technical embodiment of the present invention, a required quantity of paper printing R&D transactional mesh-sheet standardized block modules are assembled to form a R&D transactional paper printing industry standardized urban product. In a still further preferred technical embodiment of the present invention, paper printing industrial manufacturing and commercial/residential as well as R&D transactional mesh-sheet standardized block modules are assembled to form a paper printing industry standardized urban product.

The paper printing industry standardized urban product includes worldwide paper, paper manufacturing machinery, paper manufacturing machinery materials, parts and members of paper manufacturing machinery, accessories of paper manufacturing machinery, paper materials, accessories of paper, and provides paper mesh-sheet standardized block modules; includes worldwide printed products, printed product materials, printing machines, printing machine materials, parts and members of printing machine, accessories of printing machine, accessories of printed product, and provides printed product mesh-sheet standardized block modules. The paper printing industry standardized urban product includes worldwide paper printing research and development, manufacturing, marketing, operation managing enterprises, and perform intensive marketing to the world market.

Upon actual requirements, the paper printing industry standardized urban product is provided with business invitation and investment office areas, market areas, standardized workshop areas, residence areas, recreation and entertainment areas, business areas, logistic storage areas, intellectual property and various property trade centers of paper printing and accessories, paper printing cultural and artistic media centers, paper printing industry commercial centers, paper printing complaint centers, paper printing maintenance service centers, real estate investment and trade centers, talent labor exchange centers of paper printing industry, science and technology exploration institution of paper printing industry, Feicai industrial parks, paper printing industrial museums, paper printing industry book centers, paper printing industrial universities, paper printing industrial technical schools, standardized senior high schools, standardized kindergarten, primary, and middle schools, construction infrastructure and social infrastructure of standardized urban product. The paper printing commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Paper Printing Culture Festival” activity annually, so as to improve the science/technology content and cultural artistic taste of the worldwide paper printing industry, and promote the marketing ability of worldwide paper printing.

35. Gardening Industry Standardized Urban Product

In a preferred technical embodiment of the present invention, a required quantity of gardening industrial manufacturing and commercial/residential mesh-sheet standardized block modules are assembled to form a gardening industry standardized urban product. In a further preferred technical embodiment of the present invention, a required quantity of gardening R&D transactional mesh-sheet standardized block modules are assembled to form a R&D transactional gardening industry standardized urban product. In a still further preferred technical embodiment of the present invention, gardening industrial manufacturing and commercial/residential as well as R&D transactional mesh-sheet standardized block modules are assembled to form a gardening industry standardized urban product.

The gardening industry standardized urban product includes worldwide lawns, saplings, bamboo seedlings, gardening product manufacture and maintenance machines, gardening product manufacture and maintenance machine materials, parts and members of gardening product manufacture and maintenance machine, accessories of gardening product manufacture and maintenance machine, accessories of gardening product, and provides lawn, sapling, gardening product mesh-sheet standardized block modules; includes worldwide flower, bird, fish, worm and accessories, and provides flower, bird, fish, worm mesh-sheet standardized block modules; includes worldwide wood and bamboo products, wood and bamboo product manufacturing machinery, wood and bamboo product manufacturing machinery materials, parts and members of wood and bamboo product manufacturing machinery, accessories of wood and bamboo product manufacturing machinery, accessories of wood and bamboo product, and provides wood and bamboo product mesh-sheet standardized block modules. The gardening industry standardized urban product includes worldwide research and development, manufacturing, marketing, operation managing enterprises, and perform intensive marketing to the world market.

Upon actual requirements, the gardening industry standardized urban product is provided with business invitation and investment office areas, market areas, standardized workshop areas, residence areas, recreation and entertainment areas, business areas, logistic storage areas, intellectual property and various property trade centers of gardening product and accessories, gardening product cultural and artistic media centers, gardening industry commercial centers, gardening product complaint centers, gardening product maintenance service centers, real estate investment and trade centers, talent labor exchange centers of gardening industry, science and technology exploration institution of gardening industry, gardening industrial parks, gardening industrial museums, gardening industry book centers, gardening industrial universities, gardening industrial technical schools, standardized senior high schools, standardized kindergarten, primary, and middle schools, construction infrastructure and social infrastructure of standardized urban product. The gardening industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Gardening Product Culture Festival” activity annually, so as to improve the science/technology content and cultural artistic taste of the worldwide gardening industry, and promote the marketing ability of worldwide gardening product.

36. Disabled Supplies Industry Standardized Urban Product

In a preferred technical embodiment of the present invention, a required quantity of disabled supply industrial manufacturing and commercial/residential mesh-sheet standardized block modules are assembled to form a disabled supplies industry standardized urban product. In a further preferred technical embodiment of the present invention, a required quantity of disabled supply R&D transactional mesh-sheet standardized block modules are assembled to form a R&D transactional disabled supplies industry standardized urban product. In a still further preferred technical embodiment of the present invention, disabled supply industrial manufacturing and commercial/residential as well as R&D transactional mesh-sheet standardized block modules are assembled to form a disabled supplies industry standardized urban product.

The disabled supplies industry standardized urban product includes worldwide disabled culture supply, sports supplies, medical health supplies, education products, vehicle, work supplies, commodities, disabled supply manufacturing machineries, disabled supply manufacturing machinery materials, parts and members of disabled supply manufacturing machinery, accessories of disabled supply manufacturing machinery, accessories of disabled. The disabled supplies industry standardized urban product includes worldwide disabled supply research and development, manufacturing, marketing, operation managing enterprises, and perform intensive marketing to the world market.

Upon actual requirements, the disabled supplies industry standardized urban product is provided with business invitation and investment office areas, market areas, standardized workshop areas, residence areas, recreation and entertainment areas, business areas, logistic storage areas, intellectual property and various property trade centers of disabled supply and accessories, disabled supply cultural and artistic media centers, disabled supply industry commercial centers, disabled supply complaint centers, disabled supply maintenance service centers, real estate investment and trade centers, talent labor exchange centers of disabled supply industry, science and technology exploration institution of disabled supply industry, industrial parks, disabled supply industrial museums, disabled supply book centers, disabled special hospital, disabled supply industrial universities, disabled supply industrial technical schools, standardized senior high schools, standardized kindergarten, primary, and middle schools, construction infrastructure and social infrastructure of standardized urban product. The disabled supply commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Disabled Supply Culture Festival” activity annually, so as to improve the science/technology content and cultural artistic taste of the worldwide disabled supply industry, and promote the marketing ability of worldwide disabled supply.

37. Logistics Industry Standardized Urban Product

In a preferred technical embodiment of the present invention, a required quantity of logistics product industrial manufacturing and commercial/residential mesh-sheet standardized block modules are assembled to form a logistics industry standardized urban product. In a further preferred technical embodiment of the present invention, a required quantity of logistics product R&D transactional mesh-sheet standardized block modules are assembled to form a R&D transactional standardized urban products of logistics product industry. In a still further preferred technical embodiment of the present invention, logistics product industrial manufacturing and commercial/residential as well as R&D transactional mesh-sheet standardized block modules are assembled to form a logistics industry standardized urban product.

The logistics industry standardized urban product includes worldwide logistic products, logistics product manufacturing machinery, logistics product manufacturing machinery materials, parts and members of logistics product manufacturing machinery, accessories of logistics product manufacturing machinery, logistics product materials, parts and members of logistics product, accessories of logistics product, and provides logistics product mesh-sheet standardized block modules; includes worldwide logistic storage and accessories, and provides logistic storage mesh-sheet standardized block modules. The logistics industry standardized urban product includes worldwide research and development, manufacturing, marketing, operation managing enterprises, and perform intensive marketing to the world market.

Upon actual requirements, the logistics industry standardized urban product is provided with business invitation and investment office areas, market areas, standardized workshop areas, residence areas, recreation and entertainment areas, business areas, logistics product storage areas, talent labor exchange centers of logistic industry, real estate investment and trade centers, intellectual property and various property trade centers of logistics product and accessories, logistics product cultural and artistic media centers, logistic industry commercial centers, logistics product complaint centers, logistics product maintenance service centers, logistic industrial parks, logistic industrial museums, logistic industry book centers, science and technology exploration institution of logistic industry, logistic industrial universities, logistic industrial technical schools, standardized senior high schools, standardized kindergarten, primary, and middle schools, construction infrastructure and social infrastructure of standardized urban product. The logistic industry commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Logistics Product Culture Festival” activity annually, so as to improve the science/technology content and cultural artistic taste of the worldwide logistic industry, and promote the marketing ability of worldwide logistics product.

38. Military/Police Supplies Industry Standardized Urban Product

In a preferred technical embodiment of the present invention, a required quantity of military/police supplies industrial manufacturing and commercial/residential mesh-sheet standardized block modules are assembled to form a military/police supplies industry standardized urban product. In a further preferred technical embodiment of the present invention, a required quantity of military/police supplies R&D transactional mesh-sheet standardized block modules are assembled to form a R&D transactional military/police supplies industry standardized urban product. In a still further preferred technical embodiment of the present invention, military/police supplies industrial manufacturing and commercial/residential as well as R&D transactional mesh-sheet standardized block modules are assembled to form a military/police supplies industry standardized urban product.

The military/police supplies industry standardized urban product includes worldwide military weapons, military clothes, military office supplies, military logistic supplies, military communication supplies, military traffic supplies, military daily supplies, military maneuver supplies, military campaign supplies, policing weapons, policing clothes, policing office supplies, policing communication supplies, policing traffic supplies, policing daily supplies, military/police supplies manufacturing machinery, military/police supplies manufacturing machinery materials, parts and members of military/police supplies manufacturing machinery, accessories of military/police supplies manufacturing machinery, military/police supplies materials, parts and members of military/police supplies, accessories of military/police supplies. The military/police supplies industry standardized urban product includes worldwide military/police supplies research and development, manufacturing, marketing, operation managing enterprises, and perform intensive marketing to the world market.

Upon actual requirements, the military/police supplies industry standardized urban product is provided with business invitation and investment office areas, market areas, standardized workshop areas, residence areas, recreation and entertainment areas, business areas, logistic storage areas, intellectual property and various property trade centers of military/police supplies and accessories, real estate investment and trade centers, military/police supplies cultural and artistic media centers, military/police supplies industry commercial centers, military/police supplies complaint centers, military/police supplies maintenance service centers, talent labor exchange centers of military/police supplies industry, military/police industrial parks, science and technology exploration institution of military/police supplies industry, military/police supplies industrial museums, military/police supplies book centers, military/police supplies industrial universities, military/police supplies industrial technical schools, standardized senior high schools, standardized kindergarten, primary, and middle schools, construction infrastructure and social infrastructure of standardized urban product. The military/police supplies commercial centers provided in the present invention include reception offices, secretary offices, file offices, accounting offices, law service offices, exit-entry service offices, tourism service offices, industrial and commercial tax registration offices, trade mark registration offices, patent application service offices, transportation service offices, commodity inspection offices, advertisement offices, talent recruitment service offices, labor service promotion offices, service offices of import and export trade procedures, international trade lawsuit agent offices, insurance transaction offices, auction transaction offices, property assignment and property lease transaction offices, bank loan transaction offices, business invitation investment service offices, exploitation project demonstration service offices, project organization and implementation service offices, technology cooperation and intercommunication service offices, property right trade service offices, OA service offices, and civilized and considerate life service offices.

Upon actual requirements, the present invention provides “Worldwide Military/Police Supplies Culture Festival” activity annually, so as to improve the science/technology content and cultural artistic taste of the worldwide military/police supplies industry, and promote the marketing ability of worldwide military/police supplies.

The military/police supplies industry standardized urban product may apply for security management of military/police supplies to national security department for the sake of the security of ammunition transaction.

Upon actual requirements, the present invention provides standardized urban product addresses in the order of Arabic numerals. The standardized urban product provides sheet-like standardized urban module addresses numbered by the order of Arabic numerals. The sheet-like standardized urban module provides addresses of net-like standardized road/bridge modules and net-like standardized canal modules numbered by the order of Arabic numerals. The sheet-like standardized urban module may provide mesh-sheet standardized block module addresses numbered by the order of Arabic numerals. The mesh-sheet standardized block module may provide standardized building addresses numbered by the order of Arabic numerals. The standardized construction may provide standardized unit addresses numbered by the order of Arabic numerals. The standardized unit may provide house addresses numbered by the order of Arabic numerals.

For example, provided that a certain mesh-sheet standardized urban module is numbered to be 8, this city can be called No. 8 city colloquially. The net-like standardized road/bridge module of No. 8 city may be provided with addresses numbered by the order of Arabic odd numerals 1, 3, 5, 7, 9, 11, 13, 15, 17, 19 from west to east, may be provided with addresses numbered by the order of Arabic even numerals 2, 4, 6, 8, 10, 12, 14, 16, 18, 20 from north to south. Provided that owner drives on the No. 5 road, then the owner can describe the address concisely and precisely as: I am on the No. 5 road of No. 8 city, and about to arrive the intersection with No. 6 road.

For example, provided that a certain mesh-sheet standardized urban module is numbered to be 8, a certain mesh-sheet standardized block module address numbered to be 7, a certain standardized building address is numbered to be 95, a certain standardized building unit address is numbered to be 2, a certain standardized house address is numbered to be 3, then the address can be written as 8/7/95/2/3. When reporting colloquially, this address may be described as: No. 3 house of No. 2 unit of No. 95 building in the No. 7 block of No. 8 city.

### BRIEF DESCRIPTION OF THE DRAWINGS

The present invention will become more fully understood from the detailed description given herein below for illustration only, and thus are not limitative of the present invention, and wherein:

FIG. 1 is a schematic plan view of an embodiment of an extra large-size standardized urban product;

FIG. 2 is a schematic plan view of an embodiment of the extra large-size standardized urban product provided with a net-like standardized canal module;

FIG. 3 is a schematic plan view of an embodiment of a mesh-sheet standardized urban module;

FIG. 4 is a schematic plan view of an embodiment of the mesh-sheet standardized urban module provided with the net-like standardized canal module;

FIG. 5 is a schematic plan view of an embodiment of a large-size standardized urban product;

FIG. 6 is a schematic plan view of an embodiment of the large-size standardized urban product provided with the net-like standardized canal module;

FIG. 7 is a schematic plan view of an embodiment of a middle-and-small-size standardized urban product;

FIG. 8 is a schematic plan view of an embodiment of the middle-and-small-size standardized urban product provided with the net-like standardized canal module;

FIG. 9 is a schematic plan view of an embodiment of a mesh-sheet standardized block module;

FIG. 10 is a schematic plan view of an embodiment of an industrial manufacturing mesh-sheet standardized block module;

FIG. 11 is a schematic plan view of an embodiment of the industrial manufacturing mesh-sheet standardized block module provided with the net-like standardized canal module;

FIG. 12 is a schematic plan view of an embodiment of a commercial/residential mesh-sheet standardized block module;

FIG. 13 is a schematic plan view of an embodiment of the commercial/residential mesh-sheet standardized block module provided with the net-like standardized canal module;

FIG. 14 is a schematic plan view of an embodiment of a R&D transactional mesh-sheet standardized block module;

FIG. 15 is a schematic plan view of an embodiment of the R&D transactional mesh-sheet standardized block module provided with the net-like standardized canal module;

FIG. 16 is a schematic view of an embodiment of a mesh-sheet standardized block underground space module;

FIG. 17 is a schematic sectional view of the mesh-sheet standardized block underground space module;

FIGS. 18, 19, 20, and 21 are schematic views of an embodiment of a net-like, [symbol] -type standardized canal module;

FIGS. 22, 23, 24, and 25 are schematic views of an embodiment of a net-like standardized road/bridge module;

FIGS. 26 and 27 are schematic views of an embodiment of a net-like standardized rail module;

FIGS. 28 and 29 are schematic sectional views of an embodiment of an underground fairway module;

FIGS. 30 and 31 are schematic side views of an embodiment of a multifunctional bridge module;

FIGS. 32, 33, 34, 35, 36, 37, 38, 39, and 40 are schematic views of an embodiment of a standardized house module;

FIG. 41 is a schematic view illustrating a profile of a plant-type house art product in the embodiments of the present invention;

FIG. 42 is a schematic view illustrating a profile of an animal-type house art product in the embodiments of the present invention;

FIG. 43 is a schematic view illustrating a profile of another animal-type house art product in the embodiments of the present invention;

FIG. 44 is a schematic view illustrating a profile of yet another fish-type house art product in the embodiments of the present invention; and

FIGS. 45, 46, and 47 are schematic views of an embodiment of a standardized airport waiting building module.

In the figures, elements indicated by reference numerals are described as follows: 1 mountain area; 2 river; 3 lake; 4 sea; 5 town or important building structure; 6 mesh-sheet standardized urban module; 7 multifunctional bridge module; 8 river beach, lake beach, and sea beach; 9 net-like standardized rail module; 10 net-like standardized canal module; 11 underground fairway module; 12 water; 13 mineral resources or mineral resources dock; 14 electric/intelligent ship; 15 sightseeing corridor bridge; 16 net-like standardized road/bridge module; 17 intercommunication standardized overpass module, standardized canal bridge module; 18 mesh-sheet standardized block module; 19 ground main driveway of the mesh-sheet standardized block module; 20 entrance/exit of the mesh-sheet standardized block module; 21 standardized airport module; 22 roadside commercial building; 23 roadside commercial building underground space; 24 athletics place; 25 standardized kindergarten, primary school, and middle school; 26 standardized senior high school, industrial technical school; 27 standardized commercial pedestrian street module; 28 standardized workshop; 29 university or industrial university; 30 industrial museum or museum; 31 industrial park or park; 32 standardized house module and/or other building; 33 mesh-sheet standardized block underground space module; 34 underground cross main driveway; 35 underground annular main driveway; 36 underground lane; 37 underground parking space; 38 standardized airport waiting building module; 39 net-like/mesh-sheet standardized rainwater pipe module; 40 net-like/mesh-sheet standardized sewage pipe module; 41 net-like/mesh-sheet standardized tap water pipe module; 42 net-like/mesh-sheet standardized clean water pipe module; 43 net-like/mesh-sheet standardized coal gas pipe module; 44 net-like/mesh-sheet standardized natural gas pipe module; 45 net-like/mesh-sheet standardized oil pipe module; 46 net-like/mesh-sheet standardized heating pipe module; 47 net-like/mesh-sheet standardized cooling pipe module; 48 net-like/mesh-sheet standardized power supply pipeline module; 49 net-like/mesh-sheet standardized telephone pipeline module; 50 net-like/mesh-sheet standardized TV pipeline module; 51 net-like/mesh-sheet standardized computer pipeline module; 52 reinforced concrete pipe, upright post, revetment, pipeline safety support; 53 reinforced concrete pavement or bituminous pavement; 54 ventilating and light-transmissive skylight; 55 air draft window, air draft walkway, air draft pipe; 56 solar energy, wind energy, or energy-saving lamp pipeline module; 57 net-like/mesh-sheet standardized intelligent pipeline module; 58 pipeline maintenance vehicle; 59 land; 60 gardening, waterscape, sidewalk; 61 soundproof wall; 62 slow lane; 63 fast lane; 64 fast lane without high speed limitation; 65 sightseeing elevator and sightseeing stair.

The present invention is illustrated further below in conjunction with accompanying drawing.

### DETAILED DESCRIPTION OF THE INVENTION

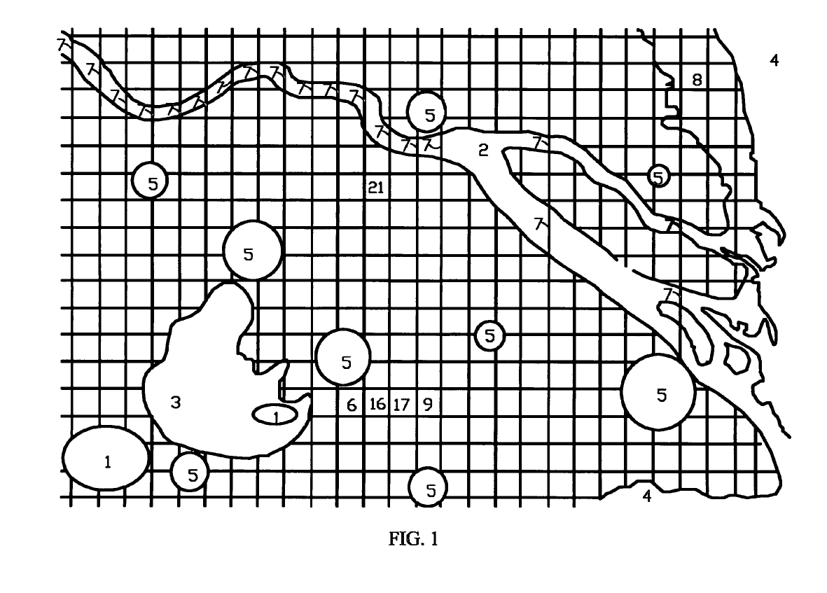

Referring to FIG. 1, a river 2 running into a sea 4 from the west to the east is shown, and a mountain 1, the river 2, a lake 3, the sea 4, an alluvial plain formed by the river 2, and a town cluster 5 with dense population are further provided. An extra large-size standardized urban product provided in the present invention possesses unique location advantages in terms of land, population, industry, technology, culture, intellectual property rights, commerce, water, mineral resources, etc. The sea port and river water transportation have geographical advantages in terms of research and development, manufacturing, marketing, operation and management of commodities. The extra large-size standardized urban product may be formed by rapidly replicating and assembling G, or tens, or hundreds, or thousands of mesh-sheet standardized urban modules 6. In FIG. 1, the water resource of the river may be used for water supply, water discharge, and shipping of the extra large-size standardized urban product. Standardized house modules and other buildings 32 prefabricated with industrial assembly lines may be provided at places of resources along the coast of the river 2, and water transported onto the land of FIG. 1 through the river 2 to be installed into the extra large-size standardized urban product. The present invention provides multifunctional bridge modules 7 over multiple waters 12 across the river 2, thereby enabling the investment in one multifunctional bridge module to achieve the traffic flow of several ordinary bridges and adding the function of appreciation and recreation for passengers. Net-like standardized rail modules 9, net-like standardized road/bridge modules 16, intercommunication standardized overpass modules 17, and standardized airport modules 21 provided in FIG. 1 enable the extra large-size standardized urban product free of traffic jam no matter how it expands. The extra large-size standardized urban product shown in FIG. 1 may expand to the north, expand the river beach, lake beach, and sea beach 8 to the east to fill the sea to build the city, expand to the west along the river 2, or expand to the river beach, lake beach, and sea beach 8 in the south according to actual requirements. The mountain area 1, river 2, lake 3, and sea 4 shown in FIG. 1 may also provide a scenic spot type mesh-sheet standardized urban module 6 in the light of local conditions.

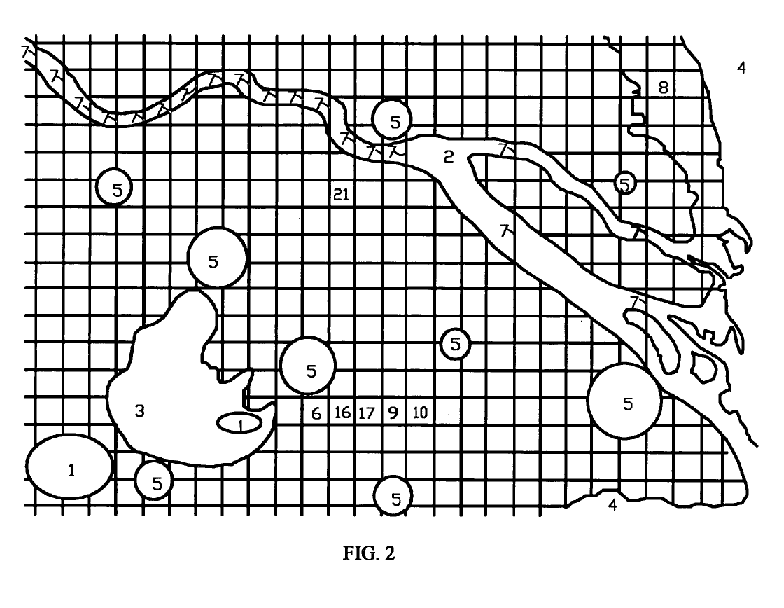

As shown in FIG. 2, a river 2 running into a sea 4 from the west to the east is shown, and a mountain 1, the river 2, a lake 3, a sea 4, an alluvial plain formed by the river 2, and a town cluster 5 with dense population are further provided. An extra large-size standardized urban product provided in the present invention possesses unique location advantages in terms of land, population, industry, technology, culture, intellectual property rights, commerce, water, mineral resources, etc. The sea port and river water transportation have geographical advantages in terms of research and development, manufacturing, marketing, operation and management of commodities. The extra large-size standardized urban product may be formed by rapidly replicating and assembling G, or tens, or hundreds, or thousands of mesh-sheet standardized urban modules 6. In FIG. 2, the water resource of the river may be used to provide net-like standardized canal modules 10, so as to facilitate the water supply, water discharge, and shipping of the extra large-size standardized urban product. Standardized house modules and other buildings 32 prefabricated with industrial assembly lines may be provided at places of resources along the river 2, and water transported onto the land of FIG. 2 through the river 2 and net-like standardized canal modules 10 to be installed into the extra large-size standardized urban product. The present invention provides multifunctional bridge modules 7 over multiple waters 12 across the river 2, thereby enabling the investment in one multifunctional bridge module to achieve the traffic flow of several ordinary bridges and adding the function of appreciation and recreation for passengers. Net-like standardized rail modules 9, net-like standardized road/bridge modules 16, intercommunication standardized overpass modules 17, and standardized airport modules 21 provided in FIG. 2 enable the extra large-size standardized urban product free of traffic jam no matter how it expands. The extra large-size standardized urban product shown in FIG. 2 may expand to the north, expand the river beach, lake beach, and sea beach 8 to the east to fill the sea to build the city, expand to the west along the river 2, or expand to the river beach, lake beach, and sea beach 8 in the south according to actual requirements. The mountain area 1, river 2, lake 3, and sea 4 shown in FIG. 2 may also provide a scenic spot type mesh-sheet standardized urban module 6 in the light of local conditions.

Since the net growth of population is more than 90 million per year all over the world, and a large rural population migrates to cities every year all over the world, the popularization and implementation of the extra large-size standardized urban product in FIGS. 1 and 2 all over the world has strategic and practical significance. The popularization and implementation of the extra large-size standardized urban product in FIGS. 1 and 2 especially in countries with large populations is the most favorable development direction of urbanization.

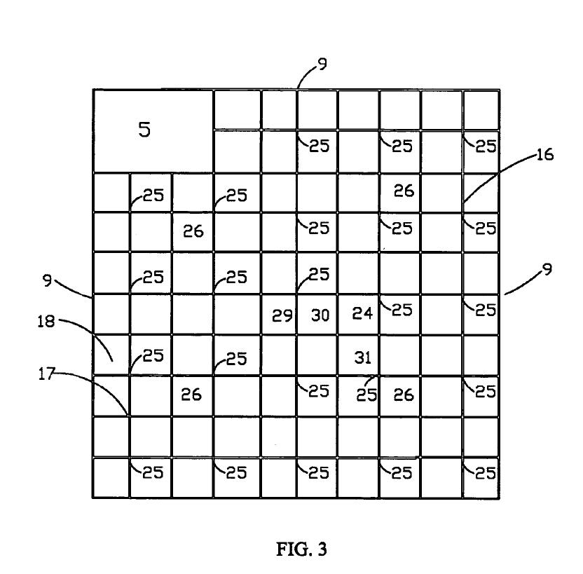

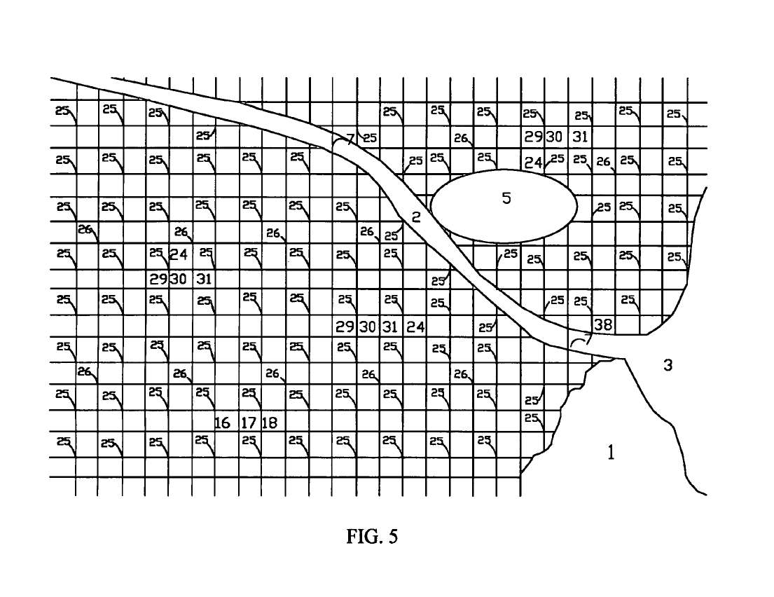

FIG. 3 is a further illustration of the mesh-sheet standardized urban module 6 shown in FIGS. 1 and 5. The mesh-sheet standardized urban module 6 shown in FIG. 3 has a calculated area of a (m)×a (m)=a² (m²) or a calculated area of a (m)×b (m)=ab (m²). For the convenience of calculating the large-size or extra large-size standardized urban product, the present invention illustrates the calculated area of the mesh-sheet standardized urban module 6 preferably with an example of 10 km×10 km=100 km². The mesh-sheet standardized urban module 6 provides net-like standardized rail modules 9 to improve the efficiency of public transportation, provides net-like standardized road/bridge modules 16 and intercommunication standardized overpass modules 17 to ensure the traffic flow of 2.52 to 3.96 million vehicles per hour of the mesh-sheet standardized urban module 6. In FIG. 3, 5 indicates the reserved town or important building structure. FIG. 3 may provide 100 (including less than 100) mesh-sheet standardized block modules 18 and standardized house modules and other buildings 32, provide standardized kindergartens, primary schools, and middle schools 25, standardized senior high schools, industrial technical schools 26, athletics places 24, industrial universities or universities 29, industrial museums or museums 30, and industrial parks or parks 31. In FIG. 3, the net-like standardized road/bridge modules 16 are communicated with mesh-sheet standardized block underground space modules 33 and further communicated with standardized house modules and other buildings 32, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in mesh-sheet standardized urban modules, which reduces the provision and maintenance cost of pipeline modules, improves the provision and maintenance efficiency of pipeline modules, and also ensures all the sewage generated by the mesh-sheet standardized urban module 6 gets qualified treatment and discharge.

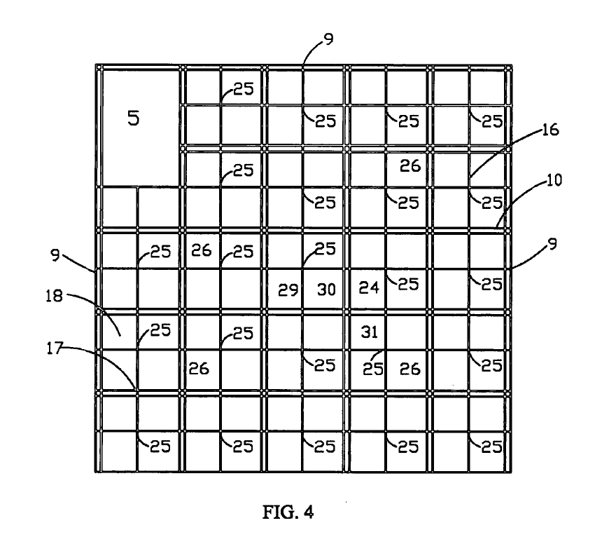

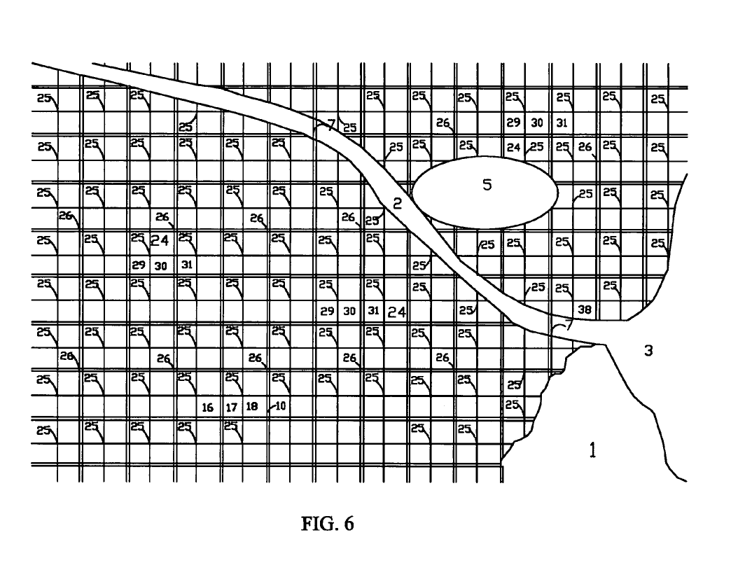

FIG. 4 is a further illustration of the mesh-sheet standardized urban module 6 shown in FIGS. 2 and 6. The mesh-sheet standardized urban module 6 shown in FIG. 4 has a calculated area of a (m)×a (m)=a² (m²) or a calculated area of a (m)×b (m)=ab (m²). For the convenience of calculating the large-size or extra large-size standardized urban product, the present invention illustrates the calculated area of the mesh-sheet standardized urban module 6 preferably with an example of 10 km×10 km=100 km². The mesh-sheet standardized urban module 6 is provided with net-like standardized rail modules 9 to improve the efficiency of public transportation. FIG. 4 provides net-like standardized canal modules 10 to increase the convenience of water supply, water discharge, and shipping, and reduce the transportation cost and water utilization cost, and provides net-like standardized road/bridge modules 16 and intercommunication standardized overpass modules 17 to ensure the traffic flow of 2.52 to 3.96 million vehicles per hour of the mesh-sheet standardized urban module 6. In FIG. 4, 5 represents the reserved town or important building structure. FIG. 4 may provide 100 (including less than 100) mesh-sheet standardized block modules 18 and standardized house modules and other buildings 32, provide standardized kindergartens, primary schools, and middle schools 25, standardized senior high schools, industrial technical schools 26, athletics places 24, industrial universities or universities 29, industrial museums or museums 30, and industrial parks or parks 31. In FIG. 4, the net-like standardized road/bridge modules 16 are communicated with mesh-sheet standardized block underground space modules 33 and further communicated with standardized house modules and other buildings 32, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in mesh-sheet standardized urban modules, which reduces the provision and maintenance cost of pipeline modules, improves the provision and maintenance efficiency of pipeline modules, and also ensures all the sewage generated by the mesh-sheet standardized urban module 6 gets qualified treatment and discharge.

The region shown in FIG. 5 has great location advantages in providing a large-size standardized urban product. In FIG. 5, a river 2 flows, from the west to the southeast, through a lake 3, and thus sand and stone resources and water transportation advantages of the river 2 and lake 3, mineral resources of mountain area 1, and the flat land rushed by the river 2 are provided. In geographical conditions, the water source of the river 2 facilitates the water supply, water discharge, and shipping of the large-size standardized urban product. Net-like standardized road/bridge modules 16 and standardized airport modules 21 as well as net-like standardized rail modules 9 may ensure a smooth traffic of the large-size standardized urban product forever, and helpful for the replication and expansion of the large-size standardized urban product to surrounding areas due to the ever-increasing population. Due to the advantages in terms of land, population, industry, technology, culture, commerce, intellectual property rights, water, mineral resources, etc., the town 5 shown in FIG. 5 may be rapidly expanded into the large-size standardized urban product assembled by G, or hundreds, or thousands of mesh-sheet standardized block modules 18. The mountain area 1, river 2, and lake 3 shown in FIG. 5 may also provide a scenic spot type mesh-sheet standardized block module 18 in the light of local conditions. The present invention provides multifunctional bridge modules 7 over multiple waters 12 across the river 2, thereby enabling the investment in one multifunctional bridge module to achieve the traffic flow of several ordinary bridges and adding the function of appreciation and recreation for passengers. FIG. 5 provides standardized kindergartens, primary schools, and middle schools 25, standardized senior high schools, industrial technical schools 26, universities or industrial universities 29, industrial museums or museums 30, and industrial parks or parks 31. The net-like standardized road/bridge modules 16 are communicated with mesh-sheet standardized block underground space modules 33 and further communicated with standardized house modules and other buildings 32, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in the standardized urban product, which reduces the provision and maintenance cost of pipeline modules, improves the provision and maintenance efficiency of pipeline modules, and also ensures all the sewage generated by the large-size standardized urban product gets qualified treatment and discharge.

The region shown in FIG. 6 has great location advantages in providing a large-size standardized urban product. In FIG. 6, a river 2 flows, from the west to the southeast, through a lake 3, and thus sand and stone resources and water transportation advantages in the river 2 and lake 3, mineral resources of the mountain area 1, and the flat land rushed by the river 2 are provided. In geographical conditions, the water source of the river 2 favors the provision of net-like standardized canal modules 10, so as to facilitate the water supply, water discharge, and shipping of the large-size standardized urban product. Net-like standardized road/bridge modules 16 and standardized airport modules 21 as well as net-like standardized rail modules 9 may ensure a smooth traffic of the large-size standardized urban product forever, and favor the replication and expansion of the large-size standardized urban product to surrounding areas due to the ever-increasing population. Due to the advantages in terms of land, population, industry, technology, culture, commerce, intellectual property rights, water, mineral resources, etc., the town 5 shown in FIG. 6 may be rapidly expanded into the large-size standardized urban product assembled by G, or hundreds, or thousands of mesh-sheet standardized block modules 18. The mountain area 1, river 2, and lake 3 shown in FIG. 6 may also provide a scenic spot type mesh-sheet standardized block module 18 in the light of local conditions. The present invention provides multifunctional bridge modules 7 over multiple waters 12 across the river 2, thereby enabling the investment in one multifunctional bridge module to achieve the traffic flow of several ordinary bridges and adding the function of appreciation and recreation for passengers. FIG. 6 provides standardized kindergartens, primary schools, and middle schools 25, standardized senior high schools, industrial technical schools 26, universities or industrial universities 29, industrial museums or museums 30, and industrial parks or parks 31. The net-like standardized road/bridge modules 16 are communicated with mesh-sheet standardized block underground space modules 33 and further communicated with the standardized house modules and other buildings 32, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in the standardized urban product, which reduces the provision and maintenance cost of pipeline modules, improves the provision and maintenance efficiency of pipeline modules, and also ensures all the sewage generated by the large-size standardized urban product gets qualified treatment and discharge.

The embodiment of the large-size standardized urban product shown in FIGS. 5 and 6 in the present invention is well suitable to be popularized in urbanization.

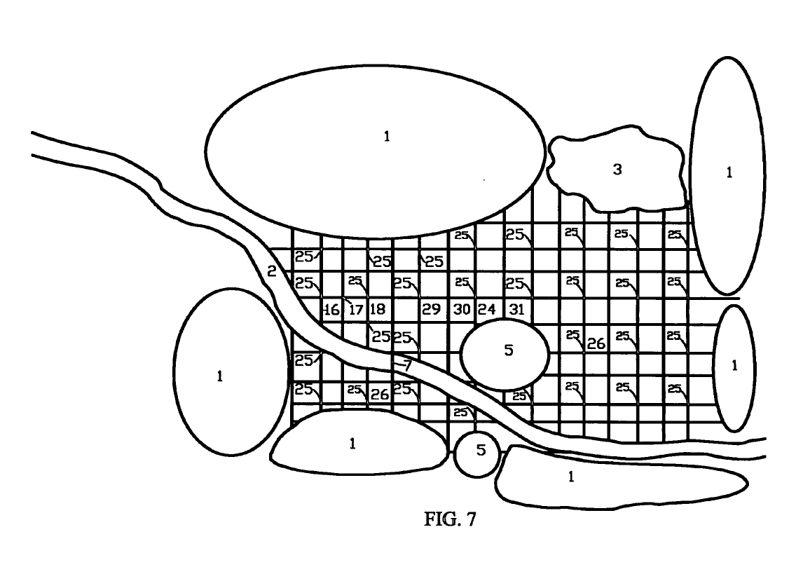

A small-size standardized urban product assembled by G or several mesh-sheet standardized block modules 18 is provided on surrounding land of the town 5 to the south of the river 2 shown in FIG. 7. A middle-size standardized urban product assembled by G or tens of mesh-sheet standardized block modules 18 is provided on surrounding areas of the town 5 to the north of the river 2 shown in FIG. 7. The small-size standardized urban product to the south of the river 2 and the middle-size standardized urban product to the north of the river 2 shown in FIG. 7 are communicated via a multifunctional bridge module 7 to form an integrated middle-and-small-size standardized urban product. The integrated middle-and-small-size standardized urban product may uniformly provide standardized kindergartens, primary schools, and middle schools 25, standardized senior high schools, industrial technical schools 26, universities or industrial universities 29, industrial museums or museums 30, industrial parks or parks 31, and physical activity places 24. Net-like standardized road/bridge modules 16 are communicated with mesh-sheet standardized block underground space modules 33 and further communicated with the standardized house modules and other buildings 32, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized canal clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in the standardized urban product, which reduces the provision and maintenance cost of pipeline modules, improves the provision and maintenance efficiency of pipeline modules, and also ensures all the sewage generated by the middle-and-small-size standardized urban product gets qualified treatment and discharge. The communication of the multifunctional bridge module 7 realizes the integrated investment and usage of construction infrastructure and social infrastructure of the middle-and-small-size standardized urban product of FIG. 7, thus reducing the cost and improving the efficiency. As shown in FIG. 7, the mountain area 1 may provide cheap mineral resources. The river 2 and lake 3 may provide the convenience of water supply, water discharge, and shipping, and reduce the drinking water cost and transportation cost. The net-like standardized road/bridge modules 16 and intercommunication standardized overpass modules 17 may ensure a smooth traffic of the middle-and-small-size standardized urban product. The mountain area 1, river 2, and lake 3 shown in FIG. 7 may also provide a scenic spot type mesh-sheet standardized block module 18 in the light of local conditions.

A small-size standardized urban product assembled by G or several mesh-sheet standardized block product modules 18 is provided on surrounding land of the town 5 to the south of the river 2 shown in FIG. 8. A middle-size standardized urban product assembled by G or tens of mesh-sheet standardized block modules 18 is provided on surrounding areas of the town 5 to the north of the river 2 shown in FIG. 8. In FIG. 8, net-like, [symbol] -type standardized canal modules provided by the water resource in the river 2 are used to facilitate the water supply, water discharge, and water transportation of the middle-and-small-size standardized urban product. The small-size standardized urban product to the south of the river 2 and the middle-size standardized urban product to the north of the river 2 shown in FIG. 8 are communicated by providing a multifunctional bridge module 7, so as to form an integrated middle-and-small-size standardized urban product. The integrated middle-and-small-size standardized urban product may uniformly provide standardized kindergartens, primary schools, and middle schools 25, standardized senior high schools, industrial technical schools 26, universities or industrial universities 29, industrial museums or museums 30, industrial parks or parks 31, and physical activity places 24. Net-like standardized road/bridge modules 16 are communicated with mesh-sheet standardized block underground space modules 33 and further communicated with the standardized house modules and other buildings 32, so as to provide net-like/mesh-sheet rainwater pipe modules 39, net-like/mesh-sheet sewage pipe modules 40, net-like/mesh-sheet tap water pipe modules 41, net-like/mesh-sheet standardized clean water pipe modules 42, net-like/mesh-sheet coal gas pipe modules 43, net-like/mesh-sheet natural gas pipe modules 44, net-like/mesh-sheet oil pipe modules 45, net-like/mesh-sheet heating pipe modules 46, net-like/mesh-sheet cooling pipe product modules 47, net-like/mesh-sheet power supply pipeline product modules 48, net-like/mesh-sheet telephone pipeline product modules 49, net-like/mesh-sheet TV pipeline product modules 50, net-like/mesh-sheet computer pipeline product modules 51, and net-like/mesh-sheet intelligent pipeline product modules 57. The present invention collectively provides and maintains various net-like pipeline modules in the standardized urban product, which reduces the provision and maintenance cost of pipeline modules, improves the provision and maintenance efficiency of pipeline modules, and also ensures all the sewage generated by the middle-and-small-size standardized urban product gets qualified treatment and discharge. The communication of the multifunctional bridge module 7 realizes the integrated investment and usage of construction infrastructure and social infrastructure of the middle-and-small-size standardized urban product of FIG. 8, thus reducing the cost and improving the efficiency.

The mountain area 1 shown in FIG. 8 may provide cheap mineral resources. The river 2 and lake 3 may provide the water source for the net-like standardized canal product modules 10, provide the convenience of water supply, water discharge, and shipping, and reduce the drinking water cost and transportation cost. The net-like standardized road/bridge modules 16 and intercommunication standardized overpass modules 17 may ensure a smooth traffic of the middle-and-small-size standardized urban product. The mountain area 1, river 2, and lake 3 shown in FIG. 8 may also provide a scenic spot type mesh-sheet standardized block module 18 in the light of local conditions. The geographical condition and population status of the mountain area 1, river 2, and town 5 shown in FIGS. 7 and 8 are common in countries around the world. The middle-and-small-size standardized urban product shown in FIGS. 7 and 8 provided in the present invention may be widely popularized in countries and places around the world to meet the requirements of rapid growth of population in urbanization.

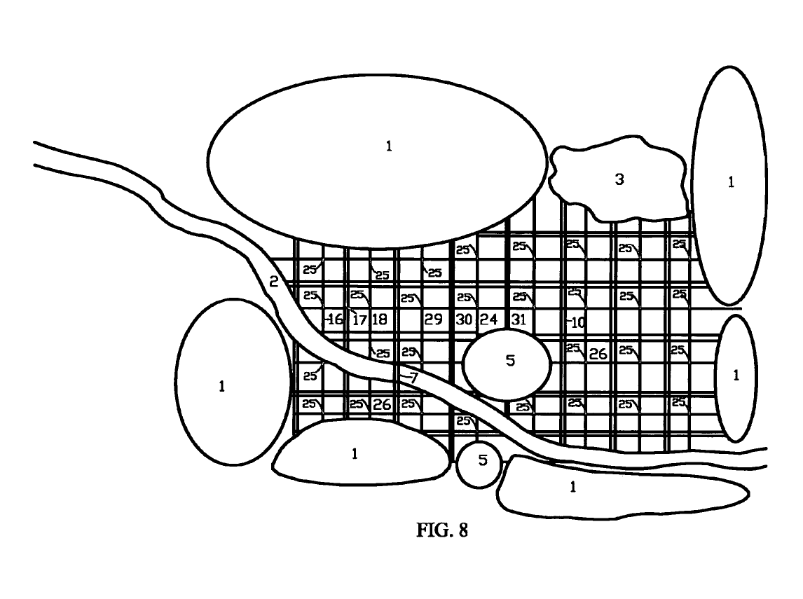

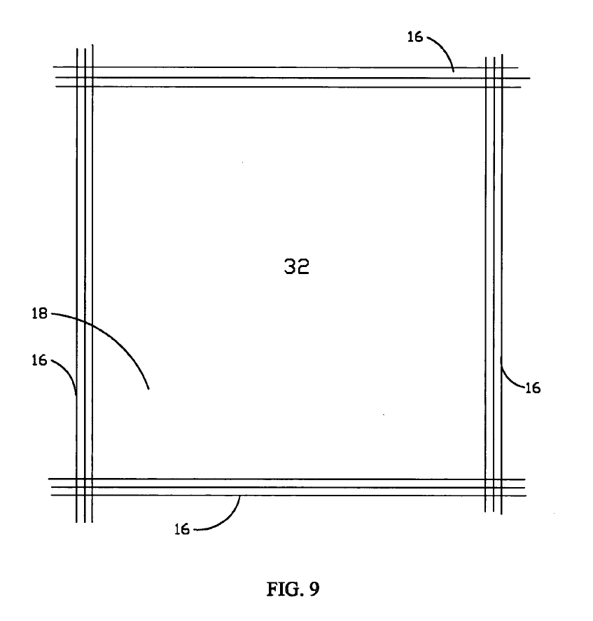

A mesh-sheet standardized block module 18 shown in FIG. 9 is a basic module of a standardized urban product. A assembled module integrating the mesh-sheet standardized block module 18 and a net-like standardized road/bridge module 16 is a basic assembled module of the standardized urban product. The mesh-sheet standardized block module 18 shown in FIG. 9 includes the net-like standardized road/bridge module 16 and a mesh-sheet standardized block module building 32 integrated together. The mesh-sheet standardized block module 18 shown in FIG. 9 is a basis for the provision of other industry-type mesh-sheet standardized block modules by the standardized urban product according to actual requirements and for the variability of the standardized urban product.

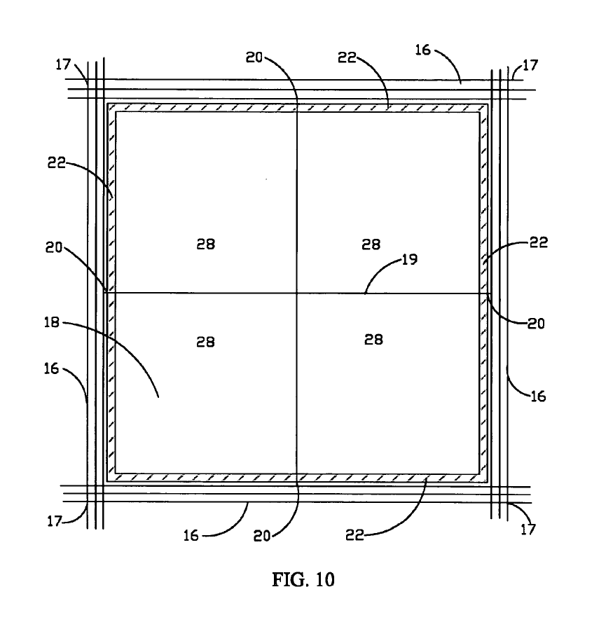

In an industrial manufacturing mesh-sheet standardized block module 18 shown in FIG. 10, net-like standardized road/bridge modules 16 and intercommunication standardized overpass modules 17 shown in FIG. 10 are used to ensure a smooth traffic of the industrial manufacturing mesh-sheet standardized block module 18. Roadside commercial buildings 22 may provide commercial service for the industrial manufacturing mesh-sheet standardized block module 18. An entrance/exit 20 is respectively provided in the east, south, west, and north of the industrial manufacturing mesh-sheet standardized block module 18. The entrance/exits 20 are communicated with ground cross main driveways and annular main driveways 19. In the industrial manufacturing mesh-sheet standardized block module 18 and standardized workshops 28 shown in FIG. 10, standardized house modules and other buildings 32 are communicated with mesh-sheet standardized block underground space modules 33 and further communicated with the net-like standardized road/bridge modules 16 to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in the standardized urban product, which reduces the provision and maintenance cost of pipeline modules, improves the provision and maintenance efficiency of pipeline modules, and also ensures all the sewage generated by the industrial manufacturing mesh-sheet standardized block module 18 gets qualified treatment and discharge. The industrial manufacturing mesh-sheet standardized block underground space module 33 is further provided with main driveways 34 and 35, traffic lanes 36, and parking space 37.

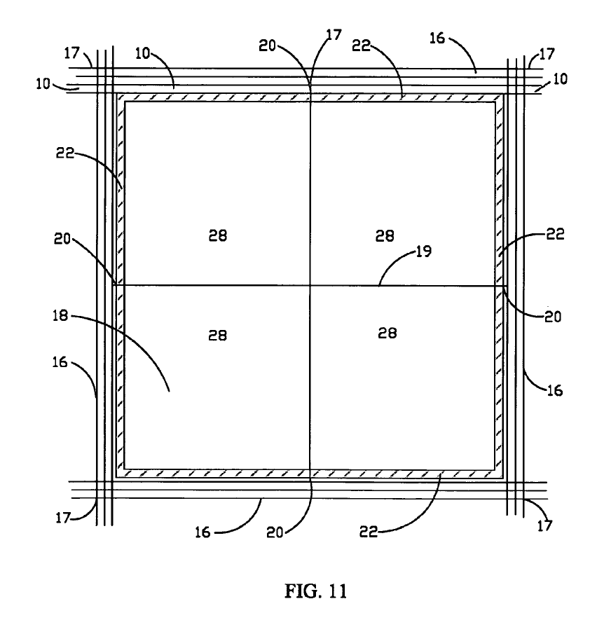

Net-like standardized canal modules 10 are provided in the north of an industrial manufacturing mesh-sheet standardized block module 18 shown in FIG. 11, so as to provide the convenience of water supply, water discharge, and shipping of the industrial manufacturing mesh-sheet standardized block module 18. Net-like standardized road/bridge modules 16 and intercommunication standardized overpass modules 17 shown in FIG. 11 are used to ensure a smooth traffic of the industrial manufacturing mesh-sheet standardized block module 18. Roadside commercial buildings 22 may provide commercial service for the industrial manufacturing mesh-sheet standardized block module 18. An entrance/exit 20 is respectively provided in the east, south, west, and north of the industrial manufacturing mesh-sheet standardized block module 18 shown in FIG. 11. The entrance/exit in the north is further provided with standardized canal bridge modules 17. The entrance/exits 20 are communicated with ground cross main driveways and annular main driveways 19. In the industrial manufacturing mesh-sheet standardized block module 18 and standardized workshops 28 shown in FIG. 11, standardized house modules and other buildings 32 are communicated with mesh-sheet standardized block underground space modules 33 and further communicated with the net-like standardized road/bridge modules 16, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in the standardized urban product, which reduces the provision and maintenance cost of pipeline modules, improves the provision and maintenance efficiency of pipeline modules, and also ensures all the sewage generated by the industrial manufacturing mesh-sheet standardized block module 18 gets qualified treatment and discharge. The industrial manufacturing mesh-sheet standardized block underground space module 33 is further provided with main driveways 34 and 35, traffic lanes 36, and parking space 37.

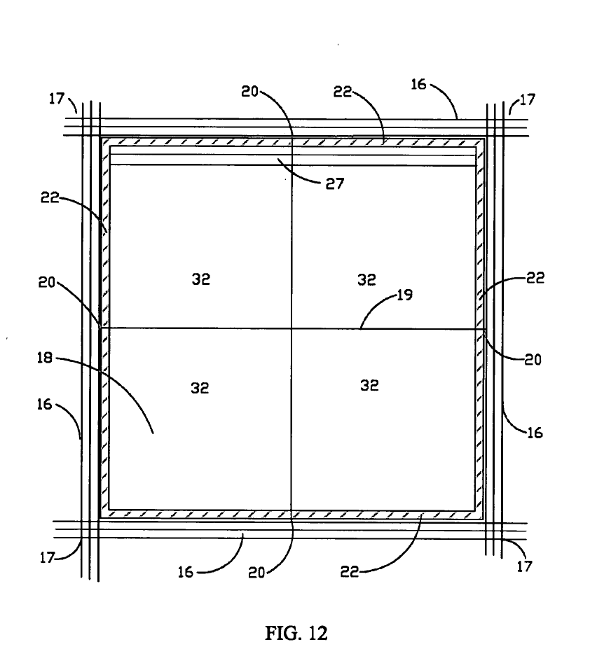

In a commercial/residential mesh-sheet standardized block module 18 shown in FIG. 12, net-like standardized road/bridge modules 16 and intercommunication standardized overpass modules 17 are provided in four directions of the east, south, west, and north of the commercial/residential mesh-sheet standardized block module 18 to ensure a smooth traffic of the commercial/residential mesh-sheet standardized block module 18. Roadside commercial buildings 22 and standardized commercial pedestrian streets 27 may provide commercial service for the commercial/residential mesh-sheet standardized block module 18. An entrance/exit 20 is respectively provided in the east, south, west, and north of the commercial/residential mesh-sheet standardized block module 18. The entrance/exits 20 are communicated with ground cross main driveways and annular main driveways 19. The commercial/residential mesh-sheet standardized block module 18 shown in FIG. 12 provides standardized house modules and other buildings 32. The standardized house modules and other buildings 32 are communicated with mesh-sheet standardized block underground space modules 33 and further communicated with net-like standardized road/bridge modules 16, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in the standardized urban product, which reduces the provision and maintenance cost of pipeline modules, improves the provision and maintenance efficiency of pipeline modules, and also ensures all the sewage generated by the commercial/residential mesh-sheet standardized block module 18 gets qualified treatment and discharge. The commercial/residential mesh-sheet standardized block underground space module 33 is further provided with main driveways 34 and 35, traffic lanes 36, and parking space 37.

Net-like standardized canal modules 10 are provided in the north of a commercial/residential mesh-sheet standardized block module 18 shown in FIG. 13, so as to provide the convenience of water supply, water discharge, and shipping of the commercial/residential mesh-sheet standardized block module 18. Net-like standardized road/bridge modules 16 and intercommunication standardized overpass modules 17 are provided in four directions of the east, south, west, and north of the commercial/residential mesh-sheet standardized block module 18 to ensure a smooth traffic of the commercial/residential mesh-sheet standardized block module 18. Roadside commercial buildings 22 and standardized commercial pedestrian streets 27 may provide commercial service for the commercial/residential mesh-sheet standardized block module 18. An entrance/exit 20 is respectively provided in the east, south, west, and north of the commercial/residential mesh-sheet standardized block module 18. The entrance/exit 20 in the north is further provided with standardized canal bridge modules 17. The entrance/exits 20 are communicated with ground cross main driveways and annular main driveways 19. The commercial/residential mesh-sheet standardized block module 18 shown in FIG. 13 provides standardized house modules and other buildings 32. The standardized house modules and other buildings 32 are communicated with mesh-sheet standardized block underground space modules 33 and further communicated with net-like standardized road/bridge modules 16, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various net-like/mesh-sheet standardized pipeline modules in the standardized urban product, which reduces the provision and maintenance cost of pipeline modules, improves the provision and maintenance efficiency of pipeline modules, and also ensures all the sewage generated by the commercial/residential mesh-sheet standardized block module 18 gets qualified treatment and discharge. The commercial/residential mesh-sheet standardized block underground space module 33 is further provided with main driveways 34 and 35, traffic lanes 36, and parking space 37.

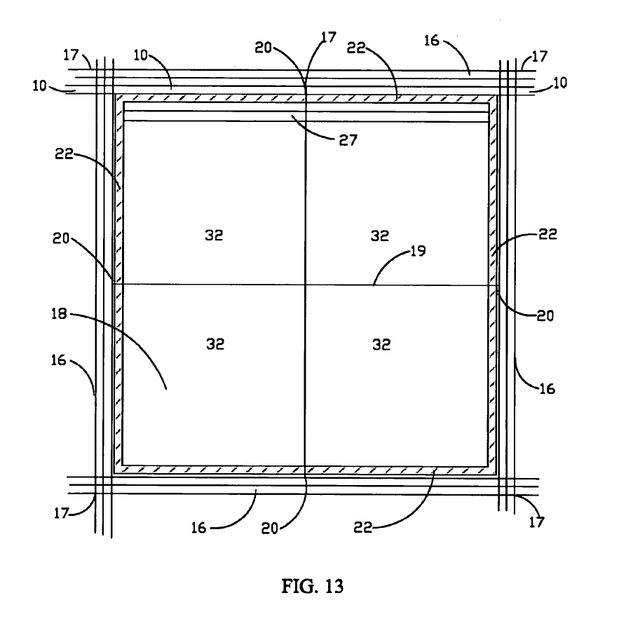

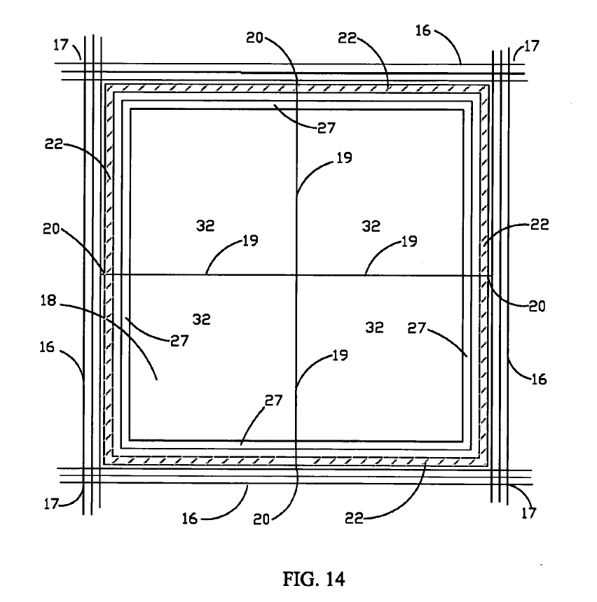

In a R&D transactional mesh-sheet standardized block module 18 shown in FIG. 14, net-like standardized road/bridge modules 16 and intercommunication standardized overpass modules 17 are provided in four directions of the east, south, west, and north of the R&D transactional mesh-sheet standardized block module 18 to ensure a smooth traffic of the R&D transactional mesh-sheet standardized block module 18. Roadside commercial buildings 22 and standardized commercial pedestrian streets 27 may provide service for the R&D transactional mesh-sheet standardized block module 18. An entrance/exit 20 is respectively provided in the east, south, west, and north of the R&D transactional mesh-sheet standardized block module 18. The entrance/exits 20 are communicated with cross main driveways and annular main driveways 19 on the ground. The R&D transactional mesh-sheet standardized block module 18 provides standardized house modules and other buildings 32. The standardized house modules and other buildings 32 are communicated with mesh-sheet standardized block underground space modules 33 and further communicated with the net-like standardized road/bridge modules 16, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various pipeline modules in the standardized urban product, which reduces the provision and maintenance cost of pipeline modules, improves the provision and maintenance efficiency of pipeline modules, and also ensures all the sewage generated by the R&D transactional mesh-sheet standardized block module 18 gets qualified treatment and discharge. The R&D transactional mesh-sheet standardized block underground space module 33 is further provided with main driveways 34 and 35, traffic lanes 36, and parking space 37.

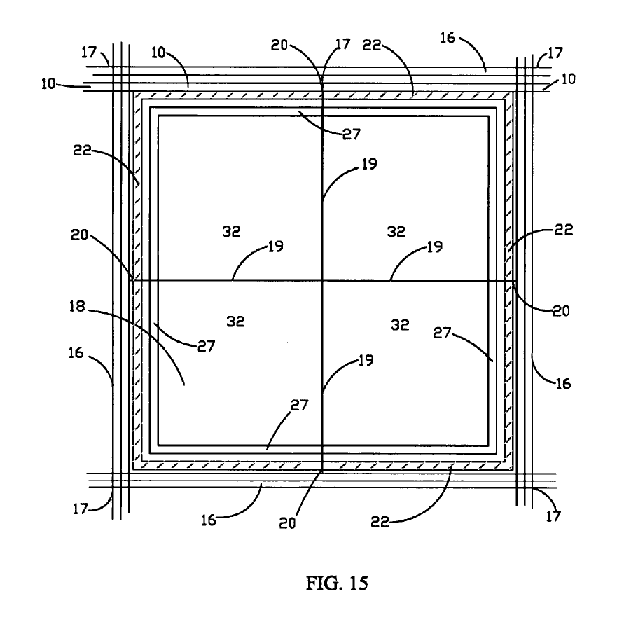

Net-like standardized canal modules 10 are provided in the north of a R&D transactional mesh-sheet standardized block module 18 shown in FIG. 15, so as to provide the convenience of water supply, water discharge, and shipping of the R&D transactional mesh-sheet standardized block module 18. Net-like standardized road/bridge modules 16 and intercommunication standardized overpass modules 17 are provided in four directions of the east, south, west, and north of the R&D transactional mesh-sheet standardized block module 18 to ensure a smooth traffic of the R&D transactional mesh-sheet standardized block module 18. Roadside commercial buildings 22 and standardized commercial pedestrian streets 27 may provide service for the R&D transactional mesh-sheet standardized block module 18. An entrance/exit 20 is respectively provided in the east, south, west, and north of the R&D transactional mesh-sheet standardized block module 18. The entrance/exit 20 in the north is further provided with standardized canal bridge modules 17. The entrance/exits 20 are communicated with cross main driveways and annular main driveways 19 on the ground. The R&D transactional mesh-sheet standardized block module 18 provides standardized house modules and other buildings 32. The standardized house modules and other buildings 32 are communicated with mesh-sheet standardized block underground space modules 33 and further communicated with the net-like standardized road/bridge modules 16, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, net-like/mesh-sheet standardized computer pipeline modules 51, and net-like/mesh-sheet standardized intelligent pipeline modules 57. The present invention collectively provides and maintains various pipeline modules in the standardized urban product, which reduces the provision and maintenance cost of pipeline modules, improves the provision and maintenance efficiency of pipeline modules, and also ensures all the sewage generated by the R&D transactional mesh-sheet standardized block module 18 gets qualified treatment and discharge. The R&D transactional mesh-sheet standardized block underground space module 33 is further provided with main driveways 34 and 35, traffic lanes 36, and parking space 37.

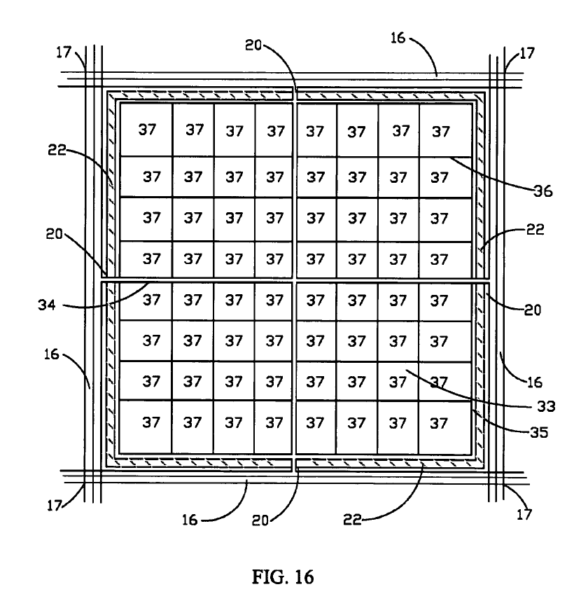

FIG. 16 shows a mesh-sheet standardized block underground space module 33, which is a further illustration of the mesh-sheet standardized block module 18 shown in FIGS. 1, 2, 3, 4, 5, 6, 7, 8, 9, 10, 11, 12, 13, 14, and 15. The mesh-sheet standardized block underground space module 33 shown in FIG. 16 provides underground cross main driveways 34, underground annular main driveways 35, underground traffic lanes 36, and underground parking space 37, and provides a roadside commercial building underground space 23. The underground main driveways are communicated with entrance/exits 20. The mesh-sheet standardized block underground space module 33 provides underground space channels 34 between adjacent mesh-sheet standardized block underground space modules 33.

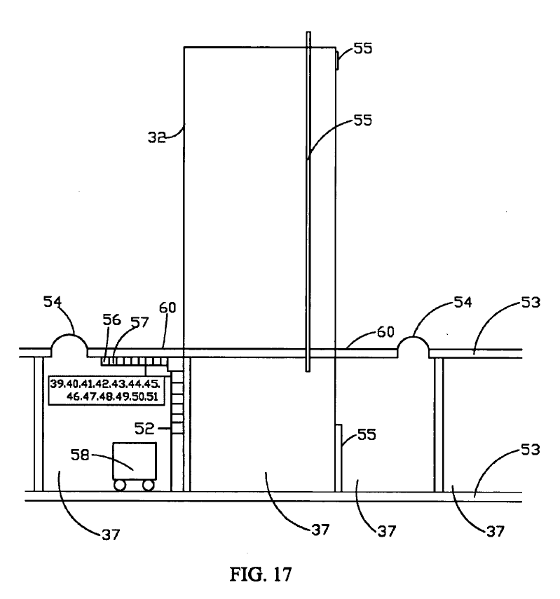

FIG. 17 is a schematic sectional view of a mesh-sheet standardized block underground space module 33. FIG. 17 shows a reinforced concrete pipe, upright post, revetment, pipeline safety support 52, reinforced concrete pavements or bituminous pavements 53, ventilating and light-transmissive skylights 54, air draft windows, air draft walkways, air draft pipes 55, a solar energy, wind energy, or energy-saving lamp pipeline 56, a net-like/mesh-sheet intelligent pipeline module 57, a pipeline maintenance vehicle 58, and gardening, waterscape, sidewalks 60. Standardized house modules and other buildings 32 are communicated with mesh-sheet standardized block underground space modules 33 and further communicated with net-like standardized road/bridge modules 16, so as to provide net-like/mesh-sheet standardized rainwater pipe modules 39, net-like/mesh-sheet standardized sewage pipe modules 40, net-like/mesh-sheet standardized tap water pipe modules 41, net-like/mesh-sheet standardized clean water pipe modules 42, net-like/mesh-sheet standardized coal gas pipe modules 43, net-like/mesh-sheet standardized natural gas pipe modules 44, net-like/mesh-sheet standardized oil pipe modules 45, net-like/mesh-sheet standardized heating pipe modules 46, net-like/mesh-sheet standardized cooling pipe modules 47, net-like/mesh-sheet standardized power supply pipeline modules 48, net-like/mesh-sheet standardized telephone pipeline modules 49, net-like/mesh-sheet standardized TV pipeline modules 50, and net-like/mesh-sheet standardized computer pipeline modules 51. The present invention collectively provides and maintains various net-like/mesh-sheet standardized pipeline modules in the standardized urban product, which reduces the provision and maintenance cost of pipeline modules, improves the provision and maintenance efficiency of pipeline modules, and also ensures all the sewage generated by the mesh-sheet standardized block module 18 gets qualified treatment and discharge.

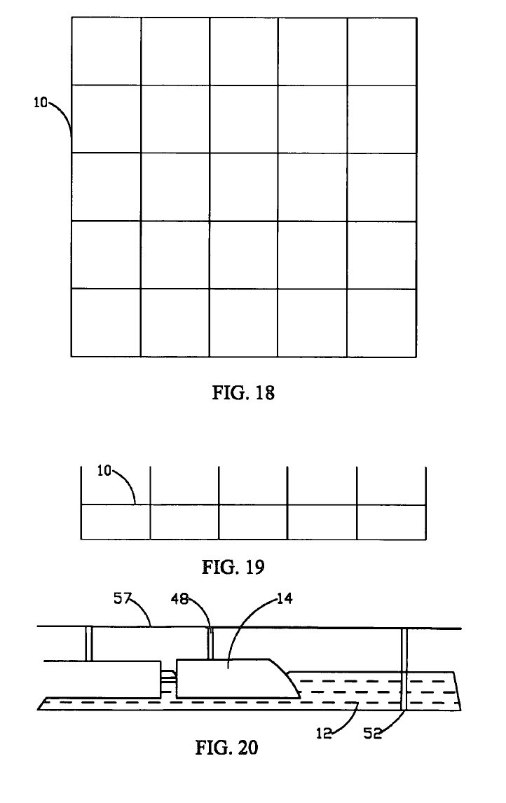

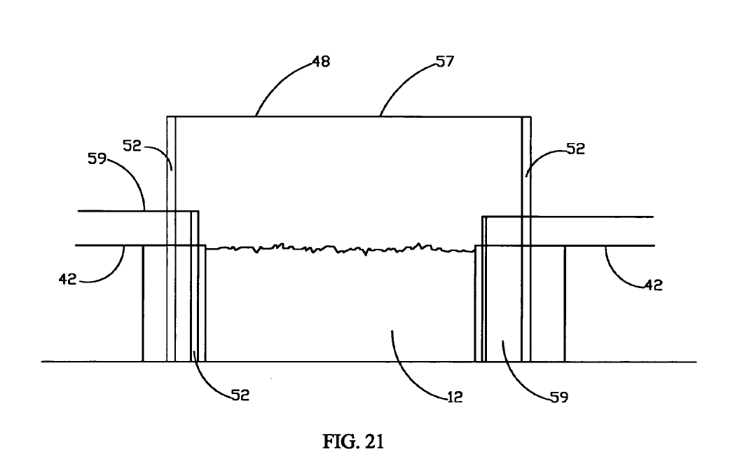

FIG. 18 shows a net-like standardized canal module 10 provided in an extra large-size and large-size standardized urban product. FIG. 19 shows a [symbol] -type standardized canal module 10 mainly used in a middle-and-small-size standardized urban product provided in a riverside, lakeside, and seaside flat land of a narrow zone. FIGS. 20 and 21 are schematic sectional and cross-sectional views of the standardized canal module 10. Lands 59 shown in FIG. 21 are installed therein with reinforced concrete pipes, upright posts, revetment, pipeline safety supports 52 provided with power supply pipeline modules 48 and intelligent pipeline modules 57. FIG. 22 provides net-like/mesh-sheet standardized clean water pipe modules 42 under the ground of canal water 12 and the ground of the bank, so as to provide cheap and clean underground clean water source. Since the standardized canal module 10 shown in FIGS. 19, 20, 21, and 22 may provide the water source of the drinking water, underground clean water, and transportation to the standardized urban product, the industrial assembly line-type prefabrication, transportation, and installation cost of the standardized urban product may be reduced, the manufacturing efficiency as well as the environment of the standardized urban product may be improved. The electric/intelligent ships 14 provided in the present invention sail in the net-like standardized canal module 10 and use clean electrical energy to substitute polluting energy sources such as oil and natural gas, thus providing a beautiful and peaceful waterscape space for the standardized urban product.

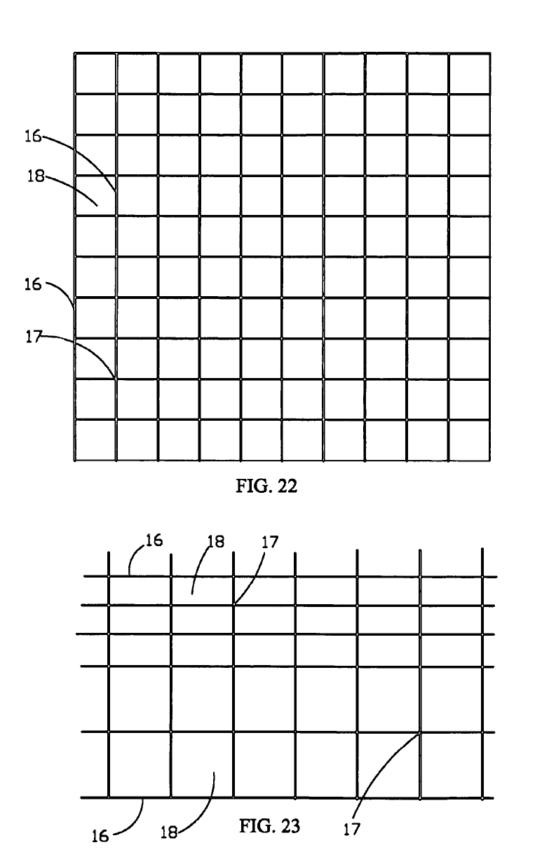

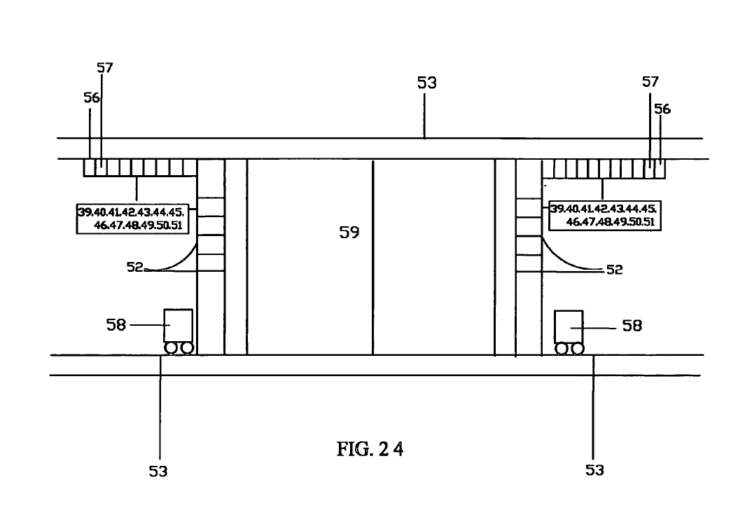

Net-like standardized road/bridge modules 16 and intercommunication standardized overpass modules 17 shown in FIGS. 22 and 23 may ensure a smooth traffic of a large-size and extra large-size standardized urban product. The net-like standardized road/bridge modules 16 are arranged between mesh-sheet standardized block modules 18. The net-like standardized road/bridge modules 16 shown in FIG. 23 is suitable for being provided in a middle-and-small-size standardized urban product which may reasonably provide the number of fast lanes of the net-like standardized road/bridge modules 16 according to the traffic flow. FIG. 24 is a schematic cross-sectional view of a net-like standardized road/bridge module 16. The net-like standardized road/bridge module 16 shown in FIG. 24 provides reinforced concrete floors or bituminous pavements 53. The underground space of sidewalks on both sides provides reinforced concrete pipes, upright posts, revetment, pipeline safety supports 52. The reinforced concrete pipes, upright posts, revetment, pipeline safety supports 52 provide net-like standardized rainwater pipe modules 39, net-like standardized sewage pipe modules 40, net-like standardized tap water pipe modules 41, net-like standardized clean water pipe modules 42, net-like standardized coal gas pipe modules 43, net-like standardized natural gas pipe modules 44, net-like standardized oil pipe modules 45, net-like standardized heating pipe modules 46, net-like standardized cooling pipe modules 47, net-like standardized power supply pipeline modules 48, net-like standardized telephone pipeline modules 49, net-like standardized TV pipeline modules 50, net-like standardized computer pipeline modules 51, solar energy, wind energy, energy-saving pipeline modules 56, net-like standardized intelligent pipeline modules 57, and pipeline maintenance vehicles 58. A land 59 is under the reinforced concrete pavements or bituminous pavements 53. The present invention collectively provides and maintains various net-like pipeline modules of the standardized urban product, which reduces the provision and maintenance cost of pipeline modules, improves the provision and maintenance efficiency of pipeline modules, and also ensures all the sewage generated in the standardized urban product gets qualified treatment and discharge. FIG. 25 is a schematic plan view of a net-like standardized road/bridge module 16. It has roadside commercial buildings 22, gardening, waterscape, sidewalks 60, slow lanes 62, soundproof walls 61, fast lanes 63, and fast lanes 64 without high speed limitation. Since the net-like standardized road/bridge module 16 is not provided with any traffic light or toll station, and around 50% of the fast lanes have no high speed limitation, a traffic flow of 2.52 to 3.96 million vehicles per hour may be achieved for a mesh-sheet standardized urban module 6 with a population of 1 to 1.5 million, everyone owns 2 underground parking space, and no traffic jam will occur even if residents of the mesh-sheet standardized urban module 6 drive on the roads at the same time.

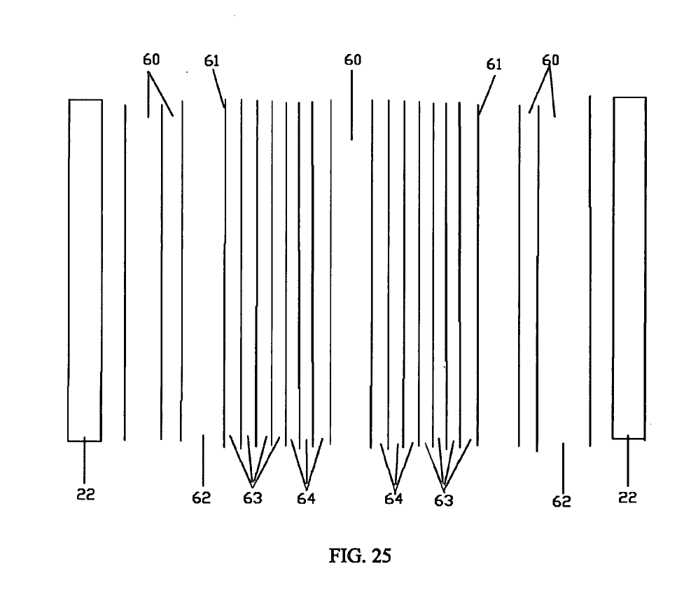

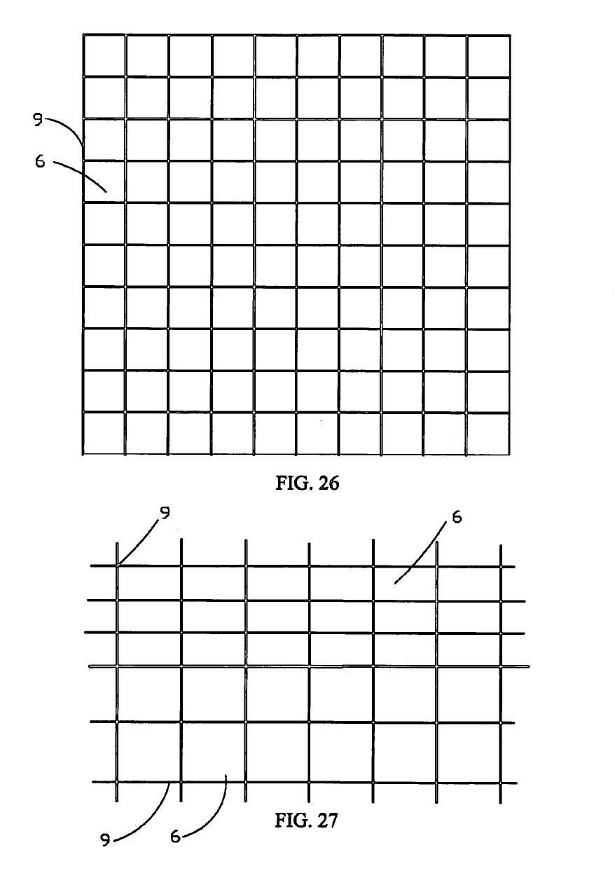

FIGS. 26 and 27 show net-like standardized rail modules 9 provided by an extra large-size and large-size standardized urban product. The net-like standardized rail modules 9 is integrated with the mesh-sheet standardized urban modules 6. The net-like standardized rail modules 9 may be provided according to actual requirements of the large-size or extra large-size standardized urban product. The net-like standardized rail modules 9 may extend outwards along with the replication and assembly of the mesh-sheet standardized urban modules 6.

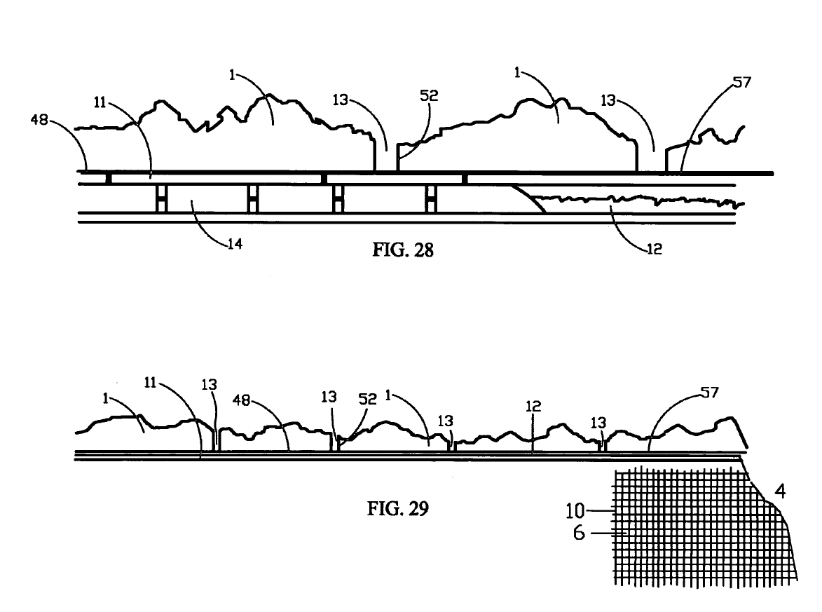

FIG. 28 is a schematic sectional view of an underground fairway module 11. Since mountain areas and inland areas are exploited with abundant mineral resources, transportation only by vehicles and trains not only consumes energy, pollutes the environment, but also increases the cost. The underground fairway module 11 shown in FIG. 28 provides a reinforced concrete pipe, upright post, revetment, pipeline safety support 52. The underground fairway module 11 uses the carrying capacity of water 12 to transport goods and materials. The underground fairway module 11 provides a power supply pipeline module 48 and an intelligent pipeline module 57 to enable an electric/intelligent ship 14 to sail in the underground fairway module 11. The underground fairway module 11 provides a mineral resources dock 13 which loads mineral resources in the electric/intelligent ship 14 through loading/unloading facilities. FIG. 29 shows mountain areas 1, sea 4, a large-size or extra large-size standardized urban product assembled by mesh-sheet standardized urban modules 6. The mesh-sheet standardized urban modules 6 is provided with a net-like standardized canal module 10 communicated with the underground fairway module 11, seawater carrying resource 12, mineral resources and mineral resources dock 13, and a reinforced concrete pipe, upright post, revetment, pipeline safety support 52. As shown in FIGS. 28 and 29, the mineral resources 13 required by the standardized urban product are located in the high-mountain areas 1 far away from the sea and the lack of the water source 12, which results in the exploitation and transportation being very difficult. In order to ensure the supply of the mineral resources 13 required by the standardized urban product, the present invention provides the underground fairway module 11 to introduce the seawater 12 as the carrying resource, uses the electric/intelligent ship 14 to ship out the mineral resources 13 from the mountain areas 1, and provides the mineral resources 13 to the standardized urban product for use through the sea 4 and the net-like standardized canal module 10.

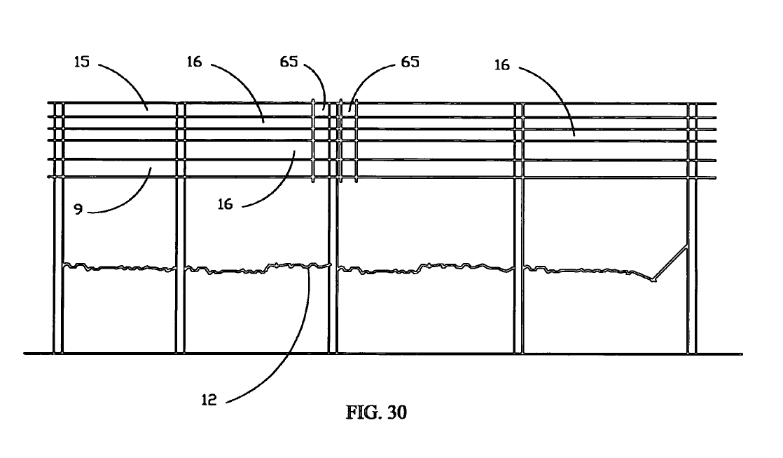

As shown in FIG. 30, bridge piers of a multifunctional bridge module 7 stand in the water 12. From bottom to top, one bridge floor provides a net-like rail traffic module 9. One bridge floor may provide a rail station platform which may provide sightseeing elevators and sightseeing stairs 65 leading directly to a sightseeing corridor bridge 15 on the top floor. One floor may also provide a bridge-passing net-like standardized canal module 10. One bridge floor also provides net-like standardized rainwater pipe modules 39, net-like standardized sewage pipe modules 40, net-like standardized tap water pipe modules 41, net-like standardized clean water pipe modules 42, net-like standardized coal gas pipe modules 43, net-like standardized natural gas pipe modules 44, net-like standardized oil pipe modules 45, net-like standardized heating pipe modules 46, net-like standardized cooling pipe modules 47, net-like standardized power supply pipeline modules 48, net-like standardized telephone pipeline modules 49, net-like standardized TV pipeline modules 50, net-like standardized computer pipeline modules 51, and net-like standardized intelligent pipe modules 57 communicated with the sightseeing corridor bridge 15 on the top floor. The second floor of the multifunctional bridge module 7 may be provided as a net-like standardized road/bridge module 16 for heavy vehicles. The third, fourth, or Gth bridge floor may be provided as the net-like standardized road/bridge module 16 connected with fast lanes and slow lanes of light vehicles. Transparent soundproof walls 61 are provided between the fast lanes 63 and slow lanes 62. The third, fourth, or Gth floor also provides, on the bridge floor, a temporary parking platform for people getting in and out which provides the sightseeing elevators and sightseeing stairs 65 leading directly to the top floor. The top floor of the multifunctional bridge module 7 provides the sightseeing corridor bridge 15 which provides a place of sightseeing and entertainment and a channel for traveling and sightseeing. The sightseeing corridor bridge 15 provided in the present invention may also be multiple floors according to actual requirements of the experience economy.

Bridge piers of a multifunctional bridge module 7 shown in FIG. 31 stand in the water 12. One bridge floor is provided as a net-like standardized road/bridge module 16 for passing vehicles. The top floor of the multifunctional bridge module 7 provides the sightseeing corridor bridge 15 which provides a place of sightseeing and entertainment and a channel for traveling and sightseeing. The sightseeing corridor bridge 15 provided in the present invention may also be multiple floors according to actual requirements of the experience economy.

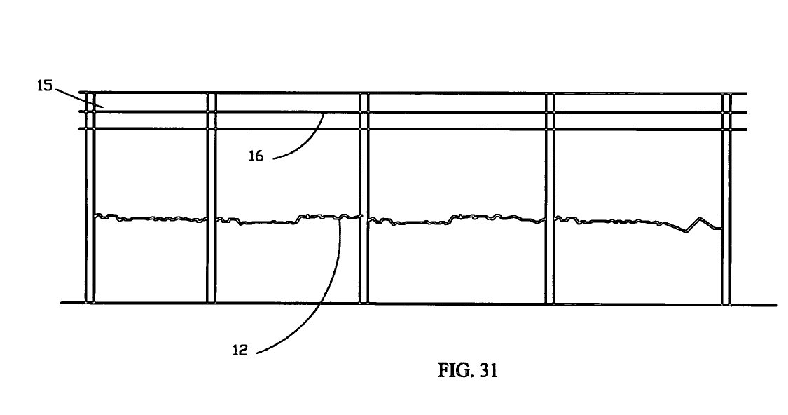

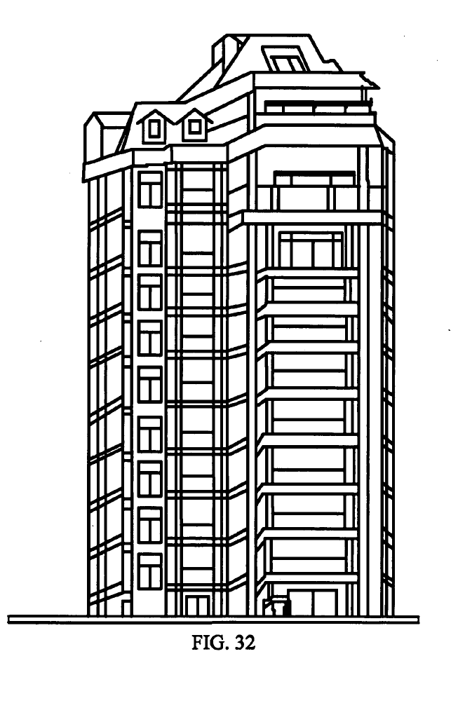

FIG. 32 is an overall schematic structural view of a standardized house module provided in the present invention. The standardized house module provided in the present invention is assembled by standardized concrete house components such as house foundations, septic tanks, walls, floorslabs, stairs, walkways, doors, windows, balconies, floors, and roofs.

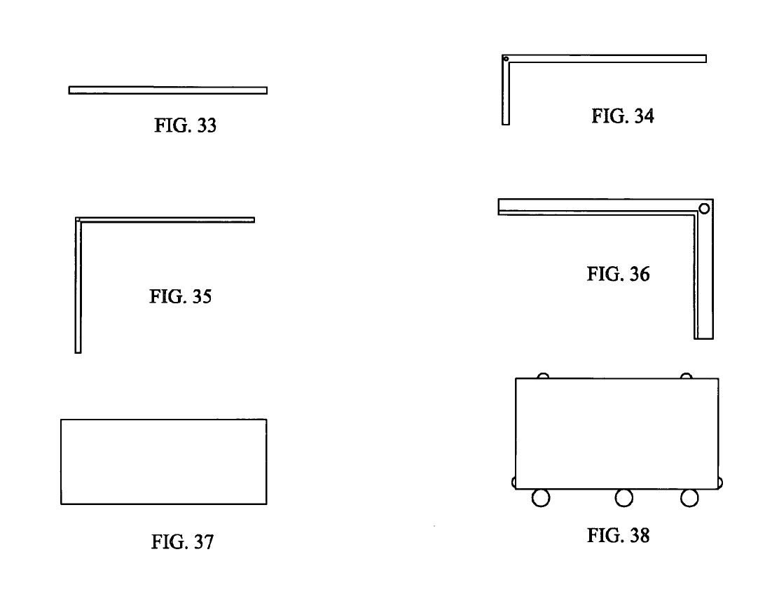

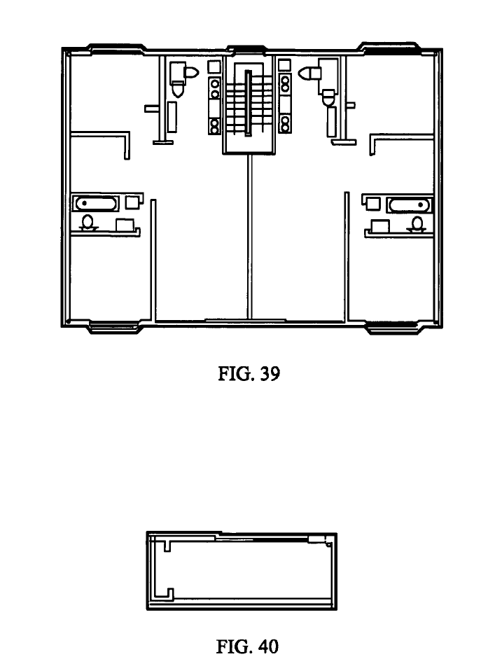

FIGS. 33, 34, 35, and 36 respectively show four forms of walls in the present invention. FIG. 33 shows a flat wall without any corner. FIG. 34 shows a wall having a corner with a prefabricated/preserved hole and one wall. FIG. 35 shows a wall having a corner with a prefabricated/preserved hole and two walls. FIG. 36 shows an external wall having a corner with a prefabricated/preserved hole and an internally attached wall. FIG. 37 shows a floorslab in the present invention. FIG. 38 shows a standard case for prefabricating and transporting house components in the present invention. The standard case in FIG. 38 has unloading rings at the top, dragging rings at both ends, and wheels at the bottom. FIG. 39 shows a floor prefabricated within a standard case. FIG. 40 is a schematic view of balconies of a complete house prefabricated within a prefabrication and transportation standard case and the prefabrication and transportation standard case.

FIG. 38 shows that a house module standard case for loading/unloading and transporting a standardized house provided in the present invention is used to transport prefabricated components of a house module to places around the world, so as to be installed into a standardized house product and assembled into a standardized urban product. The house module standard case may use a mixed material such as steels, and is designed and fabricated according to standard sizes of the prefabricated components of the house module. The standard case may be maintained, recycled, and reutilized. Mainly for loading/unloading, transporting, and installing prefabricated components of the house module and a house decoration module, the house module standard case 38 may be designed to be a square, circle, triangle, polygon, oval, cone, cylinder, honeycomb, or other geometrical shape according to actual requirements of the prefabricated components of the house module and the house decoration module, so as to increase the stability and regularity of the house module standard case. The house module standard case has two types: one for loading/unloading and transporting prefabricated components of the house module and the house decoration module only; and the other having dual functions, namely, used as models of the prefabricated products of the house module and house decoration module, and used for loading/unloading and transporting the same. The standard case has rail wheels at the bottom, dragging rings at both ends, and unloading rings at the top, thereby realizing functions of pushing, dragging, moving, unloading, and installation.

FIGS. 39 and 40 are schematic view of a standard case, in which floor suites and balconies are prefabricated. The standard case has two prefabricated house modules therein, and house balconies are provided in the balcony prefabrication standard case. When assembling the house, floors prefabricated within the standard case may be unloaded from the standard case and the standard case may be detached to perform integral installation.

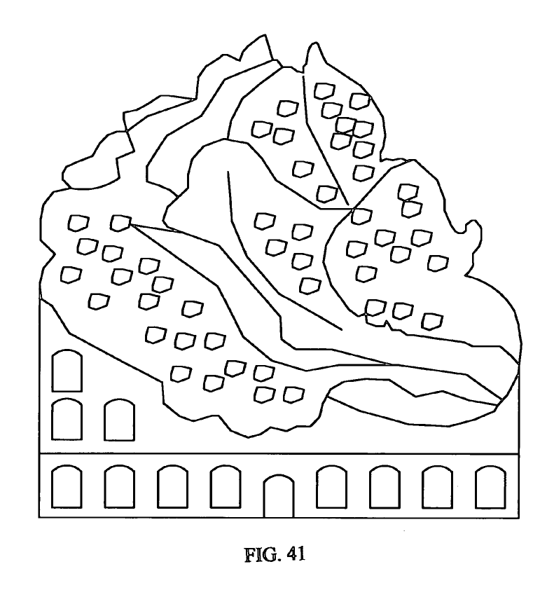

FIG. 41 is a schematic view illustrating a profile of an embodiment of a plant-type house artistic module.

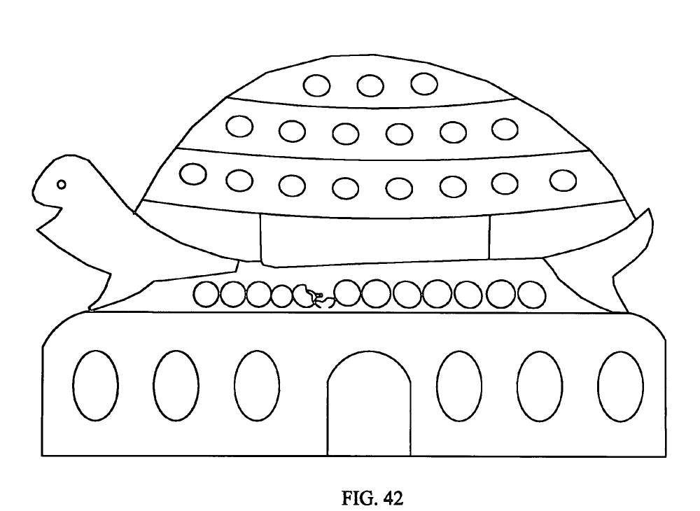

FIG. 42 is a schematic view illustrating a profile of an embodiment of an animal-type house artistic module.

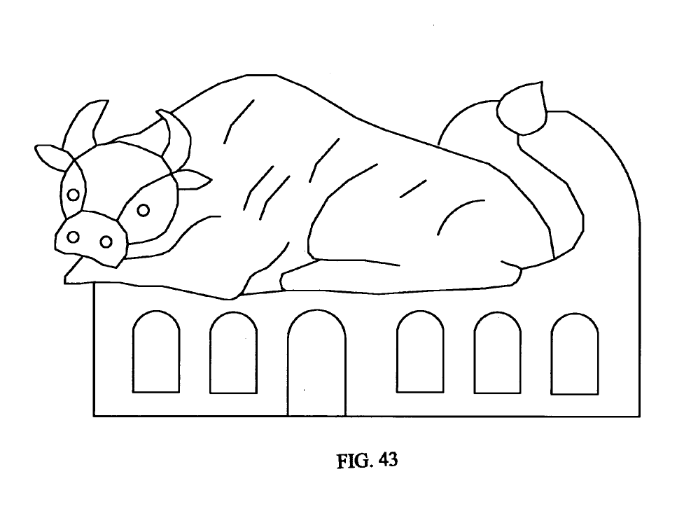

FIG. 43 is a schematic view illustrating a profile of an embodiment of another animal-type house artistic module.

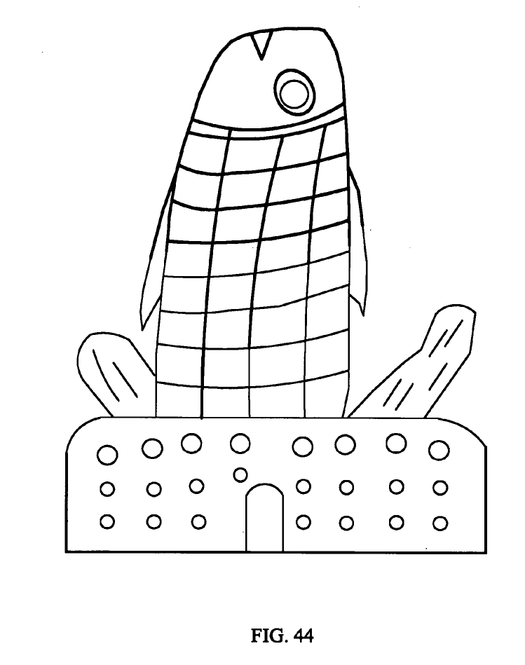

FIG. 44 is a schematic view illustrating a profile of an embodiment of yet another fish-type house artistic module.

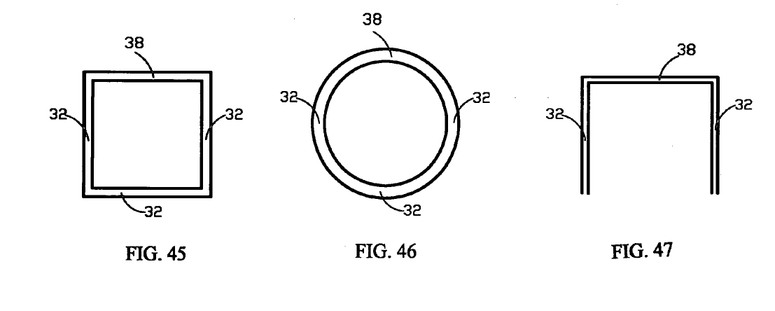

FIGS. 45, 46, and 47 show standardized airport multi-floored waiting building modules. FIG. 45 shows a square standardized airport waiting building module 38. FIG. 46 shows a circular standardized airport waiting building module 38. FIG. 47 shows a combined standardized airport waiting building module 38.

The standardized airport waiting building shown in FIGS. 45, 46, and 47 is provided with leisure squares, shopping malls, hotels, restaurants, teahouses, cafes, places of literary and art, leisure, and entertainment, and leisure and service places of airport workers. Standardized parking aprons and standardized runways are provided on surrounding areas of the standardized airport waiting building module 38 in FIGS. 45, 46, and 47.

[Analysis on Practicability of Standardized Urban Product and Manufacturing Method Thereof]

For example, many Chinese middle-and-small-size enterprises are distributed in small towns. Since they lag behind coastal cities in conditions of transportation, information, etc., these enterprises have difficulties in surviving and their environmental protection awareness and environmental protection supervision are basically superficial. Industrial pollution and domestic pollution need abundant water to be diluted and self-purified, but many rivers not only lack water but also often have flow cutoffs, so the pollution control cost is high. In practice, the pollution control is unable to be realized due to the lack of water sources. Some local governments in China set up various towns in order to develop local economy no matter objective conditions exist or not. Most of the towns are set in inland areas short of water resources, which results in high transportation cost, domestic water cost, and even higher sewage treatment cost. Most of the middle-and-small-size towns in practice have no qualifications for controlling industrial and agricultural pollution and domestic pollution.

According to the successful experience of migrating peasants and herdsmen to riverside, lakeside, and coastal cities in developed countries such as European countries, America, Japan, and Australia, if the invention of standardized urban product is popularized in China, peasants and herdsmen in the Yangtze River and Pearl River basins may be attracted to the manufacturing work of the standardized urban product by the interest-driven policy, helped to learn to manufacture the standardized urban product and learn skills of urbanized living, and become manufacturers of the standardized urban product and migration beneficiaries of the urbanization of rural population. Only if more than 80% of peasants and herdsmen are helped to break away from the life style of deforestation and land reclamation, and only if peasants and herdsmen staying in mountain areas and grasslands are helped to be engaged in the experience economy, there would be no longer water loss and soil erosion in basins of the Yangtze River, the Pearl River, etc.

In order to reduce the industrial cost, transportation cost, and information cost in the standardized urban product, the present invention provides a standardized urban product formed by replicating and assembling by industrial manufacturing and commercial/residential mesh-sheet standardized block modules, capable of selecting favorable investment attraction terms of providing standardized industrial workshops with zero rents or reduced rents in 20 years. Since the standardized urban products located on the coastal plain of middle and lower reaches of the Yangtze River and Pearl River has water transportation advantages of rivers, lakes, and seas, they may accept the industry transfer of developed countries first. The gathering of industrial manufacturing and commercial/residential standardized block products may generate the cluster effect of low cost and high benefit, the standardized and intensified treatment of various pollutions may create excellent effect of low cost and high benefit, and the standardized urban product has the cluster effect of abundant labor resources and talent resources. Therefore, the standardized urban product may accept not only the industry transfer of developed countries but also environmental and strategic migration of Chinese enterprises in large amount.

Only if the standardized urban product within China accommodates the life style of urbanization of 1.1 billion rural population, the strategic migration of polluting enterprises, and the standardized and intensified treatment of industrial and agricultural pollution and domestic pollution, a thorough control of the environment of China can be ensured.

Since ancient times, an urban house has been the largest consumption and investment of everyone. In 2004, the average price of China's commercial house is RMB 2759/m², and the average price of the commercial house in the Yangtze River Delta is around RMB 4000/m².

Although the development of Chinese urban product has benefited from the Chinese peasant workers' labor, duties and responsibilities of urban development has not taken into account the peasant workers' urbanized housing. The unprogressive manufacturing technology of existing urban products and commercial houses is the main reason why a wage-earner such as young graduates and peasant workers fail to afford a house. Therefore, the Chinese government needs to set up a national migration bureau of rural population urbanization to help young graduates and peasant workers to blend into the urbanized life in a scientific and harmonious way. China's population growth and migration of rural population urbanization has become one of the main knotty problems in Chinese economic development and urbanization development, which needs the central government's scientific development planning according to China's overall resources status and is not a conflict that can be solved by provincial and municipal governments and urban governments consciously and voluntarily.

For example, the acute shortage of water resources and long outdoor cold period during which construction and production cannot be performed outside in practice in north China result in much higher cost for keeping urban buildings warm, transportation cost, thermal energy consumption cost, and water resources cost than those of regions along the Yangtze River and the Pearl River with canal water transportation. Compared in terms of natural conditions, the manufacturing cost of the standardized urban product provided in the present invention is lower than that of cities in northeast and northwest China by about 50%. Therefore, the big drop in the business cost and housing cost provided in the present invention makes it more competitive in attracting the migration of rural population urbanization in China.

For example, for the realistic conflict that peasants and herdsmen who migrate to cities have difficulties in purchasing large commercial houses, the present invention provides a small house assembled by a balcony, a bedroom, a living room, a kitchen, and a bathroom with a construction area of 45 m² at a selling price of around RMB 40,000 to enable peasants and herdsmen having a family of three or four to migrate to cities and enjoy the most basic urbanized life style. The present invention further provides a house assembled by a balcony, three bedrooms, a living room, a kitchen, and a bathroom with a construction area of 80 m² at a selling price of around RMB 80,000. This economical and practical house is provided to enable peasants and herdsmen having a family of four or five to migrate to cities and enjoy the most practical urbanized life style. Of course, the present invention provides various house types as desired.

The national migration bureau of rural population urbanization may be united with agro-forestry enterprises to provide a part of urban house purchasing funds to peasants and herdsmen by purchasing their mountain grounds, mountain fields, farmlands, and residences.

During the manufacturing of the standardized urban products within China, project orders of about RMB 105 trillion will be generated. The engineering of using resources of mountains, water, sands, stones, and reinforced concrete to prefabricate, transport, and install the standardized urban product may be finished by peasants and herdsmen through appropriate training. The project order of RMB 105 trillion is first given to standardized poverty alleviation and migration limited companies made up of peasants and herdsmen who abandon mountain fields and lands and migrate to cities with the family. Labor service standardized poverty alleviation and migration limited companies may be made up by taking a part of money from peasants and herdsmen and borrowing a part of poverty alleviation funds from the national bureau of migration of urbanization of rural population.

For example, the use of the project orders of RMB 105 trillion may become a solid foundation of urbanized life style of rural population. Independent intellectual property rights of the standardized urban product may help the poor at places of resources to export standardized urban products and standardized house modules as well as wild animal/plant-type house artistic products to countries around the world. The provision and use of 27.5 billion m² standardized workshops and tens of billions m² standardized commercial houses in the standardized urban products within China may provide hundreds of millions of urbanized employment posts for China's population growth and the life style of urbanization of rural population. The extensive provision of economically affordable houses may prompt peasants and herdsmen to leave the life style of deforestation and slash and burn cultivation forever, so as to prevent the water loss and soil erosion in basins of the Yangtze River, the Pearl River, etc. fundamentally.

For example, based on an average of 50 m² relatively comfortable house and 60 m² public building and industrial workshop per person in China, about 55 billion m² residences and 66 billion m² public buildings and industrial workshops need to be developed and manufactured, and land resources of about 0.12 million km² are needed for the living of 1.1 billion rural population in the standardized urban product.

According to the investigation and research, in addition to arable lands, China's rural population occupies an average of about 330 m² private lot around foundation per person in practice, so that 1.1 billion rural population occupies a private lot around foundations of about 0.363 million km². If every peasant migrated to the city occupies an urban land of 110 m² in practice, the life style of urbanization of 1.1 billion rural population needs land resources of about 0.121 million km² including arable land of about 0.6 million km². If the 0.363 million km² private lot around foundation is selected to be provided to replace the 0.121 million km² urban land, land resources of 0.242 million km² may be saved. A plain area of 0.24 million km² may be re-cultivated into arable land resources. 0.24 million km²×1500 mou/km²×6000 RMB/mou re-cultivation fee=RMB 2.16 trillion. If the RMB 2.16 trillion is selected to be invested to re-cultivate the 0.24 million km² arable land, 0.27 billion mou arable lands and abundant forestlands and grasslands may be increased after completing the life style of urbanization of 1.1 billion rural population in the present invention. With the formation of purchasing or renting 2 billion mou arable lands in an operating mode of agricultural enterprisation, governments at all levels may manage China's agricultural industry in a standard way according to international standards and national standards and control agricultural pollution in accordance with the law to provide more sufficient and healthy grain and food.

In the integration of the world economy today, developed countries such as European countries, America, Japan, and Australia migrate peasants and herdsmen to riverside, lakeside, and coastal cities to concentrate the population there, which not only favors marine international trade and manufacturing and production but also has a water transportation price dozens of times lower than that of vehicles and several times lower than that of trains. The development of riverside, lakeside, and coastal cities has been a symbol of the degree of opening and development of a country.

For example, the per capita fresh water resources in China are 2200 m³ which is 25% of that of the world. China's fresh water resources are nonuniformly distributed. Lands to the south of the Yangtze River basin occupy only 36.5% of China's territory but with 81% of China's fresh water resources. Lands to the north of the Huaihe River basin take up 63.5% of China's territory but with only 19% of China's fresh water resources (see the table below).

Average annual runoff of seven great rivers in China

| | The | The | The | The | The | The | The |
|---|---|---|---|---|---|---|---|
| | Songhua | Liaohe | Haihe | Yellow | Huaihe | Yangtze | Pearl |
| Project | River | River | River | River | River | River | River |
| Drainage | 557 | 229 | 264 | 557 | 269 | 1809 | 444 |
| area (thousand | | | | | | | |
| km²) | | | | | | | |
| Average | 76.2 | 14.8 | 22.8 | 65.8 | 62.2 | 951.3 | 333.8 |
| annual runoff | | | | | | | |
| (billion m³) | | | | | | | |
| Control and | 24% | 52% | 94% | 76% | 78% | 15% | 18% |
| utilization rate | | | | | | | |
| of surface water | | | | | | | |
| Utilization | 18% | 48% | 96% | 52% | 46% | 8% | 9% |
| and | | | | | | | |
| consumption | | | | | | | |
| rate of gross | | | | | | | |
| water resources | | | | | | | |
| Exploitation | 47% | 87% | 100% | 35% | 46% | | |
| and utilization | | | | | | | |
| rate of plain | | | | | | | |
| shallow | | | | | | | |
| underground | | | | | | | |
| water | | | | | | | |

It is predicted that China's per capita amount of fresh water resources would have been less than 1700 m³ by 2020. China is the world accepted water-short country. China already has 16 provinces with a per capita amount of fresh water resources below the severe water scarcity line of 1000 m³ and 7 provinces with a per capita amount of fresh water resources below the extreme water scarcity line of 500 m³. 400 out of 669 cities in China are confronted with the problem of water scarcity. Therefore, Food and Agriculture Organization of the United Nations has put China on a list of 12 water-shortest countries. Part of northern areas in China has been unsuitable for large-scale gathering life of human beings. Due to the acute shortage of fresh water resources and serious pollution of the environment, none of western, middle, and northeastern areas in China is suitable for expanding urban construction. Only if China makes population gather in riverside and coastal areas such as those along the Yangtze River and the Pearl River with sufficient fresh water resources to develop the standardized urban product and talents develop towards western and northeastern areas to exploit resources in western and northeastern areas, the conflict between the scarcity of fresh water resources and the environmental pollution in China may be solved fundamentally. This is the successful road developed countries such as European countries, America, Japan, and Australia have taken and is also the most right direction for the development of China's urbanization of rural population

[Cost Estimation of Industrial Manufacturing and Commercial/Residential Mesh-Sheet Standardized Block Modules]

For example, the present invention uses a mesh-sheet standardized block module of 1 km² obtained by 1 km×1 km as a basic module calculation unit of the standardized urban product. Assuming that in the coming 25 years, China will have 1 billion population migrated to the standardized urban product assembled by industrial manufacturing and commercial/residential standardized block products, and assuming an average of 50 m² residential house and an average of 60 m² industrial workshop, commercial office, and public building is provided per urban person, per capita urban house is about 110 m².

An average of RMB 0.1 million shares is bought by one mou land resources in the present invention. For the convenience of calculation, assuming it is estimated based on a 100 m² mesh-sheet standardized urban module assembled by 25 industrial manufacturing mesh-sheet standardized block modules and 75 commercial/residential mesh-sheet standardized block modules, and a volume rate of land occupation to houses built of 1:1, the construction area is 0.1 billion m².

The manufacturing cost is estimated below based on the mesh-sheet standardized urban module with the construction area of 0.1 billion m² in the present invention.

1. removal, settlement, and transition charges: RMB 1.5 billion (an estimated average of RMB 10 thousand removal and transition charges per mou farmland and wasteland);

2. net-like standardized road/bridge modules: RMB 4.89714 billion (not including land resources and removal and relocation expenses);

3. net-like rail modules: 20 km light rail×0.05 billion RMB/km=RMB 1 billion (not including land resources and removal and relocation expenses);

4. standardized gardening products: 0.1 billion m²×33% gardening ratio×10 RMB/m²=RMB 0.33 billion (not including road gardening area, land resources, and removal and relocation expenses);

5. net-like standardized canal modules: RMB 0.23295 billion (not including land resources and removal and relocation expenses);

6. tap water products: RMB 0.4 billion;

7. sewage treatment products: RMB 0.21 billion;

8. design and exploration: 0.1 billion m²×10 RMB/m²=RMB 1 billion;

9. civil engineering and water-electricity installation: 0.1 billion m²×313 RMB/m²=RMB 31.3 billion (estimated according to a multi-floored building);

10. power generating and transmission products: RMB 21.42 billion;

11. coal gas and natural gas products: RMB 0.3 billion;

12. waste treatment products: RMB 0.1 billion;

13. underground space modules: 153.99 RMB/m² cost×80 million m²=RMB 12.319 billion (not including land resources and removal and relocation expenses);

14. land resources: the cost is not estimated since the land resource side buys shares;

15. advertisements: RMB 5 million;

16. construction registering fees: since the construction infrastructure and social infrastructure of the standardized urban product are invested by shareholders of the standardized urban product, this part should be derated. Therefore, fees to be turned in are not counted;

17. office incidental expenses: RMB 0.1 billion;

18. contingencies: RMB 0.2 billion;

19. property transaction tax: (1) 10 million m² shops×6,000 RMB/m²×6%=RMB 3.6 billion; (2) 90 million m² office buildings and residences×1,200 RMB/m²×6%=RMB 6.48 billion;

20. total cost: RMB 85.39409 billion (including land resources and removal and relocation expenses);

21. average comprehensive cost per m²: RMB 85.39409 billion÷0.1 billion m² residential area proportion=853.94 RMB/m² comprehensive cost;

22. since the RMB 23.43 billion industries including RMB 1 billion rail products, RMB 0.4 billion tap water, RMB 0.21 billion sewage treatment, RMB 0.1 billion waste treatment, RMB 21.42 billion power generation and transmission, RMB 0.3 billion coal gas and natural gas, etc. provided in the present invention all have investment income, the RMB 23.43 billion should be deducted and not be shared in the manufacturing cost of the house. Therefore, the manufacturing cost of the mesh-sheet standardized urban module is RMB 85.394 billion−23.43 billion=RMB 61.064 billion. RMB 61.064 billion actual manufacturing cost÷100 mesh-sheet standardized block modules=RMB 0.61064 billion/actual manufacturing cost of a mesh-sheet standardized block module;

23. in preferred technical embodiments provided in the present invention, the 100 km² mesh-sheet standardized urban module provided by assembling 25 industrial manufacturing mesh-sheet standardized block modules and 75 commercial/residential standardized block products is preferred. Since the 25 industrial mesh-sheet standardized block modules implement investment attraction terms of providing standardized workshops without any rent in 20 years, the manufacturing cost of the 25 industrial manufacturing mesh-sheet standardized block modules provided in the present invention is shared by the 75 commercial/residential mesh-sheet standardized block modules. Therefore, the actual manufacturing cost of a commercial/residential house in the mesh-sheet standardized urban product should be calculated as: RMB 0.61064 billion per mesh-sheet standardized block module÷750 thousand m² commercial/residential mesh-sheet standardized block module=814 RMB/m² commercial/residential cost;

24. assuming that 1 billion Chinese people reside in 0.11 million mesh-sheet standardized block modules, RMB 0.61064 billion/actual manufacturing cost of a mesh-sheet standardized block module×110 thousand mesh-sheet standardized block modules=RMB 67170.4 billion actual manufacturing cost (already including the investment in 27.5 billion m² standardized workshops);

25. profitable infrastructure investment in mesh-sheet standardized urban module: RMB 23.43 billion/mesh-sheet standardized urban module×1100 sheet-like standardized urban modules=RMB 25773 billon.

26. profit estimation and value estimation of mesh-sheet standardized block modules estimated assuming they are all sold:

(1) 1 million m²/mesh-sheet standardized block module×10% shop front×75% standardized commercial/residential area product proportion×6000 RMB/m² average selling price=RMB 0.45 billion;

(2) 0.8 million m² mesh-sheet standardized block modules provide 20 thousand underground parking space×RMB 20 thousand/parking space selling price=RMB 0.4 billion;

(3) residential and office buildings: 900 thousand m²×75% standardized commercial/residential block product proportion×1200 RMB/m² average selling price=RMB 0.81 billion (residential houses ranges from 900 RMB/m² to 1980 RMB/m², and are sold at 900 RMB/m² to poor families of peasants and herdsmen. The price of villas and other special houses is otherwise calculated).

(4) values of mesh-sheet standardized block modules: RMB 45 thousand+0.4 billion+0.81 billion=RMB 1.66 billion.

(5) profits: RMB 1.66 billion/value of a commercial/residential mesh-sheet standardized block module−RMB 0.61064 billion/manufacturing cost of a 25% industrial manufacturing and 75% commercial/residential mesh-sheet standardized block module=RMB 1.04936 billion/profit of a mesh-sheet standardized block module;

(6) RMB 1.04936 billion/profit of a mesh-sheet standardized block module×110 thousand mesh-sheet standardized block modules=RMB 115429.6 billion gross profit;

(7) RMB 1.66 billion/value of a commercial/residential mesh-sheet standardized block module×110 thousand mesh-sheet standardized block modules=RMB 182600 billion value;

27. a total cost of industrial manufacturing mesh-sheet standardized block modules: 110 thousand mesh-sheet standardized block modules×25% industrial manufacturing mesh-sheet standardized block modules×RMB 0.61064 billion/cost of an industrial manufacturing mesh-sheet standardized block module=RMB 16792.6 billion;

28. a total value of the standardized urban product assembled by industrial manufacturing and commercial/residential mesh-sheet standardized block modules: RMB 182600 billion+16792.6 billion=RMB 199392.6 billion.

In preferred embodiments provided in the present invention, industrial manufacturing enterprises conforming to the environmental protection and pollution control are preferably selected to be collected only property management fees, depreciation charges, and pollution treatment fees without any workshop rent in 20 years. About 27.5 billion m² standardized workshops within China maintain the rent-free investment attraction terms making no loss or profit in 20 years. The present invention may also charge the industrial manufacturing enterprises conforming to the investment attraction terms around 50% of standardized workshop rents. The preferred embodiments provided in the present invention favor the acceleration of the industrial development, the creation of taxation, the provision of more employment posts, the poverty-relieving and better-off of the poor, and the promotion of marketing for the standardized urban product and standardized house product. Standardized workshops in the industrial manufacturing mesh-sheet standardized block modules are prohibited from being inhabited, which is carried out under the supervision of security companies appointed by shareholders of the standardized urban product.

Assuming intellectual property rights of the standardized urban product may take up 20% to 30% (20% is used in calculation here) of shares, and it follows from the above calculation that the cost of every mesh-sheet standardized block module is RMB 0.61964 billion, mesh-sheet standardized block module development limited companies of RMB 0.8 billion are established in accordance with the law relying on intellectual property rights of the standardized urban product to manufacture and market one mesh-sheet standardized block module in 3 to 5 years and gain profits before income tax of about RMB 1.04936 billion without counting investment profits in terms of water, electricity, gas, wastes, and other infrastructure. The number of mesh-sheet standardized block module development limited companies established will depend on the area and amount of investment of the standardized urban product. If the area of mesh-sheet standardized block modules is 1 million m², the amount of investment should be RMB 0.8 billion. If the investment is particularly based on planned and designed standardized building groups by subcontract, an amount of investment of around RMB 10 million is enough for participating in the investment of mesh-sheet standardized block modules. The financing of the standardized urban product may be listing financing and bond financing.

[Profit Distribution Scheme for Standardized Urban Product]

The gross marketing profit of commercial/residential standardized block products is RMB 115429.6 billion. The investment income of RMB 16792.6 billion industrial manufacturing standardized block products is not counted in 20 years of investment, and therefore is not estimated. The gross profit of RMB 115429.6 billion is assumed to be distributed according to 40%:20%:40%. That is, the rural population and the state as land resource owners hold 40% share (peasants hold 25% and the state holds 15%), the independent intellectual property rights contributor for shares is assumed to hold 20%, and the fund contributor for shares is assumed to hold 40%. The profit is calculated as follows:

1. 25% rural population-hold share as land resources share×RMB 115429.6 billion=RMB 28857.4 billion;

2. 15% state-hold share as land ownership×RMB 115429.6 billion=RMB 17314.4 billion;

3. 20% share hold by intellectual property rights owner×RMB 115429.6 billion=RMB 23085.9 billion;

4. 40% share hold by fund owner×RMB 115429.6 billion=RMB 46171.8 billion.

Since RMB 16792.6 billion invested in industrial manufacturing mesh-sheet standardized block modules is provided to attract investment without any rent in 20 years, whether the RMB 16792.6 billion investment assets will be distributed 20 years later should be decided by investors according to the actual situation 20 years later.

□. Rural population income: first, rural population income per capita in 85 thousand km² (except 36 thousand km² area obtained by filling the sea) in the inventing and manufacturing process of the standardized urban product is estimated:

1. rural population: 85 thousand km²×1500 mou/km²÷around 2.5 mou/1 rural person=127.5 million mou÷around 2.5 mou/1 rural person=51 million rural population;

2. house for relocation: 40 m² per capita×1200 RMB/m² average marker price=RMB 48,000;

3. land share: RMB 28857.4 billion÷51 million rural population=RMB 565,831;

4. total rural population income per capita: RMB 48,000 house property+565,831 land share=613,831 RMB/agricultural person.

5. 51000 rural population×613,831 RMB/agricultural person=RMB 31305.4 billion.

Cost Estimation of R&D Transactional Mesh-Sheet Standardized Block Modules

In preferred technical embodiments provided in the present invention, the Yangtze River Delta with the leading city of Shanghai is preferably selected within China to provide a R&D transactional standardized urban product formed by replicating and assembling about 6000 R&D transactional mesh-sheet standardized block modules. The 6000 R&D transactional mesh-sheet standardized block modules take up an actual land of 6000 km². Therefore, large areas of farmlands and wastelands will become main resources for manufacturing the R&D transactional standardized urban product. It is estimated from the land requisition condition in 2004 that the cost of enterprise land capable of providing two indexes of financial taxation and social employment, i.e., farmlands and wastelands requisitioned into lands for construction with “eight availables (water, electricity, heat, gas, sewage, post, telecommunication, and closed-circuit TV are available) and two accessibles (accessible to paved roads and leveled ground)” is around 0.15 million RMB/mou in suburbs of Shanghai, while the cost of farmlands and wastelands without the supplies of road, water, and electricity is around 0.1 million RMB/mou. According to statistics in Shanghai Statistical Yearbook 2004, in 1990, Shanghai's total output value is composed of 4.3% primary industry, 63.8% secondary industry, and 31.9% tertiary industry. In 2003, the composition of Shanghai's total output value is changed into 1.5% primary industry, 50.1% secondary industry, and 48.4% tertiary industry. The total output value of Shanghai's primary industry has been too small to be calculated, the total output value of the secondary industry is also reduced, while the total output value of the tertiary industry is increased. However, as an international metropolis with very mature market economy, the service industry, experience economy, and knowledge industry of the tertiary industry should account for more than 70% of Shanghai's total output value.

According to the principle of social division of labor and the law of economic development, the production cost of Shanghai's primary industry is the highest compared with that of the country, and thus Shanghai's primary industry is the most uneconomical. Shanghai should cancel the production of the primary industry gradually according to the law of market economy. The production cost of Shanghai's secondary industry is also higher than that of other regions in China, so Shanghai should also gradually migrate this “body industry” of manufacturing and production to basins along rivers and seas in China to develop the standardized urban products. Land resources in special locations determine that Shanghai has the lowest comprehensive cost and highest comprehensive benefit in developing the tertiary industry, and therefore is most suitable for developing “brain industry” and knowledge industry projects like the R&D transactional standardized urban product.

According to statistics in Shanghai Statistical Yearbook 2004 and statistical yearbooks of Fengxian, Nanhui, Jinshan, Songjiang, and Qingpu districts from 2003 to 2004, the Fengxian, Nanhui, Jinshan, Songjiang, and Qingpu districts in the project region of the R&D transactional standardized urban product totally occupy land resources of 3244 km² and have a population of 2.698 million in 2003 including a 1.695 million agricultural population and 1.003 million nonagricultural population with an average of 2.82 persons per household.

The R&D transactional standardized urban product plans to put 80% of regions in the south of Wujiang of about 941 km² (the population is about 0.539 million with an agricultural population of about 0.433 million) and a region of 2520 km² in Jiaxing into the project region. According to statistics in Jiaxing Statistical Yearbook 2003 and Wujiang Statistical Yearbook 2002, the project region of the R&D transactional standardized urban product occupies land resources in Jiaxing and Wujiang of 3461 km² and has a population of about 2.5626 million including an agricultural population of about 1.8673 million and an nonagricultural population of about 0.6953 million with an average of about 3.4 persons per household. The manufacturing of the R&D transactional standardized urban product needs an occupation area of land resources in Shanghai, Jiaxing, and Wujiang of about 6700 km² and a total population of about 5.26 million including an agricultural population of about 3.56 million and a nonagricultural population of about 1.7 million with an average of about 3.1 persons per household.

A total area of land resources in the project region of the R&D transactional standardized urban product is about 10.05 million mou. According to a rough estimation that the existing secondary and tertiary industry (not including roads outside the urban area) occupies about 11% of the total area of land resources, the area of present lands for construction is around 1.05 million mou. According to a rough estimation that farmlands and wastelands (including roads outside the urban area) occupy 89% of the total area of land resources, the area of farmlands and wastelands is about 9 million mou. The 9 million mou farmlands and wastelands÷3.56 million agricultural population=2.5 mou farmlands and wastelands/agricultural person. Only if the manufacturing of the R&D transactional standardized urban product blends with the interest of 3.56 million primary industry population in the project region and the national interest to operate the R&D transactional standardized urban product by joint venture and cooperation, the project can have the rights of use, planning, and monopolized R&D manufacturing of the 9 million mou land resources.

In preferred technical embodiments provided in the present invention, the intellectual property rights of the standardized urban product are preferably combined with peasants' land resources and national land ownership in the project region, and with an input of monetary investment funds. Under the scientific development concept and realistic and pragmatic policies, required number of R&D transactional mesh-sheet standardized block module limited companies are registered and established by joint venture, so as to accomplish the research and development, manufacturing, marketing, operation, and management of the R&D transactional standardized urban product in a form of corporate juridical person.

The R&D transactional mesh-sheet standardized block module limited company implements unified planning, research and development, manufacturing, marketing, operation, and management on land resources in the project region according to special rules of the manufacturing of the R&D transactional standardized urban product, so as to effectively avoid the blindness of low-level redundant construction in the project region, thereby making the planning and development of the R&D transactional standardized urban product more scientific and reasonable. Therefore, the business cost and comprehensive living cost of the “brain industry” joining the project region are lowest, and the R&D transactional standardized urban product is most competitive internationally.

Requisitioned lands for construction in the region of the R&D transactional standardized urban product should prohibit the production of polluting enterprises in the overall planning and control, but the value of the requisitioned land resources belongs to the original land requisitioning unit. If the original land requisitioning unit is willing to join with the R&D transactional mesh-sheet standardized block module limited company in developing and operating the R&D transactional standardized urban product, the value may be reappointed according to the rule of market economy.

[Cost Estimation of the R&D Transactional Standardized Urban Product]

The garden city of Edward, England has always been regarded as a classic in urban series products in its design and planning by the experts and scholars all over the world. The Edward's satellite garden city series products were initiated in 1903 and are characterized by a cross layout of farmlands and cities, such that not only residents living in cities can appreciate rural scenes, but also domestic wastes of urban residents may be recycled by farmlands, thus facilitating the ecological balance between human residence and the nature. The overall urban planning of Shanghai has also learned from and adopted the design concept of Edward's satellite garden city. However, the planning and design concept of the satellite garden city obviously does not conform to the practical direction of urbanization of rural population of countries with large populations such as China and India for the following reasons.

The world population was only over 1 billion over 100 years ago. Due to a small population, gardens between London's main urban area and satellite cities provided by Edward have no agricultural pollution. However, areas between the main urban area and satellite cities in countries with large populations such as China and India have been reclaimed into farmlands. Sewage wastes of suburbs of the main urban area and satellite cities are discharged into farmlands. The extensive use of pesticides and fertilizers also causes serious pollution to farmlands. They both result in a severer pollution in urban-rural joint areas between the satellite cities and the main urban area than that of the main urban area. Each of the satellite cities also needs supporting facilities of urban construction infrastructure and urban social infrastructure. Due to the small size of the satellite urban areas, the cost of these supporting facilities is always higher than that of expanding a large city outwards in a cake-like spread pattern. Residents living in satellite cities, influenced by the traditional custom and culture, are used to doing shopping and consumption in the main urban area, which results in apparently higher traffic cost, energy cost, shopping cost, business cost, and comprehensive living cost for residents living in satellite cities than those in the main urban area of the large city. This is also a main reason why ordinary people are unwilling to live in satellite cities and entrepreneurs are unwilling to invest and develop satellite cities. Since the current net growth of the world population is more than 90 million per year, the global population may have grown to 9-10 billion by the middle of this century. Therefore, the realization of migration of rural population urbanization by developing satellites cities to alleviate the population pressure and traffic pressure of the main urban area in countries with large populations such as China and India is unrealistic from the perspective of global economic integration and rural population urbanization. The planning of Shanghai satellite city clusters merely by learning from and adopting the planning concept of Edward's satellite garden city 100 years ago also reduces the utilization rate of Shanghai land resources, water resources, and other resources.

From ancient to modern times, monarchs and experts and scholars in China appreciate the spider-web-like traffic road structure very much when engaged in the urban planning and design of urban roads, because they think the spider can catch preys rapidly through the spider web when catching flying insects. The road network maps of most cities in China look just like pieces of solidified spider web.

After human stepped into the capitalism period, urban products especially invested and developed by American entrepreneurs adopted the market-positioning-oriented planning and design at the very start and eliminated the monarchical spider-web-like urban roads in order to satisfy the traffic demand and other demands of the people.

Since the process of urbanization of rural population in America is several decades earlier than that in China, neither the massive flow of vehicles and passengers in today's urban product nor such rapid expansion of today's urban product can be predicted during the provision of cities. The traffic jam and environmental pollution not only bothers major cities in America and other countries around the world, but also is more predominant in urban products sharply developed in countries with large populations such as China and India. For example, roads and bridges in cities in the Yangtze River Delta and the Pearl River Delta have become mobile car parks.

Mankind is like a bee colony in many aspects. Human beings live in groups for ease of survival. Any bee that leaves the bee colony cannot survive for a long time, and so does a human being. Human beings live in groups in the structure of cities, while the honeycomb is the city for the bee colony. The bee colony manufactures standardized cells according to their own actual requirements. One bee colony may manufacture thousands of standardized cells overnight. Tens of thousands of bees inhabit one honeycomb without any traffic jam or environmental pollution. The structure of the honeycomb is a model of the standardized and intensified production, which not only saves energy but also is scientific and practical. Since bees have solved traffic and environmental problems of honeycombs scientifically and reasonably during their long evolution, can today's mankind invents a new-type urban product with a lower manufacturing coat, a higher manufacturing speed, a higher quality, a less energy consumption, a more beautiful environment and an ever-smooth traffic than those of urban products in America, Europe, and Japan like bees scientifically and reasonably?

The rapid growth of global population and the market demand of urbanization of rural population have led to the invention of the standardized urban product. In coastal plain areas of middle and lower reaches of the Yangtze River and the Pearl River, the volume rate of standardized square urban areas is more scientific and practical than the living volume rate of cake-like, spider-web like circular urban areas due to objective influences of sunlight, customs, and other factors.

The excellent effect of the standardized urban product lies in that it will have no traffic jam no matter how the standardized urban product expands, how much land is used, how many people reside, and how many motorized and non-motorized vehicles travel.

The standardized urban product within China not only absorbs civilized achievements of countries around the world, but also integrates the cultural tradition that the Chinese masses favor living in gardens and water towns, thereby inventing and manufacturing garden city, flower garden city, green city, water town city, scenic spot type standardized urban products never having traffic jams with Chinese characteristics.

In order to illustrate the practicability and implementability of the standardized urban product more thoroughly, the present invention provides the following analyses.

□. Analysis of the Removal and Relocation of Agricultural Population and Scheme of Buying Shares with Land Resources of the R&D Transactional Standardized Urban Product

1. 3.56 million rural population÷3.1 persons/household=1,148,387 households;

2. removal and relocation: 1,148,387 households×125 m²/household×1133 RMB/m²=RMB 162.6 billion;

The first scheme: the state and peasants in the project region as land owners invest capital in the R&D transactional mesh-sheet standardized block module limited company at an average of RMB 0.1 million assets per mou farmlands and wastelands, on the premise that the accomplishment of removal and relocation of the agricultural population is ensured. This provides 9 million mou land resources to the R&D transactional mesh-sheet standardized block module limited company. The RMB 162.6 billion funds of relocation houses are provided by the R&D transactional mesh-sheet standardized block module limited company.

9 million mou×0.1 million RMB/mou=RMB 900 billion land resources assets.

The second scheme: the state and peasants in the project region as land owners invest capital in the R&D transactional mesh-sheet standardized block module limited company at an average of RMB 0.15 million assets per mou farmlands and wastelands, on the premise that the accomplishment of removal and relocation of the agricultural population is ensured. About 3 million mou land for construction of urban infrastructure is deducted and the RMB 162.6 billion house removal and relocation expenses of rural population are assumed by the state and peasants. (9 million mou−3 million mou)×150 thousand RMB/mou−RMB 162.6 billion=RMB 737.4 billion net land assets.

Assuming the land resources cost (according to the first scheme) is used by the state and peasants in the project region as land owners to buy 40% of shares of the R&D transactional mesh-sheet standardized block module limited company with RMB 752 billion net land resources assets, RMB 900 billion land resources assets−752 billion assets as shares=RMB 148 billion net land resources assets. The RMB 148 billion net land resources assets may be used as removal and relocation reserves for the agricultural population in the project region of the R&D transactional standardized urban product after being sold to the R&D transactional mesh-sheet standardized block module limited company. In preferred technical implementing schemes provided in the present invention, a 100 km² mesh-sheet standardized urban module is preferably used as the calculated unit. The 9 million mou land resources may be approximately made into 60 R&D transactional mesh-sheet standardized urban modules, and thus the manufacturing cost of the 60 R&D transactional mesh-sheet standardized urban modules may be estimated basically, and so does the manufacturing cost of the R&D transactional mesh-sheet standardized block modules, as long as the manufacturing cost of one R&D transactional mesh-sheet standardized urban module is estimated.

Assuming the land resources cost is estimated according to the first scheme, (RMB 148 billion+162.6 billion)÷60 standardized urban products=RMB 5.18 billion land removal and relocation cost (not counting RMB 752 billion assets as shares bought with land resources).

□. Cost Estimation of the R&D Transactional Mesh-Sheet Standardized Urban Module

Assuming the volume rate of land to house is 1:1.5, the R&D transactional mesh-sheet standardized urban module may be used to build 150 million m² houses. The cost estimation is as follows:

1. removal and relocation charges: RMB 5.18 billion (not counting RMB 752 billion assets as shares bought with land resources);

2. net-like standardized road/bridge modules: RMB 5.209 billion (not including land resources and removal and relocation expenses);

3. 100 km net-like standardized light rail modules or 20 km mesh-like standardized subway modules: RMB 5 billion (not including land resources and removal and relocation expenses);

4. gardening products: 0.1 billion m²×30% gardening ratio×10 RMB/m²=RMB 0.3 billion (not including land resources and removal and relocation expenses);

5. net-like standardized canal modules: RMB 0.23295 billion (not including land resources and removal and relocation expenses);

6. tap water products: RMB 0.6 billion;

7. sewage treatment products: RMB 0.315 billion;

8. planning, design, and exploration: 0.15 billion m²×10 RMB/m²=RMB 1.5 billion;

9. civil engineering and water-electricity installation: 0.15 billion m²×691 RMB/m²=RMB 103.65 billion (most are small high-rise buildings, the rest are high-rise and multi-floored buildings and villas);

10. underground space products: RMB 12.319 billion (not including land resources and removal and relocation expenses);

11. power generating and transmission products: RMB 32.13 billion;

12. coal gas and natural gas products: RMB 0.45 billion;

13. waste treatment products: RMB 0.15 billion;

14. advertisements: RMB 15 million;

15. construction registering fees: since the construction infrastructure and social infrastructure of the standardized urban product is invested by shareholders of the R&D transactional standardized urban product, this part should be derated, and therefore is not counted;

16. land resources: they are not estimated since the land resource side buys shares with land resources;

17. office incidental expenses: RMB 0.1 billion;

18. contingencies: RMB 0.54 billion;

19. property transaction tax: (1) shop fronts: 15 million m²×10000 RMB/m² average selling price×6% tax rate=RMB 9 billion; (2) residential and office buildings: 135 million m²×1980 RMB/m²×6% tax rate=RMB 16.038 billion;

20. total comprehensive cost: RMB 192.72895 billion (including land resources and removal and relocation expenses);

21. average comprehensive cost per m²: RMB 192.72895 billion cost÷0.15 billion m² construction area=1284.86 RMB/m²;

22. total cost: RMB 192.72895 billion/mesh-sheet standardized urban module×60 mesh-sheet standardized urban modules=RMB 11563.7 billion;

23. since the RMB 38.645 billion investment industries of RMB 5 billion rail products, RMB 0.6 billion tap water, RMB 0.315 billion sewage treatment, RMB 0.15 billion waste treatment, RMB 32.13 billion power generation, transmission, and distribution, RMB 0.45 billion coal gas and natural gas, etc. have respective investment returns, the RMB 38.645 billion cannot be counted in the manufacturing cost of houses. Therefore, the actual manufacturing cost per square meter should be RMB 192.729 billion−38.645 billion=RMB 154.084 billion. RMB 154.084 billion÷0.15 billion m²=1027.23 RMB/m² actual manufacturing cost.

24. the manufacturing cost of the R&D transactional mesh-sheet standardized block module: RMB 154.084 billion/R&D transactional mesh-sheet standardized urban module÷100 R&D transactional mesh-sheet standardized block modules=RMB 1.54084 billion;

25. profitable infrastructure investment in the R&D transactional standardized urban modules: RMB 38.645 billion/profitable infrastructure investment in a R&D transactional standardized urban module×60 R&D transactional standardized urban modules=RMB 2318.7 billion.

26. RMB 154.084 billion actual manufacturing cost of the R&D transactional standardized urban module×60 R&D transactional standardized urban modules=RMB 9245 billion.

[Value Estimation of R&D Transactional Standardized Urban Products]

Profits of the R&D transactional standardized urban products are estimated as follows assuming that properties are all sold:

□. 0.135 billion m² office buildings, apartment buildings, complex buildings of scientific research, culture, sports, and education, and residences sold×1980 RMB/m² average selling price×60 sheet type standardized urban modules=RMB 16038 billion (the selling price per square meter of complex buildings such as office buildings, residences, and apartment buildings is RMB 1500-2900, while villa and special houses are otherwise priced);

□. 15 million m² shops sold×10000 RMB/m² average selling price×60 mesh-sheet standardized urban modules=RMB 9000 billion;

□. 4.86 billion m² underground space products sold÷30 m²/parking space×20000 RMB/parking space=RMB 3240 billion;

□. total sales: RMB 16038 billion+9000 billion+3240 billion=RMB 28278 billion;

□. profits: RMB 28278 billion total sales−9245 billion total cost=RMB 19033 billion profits.

□. intellectual property rights of the standardized urban product are assumed to legally hold 20% of total shares of the R&D transactional mesh-sheet standardized block module limited company. Assets such as land resources owned by the state and peasants are assumed to legally hold 40% of shares of the R&D transactional mesh-sheet standardized block module limited company, in which peasants' rights of survival and development of land resources are assumed to hold 25% of shares of the R&D transactional mesh-sheet standardized block module limited company and the state rights of assigning and transferring land resources such as state-owned farmlands, wastelands, roads, water, sea beaches, lake beaches, and river beaches of continental shelf are assumed to legally hold 15% of total shares of the R&D transactional mesh-sheet standardized block module limited company to reflect the state function of transferring payment. Monetary funds are assumed to legally hold 40% of shares of the R&D transactional mesh-sheet standardized block modules. In order to enhance the financial strength of poverty alleviation and migration of urbanization of rural population, the R&D transactional standardized block product limited company donates RMB 100 to the national bureau of migration of urbanization of rural population whenever 1 m² house is sold to help poor peasants and herdsmen to migrate to cities. The rough estimation is as follows:

1. RMB 19033 billion−(0.15 billion m²×60×100 RMB/m²)=RMB 18133 billion;

2. intellectual property rights owner's 20% share×RMB 18133 billion=RMB 3626.6 billion;

3. state-owned 15% share with land resources×RMB 18133 billion=RMB 2720 billion;

4. peasants-owned 25% share with land resources×RMB 18133 billion=RMB 4533.3 billion;

5. monetary funds side-owned 40% share×RMB 18155.8 billion=RMB 7253.2 billion; RMB 7253.2 billion total investment value of monetary funds÷RMB 752 billion registered capital÷25 year construction period=38.6% annual average return on investment. During the long term investment of 25 years in the project, the annual average return on investment is 38.6%.

6. agricultural land side's RMB 4533.3 billion total value÷3.56 million agricultural population=1.273 million RMB/agricultural person. The land resources per capita in the project region may be converted into RMB 1.273 million return on equity during the invention and manufacturing of the R&D transactional standardized urban product.

7. profits of the R&D transactional mesh-sheet standardized block module: RMB 18133 billion profits of the R&D transactional standardized urban product÷6000 R&D transactional mesh-sheet standardized block modules=RMB 3.02217 billion.

Assuming that the owner of intellectual property rights of the standardized urban product may hold 20% of shares, the R&D transactional mesh-sheet standardized block module may establish the R&D transactional mesh-sheet standardized block module development limited company of around RMB 2 billion in accordance with the law to manufacture and market one R&D transactional mesh-sheet standardized block module in 3 to 5 years and gain profits before income tax of about RMB 30221.7 billion without counting the investment income in terms of water, electricity, gas, swage, garbage, and other infrastructure.

If the investment is organized based on the R&D transactional mesh-sheet standardized block module having an area of 1 million m² and the standardize district module having a floor area of 0.25 million m², the amount of investment is RMB 2 billion to 0.5 billion. If the investment is particularly based on planned and designed standardized building groups by subcontract, an amount of investment of more than RMB 10 million is enough for participating in the investment of the R&D transactional standardized urban product.

The financing of the R&D transactional standardized urban product may be listing financing and bond financing.

[Estimation of Initial-Phase Project of the R&D Transactional Standardized Urban Product]

The initial-phase project of the R&D transactional standardized urban product within China for example selects sites in southern and western region in Shanghai. The southern region uses a land of about 500 km², while the western region uses a land of about 700 km². Therefore, the land used by the initial-phase project is about 1200 km² in total, which is about 20% of the actual total land of 6000 km² used by the invention and manufacturing of the R&D transactional standardized urban product.

1. actual cost of the R&D transactional standardized urban product of RMB 9245 billion×20% proportion of the initial-phase project=RMB 1849 billion actual cost of the initial-phase project;

2. gross profit of the R&D transactional standardized urban product of RMB 18133 billion×20% profit proportion of the initial-phase project=RMB 3626.6 billion profit.

For example, the initial-phase project of the R&D transactional standardized urban product within China selects sites in southern and western region in Shanghai. These regions have good basic traffic conditions and are close to central region of Shanghai in locations, thus easily accepting the expansion and radiation of central Shanghai and forming benefits of marketing and managing the R&D transactional standardized urban product. On the other hand, the invention and manufacturing of the R&D transactional standardized urban product may also effectively stabilize real estate prices in Shanghai, reduce the business cost of Shanghai, and enhance the international competitive strength of Shanghai.

The current land auction policy in China is mainly directed to the supply of scarce and competitive urban land resources with complete supporting facilities of urban construction infrastructure and urban social infrastructure. The auction policy is not required for enterprise lands capable of both providing employment posts and creating taxation. Ultimately, the land auction policy is only a fair means for supplying scarce land resources in cities and a means for accumulating urban wealth and enlarging urban functions with scarce urban land resources. The practice has proven that although the land auction policy solves problems of unfair competition and black case work, it generally results in a large increase in the living cost and working and business cost of urban residents, thereby decreasing the comprehensive competitive strength of Chinese cities. Hangzhou and Suzhou cities in China have adopted two different land resources policies. After years of practice, Hangzhou adopting the land auction policy lags far behind Suzhou with flexible land resources policy in terms of economic aggregate, development speed, etc.

The standardized urban product is not only a land for project use capable of providing employment for several hundred million people but also a project capable of creating taxation of trillions of Yuan. Moreover, the 0.12 million km² land for project use required by the standardized urban product is neither the scarce and competitive land nor the urban land with complete supporting facilities of urban construction infrastructure and urban social infrastructure. Therefore, the 0.12 million km² land resources for project use of the standardized urban product within China belong to land resources unable to and without the need to implement the auction policy

Since the original industry and tertiary industry in the project region of the standardized urban product are relatively developed, the local fiscal revenue entirely affords the daily expenditure of the local government. Also because of the project approval and implementation of the standardized urban product, the local fiscal revenue no longer needs to carry out large-scale financial investment in the project region. Therefore, the local government does not have to raise funds by the land auction to pay the daily expenditure thereof, either.

Since the standardized urban product project has industrial manufacturing and R&D transactional projects whose development is given priority to by governments at all levels, the State Council and governments at all levels should supply land resources of the standardized urban product at requisition cost price, thereby forming the international competitive edge of low cost of the standardized urban product.

[Implementing Scheme of the R&D Transactional Standardized Urban Product]

1. Necessity of Providing an “Intelligence Special Zone”

In the opinion of experts concerned, currently, the concept of industry has been largely refined from “industry”, “product”, “component”, to “section”. One enterprise may be divided into four sections of research and development, manufacturing, marketing, and operation and management in a value chain. The four sections correspondingly form four industries, in which the research and development, marketing, and operation and management are called “brain industries”, while manufacturing is called “body industry”. Generally speaking, a region gathered with brain industries is a combination of knowledge center, financial center, circulation center, and environmental center.

The function of the R&D transactional standardized urban product is exactly the “brain industry” analyzed by experts concerned, which is also called the experience economy and knowledge industry in the international society. The R&D transactional standardized urban product within China selects a site in the southwestern region of Shanghai, southeastern region of the Taihu Lake, and a region north of the Hangzhou Bay. The region is along the river, faces the lake, and has the freshest air, the richest water resources, the lowest transportation cost by sea, land, and air, the most sufficient human resources, and the lowest comprehensive cost of inventing and manufacturing the standardized urban product with the knowledge industry. The regional economy has the highest investment profit rate of the brain industry, knowledge industry, business, service industry, and experience economy.

Most existing towns in China develop in a pattern relying on administrative centers. This is the case in the feudal society of thousands of years, and also with the planned economy of several decades. There are also planned economy cities like Daqing and Ma'anshan formed by exploiting and processing oil and mine resources. There are also cities like Shenzhen and Pudong provided by national special policies and in special regions. In all processes of urbanization development in the past, most of them have economic development and urbanization development pushed by government's planned economy, thus having low resources utilization efficiency and poor pre-warning and preventing function of natural disasters, and failing to thoroughly eliminate the urban syndrome such as traffic jam and environmental pollution.

The per capita arable land of natural resources in China is only ⅕ of the world average, the water resources ¼, and the forests 1/7. Although the development and exploitation of natural resources in China is limited, the development of intelligence resources of the Chinese nation and mankind is limitless.

Existing development zones in China basically belong to manufacturing industry development zones, and most of enterprises accommodated in the development zones belong to the “body industry”. The “body industry” in China is huge and miscellaneous, but “brain industry”, knowledge industry, and experience economy of the research and development, marketing, and operation and management are scarce and incomplete. Currently, China is a world factory with a huge dragon body without any leading industry.

The R&D transactional standardized urban product as the “brain industry” is exactly the leading industry of Chinese manufacturing “body industry”. The R&D transactional standardized urban product will fully take advantage of the knowledge industry and experience economy to integrate “body industries” lacking intellectual property rights and international competitive strength, so as to form a comprehensive strength with overall cooperation to fight in the world market.

The present invention may provide an “intelligence special zone” in the project region of the R&D transactional standardized urban product as a typical example under test of the country. With the “intelligence special zone” government as a deputy municipal agency of Shanghai and the R&D transactional standardized urban product as an important component of Shanghai, the brand effect of Shanghai may be fully used to further strengthen the economic aggregate and knowledge brand of Shanghai.

The R&D transactional standardized urban product initiates the project of inventing and manufacturing the standardized urban product with the “brain industry”, service economy, experience economy, and knowledge industry, thereby thoroughly changing the pattern of slow development of cities driven by cities relying on administrative centers. The invention and manufacturing of the R&D transactional standardized urban product thoroughly eliminates various urban diseases, such as heavy traffic and environmental pollution, resulted from the development of cities relying on administrative centers.

The invention and manufacturing of the standardized urban product not only saves land resources and other relevant resources, and creates a new road for urbanization development of rural population. It also evolves the agriculture, rural areas, and peasants as disadvantaged groups in the project region into advantaged groups in the market economy, thoroughly changes peasants' embarrassed situation of being forced to become destitute and homeless after their lands are requisitioned, and makes peasants right investors of the standardized urban product. Peasants in the project region buy shares in the mesh-sheet standardized block module limited company legally with land resources for operation instead of deputing land resources to local governments for auction, such that peasants become shareholders and operating decision-makers of the mesh-sheet standardized block module limited company. Local governments in the project region are also turned from auctioning and selling operators of land resources into legal managers and service coordinators of land resources. The intelligence special zone governments provided in the project region of the R&D transactional standardized urban product by the State Council can be creatively provided according to the function of the world economic integration.

[Project Planning of the R&D Transactional Standardized Urban Product]

In 1820, China accounted for about 33% of the world GDP. In 1870, Shanghai's foreign trade volume accounted for 63% of China's share. In 1978, China accounted for 1% of the world GDP. In 2004, China accounted for 4% of the world GDP.

The invention and manufacturing of the R&D transactional standardized urban product will be a new milestone for the revival of the great Shanghai region, because the invention and manufacturing of the R&D transactional standardized urban product does not design Shanghai merely as an economic center, trade center, financial center, and transportation center of China but treat the Yangtze River Delta region of great Shanghai as the world economic center, trade center, financial center, and transportation center.

With the R&D transactional standardized urban product and standardized urban product attracting the people flow, material flow, and financial flow all over the world, China will have the possibility of accounting for around 25% of the world GDP by the end of this century.

The R&D transactional standardized urban product with a gross investment of RMB 9245 billion is open not only to China's capital market but also to the world capital market.

The R&D transactional standardized urban product belongs to service economy and experience economy-natured knowledge industry, and is the largest base of “brain industry” of Chinese industrial and agricultural enterprises. Only if Chinese enterprises separately invest the “brain industry” portion of the research and development, marketing, and operation and management in the R&D transactional standardized urban product and migrate the manufacturing as the “body industry” into the standardized urban product for development or distribute it on the 9.6 million km² land to absorb cheap labor resources and other cheap resource allocation, the enterprises will have the greatest brand effect, the lowest operating cost, and the strongest competitive strength. This is a preference of most of enterprises in China and other countries around the world.

Since the state and peasants buy shares in the R&D transactional standardized urban product with land resources, their interests are greater than the conflict between the land requisition and removal. The planning and design of the R&D transactional standardized urban product may be more scientific, more economical, more rational, and more humanistic, may have larger measure of domestic progress, and may absorb and gather civilized achievements all over the world more easily. Therefore, the funds and talents with which Chinese enterprises separately invest the “brain industry” in the R&D transactional standardized urban product are just like water of the Yangtze River coming rolling in and unstoppable. Due to the advantages of geographical position and large population of the R&D transactional standardized urban product, it has a low water resource cost, low land resource cost, low transportation cost, low cost of labor resources, scientific research talents, and managerial talents, and low cost of research and development and marketing. It radiates a population of about 4 billion with a radius of 5000 km, and therefore has a large population and vast market. The funds and talents with which enterprises of countries around the world separately invest the “brain industry” in the R&D transactional standardized urban product are just like unstoppable water of the Pacific Ocean.

The R&D transactional standardized urban product has solid land resources as strong foundation and original independent intellectual property rights, performs research and development while doing manufacturing and operation, thus having a short period of invest to output, and small risk and large profit with rolling investment.

In order to collect the intelligence of all talents and creatively implement and operate the standardized urban product, the intellectual property rights owner of the standardized urban product voluntarily draws 50% of the return on equity of the standardized urban product as award funds to establish an award foundation of standardized urban product. Objects of the award include the following. 1. The funds are awarded to people who help the inventor to acquire intellectual property rights of the standardized urban product and support and protect the inventor's acquisition of intellectual property rights interests, as well as personnel contributing to the implementation of the standardized urban product including experts and scholars at home and abroad and government employees contributing to the standardized urban product. 2. The funds are awarded to personnel contributing to the environmental protection of the standardized urban product to facilitate a sustainable development of the standardized urban product. 3. The funds are awarded to scientific and technical personnel contributing to the standardized urban product to facilitate a more thorough, extensive, and lasting development of the standardized urban product in the field of science and technology. 4. The funds are awarded to cultural and artistic personnel contributing to the standardized urban product to facilitate a more thorough, extensive, and lasting development of the standardized urban product in the field of culture and arts. The intellectual property rights owner of the standardized urban product draws 50% of the return on equity of the standardized urban product to be donated to governments at all levels and social welfare organizations in the country thereof, under the principle of “what is obtained from the society is used in the interest of the society.

[Profit of Governments at all Levels and Social Welfare Organizations within China]

Standardized road/bridge modules and standardized gardening products invested by the standardized urban product and the R&D transactional standardized urban product will be handed over to governments and social welfare organizations free for management.

1. Profit of R&D Transactional Standardized Urban Product

(1) standardized public gardening products: 0.1 billion m²/sheet-like standardized urban module×10% gardening×250 RMB/m²×60 sheet-like standardized urban modules=RMB 150 billion; (2) standardized road/bridge modules: [100 km²×18.5% land for road/bridge×150 thousand RMB/mou (including land requisition, removal, and relocation)+RMB 5.209 billion cost of standardized road/bridge modules in a sheet-like standardized urban module]×60 sheet-like standardized urban modules=RMB 562.3 billion; (3) business tax: RMB 1502.3 billion; (4) RMB 900 billion marketing donation; (5) intellectual property rights side: RMB 18133 billion×20% share×50% amount of donation=RMB 1813.3 billion; (6) government-owned 15% equity assets: RMB 2720 billion; (7) aggregate: RMB 7647.9 billion.

2. Profit of Standardized Urban Product

(1) business tax revenue of property transaction of sheet-like standardized urban module (RMB 3.6 billion+6.48 billion)×75% proportion of standardized commercial/residential block product×1100 sheet-like standardized urban modules=RMB 8316 billion business tax revenue of property transaction; (2) government's 15% land resources share: RMB 115429.6 billion×15%=RMB 17314.4 billion; (3) standardized public gardening products: 0.1 billion m²/land area of standardized urban product×10% standardized public gardening products×200 RMB/m²×1100 standardized urban products=RMB 2200 billion; (4) standardized road/bridge products: [100 km²×18.5% land occupation proportion of roads and bridges×120 thousand RMB/mou (including removal and relocation)+RMB 4.897 billion]×1100 sheet-like standardized urban modules=RMB 9049.7 billion; (5) donation of intellectual property rights: RMB 115429.6 billion×20% share of intellectual property rights×50% amount of donation=RMB 11543 billion; (6) aggregate: RMB 48423.1 billion; (7) total aggregate: RMB 7647.9 billion+48423.1 billion=RMB 56071 billion.

Governments at all levels and social welfare organizations within China may obtain an income of RMB 56071 billion.

Total value of the standardized urban product within China: RMB 199392.6 billion total value of the standardized urban product+RMB 28278 billion total value of the R&D transactional standardized urban product=RMB 227670.6 billion.

Total cost of the standardized urban product within China: RMB 67170.4 billion total cost of the standardized urban product+RMB 9245 billion total cost of the R&D transactional standardized urban product=RMB 76415.4 billion.

Total amount of investment of profitable infrastructure supporting facilities within China: RMB 25773 billion gross investment of the standardized urban product+RMB 2318.7 billion gross investment of the R&D transactional standardized urban product=RMB 28091.7 billion.

Total amount of engineering of the standardized urban product within China: RMB 76415.4 billion total cost+RMB 28091.7 billion total cost of supporting facilities=RMB 104507.1 billion.

Gross profit of development of the standardized urban product within China: RMB 115429.6 billion gross profit of the standardized urban product+RMB 18133 billion gross profit of the R&D transactional standardized urban product=RMB 133562.6 billion.

Peasants' profit in land requisition and removal areas of the standardized urban product within China: RMB 31305.4 billion standardized urban product+RMB 4533.3 billion R&D transactional standardized urban product=RMB 35838.7 billion.

Investment Forms of the Standardized Urban Product

In order to ensure that governments and enterprises in poor areas in countries around the world can afford the standardized urban product and the R&D transactional standardized urban product and participate in the main stream of global economic integration and world trade integration in the long term, according to actual situations in poor countries and poor areas, the present invention provides a method of marketing office buildings, residential buildings, and shops at prices far below market prices. The present invention may also market some products at poverty subsidized prices for special poor countries and areas. Residential buildings of the standardized urban product within China may be sold to poor population within China at an especially favorable price of 900 RMB/m². In order to stabilize the price and improve the efficiency, the present invention provides some supporting enterprises of the standardized urban product by inviting investments. The supporting enterprises of the standardized urban product may reduce the cost in research and development, marketing, packaging, advertising, transportation, etc., thereby regulating and controlling constructional steels to a rational price of around 3300 RMB/ton and constructional cement to a rational price of around 260 RMB/ton. The present invention may also provide supporting enterprises of sand mining, stone mining, reinforced concrete or “glued stone” concrete prefabricated components, door and window products, solar energy, house decoration, hotels, rail traffic, ports, ships, trolley buses, car parks, sewage treatment, waste treatment, sea reclamation, pipelines, canal products, funeral and interment, and airports by inviting investments, so as to reduce the manufacturing cost, improve the manufacturing efficiency with scientific division of labor, keep the business cost and living cost of the standardized urban product low, and ensure the competitive edge of the standardized urban product in the international market.

In order to ensure business people of enterprises in poor areas in countries around the world can afford the lodging, meals, and normal marketing expenditure, the present invention provides business hotels and business restaurants with ultra-low prices to provide high-quality services for business people and consumer group in poor areas all over the world, such that the commodity transaction price, hotel accommodation price, and food and beverage price in the standardized urban product are lower than those in large and middle-size cities.

The present invention also provides the idealist region of the R&D transactional standardized urban product in the world for enterprises and wealthy class in developed countries, and provides private airports and private yacht ports for millionaires living in the standardized urban product from countries around the world.

In preferred technical embodiments provided in the present invention, a standardized education group limited company is preferably provided by inviting investments. The standardized education group limited company will collect the development experience, intelligence, knowledge, funds, talents, and scientific and rational marketized management methods of the education industrialization of countries around the world to develop and establish vocational universities, vocational colleges, primary and middle schools, and kindergartens in the standardized urban product in various forms of share offer, joint venture and cooperation, etc., thereby providing schools in the standardized urban product as the base of the knowledge industrialization.

In preferred technical embodiments provided in the present invention, a standardized culture group limited company is preferably provided by inviting investments. The standardized culture group limited company will collect the development experience, intelligence, knowledge, funds, talents, and scientific and rational marketized management methods of the culture industry of countries around the world to establish the culture industry in the standardized urban product into the culture industry with the most distinctive national features in various forms of share offer, joint venture and cooperation, etc.

In preferred technical embodiments provided in the present invention, a standardized medical and health group limited company is preferably provided by inviting investments. The standardized medical group limited company will collect the development experience, intelligence, knowledge, funds, talents, and scientific and rational marketized management methods of the medical of countries around the world to establish the medical industry of the standardized urban product into the most humanized medical industry in various forms of share offer, joint venture and cooperation, etc.

In preferred technical embodiments provided in the present invention, a standardized physical education industry group limited company is preferably provided by inviting investments. The standardized physical education group limited company will collect the development experience, intelligence, knowledge, funds, talents, and scientific and rational marketized management methods of the physical education industry of countries around the world to establish the physical education industry of the standardized urban product into the physical education industry capable of ensuring the physical health of mankind in various forms of share offer, joint venture and cooperation, etc.

In preferred technical embodiments provided in the present invention, a standardized gardening group limited company is preferably established by inviting investments. The standardized gardening group limited company will collect the development experience, intelligence, knowledge, funds, talents, and scientific and rational marketized management methods of the urban gardening industrialization of countries around the world to establish the gardening industry in the standardized urban product into the most humanized gardening industry in forms of share offer, joint venture and cooperation, etc.

In preferred technical embodiments provided in the present invention, a standardized water affairs group limited company is preferably provided by inviting investments. The standardized water affairs group limited company will collect the development experience, intelligence, knowledge, funds, talents, and scientific and rational marketized management methods of the water industry of rainwater, sewage, tap water, underground water, landscape water, etc. of countries around the world to develop all resources of tap water, rainwater, underground water, sewage, river water, lake water, canal water, sea water, landscape water, etc. in the standardized urban product in various forms of share offer, joint venture and cooperation, etc., so as to provide a dreamlike and changeable waterscape world.

In preferred technical embodiments provided in the present invention, a standardized commodity museum group limited company is preferably provided by inviting investments. The commodity museum group limited company will collect the development experience, intelligence, knowledge, funds, talents, and scientific and rational marketized management methods of the commodity museum industrialization of countries around the world to provide theme museums and other museums of various commodity industries in the standardized urban product in forms of share offer, joint venture and cooperation, etc., thereby enabling people to experience the historical process and future development of commodities.

In preferred technical embodiments provided in the present invention, a standardized road/bridge group limited company is preferably provided by inviting investments. The standardized road/bridge group limited company will collect the development experience, intelligence, knowledge, funds, talents, and scientific and rational marketized management methods of the urban road/bridge industrialization of countries around the world to provide standardized and healthy road/bridge facilities in forms of share offer, joint venture and cooperation, etc.

In preferred technical embodiments provided in the present invention, a standardized energy limited company is preferably provided by inviting investments. The standardized energy limited company will collect the development experience, intelligence, knowledge, funds, talents, and scientific and rational marketized management methods of the energy industrialization of countries around the world to provide the standardized energy industry in charge of the energy consumption of the standardize urban product in forms of share offer, joint venture and cooperation, etc.

In preferred technical embodiments provided in the present invention, a standardized information industry group limited company is preferably provided by inviting investments. The standardized information industry group limited company will collect the development experience, intelligence, knowledge, funds, talents, and scientific and rational marketized management methods of the information industry of countries around the world to provide the standardized and healthy communication information facilities in forms of share offer, joint venture and cooperation, etc.

In preferred technical embodiments provided in the present invention, a standardized traffic group limited company is preferably provided by inviting investments. The standardized traffic group limited company will collect the development experience, intelligence, knowledge, funds, talents, and scientific and rational marketized management methods of the traffic industrialization of countries around the world to plan and establish standardized, healthy, and comfortable traffic vehicles in forms of share offer, joint venture and cooperation, etc.

In preferred technical embodiments provided in the present invention, a standardized planning and design group limited company is preferably provided by inviting investments. The standardized planning and design group limited company will collect the experience, intelligence, knowledge, funds, talents, and scientific and rational marketized management methods of the design industrialization of the standardized urban product of countries around the world to plan and design the standardized urban product in forms of share offer, joint venture and cooperation, etc.

In preferred technical embodiments provided in the present invention, a standardized real estate group limited company is preferably provided. The standardized real estate group limited company will collect the development experience, intelligence, knowledge, funds, talents, and scientific and rational marketized management methods of the urban real estate industrialization of countries around the world to manufacture and market house products in the standardized urban product in forms of share offer, joint venture and cooperation, etc.

In preferred technical embodiments provided in the present invention, a standardized financial group limited company is preferably provided. The standardized financial group limited company will collect the experience, intelligence, knowledge, funds, talents, and scientific and rational marketized management methods of the financial industrialization of countries around the world to invest to establish the standardized financial holding bank in forms of share offer, joint venture and cooperation, etc. and implement the market benefitized operation and management on all funds of the standardized urban product, so as to ensure various smooth investment and financing channels of riverside and coastal standardized urban product and maximized funds benefit as well as scientific and rational financial industry distribution of riverside and coastal standardized urban series products.

The greatest wish of inventing and manufacturing the riverside and coastal standardized urban product is to enable investors and consumers to obtain complete information resources about the entire process of investment, research and development, manufacturing and marketing, operation and management, and consumption during the investment, research and development, manufacturing, and transaction, and soberly obtain the most unforgettable knowledge and fun of the marketing process of the entire industry through experiencing by themselves.

So, is there any one who would not like to do concentrated investment and consumption in this urban scenic spot with distinct tastes and offering the most at the best price no matter government agencies and enterprises or shopping lovers from countries around the world? Whoever wants to buy, sell, invest, needs the investment, wants to be employed, needs service and talents, wants to get rid of poverty, dreams of getting rich can find a struggling opportunity and miracle of being successful in the standardized urban product.

For example, a standardized canal module communicating the Yangtze River and the Huaihe River may be built in the place of the inventor, i.e., Anhui province of China, so as to introduce the water source of the Yangtze River and communicate water sources of the Chaohu Lake and the Huaihe River. In this way, Huainan city as China's coal base, Hefei city as China's science and education base, Chaohu city along the lake and river, riverside Wuhu city of new-type industry, and Ma'anshan city as China's iron and steel base in Anhui province may be connected together. Anqing city, Tongling city, Guichi city, and Bengbu city may also be connected by the standardized canal module. With the water source advantage of the Chaohu Lake and the Huaihe River communicated with the Yangtze River, the research and development cost, manufacturing cost, marketing cost, and operation and management cost of the standardized urban product of the Yangtze-Huai Plain of Anhui province may be greatly reduced. Thus, an extra large-size industrial, scientific, commercial, and tourist standardized urban product is manufactured in Anhui province together with coastal cities in middle and lower reaches of the Yangtze River.

For example, factories and dangerous and old houses may be removed in the old city transformation around the Baohe Park of the place of the inventor, i.e., Hefei city to provide tourist spots of the wild animal/plant-type house artistic product for the Baohe scenic spot by applying the invention of the wild animal/plant-type house artistic product. The present invention may also provide wild animal/plant-type restaurant tourist areas around the Dashushan Mountain and the Chaohu Lake of Hefei to enlarge the investment in tourist resources of Hefei.

For example, if more than 80% of the rural population in China migrates to riverside, lakeside, and coastal plains of the middle and lower reaches of the Yangtze River and the Pearl River to realize an urbanized life, the resource wealth per capita is rapidly increased in other provinces of China with the migration and reduction of the population, thereby making most provinces in China provinces of resources. According to the demand of development of the global economic integration, some provinces may be oriented as tourist and cultural provinces, some may be oriented as agricultural provinces, some may be oriented as energy provinces, and those along the river, lake, and sea will become manufacturing and R&D transactional provinces. The harmonious development of the agriculture, forestry, animal husbandry, fishery, cultural tourism, experience economy, energy industry, and processing industry will rapidly increase the per capita wealth of every province, thereby narrowing the income gap between urban and rural areas as well as the rich-poor gap among the eastern, western, and middle regions of China. Finally, like western developed countries such as America and European countries, the rural per capita income will exceed the urban per capita income in China.

The technical scheme provided in the present invention has the following beneficial effects.

Since the transportation volume of ships is larger than that of vehicles and trains, the transportation price of ships is dozens of times lower than that of vehicles and several times lower than that of trains. The use of net-like, [symbol] -type; [symbol] -type, [symbol] -type, [symbol] -type and [symbol] -type standardized canal modules and underground driveway modules may embody the advantage of the standardized urban product in shipping, reduce the manufacturing cost and commercial/residential cost of the standardized urban product, and have very prominent economic benefit. Since the net-like, [symbol] -type, [symbol] -type, [symbol] -type, [symbol] -type, and [symbol] -type standardized canal modules are used to provide the water supply, water discharge, and landscape water to the standardized urban product at a low cost and with sufficient water, the water utilization cost of residents may be reduced and the landscape taste of the standardized urban product may be enhanced. The use of the standardized canal module and the manufacturing method thereof provided in the present invention does not need to be invested with the money of taxpayers.

The net-like standardized road/bridge module provided in the present invention functions as both a highway and a commercial street. Since the net-like standardized road/bridge module provided in the present invention does not need to be invested with the money of taxpayers, has no toll station, does not need any traffic light, and has a smooth traffic, the business cost and residential cost of residents are reduced and their work efficiency and quality of life are improved as well.

The use of the technical scheme of the multifunctional bridge module may not only save the investment in the bridge and increase the traffic capacity of the bridge but also provide special experience services to consumers through entertainment and tourist facilities of the corridor bridge.

The use of the technical scheme of the standardized airport module not only saves land resources, improves the efficiency of checking in at the airport, enhances the gardening landscape taste, and alleviates the visual pollution and noise pollution to residents during the airplane's taking off and landing, but also increases the supply of fresh products such as fresh fish, vegetables, and flowers, which has very prominent economic benefit.

The use of the technique of filling the sea to build cities provided in the present invention may not only dredge up sands, stones, and silt in driveways of rivers and lakes and utilize waste soil resources in the underground space, but also build the standardized urban product by filling, which has very prominent economic benefit.

The use of the mesh-sheet standardized block module may conveniently provide the standardized underground space module on a scale as desired. The mesh-sheet standardized underground space modules are communicated with the mesh-sheet standardized block underground space modules and further communicated with the standardized assembled house modules and other buildings to provide the net-like/mesh-sheet standardized pipeline modules. The maintenance personnel may also drive the maintenance vehicle to check and maintain pipeline products in the underground space, thereby increasing the benefit and reducing the cost without the need of digging and mending on the ground for maintaining the pipeline products any more.

Since all the standardized house module, infrastructure product, gardening product, and waterscape product of the mesh-sheet standardized block module may be prefabricated at the places of resources and transported to the place of the standardized urban product for installation, the price is especially low, thereby not only providing commercial houses at a special price of 900 RMB/m² for the poor of developing countries such as China and India, but also providing intelligent anti-terrorist house products to the rich.

Since the animal/plant-type house artistic product creates more space for human beings to get acquainted and compatible with animals and plants, not only the fairytale house artistic products are created and wild animal/plant-type restaurant products enabling consumers healthy, young, and long-lived are provided, but also the urban architecture art is developed.

All the industrial sewage and domestic sewage in the mesh-sheet standardized block module are respectively collected, scientifically treated, and qualifiedly discharged by sewage pipes. All the wastes in the mesh-sheet standardized block module are transported by the standardized waste dedicated ship to the standardized waste treatment plant for treatment and then used to fill the sea to build cities. The industrial manufacturing and commercial/residential as well as R&D transactional mesh-sheet standardized block modules may be assembled with the net-like standardized canal modules and net-like standardized road/bridge modules, therefore, a small-size standardized urban product may be formed by replicating and assembling three to five or eight to ten mesh-sheet standardized block modules, a middle-size standardized urban product may be formed by replicating and assembling dozens of or hundreds of mesh-sheet standardized block modules, a large-size standardized urban product may be formed by replicating and assembling hundreds of or thousands of mesh-sheet standardized block modules, and an extra large-size standardized urban product may be formed by replicating and assembling tens of, hundreds of, or thousands of sheet-like standardized urban modules. The standardized urban product has a scientific layout, rational function, fresh air, beautiful landscape, and very prominent economic benefit.

Since the teaching form and content of industrial universities and industrial technical schools provided in the present invention match the industrial demand of the global economic integration, the way of combining the teaching with practice, with industrial research and development, and with practical techniques may be realized. Students are not worried about their assignment after graduation. Enterprises are also capable of recruiting profession talents applying theory to practice and skilled industrial artisans.

The industrial park, industrial museum, industrial book center, and industrial science and technology exploration institution provided in the present invention promote the research and development of the commodity industry and the development of the commodity industry economy.

The commodity business center and commodity culture festival provided in the present invention not only improve the work efficiency of commodity enterprises but also enhance the technology content and cultural and artistic taste of commodities.

By the preferred technical embodiments within China provided in the present invention, the life style of the urbanization of 1.1 billion rural population and hundreds of millions of urbanized employment posts may be provided. 0.27 billion mou arable lands and abundant mountain forests and grasslands may be added. 36 thousand km² urban land resources may be added. The water loss and soil erosion and environmental pollution may be effectively controlled.

By the preferred technical scheme embodiments provided in the present invention, a 20 trillion dollar profit of the standardized urban product may be created all over the world under certain conditions. More urban employment posts may be provided. Therefore, the standardized urban product becomes not only an investment paradise for entrepreneurs but also an ideal homestead for young people to live and work in peace and contentment.

What is claimed is:

1. A standardized urban product, characterized by, said standardized urban product is formed by replicating and assembling net-like standardized road/bridge modules and mesh-sheet standardized block modules, wherein the net-like standardized road/bridge modules are arranged between the mesh-sheet standardized block modules; the mesh-sheet standardized block module comprises buildings of the mesh-sheet standardized block modules and underground space modules of the mesh-sheet standardized block modules; the mesh-sheet standardized block modules are arranged between the net-like standardized road/bridge modules; and the mesh-sheet standardized block modules and the net-like standardized road/bridge modules are replicated and assembled to form said standardized urban products on scales meeting people's demands.

2. The standardized urban product according to claim 1, further comprising net-like standardized canal modules, wherein the net-like standardized canal modules are arranged between the mesh-sheet standardized block modules and the net-like standardized road/bridge modules, and the net-like standardized canal modules connect the mesh-sheet standardized block modules and the net-like standardized road/bridge modules, also the mesh-sheet standardized block modules, the net-like standardized road/bridge modules and the net-like standardized canal modules are replicated and assembled to form a standardized urban product with a waterway-canal.

3. The standardized urban product according to claim 1 or 2, wherein a sheet-like standardized urban module comprises net-like standardized rail modules, multifunctional bridge modules, underground fairway modules, standardized airport modules, standardized kindergartens, primary schools, and middle schools, standardized senior high schools, industrial technical schools, industrial universities, industrial museums, and industrial parks.

4. The standardized urban product according to claim 1 or 2, wherein the net-like standardized road/bridge modules are provided with intercommunication standardized overpasses, fast lanes, landscape isolation zones, slow lanes, and sidewalks, the net-like standardized road/bridge modules are arranged in such a way that motor vehicles can drive straightforward and turn right.

5. The standardized urban product according to claim 2, wherein the standardized urban product provides [symbol] -shaped standardized canal modules on irregular landscapes, and the [symbol] -shaped standardized canal modules are arranged between the net-like standardized road/bridge modules and the mesh-sheet standardized block modules.

6. The standardized urban product according to claim 2, wherein the standardized urban product provides standardized canal modules in the shape of [symbol] on irregular landscapes, and the [symbol] shaped standardized canal modules are arranged between the net-like standardized road/bridge modules and the mesh-sheet standardized block modules.

7. The standardized urban product according to claim 2, wherein the net-like, [symbol] [symbol] -shaped standardized canal modules are provided with net-like, [symbol] [symbol] -shaped power supply pipeline modules and intelligent pipeline modules.

8. The standardized urban product according to claim 2, wherein the net-like, [symbol] [symbol] -shaped standardized canal modules are further provided with net-like and mesh-sheet standardized clean water pipe modules for drawing clean groundwater under the ground thereof or under the ground of both sides thereof.

9. The standardized urban product according to claim 1 or 2, wherein the standardized urban product is provided with industrial manufacturing mesh-sheet standardized block modules comprising standardized workshops and other buildings; the industrial manufacturing mesh-sheet standardized block modules are arranged between the mesh-sheet standardized underground space modules and the net-like/mesh-sheet standardized pipeline modules, and also arranged between the net-like standardized road/bridge modules.

10. The standardized urban product according to claim 1 or 2, wherein the standardized urban product is provided with commercial/residential mesh-sheet standardized block modules comprising standardized house modules, animal/plant type house artistic modules, or other buildings; the commercial/residential mesh-sheet standardized block modules are arranged between the mesh-sheet standardized block underground space modules and the net-like/mesh-sheet standardized pipeline modules, and also arranged between the net-like standardized road/bridge modules.

11. The standardized urban product according to claim 1 or 2, wherein the standardized urban product is further provided with research and development (R&D) transactional mesh-sheet standardized block modules comprising standardized house modules, animal/plant type house artistic modules, or other buildings; the R&D transactional mesh-sheet standardized block modules are arranged between the mesh-sheet standardized block underground space modules and the net-like/mesh-sheet standardized pipeline modules, and also arranged between the net-like standardized road/bridge modules.

12. The standardized urban product according to claim 1 or 2, the standardized urban product is further provided with hybrid economic mesh-sheet standardized block modules comprising standardized house modules, animal/plant type house artistic modules, or other buildings; the hybrid economic mesh-sheet standardized block modules are arranged between the mesh-sheet standardized block underground space modules and the net-like/mesh-sheet standardized pipeline modules, and also arranged between the net-like standardized road/bridge modules.

13. The standardized urban product according to claim 1 or 2, wherein the standardized urban product is further provided with garden-type mesh-sheet standardized block modules comprising standardized house modules, animal/plant type house artistic modules, or other buildings; the garden-type mesh-sheet standardized block modules are arranged between the mesh-sheet standardized block underground space modules and the net-like/mesh-sheet standardized pipeline modules, and also arranged between the net-like standardized road/bridge modules.

14. The standardized urban product according to claim 1 or 2, wherein the standardized urban product is further provided with cultural relics and historic sites type mesh-sheet standardized block modules comprising standardized house modules, animal/plant type house artistic modules, or other buildings; the cultural relics and historic sites type mesh-sheet standardized block modules are arranged between the mesh-sheet standardized block underground space modules and the net-like/mesh-sheet standardized pipeline modules, and also arranged between the net-like standardized road/bridge modules.

15. The standardized urban product according to claim 1 or 2, wherein upon actual requirements of resources like rivers, lakes, seas, mountain areas, and wetlands, the standardized urban product is further provided with scenic spot type mesh-sheet standardized block modules comprising standardized house modules or animal/plant type house artistic modules, or other buildings; the scenic spot type mesh-sheet standardized block modules are arranged between the mesh-sheet standardized block underground space modules and the net-like/mesh-sheet standardized pipeline modules, and also arranged between the net-like standardized road/bridge modules.

16. The standardized urban product according to claim 1 or 2, wherein the standardized urban product is further provided with square standardized block modules.

17. The standardized urban product according to claim 1 or 2, wherein the standardized urban product further provides rectangular standardized block modules.

18. The standardized urban product according to claim 1 or 2, wherein the standardized urban product is further provided with triangular standardized block modules.

19. The standardized urban product according to claim 1 or 2, wherein the standardized urban product is further provided with rhombic standardized block modules.

20. The standardized urban product according to claim 1 or 2, wherein the standardized urban product is further provided with hexagonal standardized block modules.

21. The standardized urban product according to claim 1 or 2, wherein the standardized urban product is further provided with patch standardized block modules.

22. The standardized urban product according to claim 1 or 2, wherein the standardized urban product is further provided with circular standardized block modules.

23. The standardized urban product according to claim 1 or 2, wherein the standardized urban product is further provided with elliptic standardized block modules.

24. The standardized urban product according to claim 1 or 2, wherein the standardized urban product is further provided with animal/plant type block artistic modules.

25. The standardized urban product according to claim 1 or 2, wherein the mesh-sheet standardized block modules are provided with standardized commercial pedestrian street modules.

26. The standardized urban product according to claim 1 or 2, wherein the mesh-sheet standardized block modules are set with an area of a (m)×a (m)=a² (m²).

27. The standardized urban product according to claim 1 or 2, wherein the mesh-sheet standardized block modules are set with an area of a (m)×b (m)=ab (m²).

28. The standardized urban product according to claim 1 or 2, wherein the mesh-sheet standardized block modules and the net-like standardized road/bridge modules are integrated and replicated to form a sheet-like standardized urban module assembled with G, one hundred, or within one hundred mesh-sheet standardized block modules.

29. The standardized urban product according to claim 1 or 2, wherein the mesh-sheet standardized block modules, the net-like standardized road/bridge modules, and the net-like standardized canal modules are integrated and replicated to form a net sheet-like standardized urban module assembled with G, one hundred, or within one hundred mesh-sheet standardized block modules.

30. The standardized urban product according to claim 10, further comprising followings industrial prefabricated standardized house components: house foundations, septic tanks, walls, floorslabs, stairs, walkways, doors, windows, balconies, floors, roofs, and other industrial prefabricated standardized house components.

31. The standardized urban product according to claim 10, wherein the standardized house module components are provided with buckling members and prefabricated/preserved holes; the upper-layer walls and the low-layer walls as well as the walls and the roofs are joined by butt welded reinforcing steel bars, and the welding joint are filled by concrete; the lateral joining between the walls, the joining between the doors, windows, walls and the floorslabs, and the joining between the floors are accomplished by buckling members, and then the joints are filled by concrete.

32. The standardized urban product according to claim 10, wherein the standardized house module is integrally prefabricated in a template house module transportation standard case.

33. The standardized urban product according to claim 10, wherein the hollow wall boards of the standardized house module are filled with rice hulls, straws, crop stalks, and other plants, or with plastic foam.

34. The standardized urban product according to claim 10, wherein the walls of the standardized house module have corners with prefabricated/preserved holes; when being assembled, the house module is locked by anchor chains passing through the roof to the house module foundation and penetrating the corners of each floor.

35. The standardized urban product according to claim 10, wherein external walls of the standardized house module have lining walls, and the lining walls are provided with prefabricated/preserved screws and hidden buckle locking chain so as to be chained to the external walls.

36. The standardized urban product according to claim 10, wherein the lining walls of the standardized house module are adhered to the external walls through adhesives.

37. The standardized urban product according to claim 10, wherein the lining walls of the standardized house module are hollow.

38. The standardized urban product according to claim 10, wherein the roofs, walls, doors, and enclosure walls of anti-terrorism house modules are fabricated by explosion-proof, bulletproof, fireproof, waterproof, and sound insulation materials; and the transparent enclosure walls, windows, and swimming pool safety covers of the anti-terrorism house modules are made of bulletproof, radiation-proof, and sound insulation glass.

39. The standardized urban product according to claim 10, wherein the anti-terrorism house modules are provided with antitoxic oxygen supply intelligent early-warning facilities connected to air-conditioners.

40. The standardized urban product according to claim 10, wherein the animal/plant type house artistic modules are fabricated with colors and vivid images of the animals and plants in the nature by construction and decoration materials; the shapes of the animal/plant type house artistic modules portray the animals and plants in the nature; as for the house artistic modules in shapes of animals and plants in the water, environmental color modules matching the animals and plants in the water are provided to serve as podium buildings of the aquatic animal/plant type house artistic modules; and as for the house artistic modules in shapes of the animals and plants on the land, environmental color modules matching the animals and plants on the land are provided to serve as podium buildings of the terrestrial animal/plant type house artistic modules.

41. The standardized urban product according to claim 10, wherein the walls, doors, windows, balconies, roofs, and external decorations of the animal/plant type house artistic modules are artistic portrayal of the animal/plant or in consistent environmental colors; and the walkways, bedrooms, kitchens, toilets, and various pipelines inside the animal/plant type house artistic modules are fabricated by combining the conventional house inner structure with characteristics of the animals and plants.

42. The standardized urban product according to claim 10, wherein the internal/external decorations of the animal/plant type house artistic modules demonstrate and portray origins, evolution, taming, living environment, food chains, natural enemies, scientific knowledge, or legend stories of the animals and plants.

43. The standardized urban product according to claim 10, wherein the animal/plant type house artistic modules are fabricated in the form of comics, sketch, animation, cartoon, paper-cut, iron picture, feather picture, sample picture, shell picture, oil painting, traditional Chinese painting, water color painting, computer drawing, spray painting, sculpture, ceramics, clay sculpture, aluminum alloy steel engraving, reinforcing steel bar cement, wood bamboo carving, clay rock, plastic sculpture, copper sculpture, glass artwork, bio-nano hybrid material imitation, picture-story book, woodcut, fairy tale picture, story picture, film/TV program picture, or photograph.

44. The standardized urban product according to claim 1 or 2, wherein the assemble module in which the net-like standardized road/bridge modules and the mesh-sheet standardized block modules are integrated comprises the net-like/mesh-sheet standardized pipeline modules; upon actual requirements, the net-like/mesh-sheet standardized pipeline modules are selectively provided with net-like/mesh-sheet standardized rainwater pipe modules, net-like/mesh-sheet standardized tap water pipe modules, net-like/mesh-sheet standardized sewage pipe modules, net-like/mesh-sheet standardized clean water pipe modules, net-like/mesh-sheet standardized coal gas pipe modules, net-like/mesh-sheet standardized natural gas pipe modules, net-like/mesh-sheet standardized oil pipe modules, net-like/mesh-sheet standardized heating pipe modules, net-like/mesh-sheet standardized cooling pipe modules, net-like/mesh-sheet standardized power supply pipeline modules, net-like/mesh-sheet standardized telephone pipeline modules, net-like/mesh-sheet standardized TV pipeline modules, net-like/mesh-sheet standardized computer pipeline modules, and net-like/mesh-sheet standardized intelligent pipeline modules.

45. The standardized urban product according to claim 1 or 2, wherein upon actual requirements, the mesh-sheet standardized block underground space modules are provided with underground annular main driveways and cross main driveways in communication with the net-like standardized road/bridge modules; and traffic lanes and sidewalks for ease of coming in and out are located between the annular/cross main driveways and the parking spaces.

46. The standardized urban product according to claim 1 or 2, wherein a business invitation industry standardized urban product is provided.

47. The standardized urban product according to claim 1 or 2, wherein an aircraft industry standardized urban product is provided.

48. The standardized urban product according to claim 1 or 2, wherein a shipping industry standardized urban product is provided.

49. The standardized urban product according to claim 1 or 2, wherein a rail industry standardized urban product is provided.

50. The standardized urban product according to claim 1 or 2, wherein an automobile industry standardized urban product is provided.

51. The standardized urban product according to claim 1 or 2, wherein a motorcycle industry standardized urban product is provided.

52. The standardized urban product according to claim 1 or 2, wherein a bicycle industry standardized urban product is provided.

53. The standardized urban product according to claim 1 or 2, wherein a construction machinery industry standardized urban product is provided.

54. The standardized urban product according to claim 1 or 2, wherein a construction material industry standardized urban product is provided.

55. The standardized urban product according to claim 1 or 2, wherein a steel industry standardized urban product is provided.

56. The standardized urban product according to claim 1 or 2, wherein a copper material industry standardized urban product is provided.

57. The standardized urban product according to claim 1 or 2, wherein an aluminum material industry standardized urban product is provided.

58. The standardized urban product according to claim 1 or 2, wherein a mining industry standardized urban product is provided.

59. The standardized urban product according to claim 1 or 2, wherein a petrochemical industry standardized urban product is provided.

60. The standardized urban product according to claim 1 or 2, wherein a fuel gas industry standardized urban product is provided.

61. The standardized urban product according to claim 1 or 2, wherein an environmental protection industry standardized urban product is provided.

62. The standardized urban product according to claim 1 or 2, wherein an electric power industry standardized urban product is provided.

63. The standardized urban product according to claim 1 or 2, wherein an agricultural product industry standardized urban product is provided.

64. The standardized urban product according to claim 1 or 2, wherein an ethnic customs dietary culture industry standardized urban product is provided.

65. The standardized urban product according to claim 1 or 2, wherein a furniture industry standardized urban product is provided.

66. The standardized urban product according to claim 1 or 2, wherein an office industry standardized urban product is provided.

67. The standardized urban product according to claim 1 or 2, wherein a cultural and artistic industry standardized urban product is provided.

68. The standardized urban product according to claim 1 or 2, wherein a sports industry standardized urban product is provided.

69. The standardized urban product according to claim 1 or 2, wherein a medical health industry standardized urban product is provided.

70. The standardized urban product according to claim 1 or 2, wherein an education industry standardized urban product is provided.

71. The standardized urban product according to claim 1 or 2, wherein a communication information industry standardized urban product is provided.

72. The standardized urban product according to claim 1 or 2, wherein a household appliances industry standardized urban product is provided.

73. The standardized urban product according to claim 1 or 2, wherein a textile industry standardized urban product is provided.

74. The standardized urban product according to claim 1 or 2, wherein an industrial machinery industry standardized urban product is provided.

75. The standardized urban product according to claim 1 or 2, wherein a commodity industry standardized urban product is provided.

76. The standardized urban product according to claim 1 or 2, wherein a heater/cooler industry standardized urban product is provided.

77. The standardized urban product according to claim 1 or 2, wherein an elevator industry standardized urban product is provided.

78. The standardized urban product according to claim 1 or 2, wherein a food industry standardized urban product is provided.

79. The standardized urban product according to claim 1 or 2, wherein a paper printing industry standardized urban product is provided.

80. The standardized urban product according to claim 1 or 2, wherein a gardening industry standardized urban product is provided.

81. The standardized urban product according to claim 1 or 2, wherein a disabled supplies industry standardized urban product is provided.

82. The standardized urban product according to claim 1 or 2, wherein a logistics industry standardized urban product is provided.

83. The standardized urban product according to claim 1 or 2, wherein a military/police supplies industry standardized urban product is provided.

84. The standardized urban product according to claim 3, wherein the sheet-like standardized urban modules are set with an area of a (m)×a (m)=a² (m²).

85. The standardized urban product according to claim 3, wherein the sheet-like standardized urban modules are set with an area of a (m)×b (m)=ab (m²).

86. The standardized urban product according to claim 3, wherein the standardized urban product is provided with the net-like standardized rail modules, and the net-like standardized rail modules are arranged between the net-like standardized road/bridge modules and the mesh-sheet standardized block modules.

87. The standardized urban product according to claim 3, wherein t the standardized urban product is provided with the net-like standardized rail modules, and the net-like standardized rail modules are arranged between the net-like standardized road/bridge modules and the mesh-sheet standardized block modules as well as the net-like standardized canal modules.

88. The standardized urban product according to claim 3, wherein the standardized urban product is provided with the net-like standardized rail modules, and the net-like standardized rail modules are arranged between the net-like standardized road/bridge modules and the sheet-like standardized urban modules.

89. The standardized urban product according to claim 3, wherein the standardized urban product is provided with the net-like standardized rail modules, and the net-like standardized rail modules are arranged between the net-like standardized road/bridge modules and the sheet-like standardized urban modules as well as the net-like standardized canal modules.

90. The standardized urban product according to claim 3, further comprising industrial technical schools.

91. The standardized urban product according to claim 3, further comprising industrial universities.

92. The standardized urban product according to claim 3, further comprising industrial parks.

93. The standardized urban product according to claim 3, further comprising industrial museums.

94. The standardized urban product according to claim 3, wherein the mesh-sheet standardized block modules at a number less than or equal to four, or less than or equal to G are provided with a standardized kindergarten, primary and middle school composed of a kindergarten, a primary school, and a middle school; the mesh-sheet standardized block modules at a number less than or equal to 25 or less than or equal to G are provided with a standardized senior high school; the standardized senior high school and the standardized kindergarten, primary, and middle school both have sports, scientific, literary & experimental, library, and network areas.

95. The standardized urban product according to claim 3, wherein the underground fairway module takes water as the carrier.

96. The standardized urban product according to claim 3, wherein the underground fairway module having a cross-sectional area=π×(d÷2)²÷2+d·b+π×(d÷2)²÷2 and a length of L (m) is located in a range from altitude D (m) to altitude C (m).

97. The standardized urban product according to claim 3, wherein the underground fairway module is provided with standardized power supply pipelines, standardized intelligent pipelines, and electric/intelligent loading/unloading dock areas.

98. The standardized urban product according to claim 3, wherein water inlets and outlets of the underground fairway module are equipped with electric/intelligent water gates.

99. The standardized urban product according to claim 3, wherein the multifunctional bridge module is provided with railways and rail stations; the rail station is equipped with sightseeing elevators and sightseeing stairs directly leading to the sightseeing corridor bridge on the top floor; the multifunctional bridge module is further provided with traffic lanes for heavy/light vehicles and parking platforms; and the parking platform is equipped with sightseeing elevators or sightseeing stairs.

100. The standardized urban product according to claim 3, wherein the multifunctional bridge module is provided with one-story or multi-story sightseeing corridor bridges; and the sightseeing corridor bridge is further equipped with entertainment sightseeing places and sightseeing passages.

101. The standardized urban product according to claim 3, wherein the multifunctional bridge module has a first-layer bridge floor provided with fast lanes and slow lanes, and a second-layer bridge floor provided with sightseeing corridor bridges for pedestrians.

102. The standardized urban product according to claim 3, wherein the standardized airport module is provided with standardized terminal modules in a shape of [symbol] [symbol] .

103. A method for manufacturing a standardized urban product, wherein components of standardized house modules and urban infrastructures in the standardized urban product are designed, fabricated at places of origin for raw materials according to standardized modules, and then transported to a location of the standardized urban product to be further installed in standard.

104. The method for manufacturing a standardized urban product according to claim 103, wherein it is convenient for the mesh-sheet standardized block modules to provide underground space modules with required scales; and earthwork demanded by the mesh-sheet standardized block underground space modules is shipped through amphibian dredges or earthwork transport belts or earthwork transport ships to a sea beach for filling the sea to build cities or to a lake shoal for filling the lake to build cities.

105. The method for manufacturing a standardized urban product according to claim 103, wherein the standardized urban product lends standardized workshops by means of rent-free or rent reduction, so as to attract more industrial enterprises and accommodate more employees, thereby promoting the marketing of standardized house products.
